(19) United States
(12) Patent Application Publication
(10) Pub. No.: US 2025/0315221 A1
(43) Pub. Date: Oct. 9, 2025

(54) USER INTERFACES FOR MANAGING CONTENT

(71) Applicant: Apple Inc., Cupertino, CA (US)

(72) Inventors: Holly C. LOWE, Redwood City, CA (US); Anders BERTELRUD, Burlingame, CA (US); Cecilia M. MINNIEAR, San Francisco, CA (US); Johanna D. LYNN, Vancouver (CA); John T. CROMIE, Co. Donegal (IE); Justin CHUNG, Redwood City, CA (US); Kfir LEV-ARI, Sunnyvale, CA (US); Madison FILEMAN, San Francisco, CA (US); Marcus T. JACKSON, San Francisco, CA (US); Maxwell O. DRUKMAN, New York, NY (US); Ori HERRNSTADT, Los Altos Hills, CA (US); Ryan P. DOHERTY, Ofallon, MO (US); Samuel PAGE, Brunswick West (AU); Seyyed Mostafa AREFIYAN KHALILABAD, San Jose, CA (US); Solomon Jason KIM, Santa Clara, CA (US); Stephen D. WAKULCHIK, Mill Valley, CA (US); Timothy V. ISTED, Los Gatos, CA (US); Tomer Y. DORON, San Francisco, CA (US)

(21) Appl. No.: 19/049,828

(22) Filed: Feb. 10, 2025

Related U.S. Application Data
(60) Provisional application No. 63/631,092, filed on Apr. 8, 2024.
(60) Provisional application No. 63/646,854, filed on May 13, 2024.
(60) Provisional application No. 63/657,905, filed on Jun. 9, 2024.
(60) Provisional application No. 63/703,992, filed on Oct. 6, 2024.

(51) Int. Cl. G06F 8/34; G06F 8/33

(52) U.S. Cl. CPC G06F 8/34; G06F 8/33

(57) ABSTRACT

The present disclosure generally relates to managing content. Some techniques are for providing responses based on a portion of content and a user inquiry in accordance with some embodiments. Other techniques are for displaying a visual indications of the result of running a section of code in accordance with some embodiments. Other techniques are for selectively displaying an indication of additional proposed text based on length of additional text in accordance with some embodiments. Other techniques are for modifying multiple portions of text as the result of an input to a request to modify the text in accordance with some embodiments.

### CROSS-REFERENCE TO RELATED APPLICATIONS

This application relates to U.S. Provisional Patent Application Ser. No. 63/703,992, entitled “USER INTERFACES FOR MANAGING CONTENT” filed Oct. 6, 2024, U.S. Provisional Patent Application Ser. No. 63/657,905, entitled “USER INTERFACES FOR MANAGING CONTENT” filed Jun. 9, 2024, to U.S. Provisional Patent Application Ser. No. 63/646,854, entitled “USER INTERFACES FOR MANAGING CONTENT” filed May 13, 2024, and to U.S. Provisional Patent Application Ser. No. 63/631,092, entitled “USER INTERFACES FOR MANAGING CONTENT” filed Apr. 8, 2024, which are hereby incorporated by reference in their entireties for all purposes.

### FIELD

The present disclosure relates generally to computer user interfaces, and more specifically to techniques for managing content.

### BACKGROUND

Electronic devices are often used for editing content. Such electronic devices include user interfaces that enable deleting and adding content.

### SUMMARY

Some techniques for managing content using electronic devices, however, are generally cumbersome and inefficient. For example, some existing techniques use a complex and time-consuming user interface, which may include multiple mouse clicks, key presses, and/or keystrokes. Existing techniques require more time than necessary, wasting user time and device energy. This latter consideration is particularly important in battery-operated devices.

Accordingly, the present technique provides electronic devices with faster, more efficient processes and interfaces for managing content. Such processes and interfaces optionally complement or replace other processes for managing content. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more input devices and one or more output devices including one or more display generation components is described. In some embodiments, the method comprises: displaying, via the one or more display generation components, an editing user interface including content; while displaying the editing user interface, detecting, via the one or more input devices, an input corresponding to a respective user inquiry; and in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

In some embodiments, a non-transitory computer-readable storage medium storing one or more programs configured to be executed by one or more processors of a computer system that is in communication with one or more input devices and one or more output devices including one or more display generation components is described. In some embodiments, the one or more programs includes instructions for: displaying, via the one or more display generation components, an editing user interface including content; while displaying the editing user interface, detecting, via the one or more input devices, an input corresponding to a respective user inquiry; and in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

In some embodiments, a transitory computer-readable storage medium storing one or more programs configured to be executed by one or more processors of a computer system that is in communication with one or more input devices and one or more output devices including one or more display generation components is described. In some embodiments, the one or more programs includes instructions for: displaying, via the one or more display generation components, an editing user interface including content; while displaying the editing user interface, detecting, via the one or more input devices, an input corresponding to a respective user inquiry; and in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

In some embodiments, a computer system configured to communicate with one or more input devices and one or more output devices including one or more display generation components is described. In some embodiments, the computer system comprises one or more processors and memory storing one or more programs configured to be executed by the one or more processors. In some embodiments, the one or more programs includes instructions for: displaying, via the one or more display generation components, an editing user interface including content; while displaying the editing user interface, detecting, via the one or more input devices, an input corresponding to a respective user inquiry; and in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

In some embodiments, a computer system configured to communicate with one or more input devices and one or more output devices including one or more display generation components is described. In some embodiments, the computer system comprises means for performing each of the following steps: displaying, via the one or more display generation components, an editing user interface including content; while displaying the editing user interface, detecting, via the one or more input devices, an input corresponding to a respective user inquiry; and in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

In some embodiments, a computer program product is described. In some embodiments, the computer program product comprises one or more programs configured to be executed by one or more processors of a computer system that is in communication with one or more input devices and one or more output devices including one or more display generation components. In some embodiments, the one or more programs include instructions for: displaying, via the one or more display generation components, an editing user interface including content; while displaying the editing user interface, detecting, via the one or more input devices, an input corresponding to a respective user inquiry; and in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

In some embodiments, a method that is performed at a computer system that is in communication with a display generation component and one or more input devices is described. In some embodiments, the method comprises: detecting, via the one or more input devices, an input corresponding to a request to generate auxiliary code that corresponds to a first section of code; and in response to detecting the input corresponding to the request to generate the auxiliary code that corresponds to the first section of code: displaying, via the display generation component, a second section of code that is different from the first section of code and was generated based on the request to generate the auxiliary code; and displaying, via the display generation component, a visual indication of a result of running the second section of code.

In some embodiments, a non-transitory computer-readable storage medium storing one or more programs configured to be executed by one or more processors of a computer system that is in communication with a display generation component and one or more input devices is described. In some embodiments, the one or more programs includes instructions for: detecting, via the one or more input devices, an input corresponding to a request to generate auxiliary code that corresponds to a first section of code; and in response to detecting the input corresponding to the request to generate the auxiliary code that corresponds to the first section of code: displaying, via the display generation component, a second section of code that is different from the first section of code and was generated based on the request to generate the auxiliary code; and displaying, via the display generation component, a visual indication of a result of running the second section of code.

In some embodiments, a transitory computer-readable storage medium storing one or more programs configured to be executed by one or more processors of a computer system that is in communication with a display generation component and one or more input devices is described. In some embodiments, the one or more programs includes instructions for: detecting, via the one or more input devices, an input corresponding to a request to generate auxiliary code that corresponds to a first section of code; and in response to detecting the input corresponding to the request to generate the auxiliary code that corresponds to the first section of code: displaying, via the display generation component, a second section of code that is different from the first section of code and was generated based on the request to generate the auxiliary code; and displaying, via the display generation component, a visual indication of a result of running the second section of code.

In some embodiments, a computer system configured to communicate with a display generation component and one or more input devices is described. In some embodiments, the computer system comprises one or more processors and memory storing one or more programs configured to be executed by the one or more processors. In some embodiments, the one or more programs includes instructions for: detecting, via the one or more input devices, an input corresponding to a request to generate auxiliary code that corresponds to a first section of code; and in response to detecting the input corresponding to the request to generate the auxiliary code that corresponds to the first section of code: displaying, via the display generation component, a second section of code that is different from the first section of code and was generated based on the request to generate the auxiliary code; and displaying, via the display generation component, a visual indication of a result of running the second section of code.

In some embodiments, a computer system configured to communicate with a display generation component and one or more input devices is described. In some embodiments, the computer system comprises means for performing each of the following steps: detecting, via the one or more input devices, an input corresponding to a request to generate auxiliary code that corresponds to a first section of code; and in response to detecting the input corresponding to the request to generate the auxiliary code that corresponds to the first section of code: displaying, via the display generation component, a second section of code that is different from the first section of code and was generated based on the request to generate the auxiliary code; and displaying, via the display generation component, a visual indication of a result of running the second section of code.

In some embodiments, a computer program product is described. In some embodiments, the computer program product comprises one or more programs configured to be executed by one or more processors of a computer system that is in communication with a display generation component and one or more input devices. In some embodiments, the one or more programs include instructions for: detecting, via the one or more input devices, an input corresponding to a request to generate auxiliary code that corresponds to a first section of code; and in response to detecting the input corresponding to the request to generate the auxiliary code that corresponds to the first section of code: displaying, via the display generation component, a second section of code that is different from the first section of code and was generated based on the request to generate the auxiliary code; and displaying, via the display generation component, a visual indication of a result of running the second section of code.

In some embodiments, a method that is performed at a computer system that is in communication with one or more input devices and one or more display generation components is described. In some embodiments, the method comprises: detecting, via the one or more input devices, an input corresponding to a request to add additional text to a text entry field; and in response to detecting the input corresponding to the request to add additional text to the text entry field: in accordance with a determination that proposed text includes a first amount of text, displaying, via the one or more display generation components, a first portion of the proposed text with a respective indication that an additional portion of the proposed text is available to be added to the text entry field, wherein the additional portion of the proposed text is different from the first portion of the proposed text; and in accordance with a determination that the proposed text includes a second amount of text different from the first amount, displaying, via the one or more display generation components, a second portion of the proposed text without the respective indication that an additional portion of the proposed text is available to be added to the text entry field.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: detecting, via the one or more input devices, an input corresponding to a request to add additional text to a text entry field; and in response to detecting the input corresponding to the request to add additional text to the text entry field: in accordance with a determination that proposed text includes a first amount of text, displaying, via the one or more display generation components, a first portion of the proposed text with a respective indication that an additional portion of the proposed text is available to be added to the text entry field, wherein the additional portion of the proposed text is different from the first portion of the proposed text; and in accordance with a determination that the proposed text includes a second amount of text different from the first amount, displaying, via the one or more display generation components, a second portion of the proposed text without the respective indication that an additional portion of the proposed text is available to be added to the text entry field.

In some embodiments, a transitory computer-readable storage medium storing one or more programs configured to be executed by one or more processors of a computer system that is in communication with one or more input devices and one or more display generation components is described. In some embodiments, the one or more programs includes instructions for: detecting, via the one or more input devices, an input corresponding to a request to add additional text to a text entry field; and in response to detecting the input corresponding to the request to add additional text to the text entry field: in accordance with a determination that proposed text includes a first amount of text, displaying, via the one or more display generation components, a first portion of the proposed text with a respective indication that an additional portion of the proposed text is available to be added to the text entry field, wherein the additional portion of the proposed text is different from the first portion of the proposed text; and in accordance with a determination that the proposed text includes a second amount of text different from the first amount, displaying, via the one or more display generation components, a second portion of the proposed text without the respective indication that an additional portion of the proposed text is available to be added to the text entry field.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: detecting, via the one or more input devices, an input corresponding to a request to add additional text to a text entry field; and in response to detecting the input corresponding to the request to add additional text to the text entry field: in accordance with a determination that proposed text includes a first amount of text, displaying, via the one or more display generation components, a first portion of the proposed text with a respective indication that an additional portion of the proposed text is available to be added to the text entry field, wherein the additional portion of the proposed text is different from the first portion of the proposed text; and in accordance with a determination that the proposed text includes a second amount of text different from the first amount, displaying, via the one or more display generation components, a second portion of the proposed text without the respective indication that an additional portion of the proposed text is available to be added to the text entry field.

In some embodiments, a computer system configured to communicate with one or more input devices and one or more display generation components is described. In some embodiments, the computer system comprises means for performing each of the following steps: detecting, via the one or more input devices, an input corresponding to a request to add additional text to a text entry field; and in response to detecting the input corresponding to the request to add additional text to the text entry field: in accordance with a determination that proposed text includes a first amount of text, displaying, via the one or more display generation components, a first portion of the proposed text with a respective indication that an additional portion of the proposed text is available to be added to the text entry field, wherein the additional portion of the proposed text is different from the first portion of the proposed text; and in accordance with a determination that the proposed text includes a second amount of text different from the first amount, displaying, via the one or more display generation components, a second portion of the proposed text without the respective indication that an additional portion of the proposed text is available to be added to the text entry field.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: detecting, via the one or more input devices, an input corresponding to a request to add additional text to a text entry field; and in response to detecting the input corresponding to the request to add additional text to the text entry field: in accordance with a determination that proposed text includes a first amount of text, displaying, via the one or more display generation components, a first portion of the proposed text with a respective indication that an additional portion of the proposed text is available to be added to the text entry field, wherein the additional portion of the proposed text is different from the first portion of the proposed text; and in accordance with a determination that the proposed text includes a second amount of text different from the first amount, displaying, via the one or more display generation components, a second portion of the proposed text without the respective indication that an additional portion of the proposed text is available to be added to the text entry field.

In some embodiments, a method that is performed at a computer system that is in communication with one or more input devices and one or more display generation components is described. In some embodiments, the method comprises: displaying, via the one or more display generation components, text including a first portion of the text and a second portion of the text different from the first portion of the text; while displaying the text, detecting, via the one or more input devices, an input corresponding to a request to modify the text based on a respective user inquiry; in response to detecting the input corresponding to the request to modify the text based on the respective user inquiry, modifying the text including a first modification to the first portion of the text and a second modification to the second portion of the text, wherein the first modification includes a different change than the second modification; and after modifying the text in response to detecting the input corresponding to the request to modify the text, displaying, via the one or more display generation components, the first portion of the text with the first modification and the second portion of the text with the second modification.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, text including a first portion of the text and a second portion of the text different from the first portion of the text; while displaying the text, detecting, via the one or more input devices, an input corresponding to a request to modify the text based on a respective user inquiry; in response to detecting the input corresponding to the request to modify the text based on the respective user inquiry, modifying the text including a first modification to the first portion of the text and a second modification to the second portion of the text, wherein the first modification includes a different change than the second modification; and after modifying the text in response to detecting the input corresponding to the request to modify the text, displaying, via the one or more display generation components, the first portion of the text with the first modification and the second portion of the text with the second modification.

In some embodiments, a transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, text including a first portion of the text and a second portion of the text different from the first portion of the text; while displaying the text, detecting, via the one or more input devices, an input corresponding to a request to modify the text based on a respective user inquiry; in response to detecting the input corresponding to the request to modify the text based on the respective user inquiry, modifying the text including a first modification to the first portion of the text and a second modification to the second portion of the text, wherein the first modification includes a different change than the second modification; and after modifying the text in response to detecting the input corresponding to the request to modify the text, displaying, via the one or more display generation components, the first portion of the text with the first modification and the second portion of the text with the second modification.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: displaying, via the one or more display generation components, text including a first portion of the text and a second portion of the text different from the first portion of the text; while displaying the text, detecting, via the one or more input devices, an input corresponding to a request to modify the text based on a respective user inquiry; in response to detecting the input corresponding to the request to modify the text based on the respective user inquiry, modifying the text including a first modification to the first portion of the text and a second modification to the second portion of the text, wherein the first modification includes a different change than the second modification; and after modifying the text in response to detecting the input corresponding to the request to modify the text, displaying, via the one or more display generation components, the first portion of the text with the first modification and the second portion of the text with the second modification.

In some embodiments, a computer system configured to communicate with one or more input devices and one or more display generation components is described. In some embodiments, the computer system comprises means for performing each of the following steps: displaying, via the one or more display generation components, text including a first portion of the text and a second portion of the text different from the first portion of the text; while displaying the text, detecting, via the one or more input devices, an input corresponding to a request to modify the text based on a respective user inquiry; in response to detecting the input corresponding to the request to modify the text based on the respective user inquiry, modifying the text including a first modification to the first portion of the text and a second modification to the second portion of the text, wherein the first modification includes a different change than the second modification; and after modifying the text in response to detecting the input corresponding to the request to modify the text, displaying, via the one or more display generation components, the first portion of the text with the first modification and the second portion of the text with the second modification.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: displaying, via the one or more display generation components, text including a first portion of the text and a second portion of the text different from the first portion of the text; while displaying the text, detecting, via the one or more input devices, an input corresponding to a request to modify the text based on a respective user inquiry; in response to detecting the input corresponding to the request to modify the text based on the respective user inquiry, modifying the text including a first modification to the first portion of the text and a second modification to the second portion of the text, wherein the first modification includes a different change than the second modification; and after modifying the text in response to detecting the input corresponding to the request to modify the text, displaying, via the one or more display generation components, the first portion of the text with the first modification and the second portion of the text with the second modification.

In some embodiments, a method that is performed at a computer system that is in communication with one or more input devices and one or more display generation components is described. In some embodiments, the method comprises: displaying, via the one or more display generation components, a representation of content, wherein the content includes a first portion of text and a second portion of text different from the first portion of text; while displaying the representation of content, detecting, via the one or more input devices, an input corresponding to a request to modify the content based on a respective user inquiry; in response to detecting the input corresponding to the request to modify the content based on the respective user inquiry, modifying the content including a first modification to the first portion of text and a second modification to the second portion of text, wherein the first modification includes a different change than the second modification; and after modifying the content in response to detecting the input corresponding to the request to modify the content, displaying, via the one or more display generation components, the first portion of text with the first modification and the second portion of text with the second modification.

In some embodiments, a non-transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a representation of content, wherein the content includes a first portion of text and a second portion of text different from the first portion of text; while displaying the representation of content, detecting, via the one or more input devices, an input corresponding to a request to modify the content based on a respective user inquiry; in response to detecting the input corresponding to the request to modify the content based on the respective user inquiry, modifying the content including a first modification to the first portion of text and a second modification to the second portion of text, wherein the first modification includes a different change than the second modification; and after modifying the content in response to detecting the input corresponding to the request to modify the content, displaying, via the one or more display generation components, the first portion of text with the first modification and the second portion of text with the second modification.

In some embodiments, a transitory computer-readable storage medium storing one or more programs configured to be executed by one or more processors of a computer system that is in communication with one or more input devices and one or more display generation components is described. In some embodiments, the one or more programs includes instructions for: displaying, via the one or more display generation components, a representation of content, wherein the content includes a first portion of text and a second portion of text different from the first portion of text; while displaying the representation of content, detecting, via the one or more input devices, an input corresponding to a request to modify the content based on a respective user inquiry; in response to detecting the input corresponding to the request to modify the content based on the respective user inquiry, modifying the content including a first modification to the first portion of text and a second modification to the second portion of text, wherein the first modification includes a different change than the second modification; and after modifying the content in response to detecting the input corresponding to the request to modify the content, displaying, via the one or more display generation components, the first portion of text with the first modification and the second portion of text with the second modification.

In some embodiments, a computer system configured to communicate with one or more input devices and one or more display generation components is described. In some embodiments, the computer system comprises one or more processors and memory storing one or more programs configured to be executed by the one or more processors. In some embodiments, the one or more programs includes instructions for: displaying, via the one or more display generation components, a representation of content, wherein the content includes a first portion of text and a second portion of text different from the first portion of text; while displaying the representation of content, detecting, via the one or more input devices, an input corresponding to a request to modify the content based on a respective user inquiry; in response to detecting the input corresponding to the request to modify the content based on the respective user inquiry, modifying the content including a first modification to the first portion of text and a second modification to the second portion of text, wherein the first modification includes a different change than the second modification; and after modifying the content in response to detecting the input corresponding to the request to modify the content, displaying, via the one or more display generation components, the first portion of text with the first modification and the second portion of text with the second modification.

In some embodiments, a computer system configured to communicate with one or more input devices and one or more display generation components is described. In some embodiments, the computer system comprises means for performing each of the following steps: displaying, via the one or more display generation components, a representation of content, wherein the content includes a first portion of text and a second portion of text different from the first portion of text; while displaying the representation of content, detecting, via the one or more input devices, an input corresponding to a request to modify the content based on a respective user inquiry; in response to detecting the input corresponding to the request to modify the content based on the respective user inquiry, modifying the content including a first modification to the first portion of text and a second modification to the second portion of text, wherein the first modification includes a different change than the second modification; and after modifying the content in response to detecting the input corresponding to the request to modify the content, displaying, via the one or more display generation components, the first portion of text with the first modification and the second portion of text with the second modification.

In some embodiments, a computer program product is described. In some embodiments, the computer program product comprises one or more programs configured to be executed by one or more processors of a computer system that is in communication with one or more input devices and one or more display generation components. In some embodiments, the one or more programs include instructions for: displaying, via the one or more display generation components, a representation of content, wherein the content includes a first portion of text and a second portion of text different from the first portion of text; while displaying the representation of content, detecting, via the one or more input devices, an input corresponding to a request to modify the content based on a respective user inquiry; in response to detecting the input corresponding to the request to modify the content based on the respective user inquiry, modifying the content including a first modification to the first portion of text and a second modification to the second portion of text, wherein the first modification includes a different change than the second modification; and after modifying the content in response to detecting the input corresponding to the request to modify the content, displaying, via the one or more display generation components, the first portion of text with the first modification and the second portion of text with the second modification.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing content, thereby increasing the effectiveness, efficiency, and user satisfaction with such devices. Such processes and interfaces may complement or replace other processes for managing content.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AN illustrate exemplary user interfaces for managing content in accordance with some embodiments.

FIG. 7 is a flow diagram illustrating a process for providing responses based on a portion of content and a user inquiry in accordance with some embodiments.

FIG. 8 is a flow diagram illustrating a process for displaying a visual indications of the result of running a section of code in accordance with some embodiments.

FIGS. 9A-9AD illustrate exemplary user interfaces for completing content in accordance with some embodiments.

FIG. 10 is a flow diagram illustrating a process for selectively displaying an indication of additional proposed text based on length of additional text in accordance with some embodiments.

FIG. 11 is a flow diagram illustrating a process for modifying multiple portions of text as the result of an input to a request to modify the text in accordance with some embodiments.

FIG. 12 is a flow diagram illustrating a process for modifying multiple portions of text as the result of an input to a request to modify content in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing content. For example, answers can be provided based on a user inquiry and a portion of code. In another example, a result can be provided by running auxiliary code for a section of code. In another example, proposed code can be provided including an indication of additional code based on the length of the proposed code. In yet another example, multiple portions of text are modified based on an inquiry from a user. Such techniques can reduce the cognitive burden on a user who on a user who edits code, thereby enhancing productivity. Further, such techniques can reduce processor and battery power otherwise wasted on redundant user inputs.

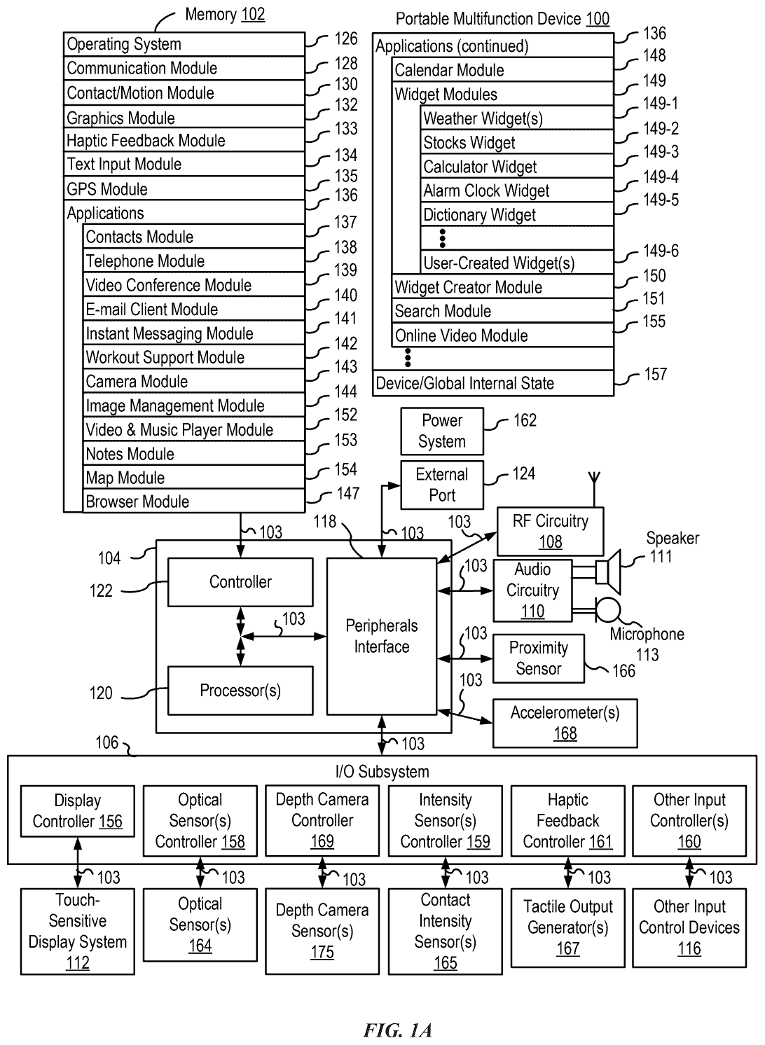

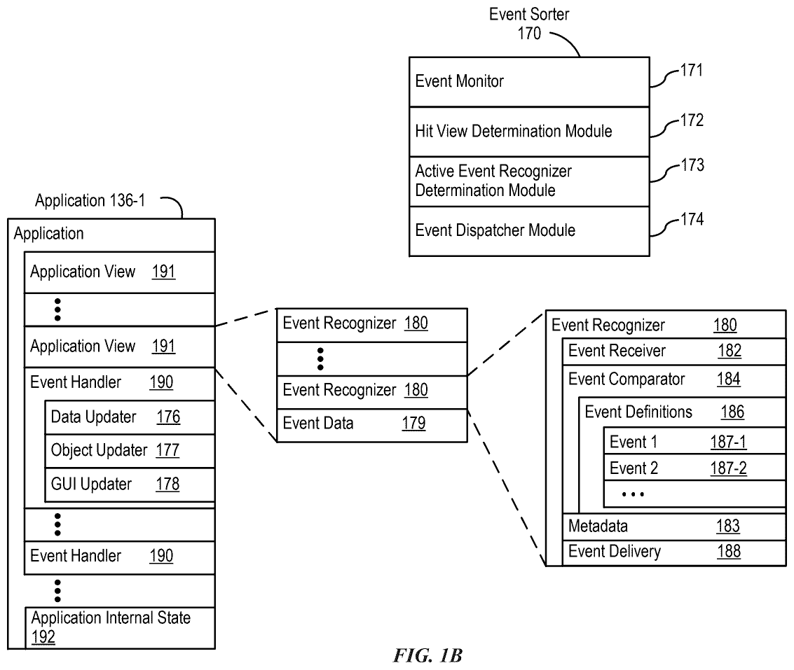

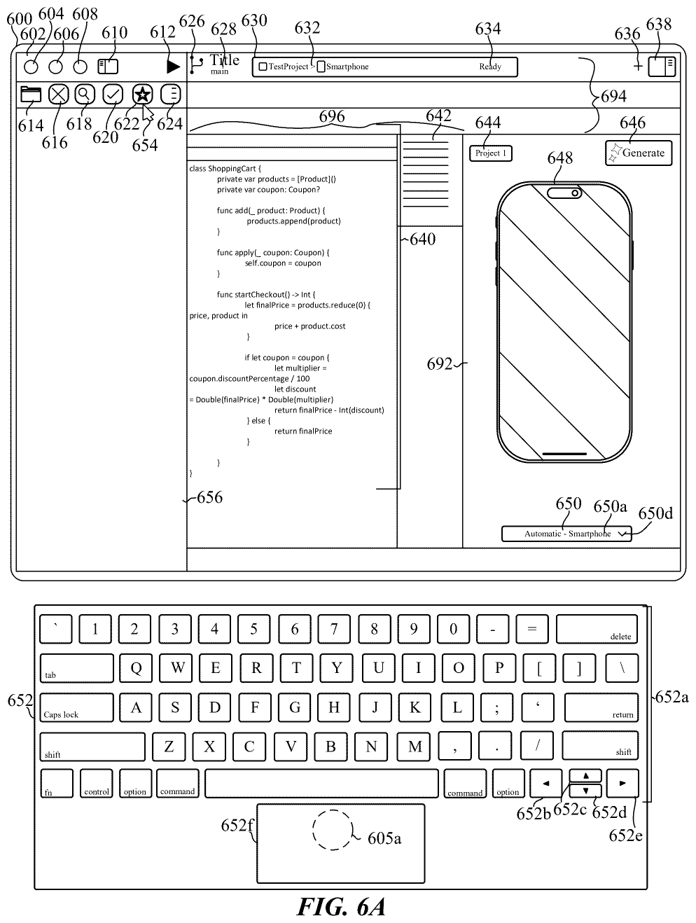

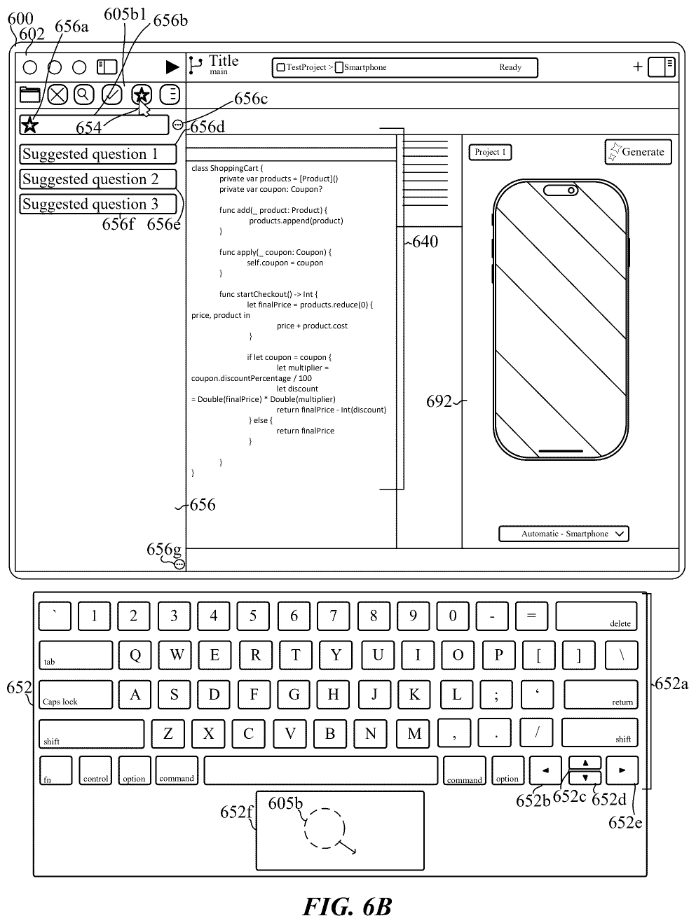

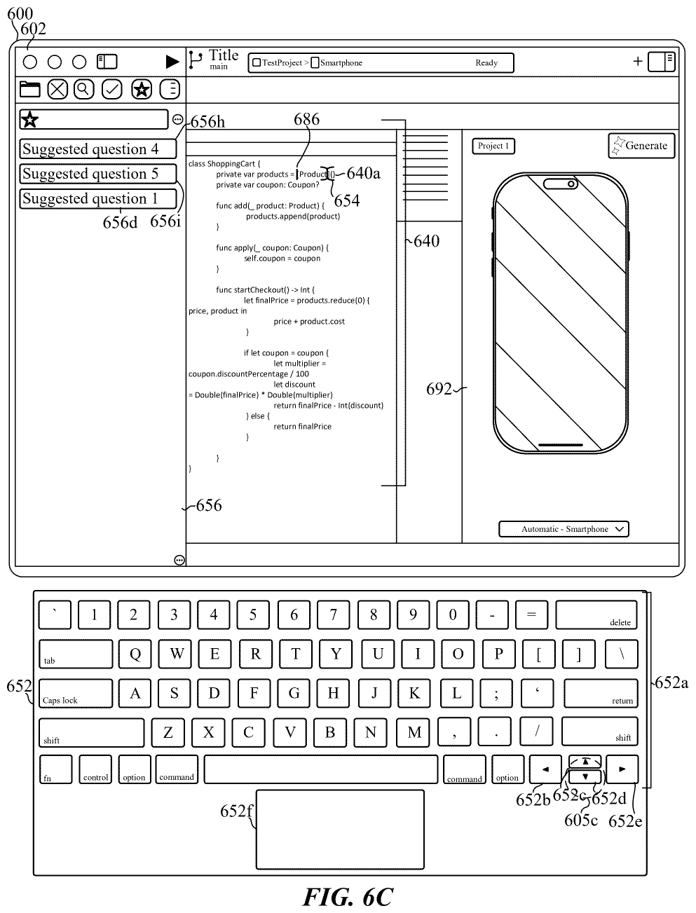

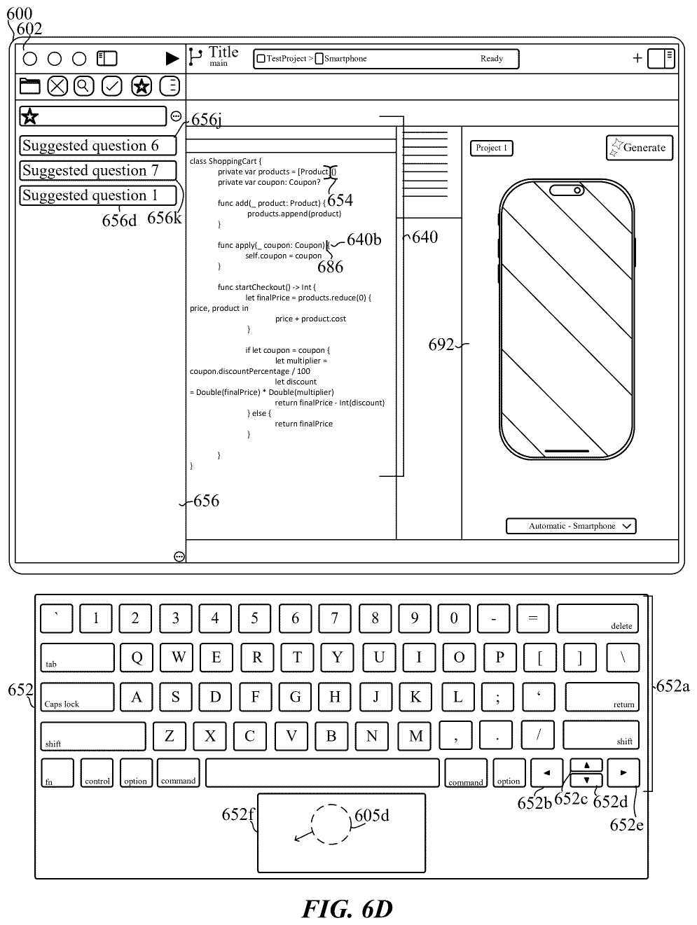

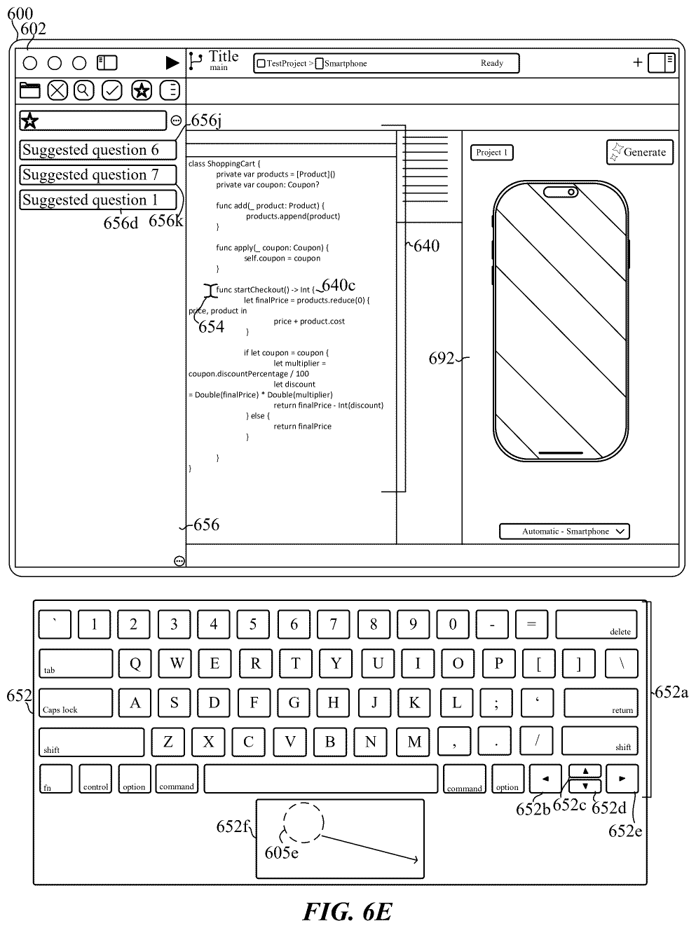

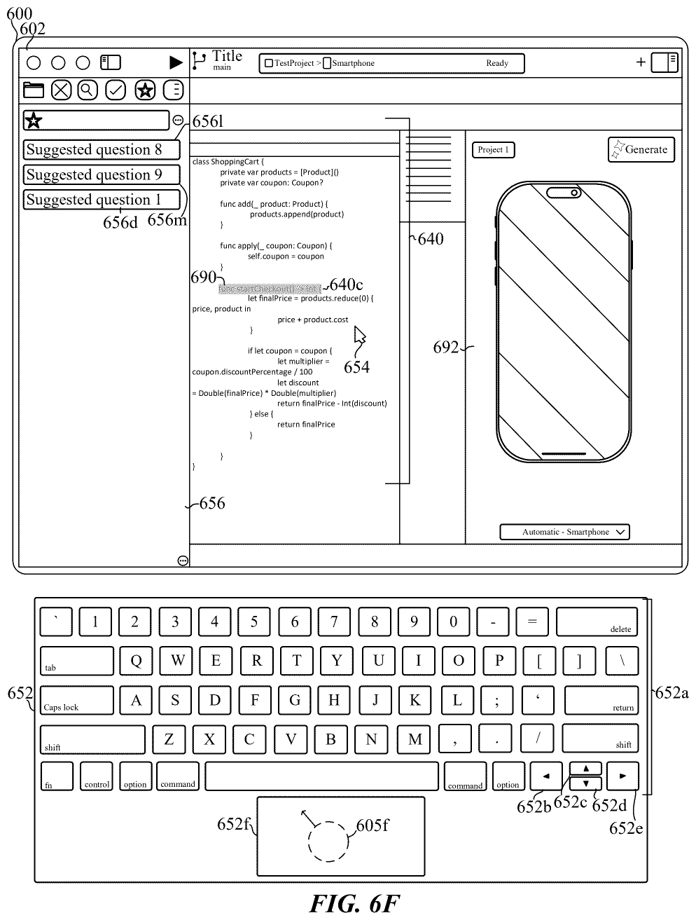

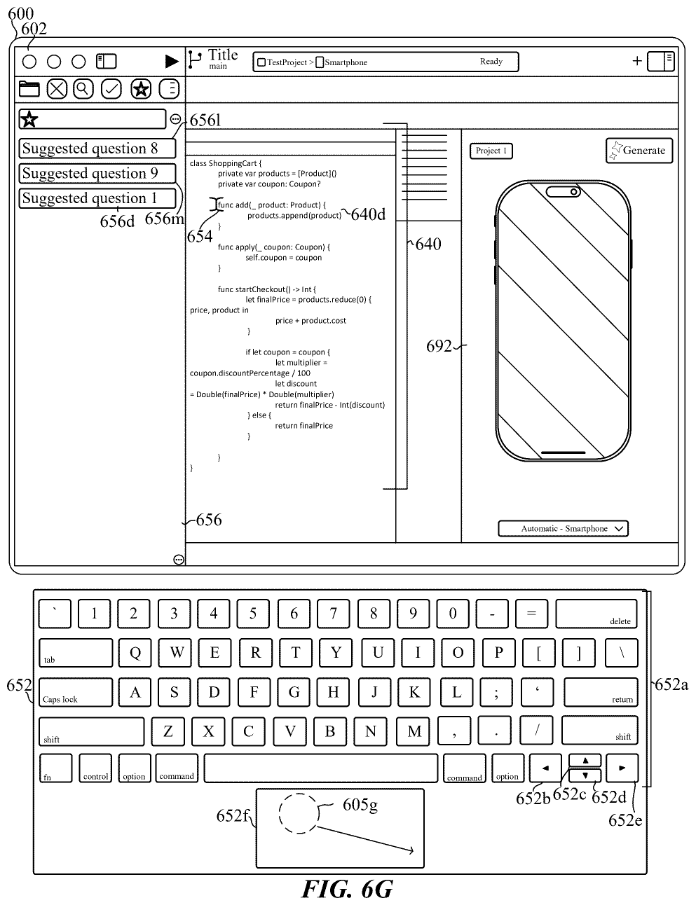

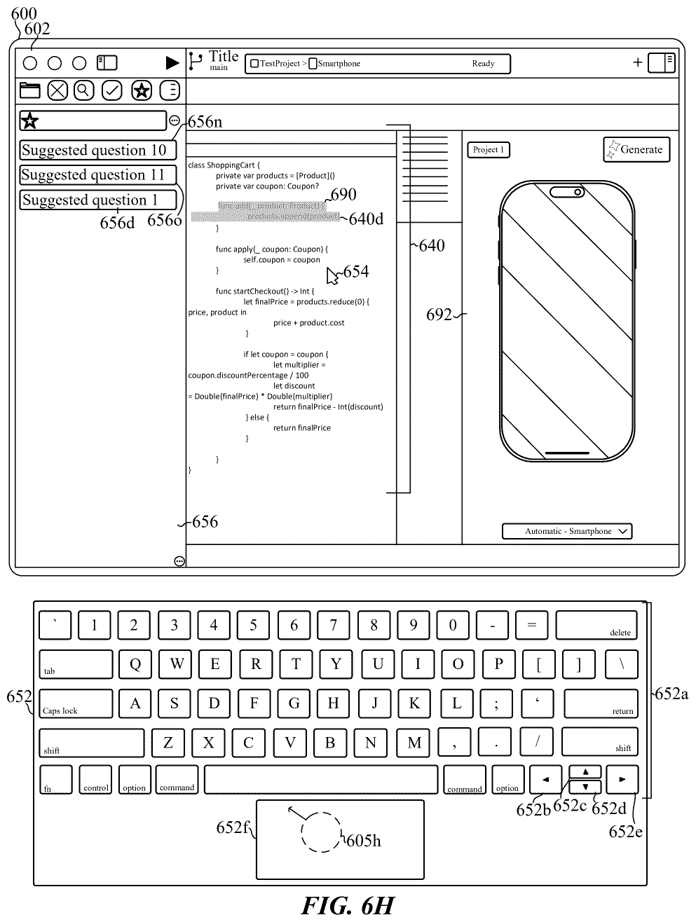

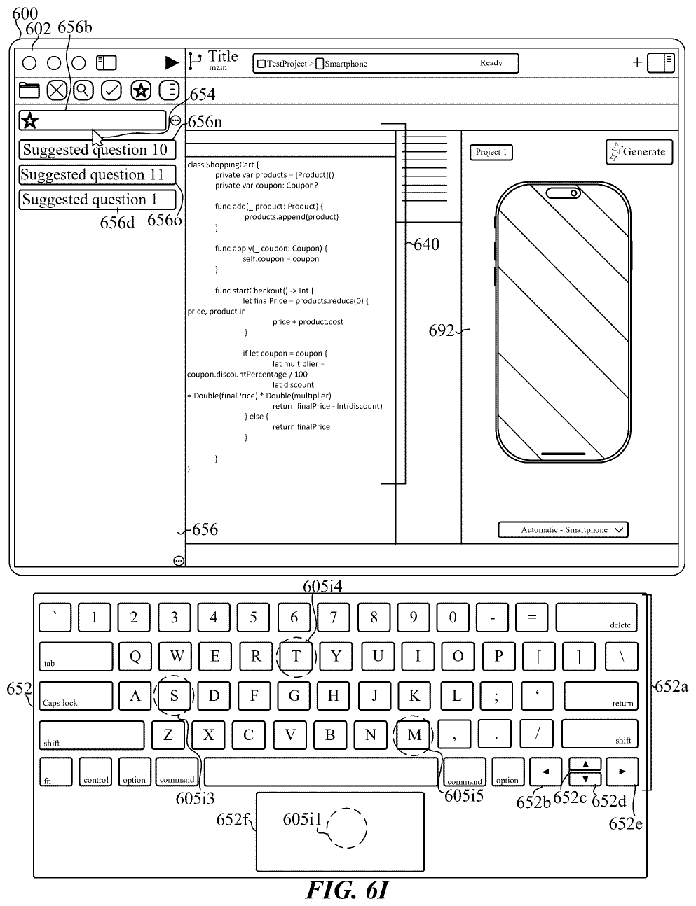

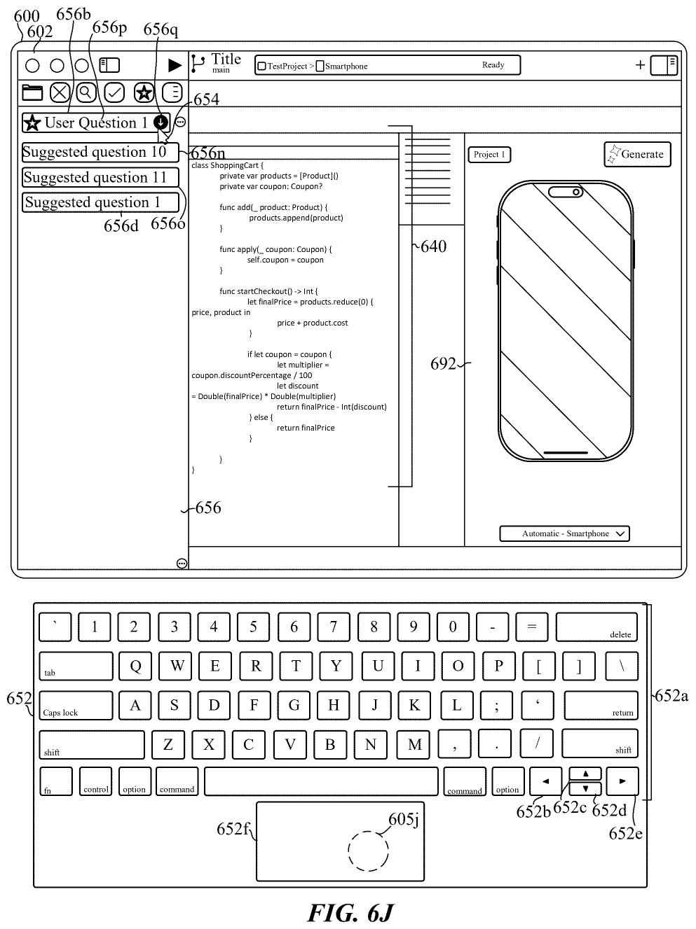

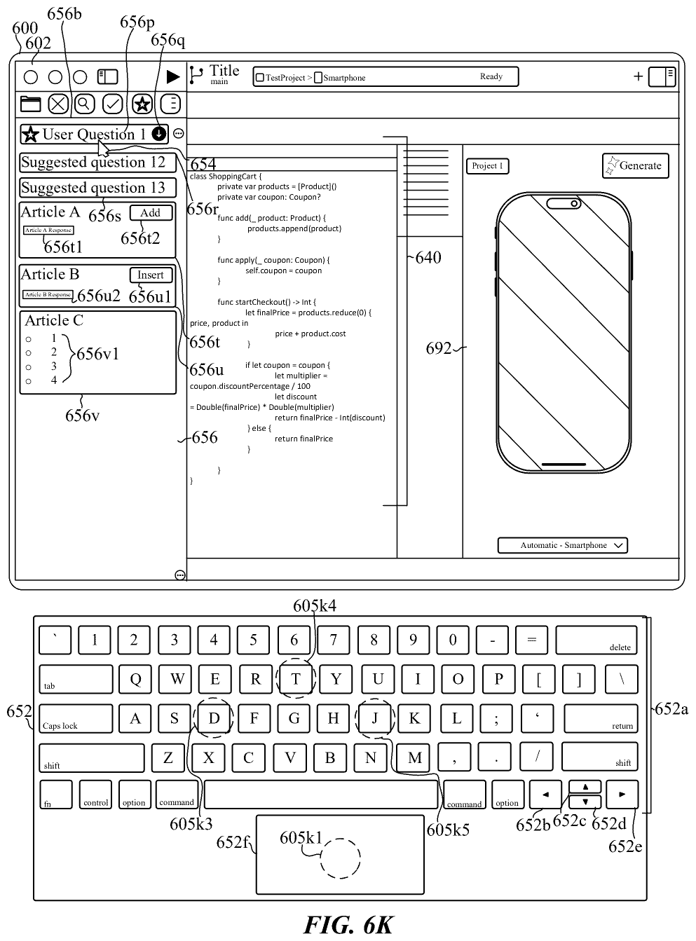

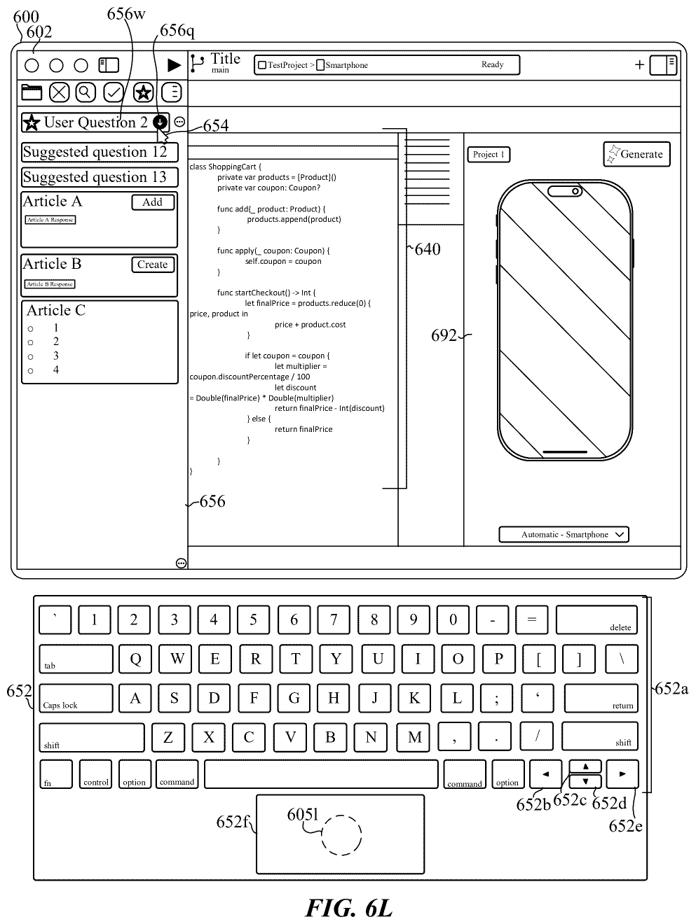

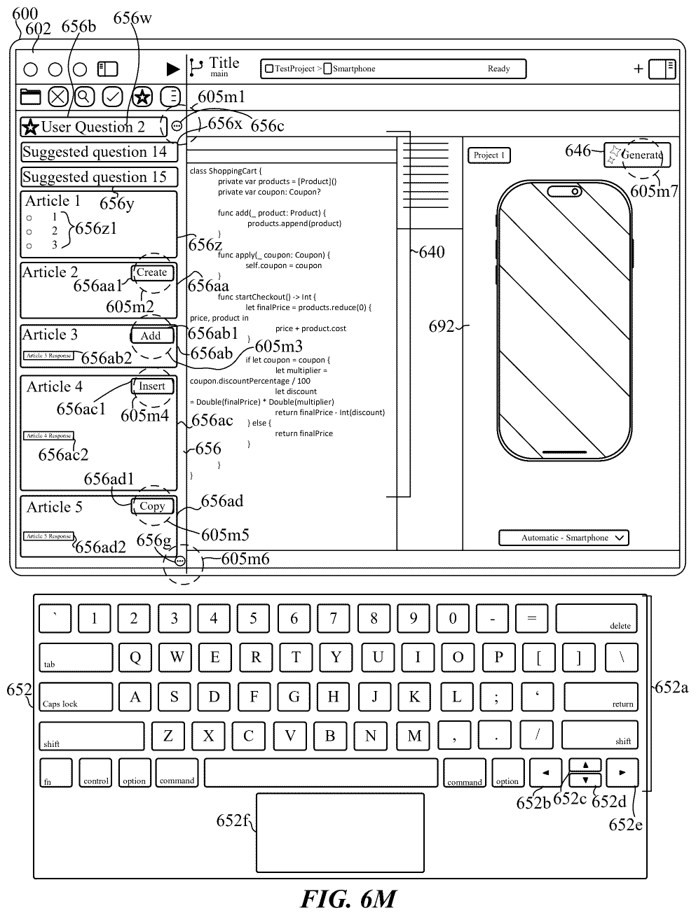

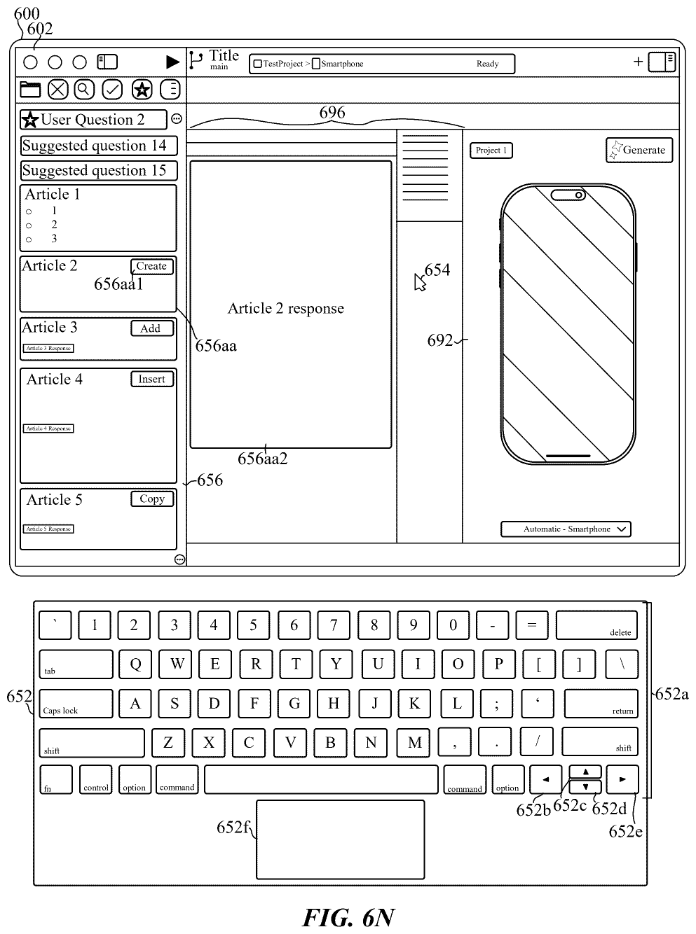

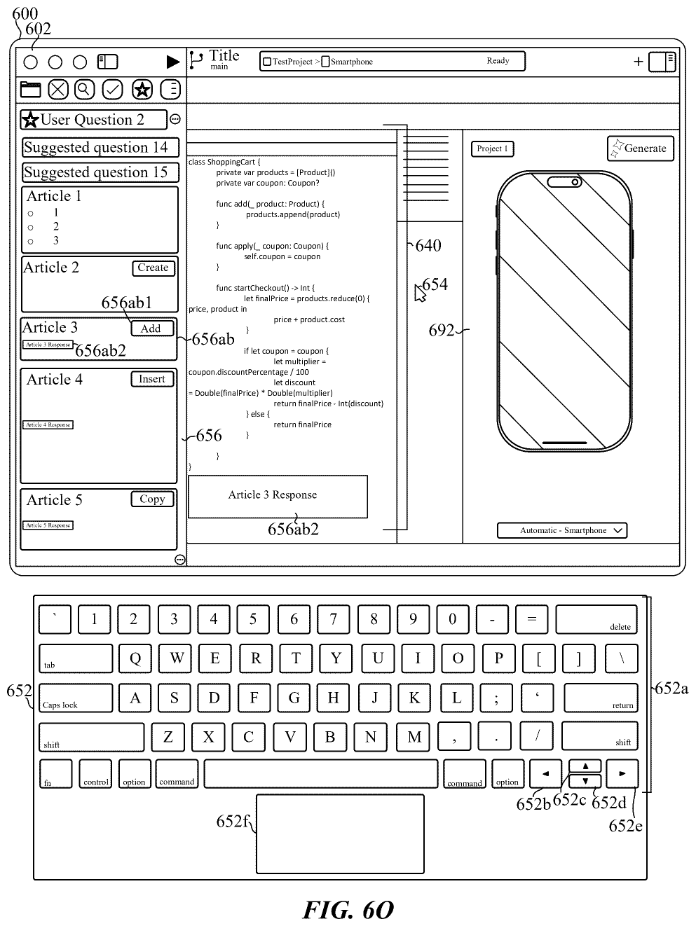

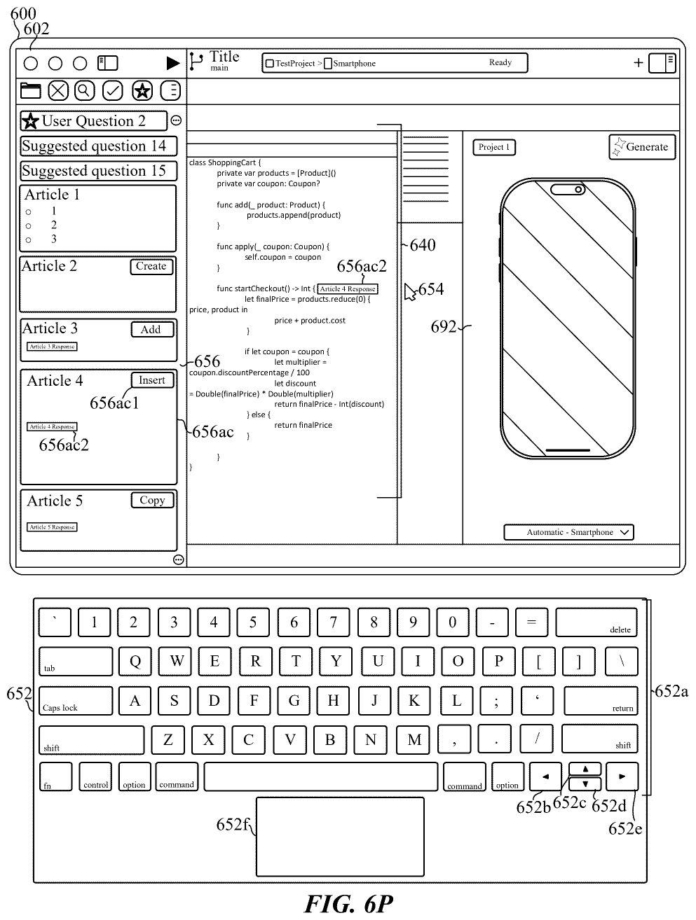

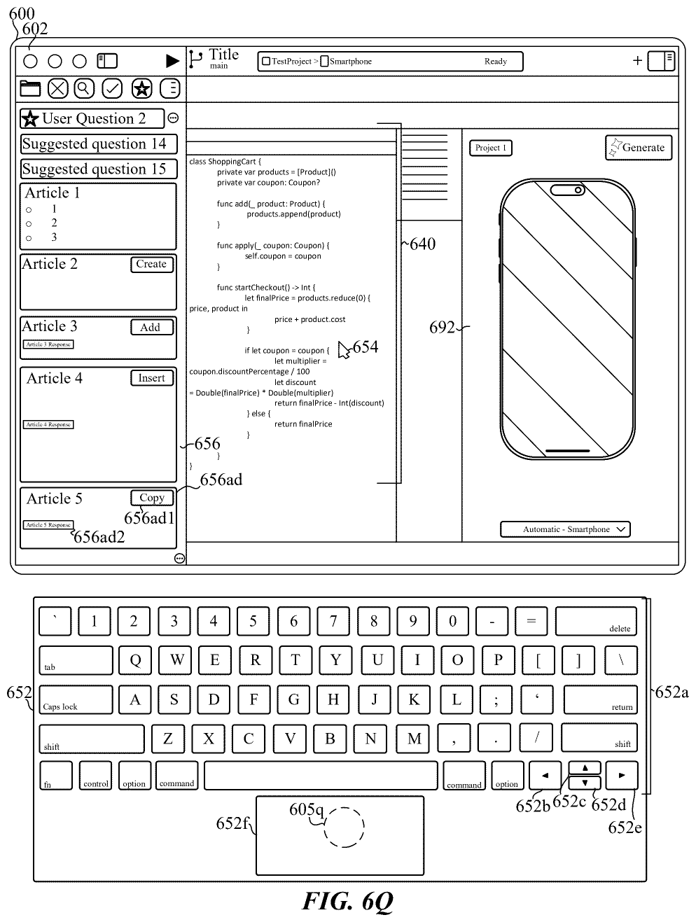

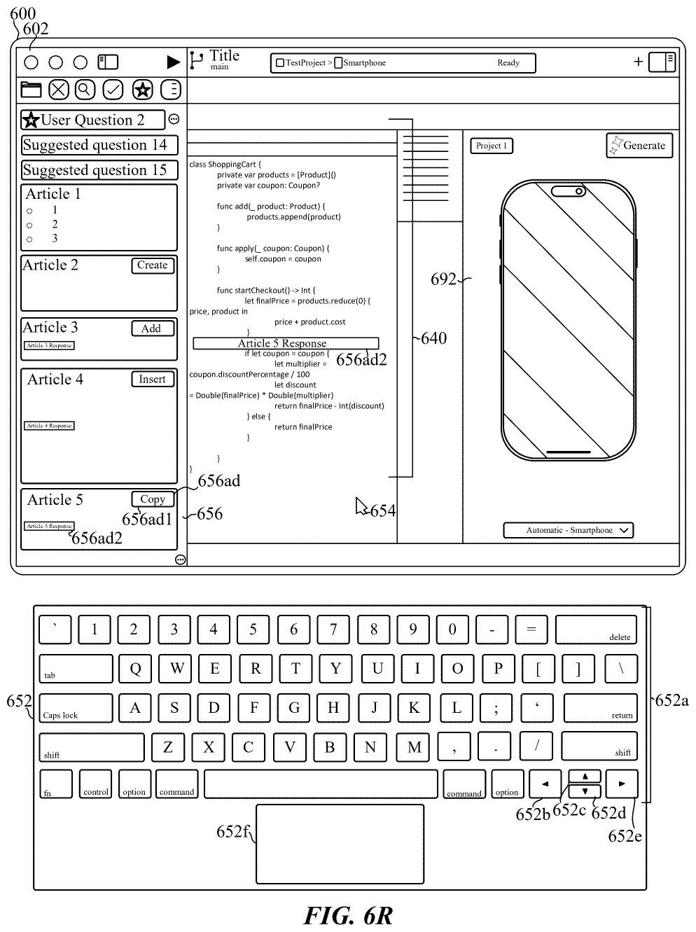

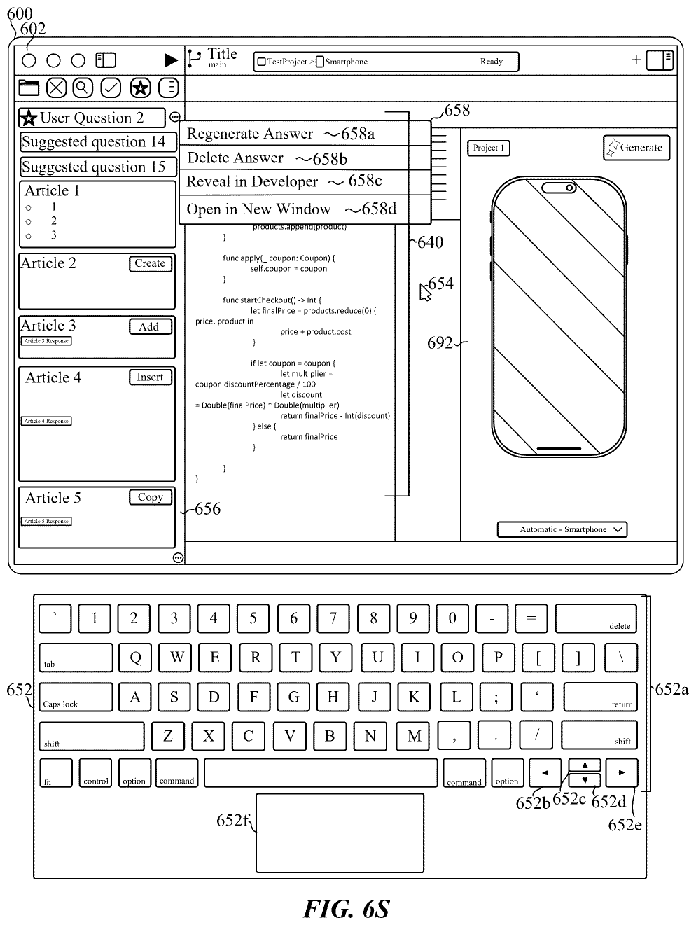

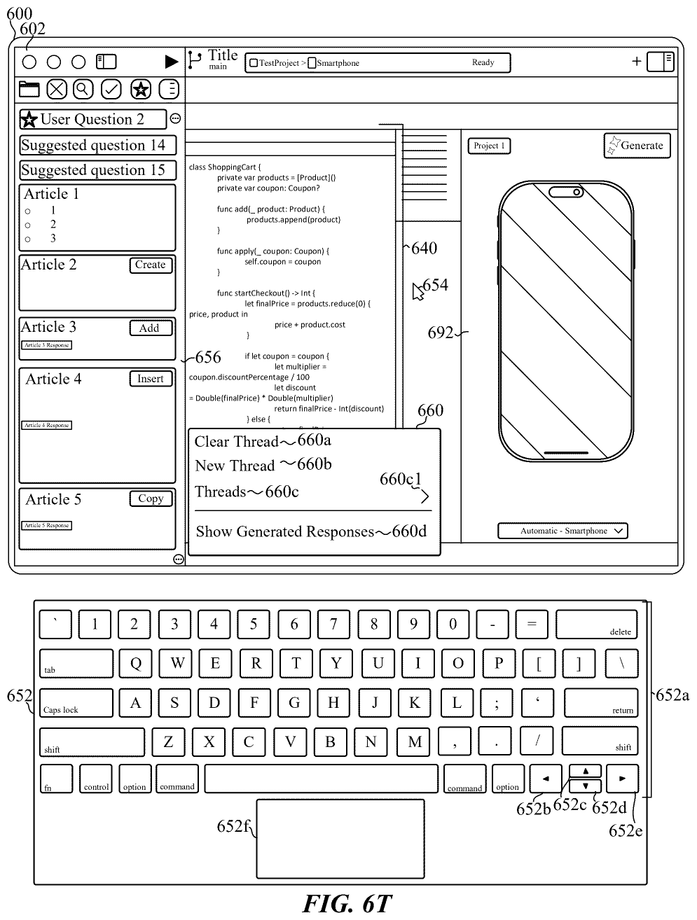

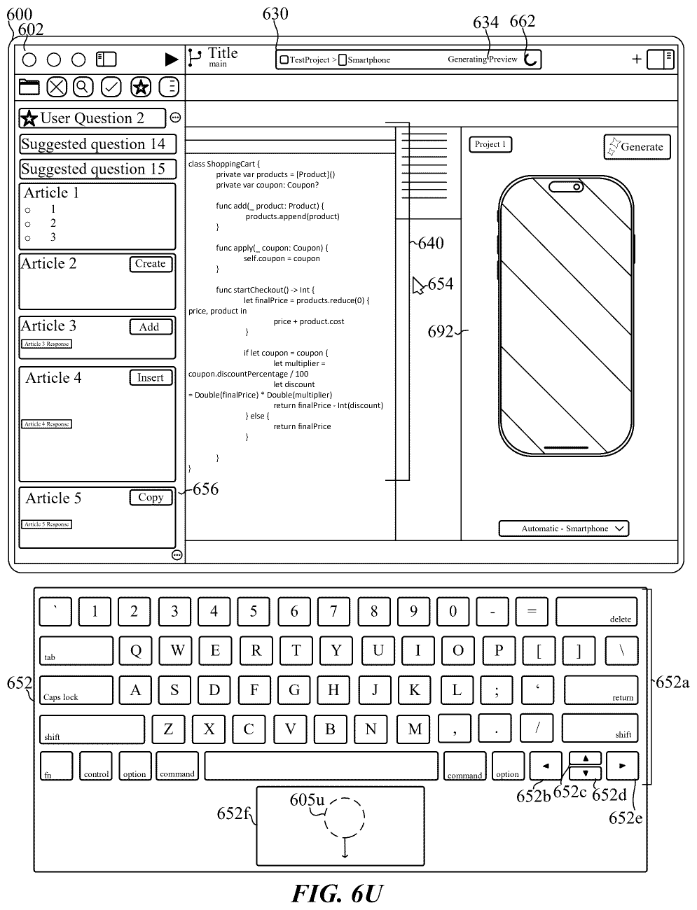

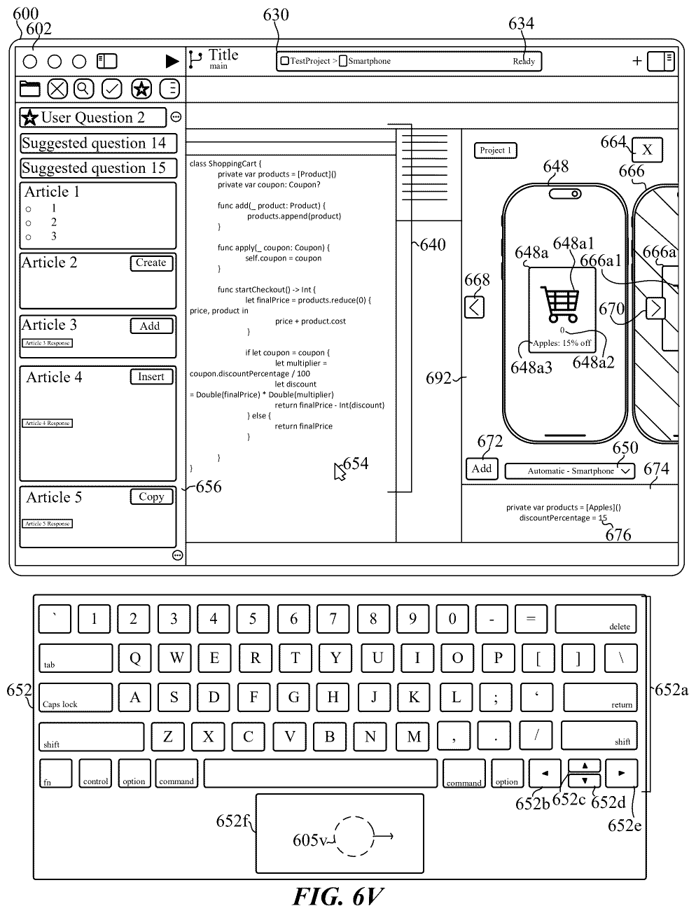

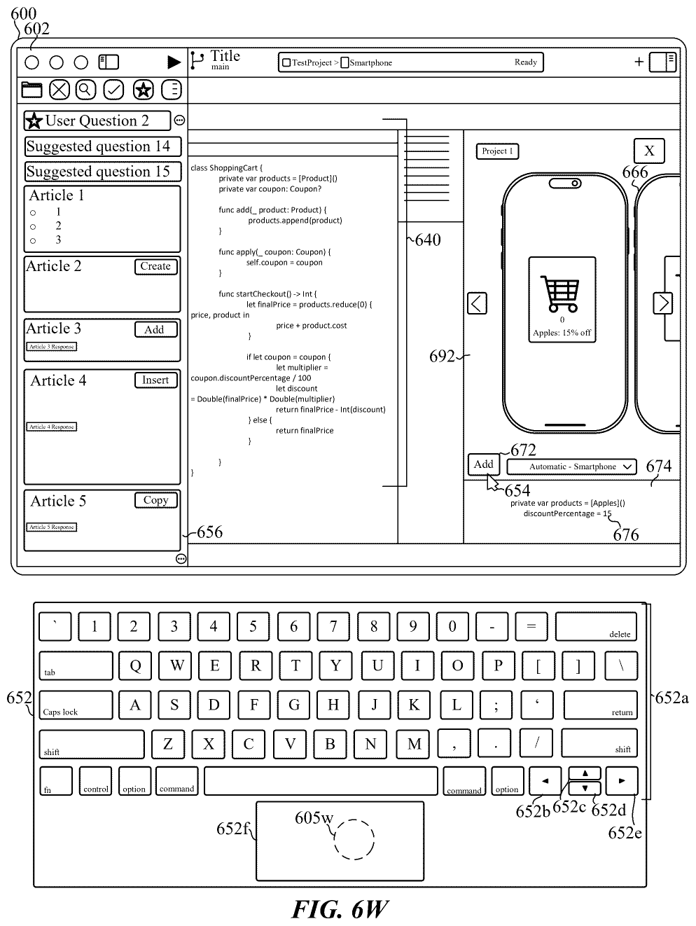

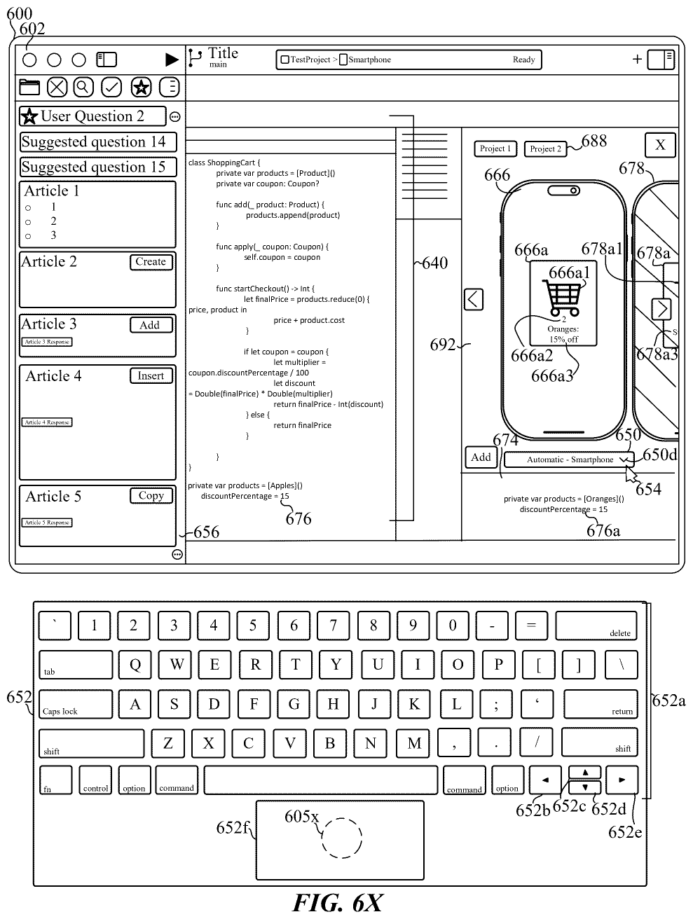

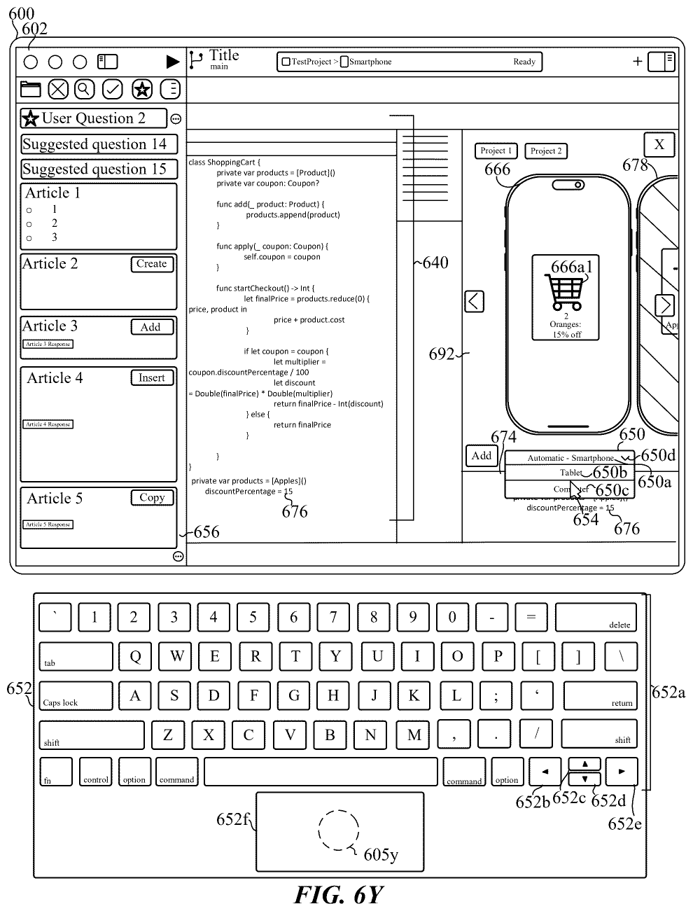

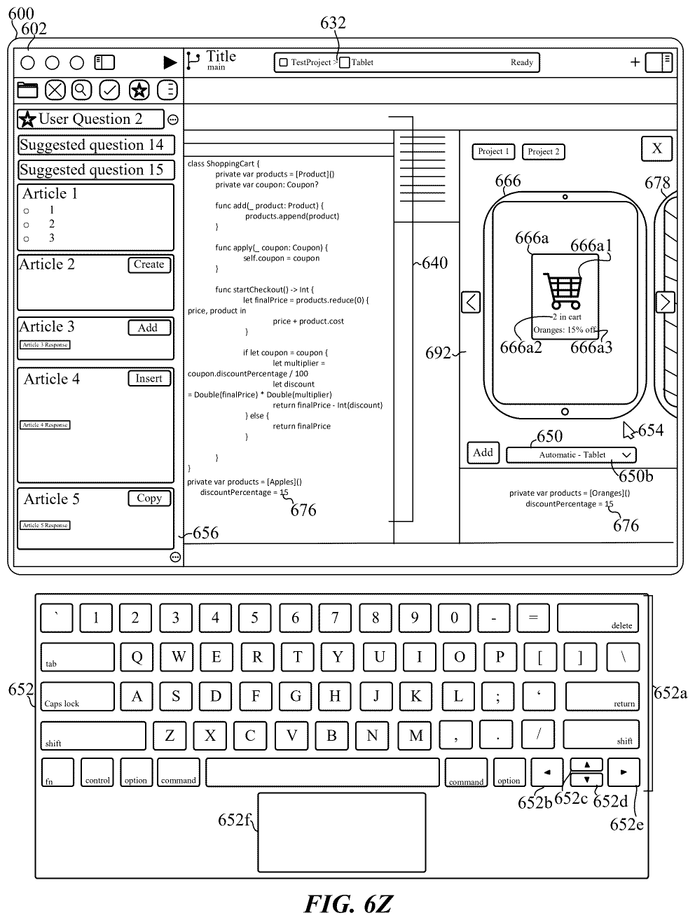

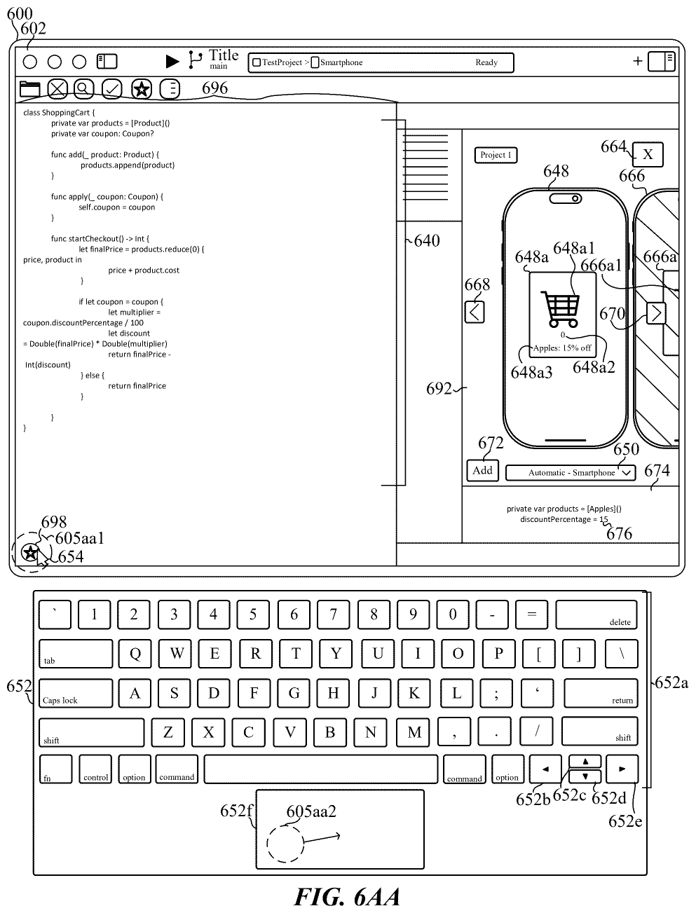

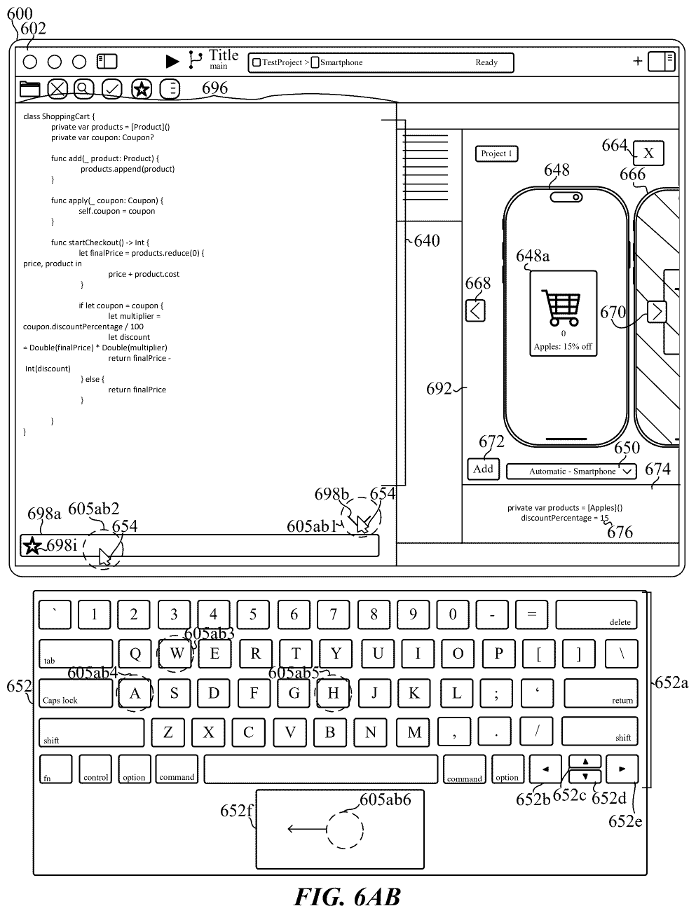

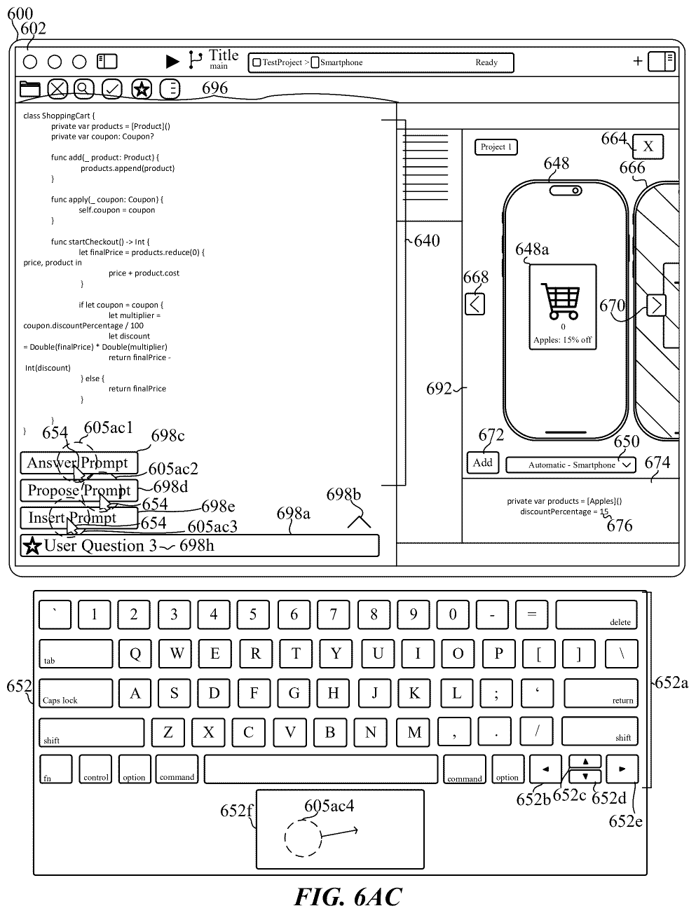

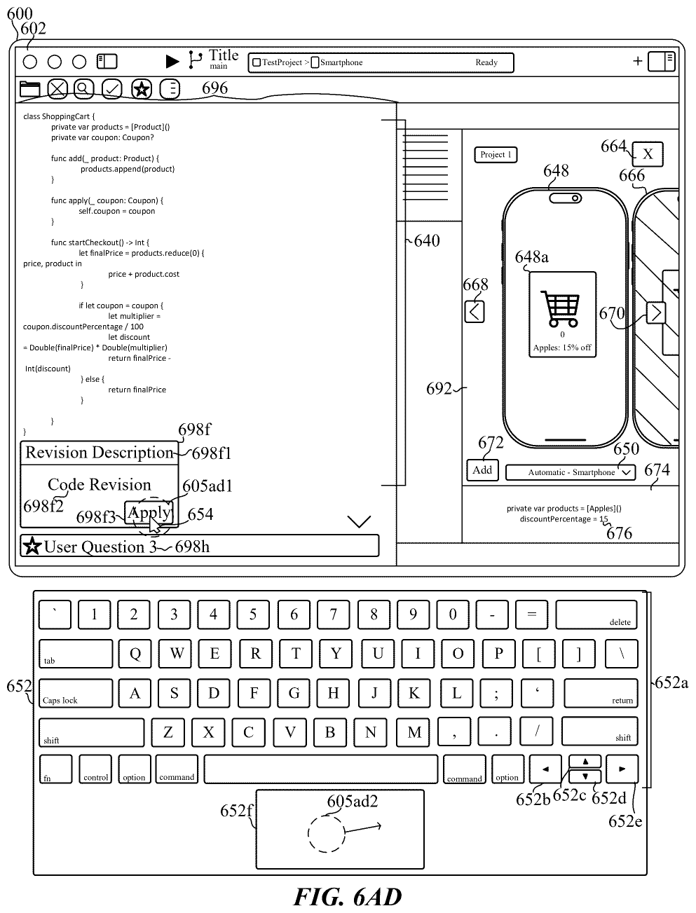

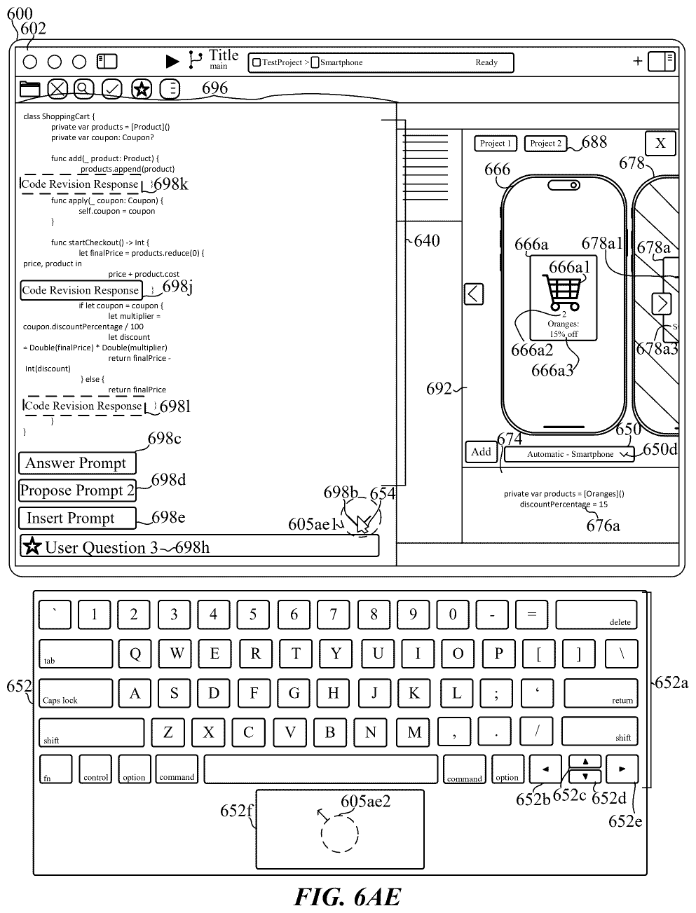

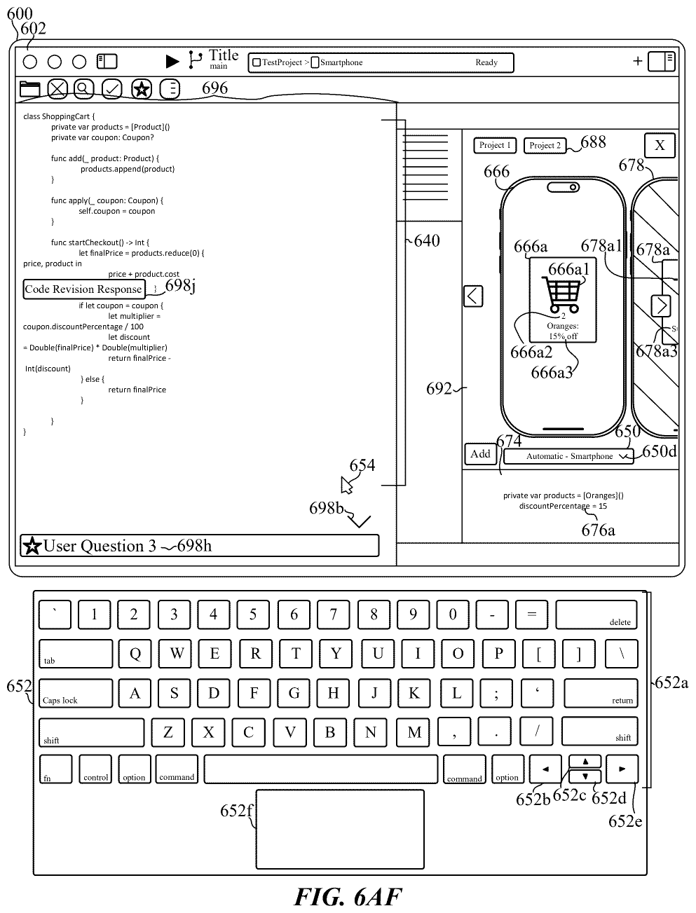

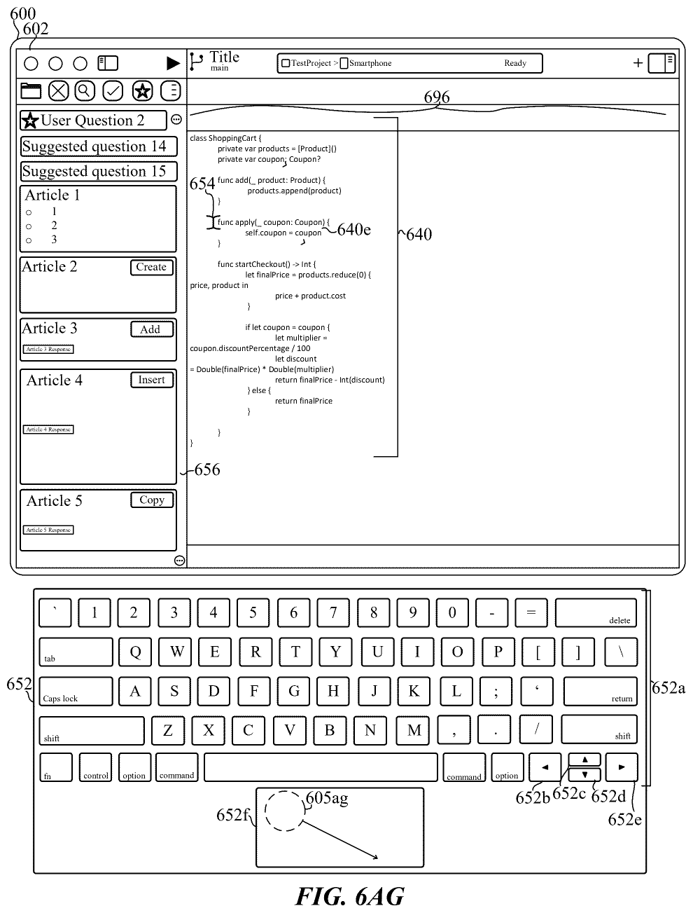

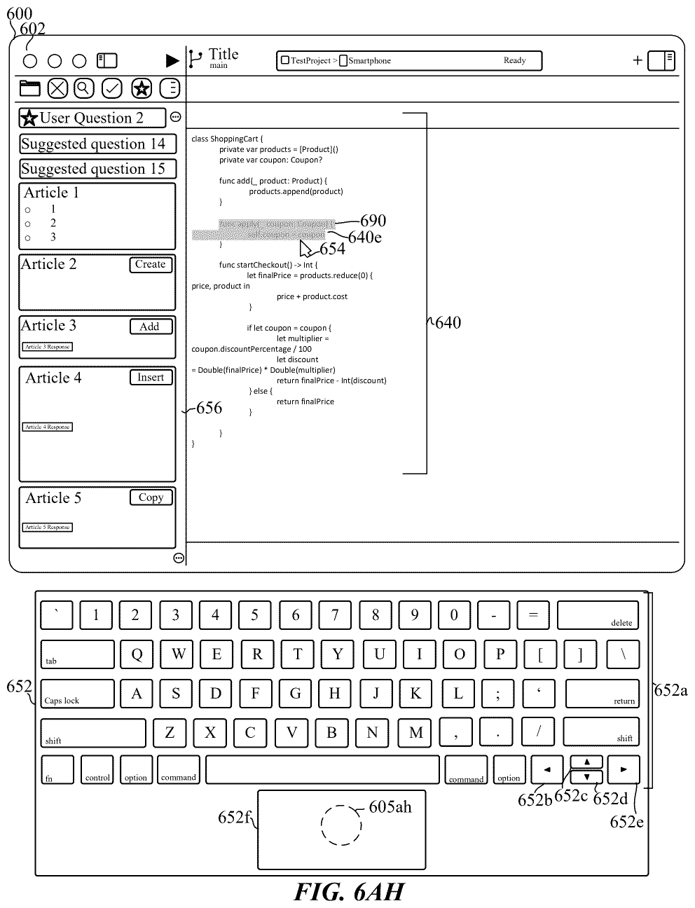

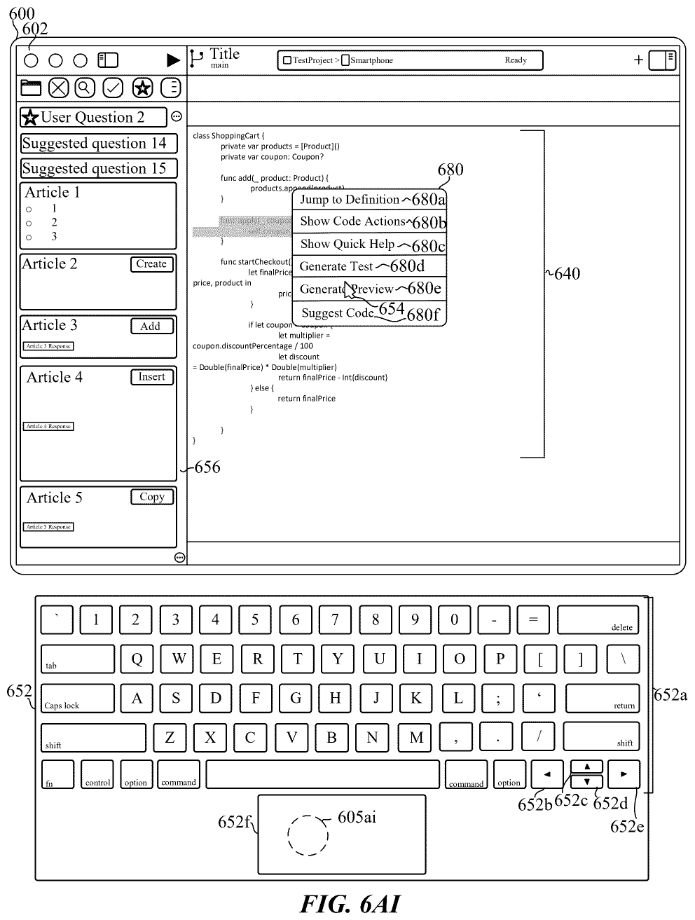

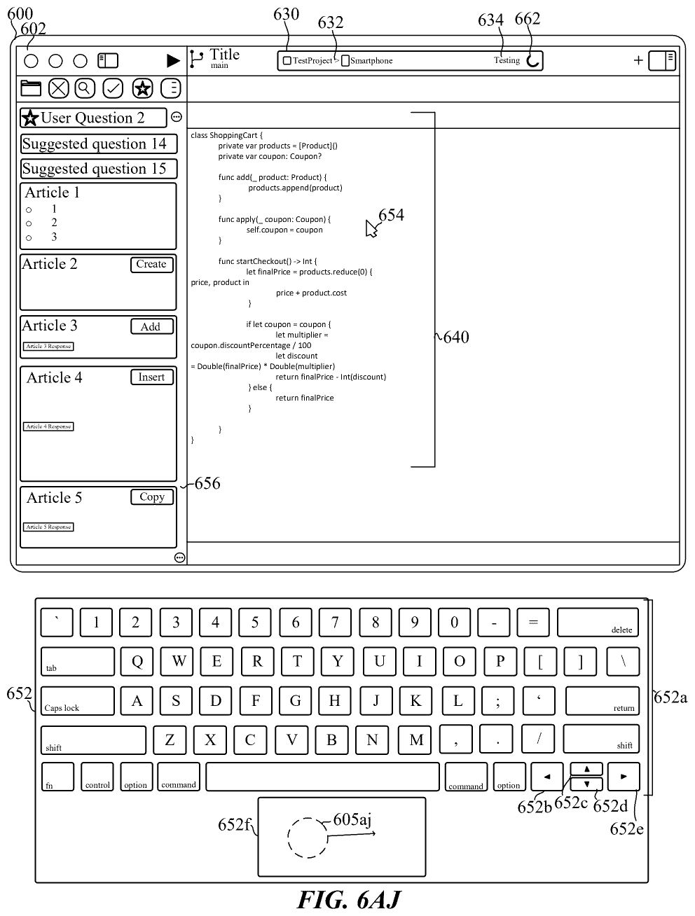

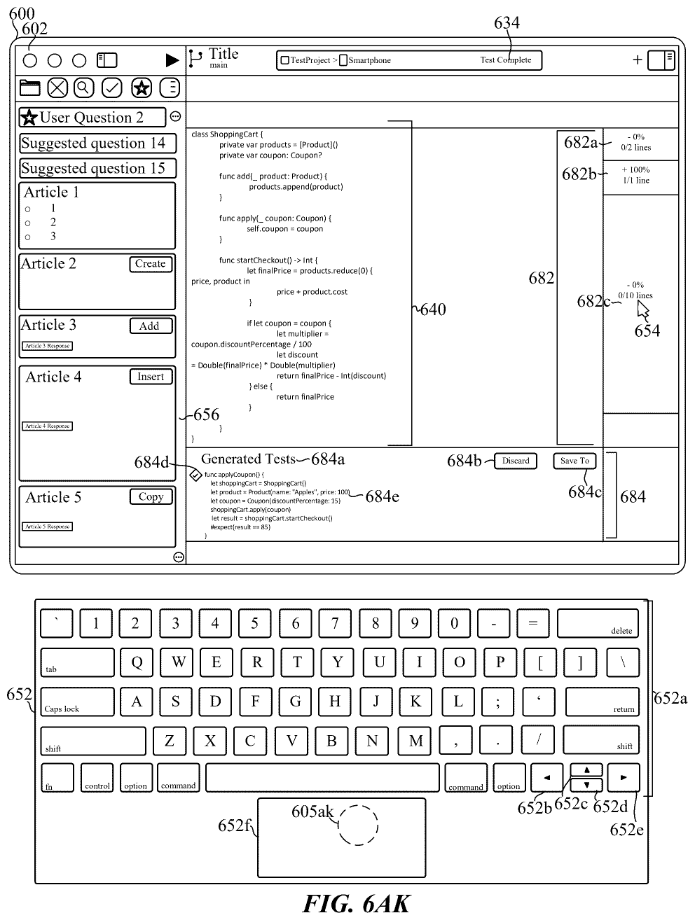

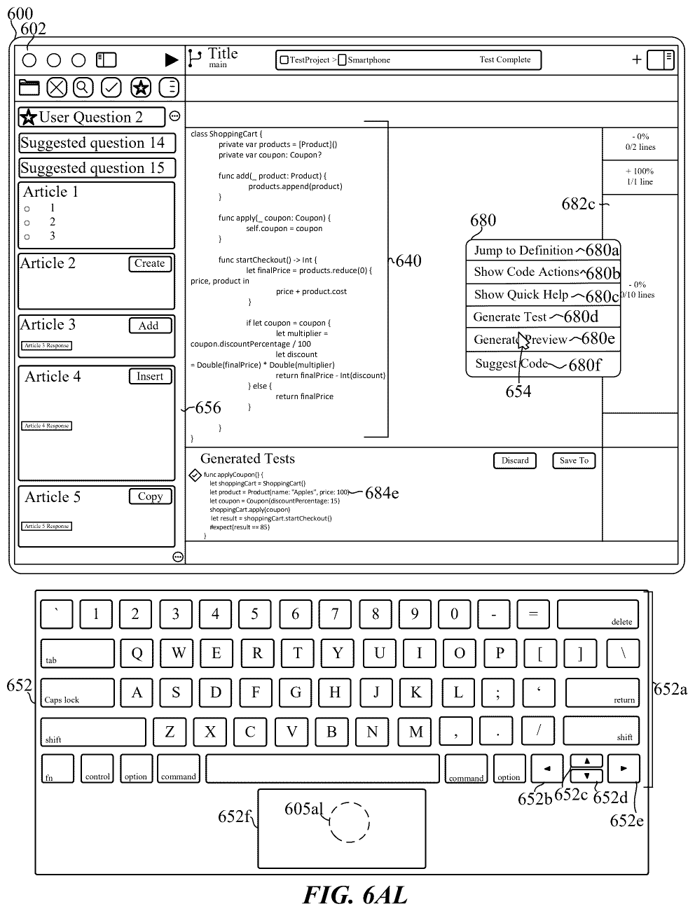

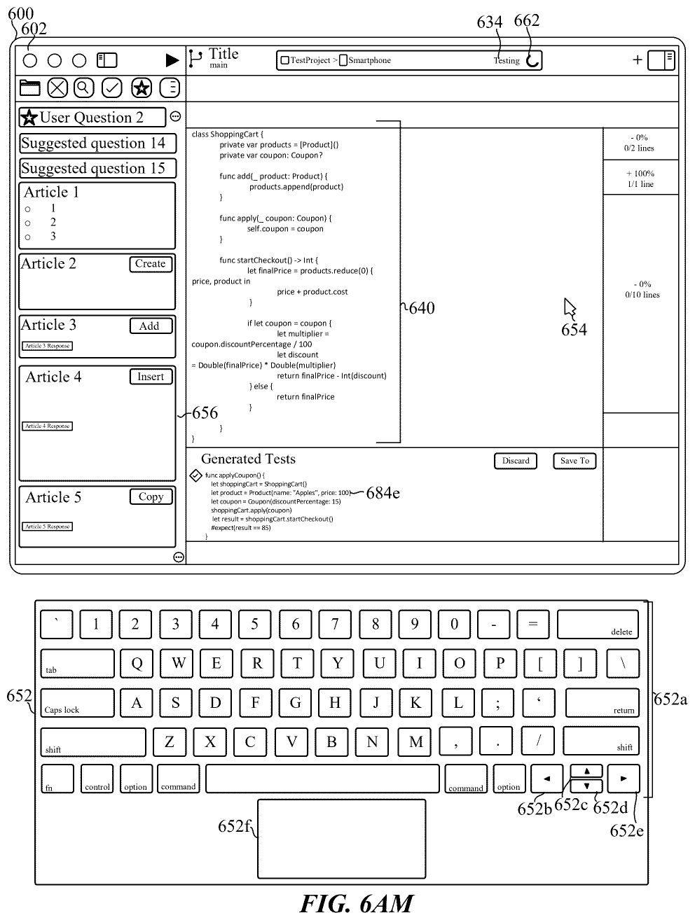

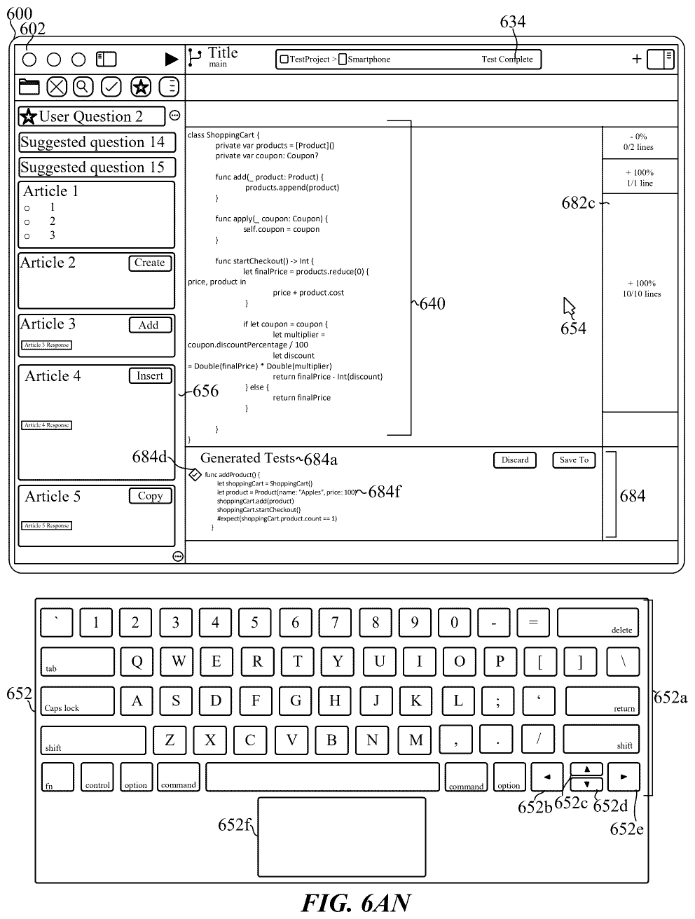

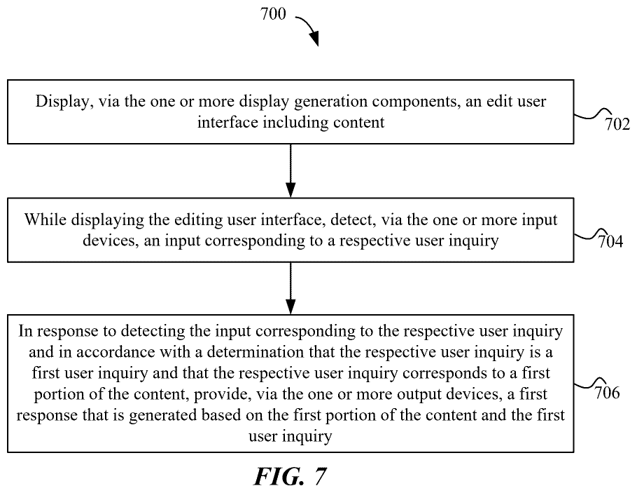

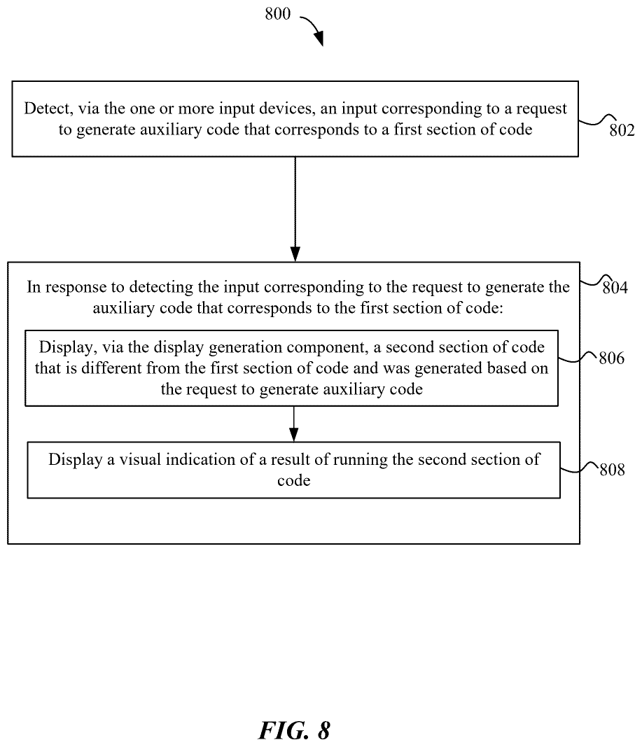

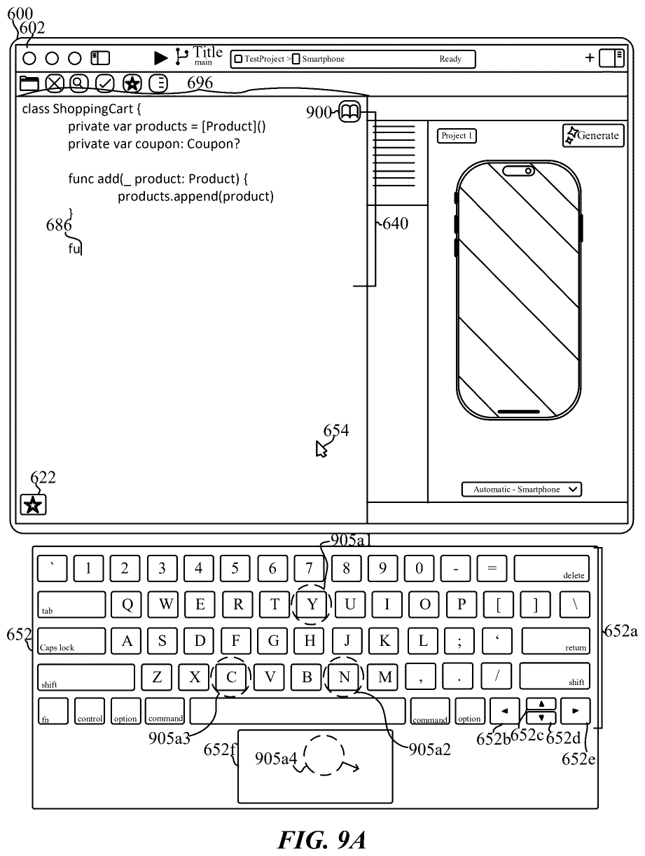

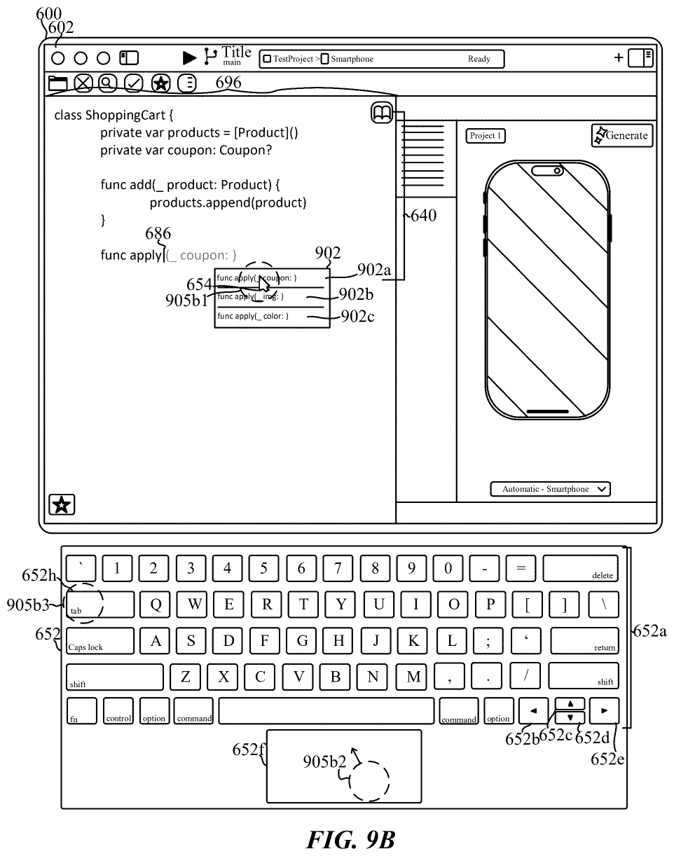

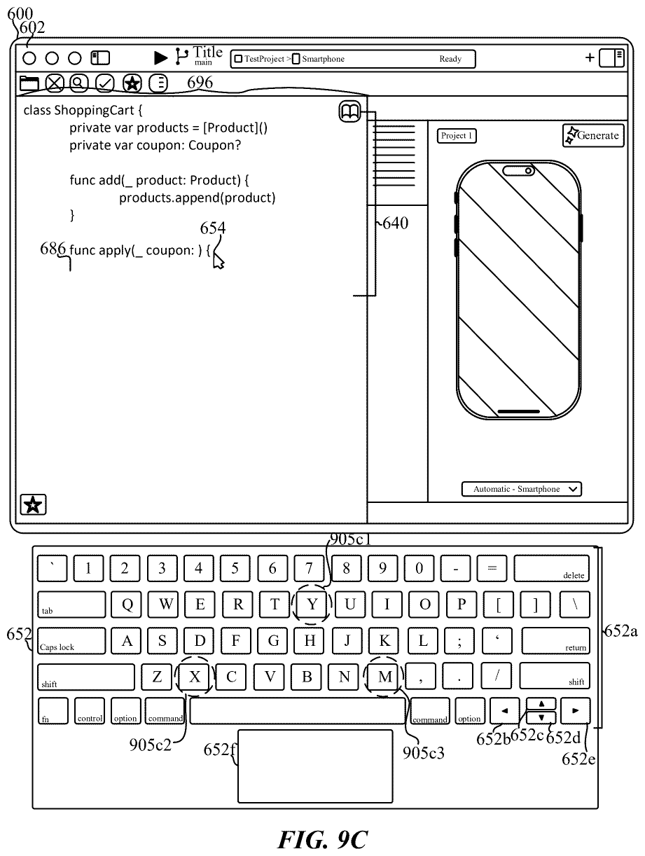

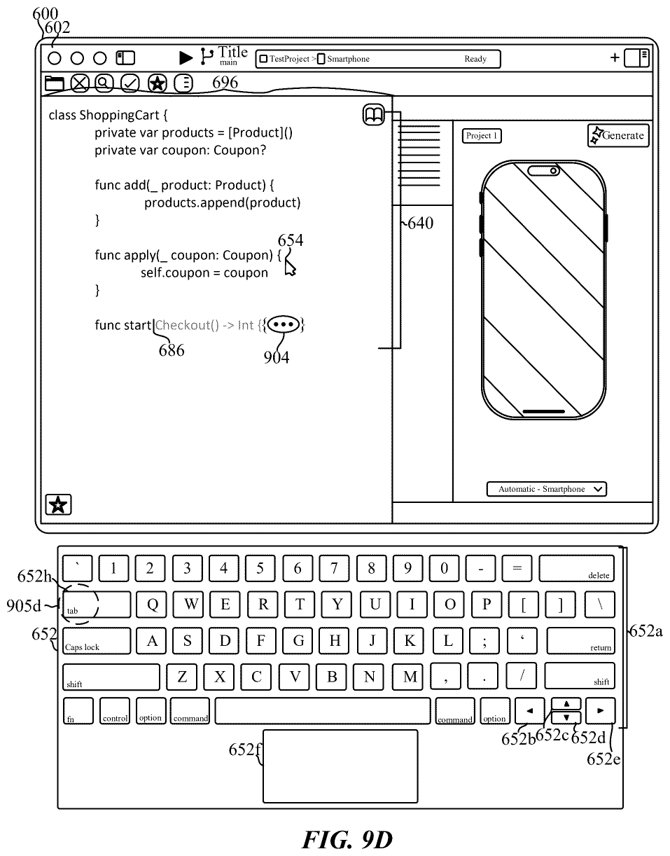

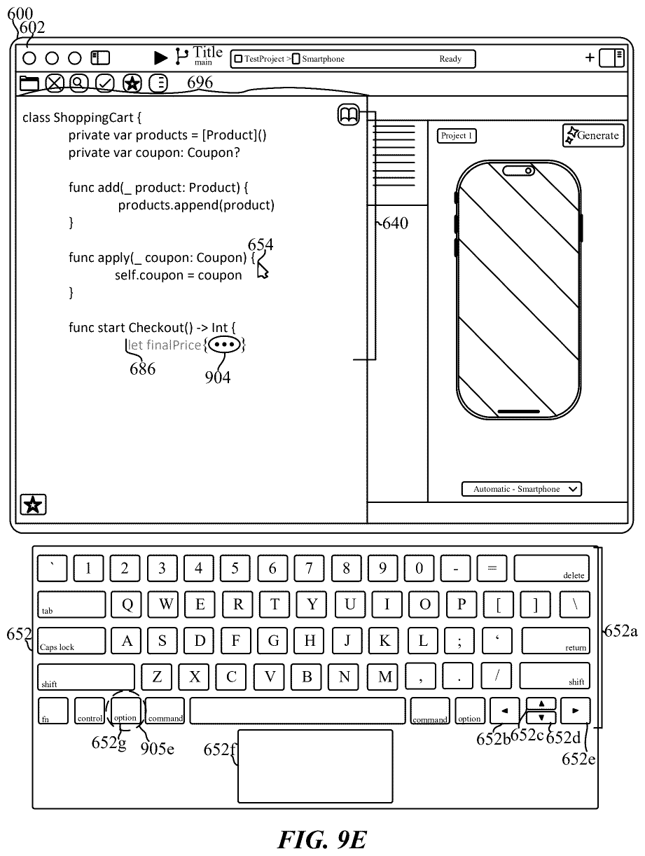

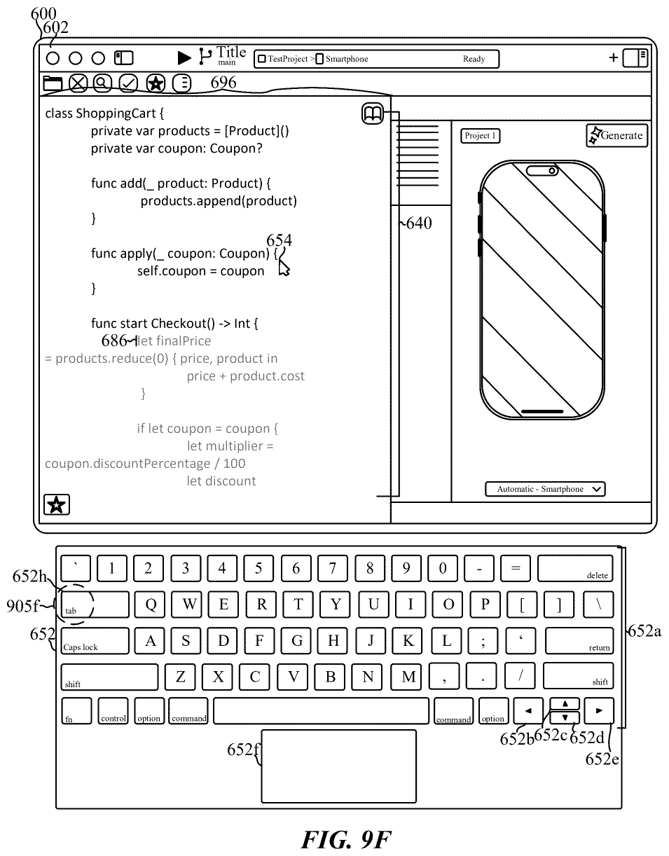

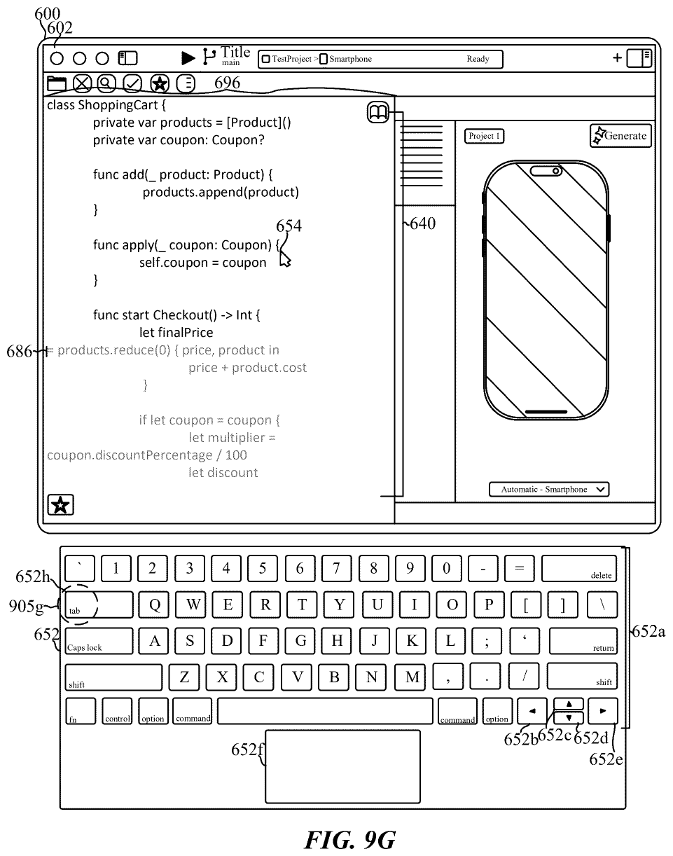

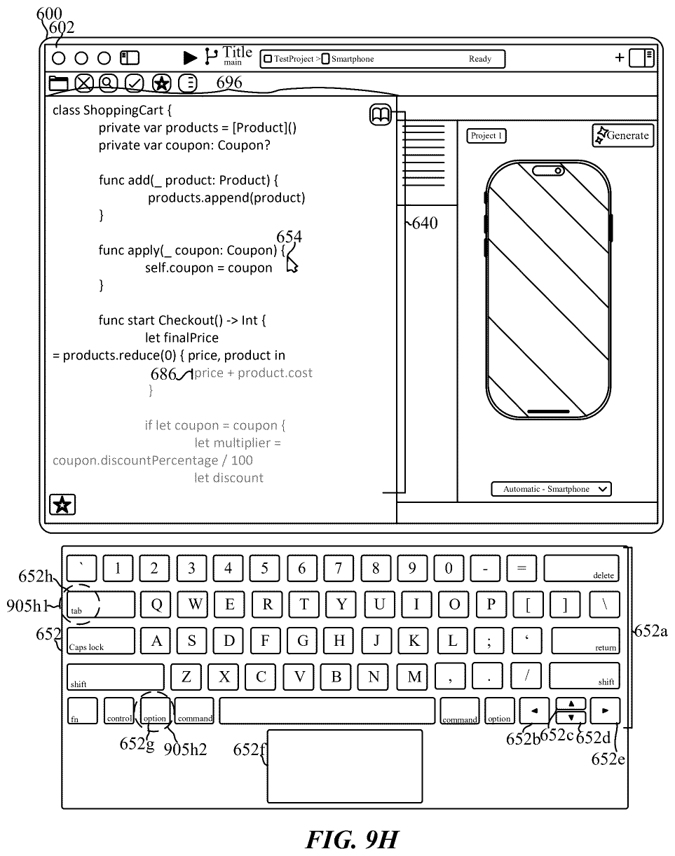

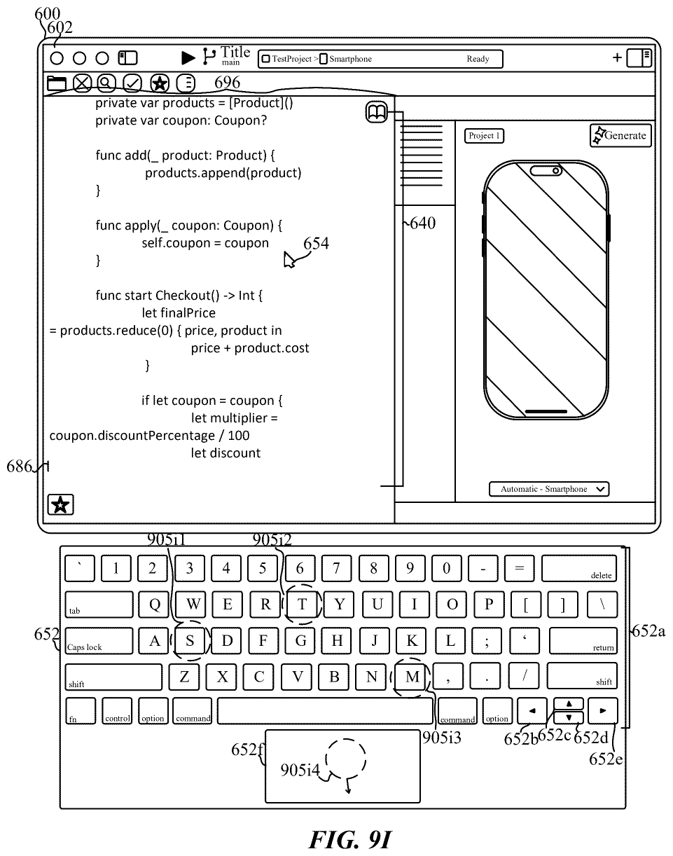

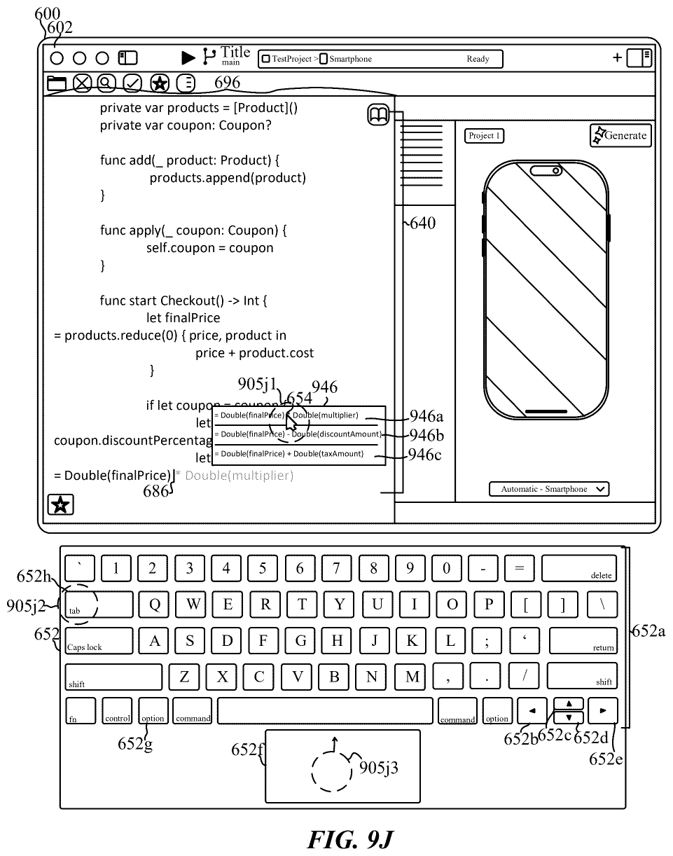

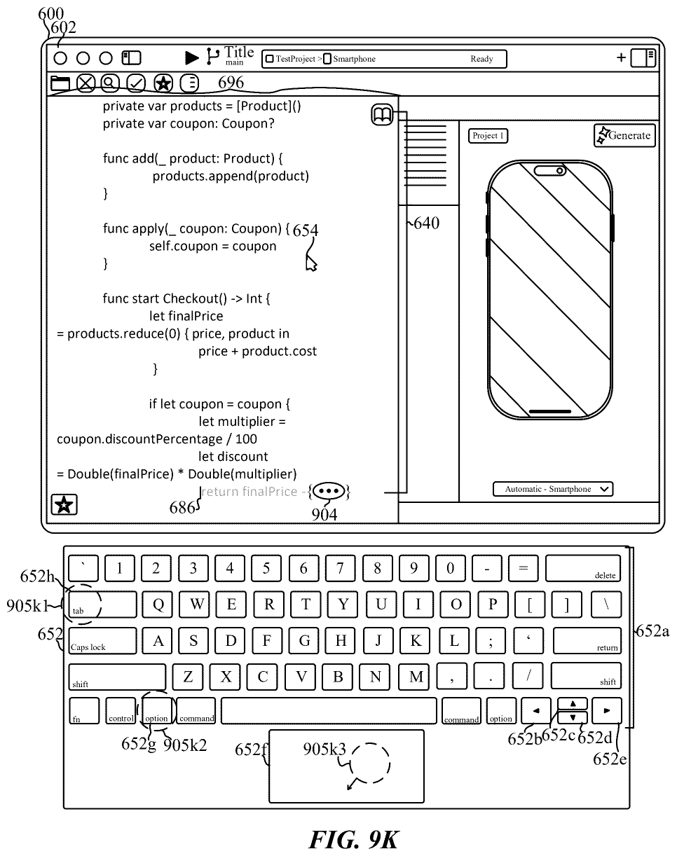

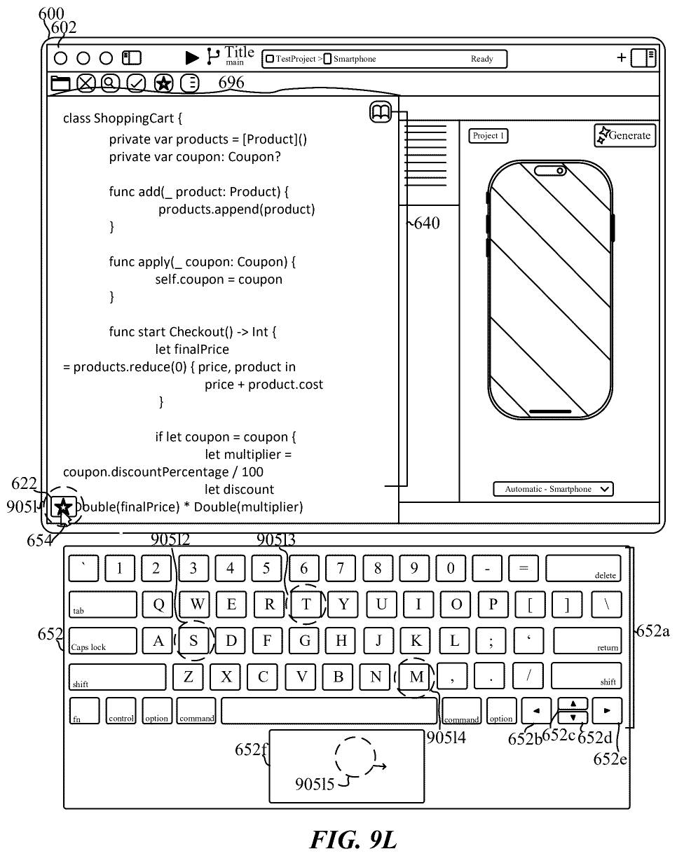

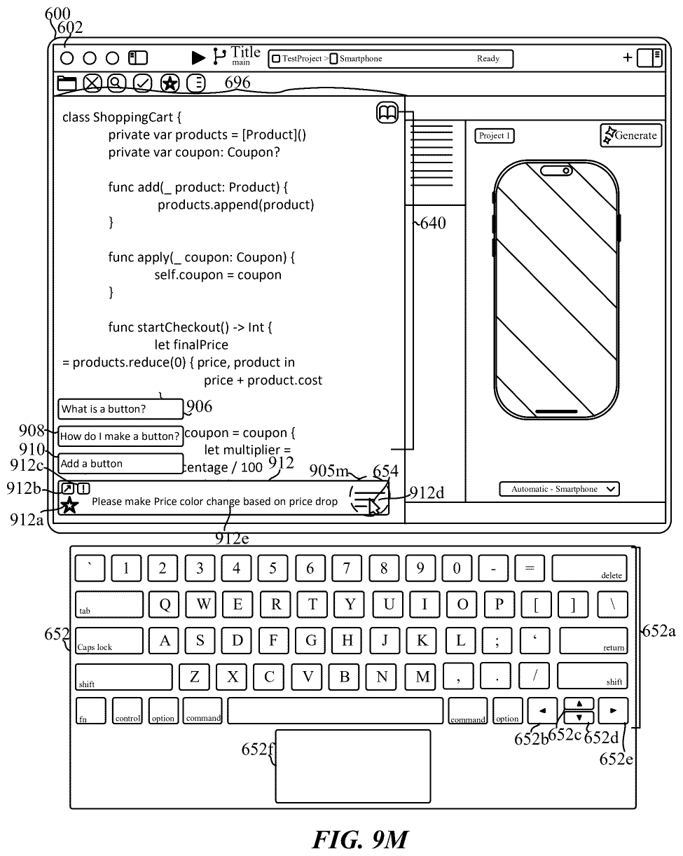

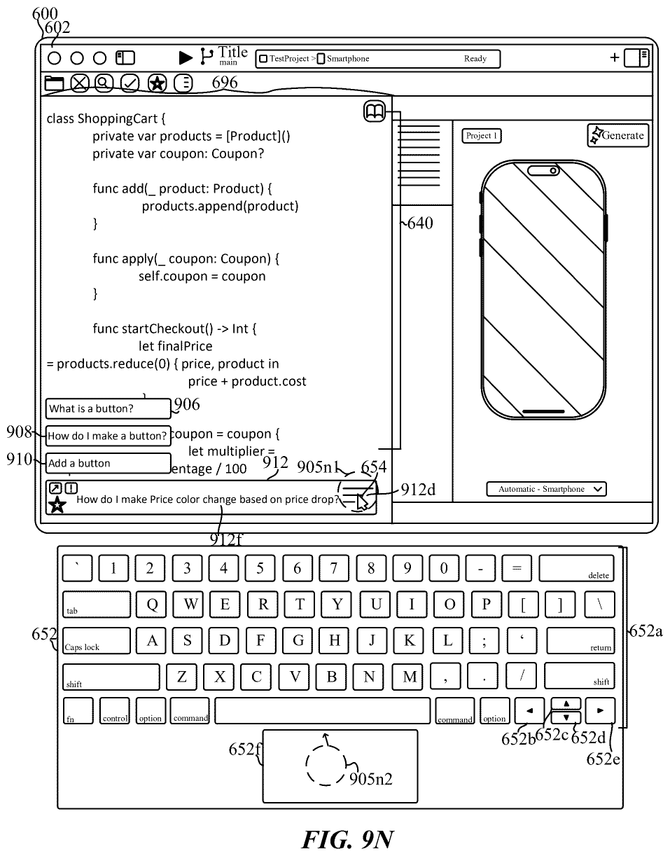

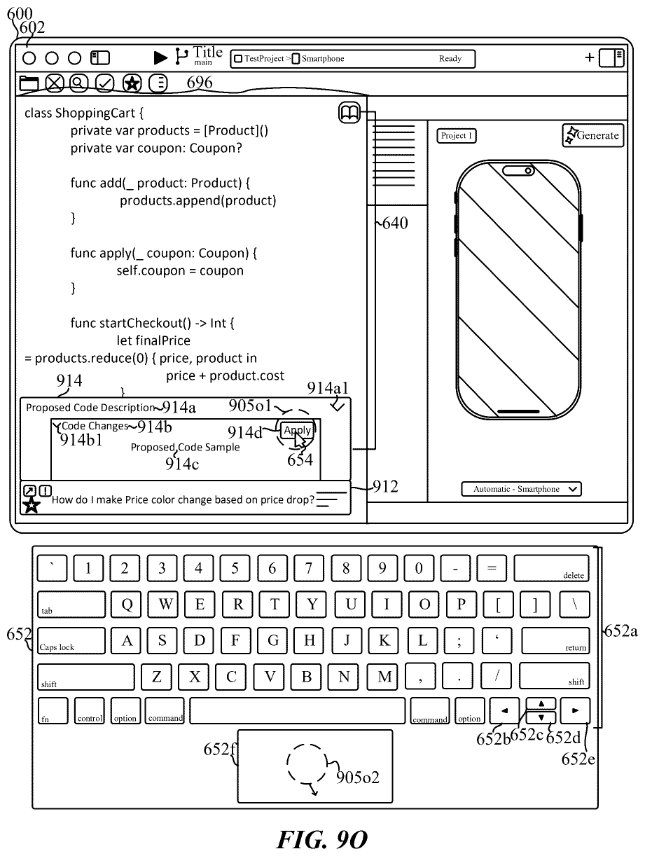

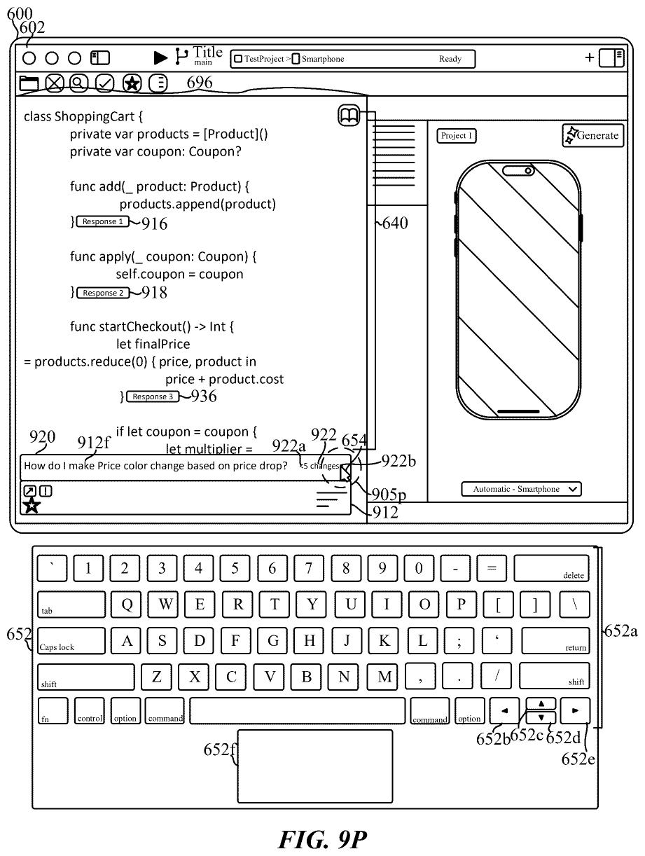

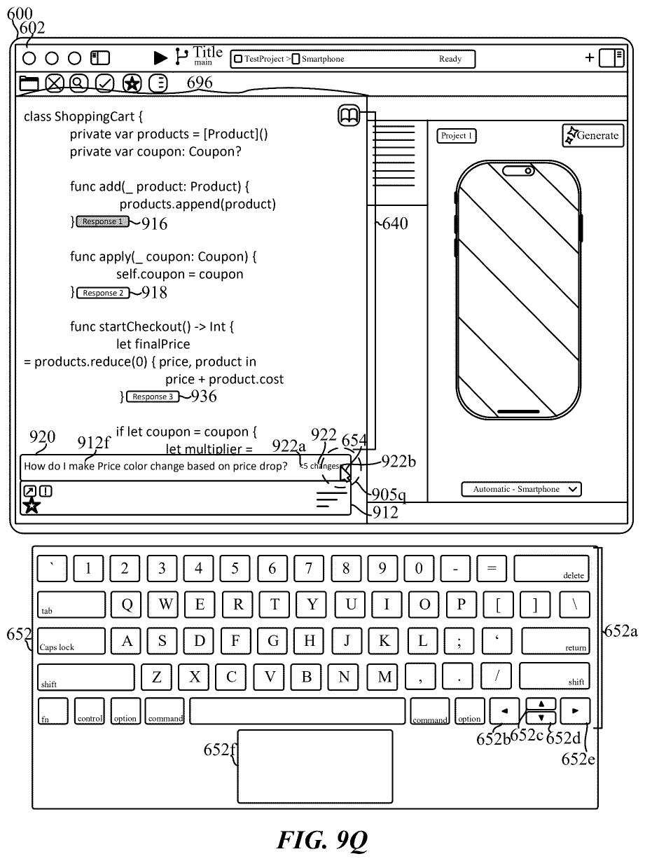

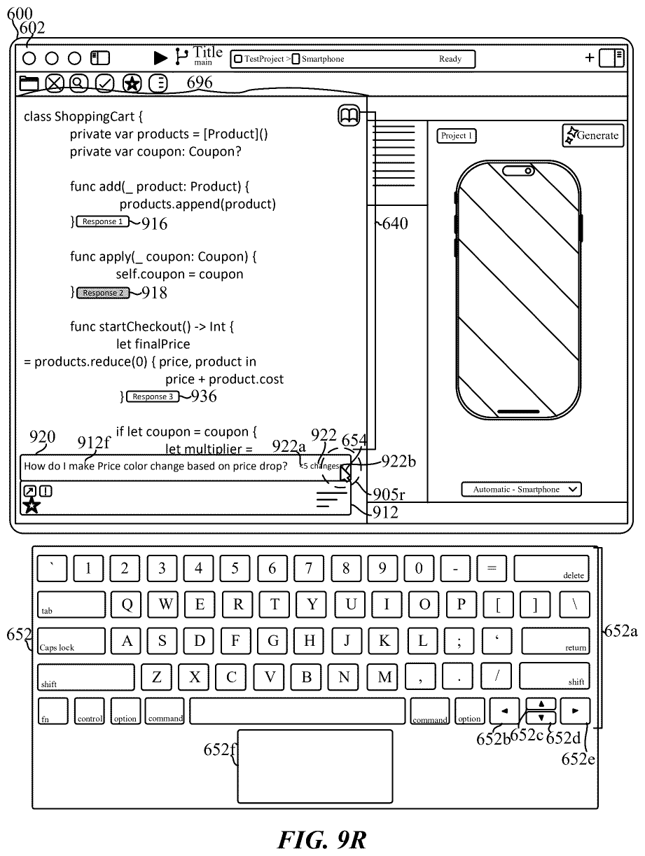

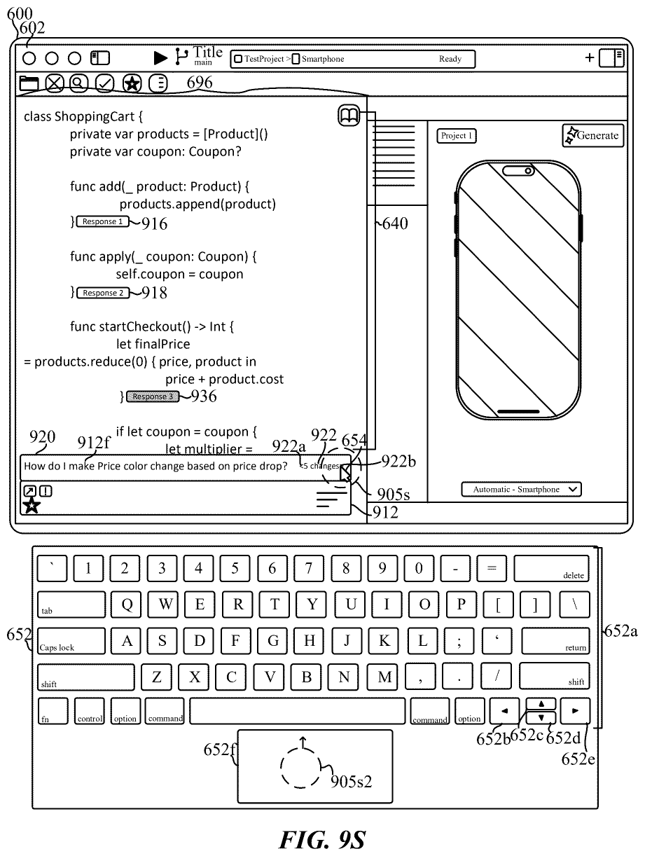

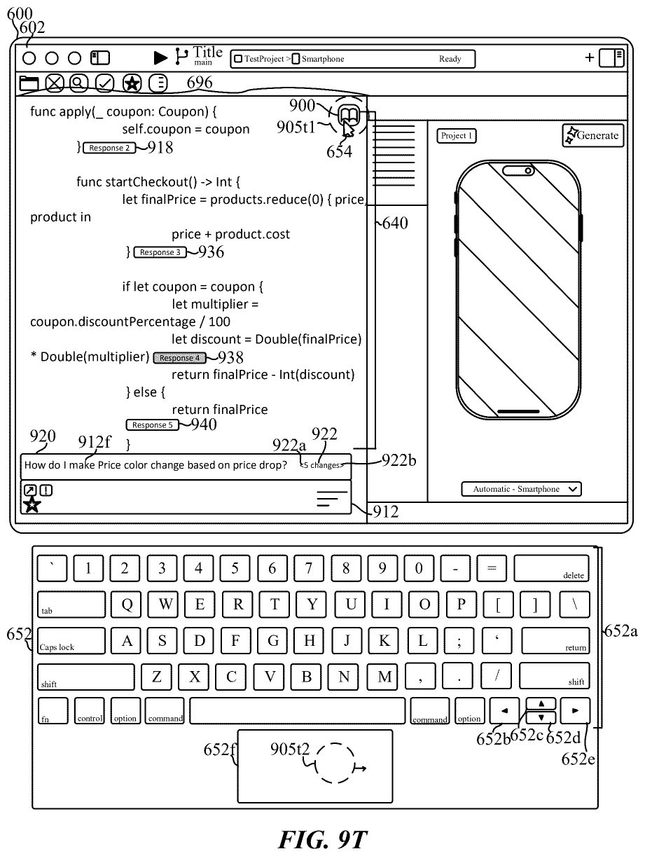

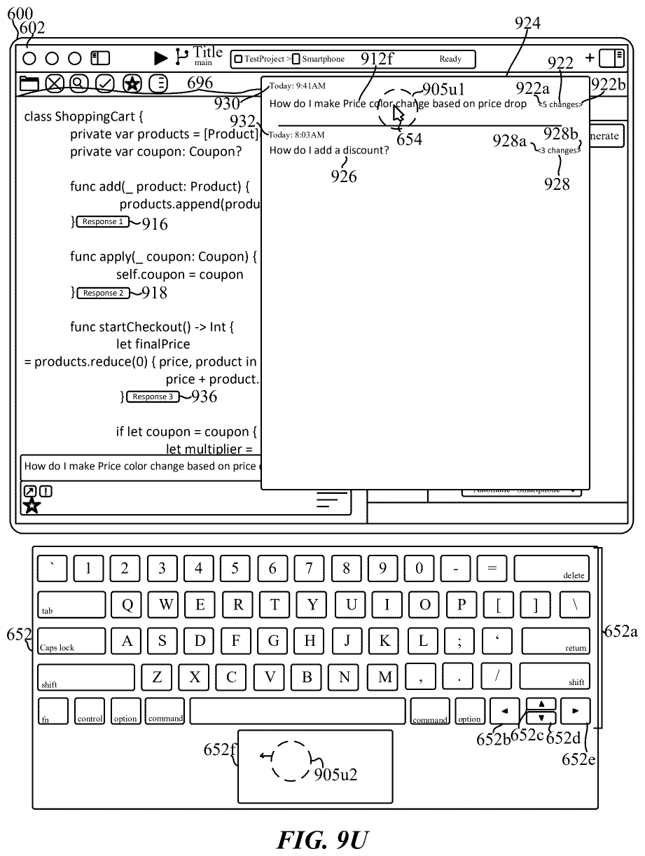

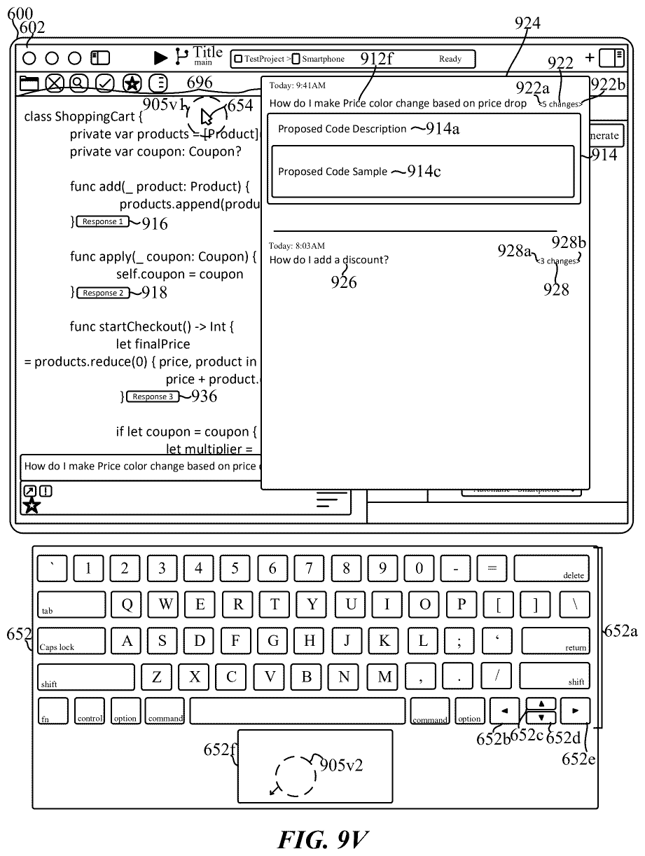

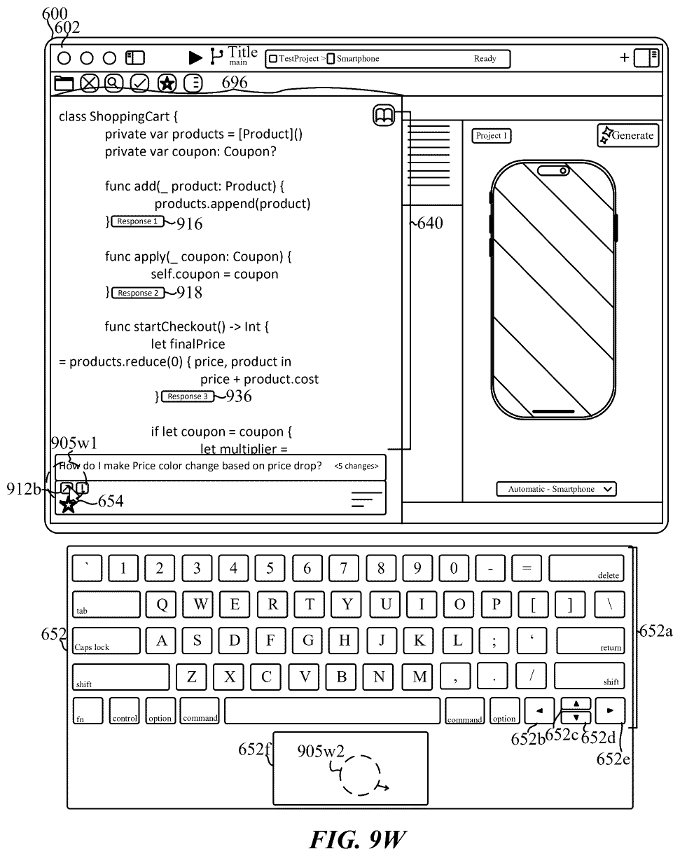

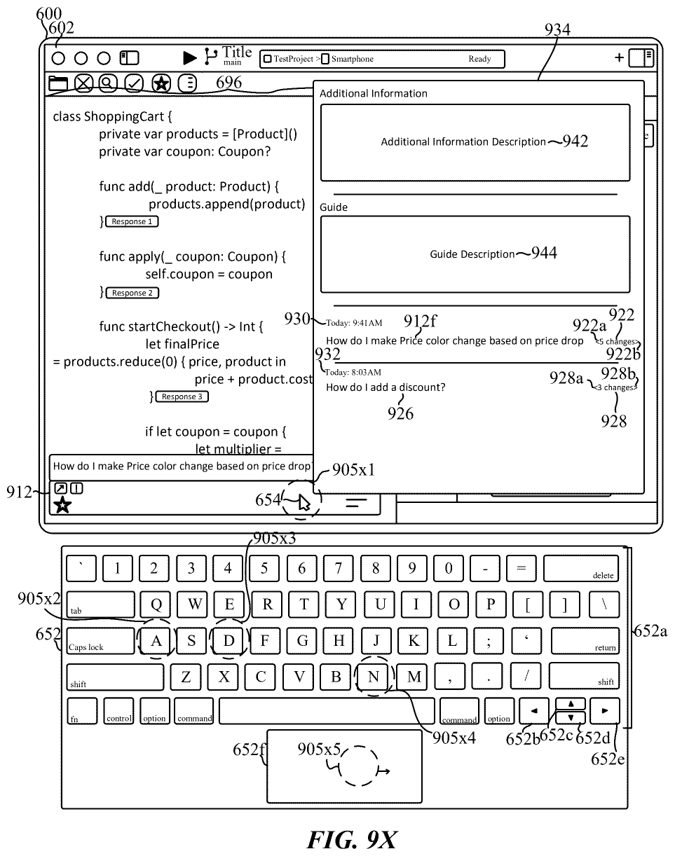

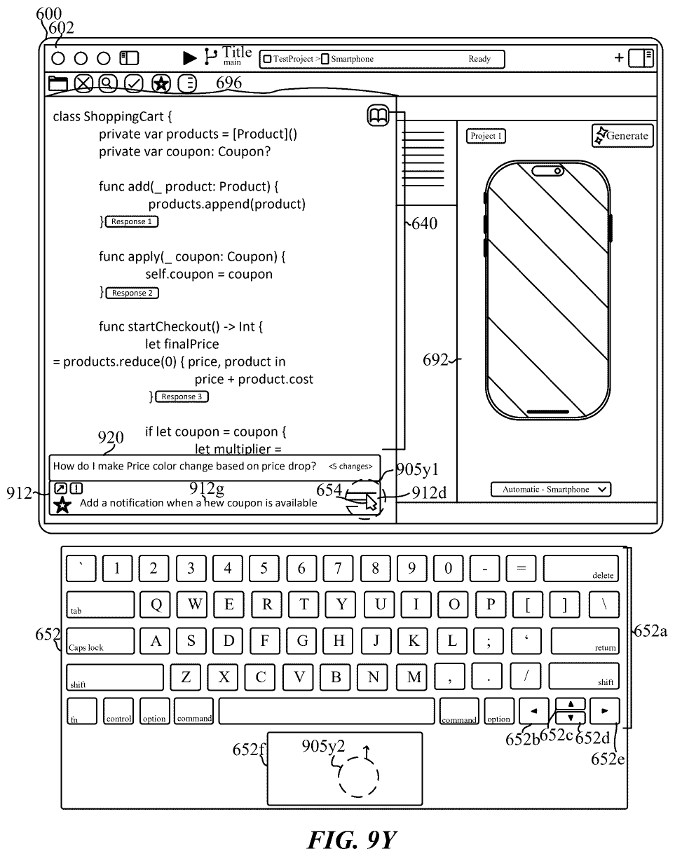

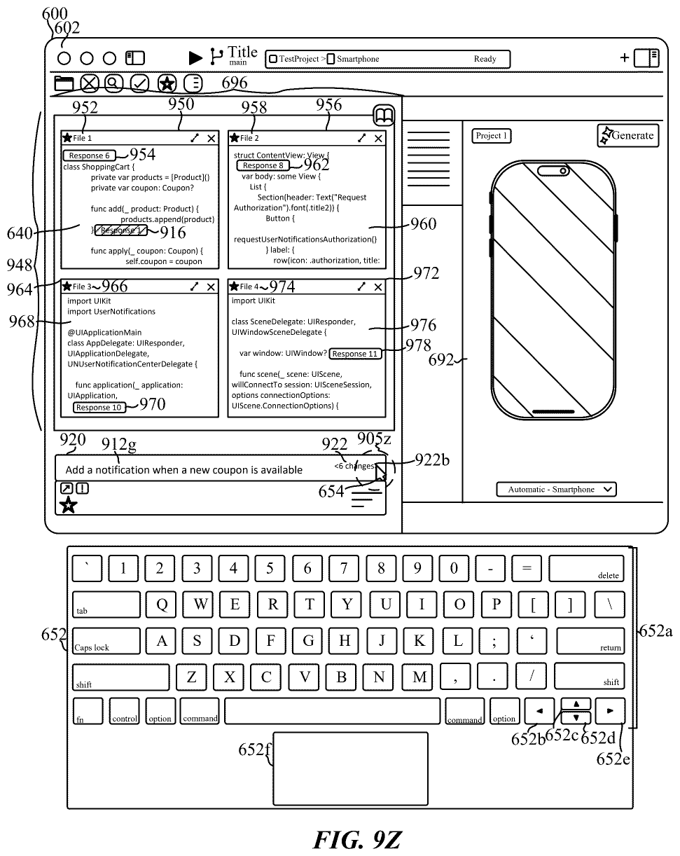

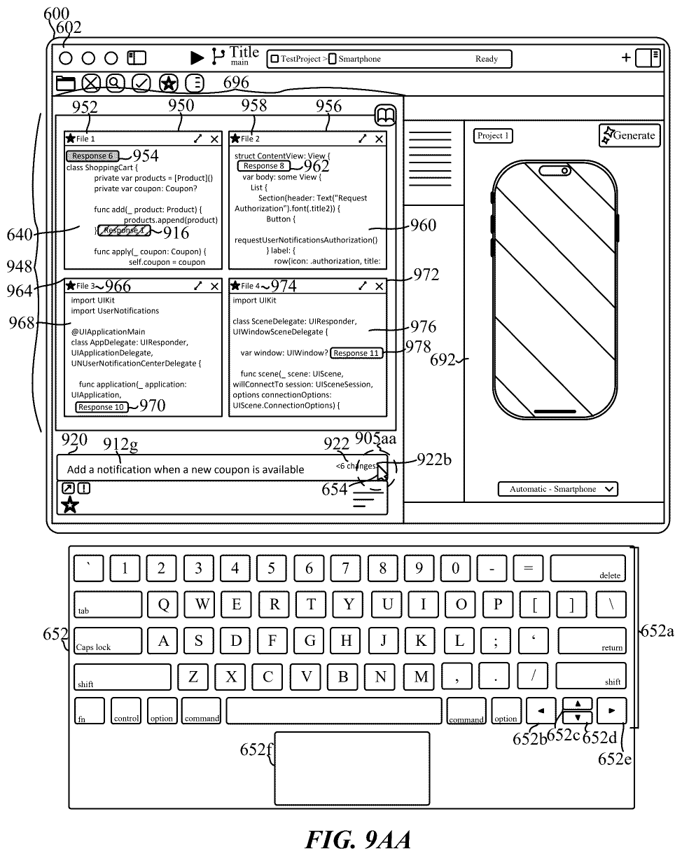

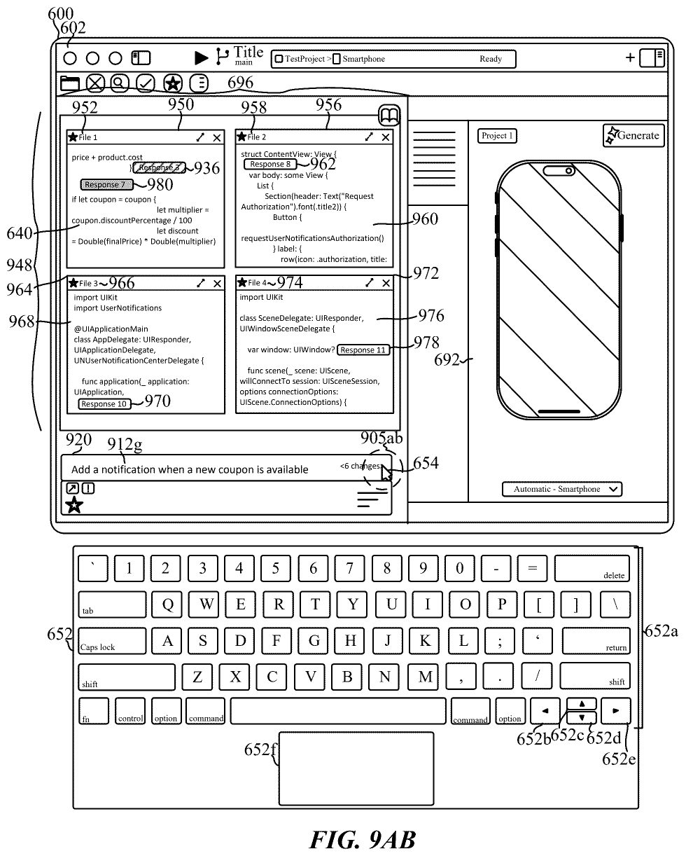

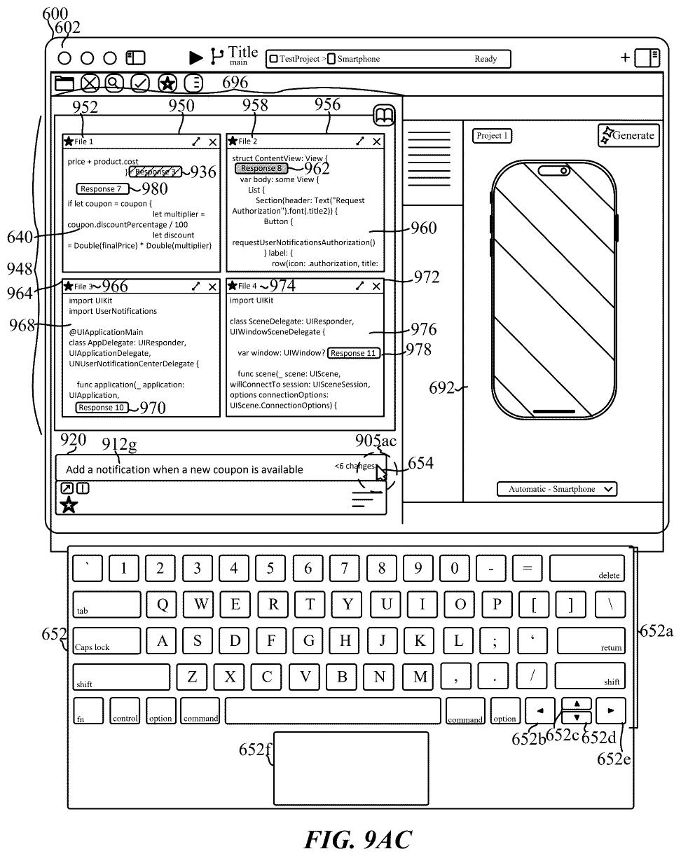

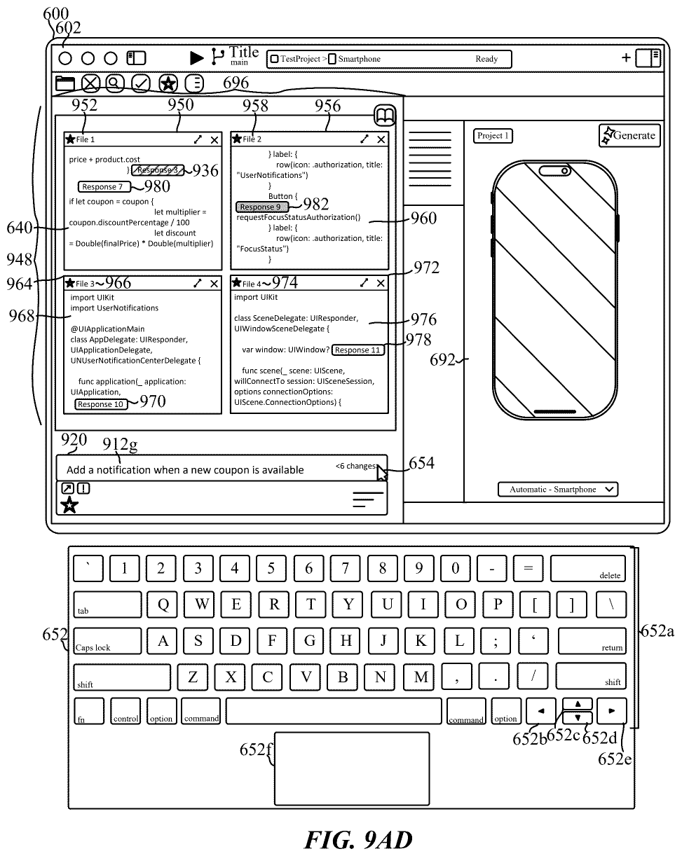

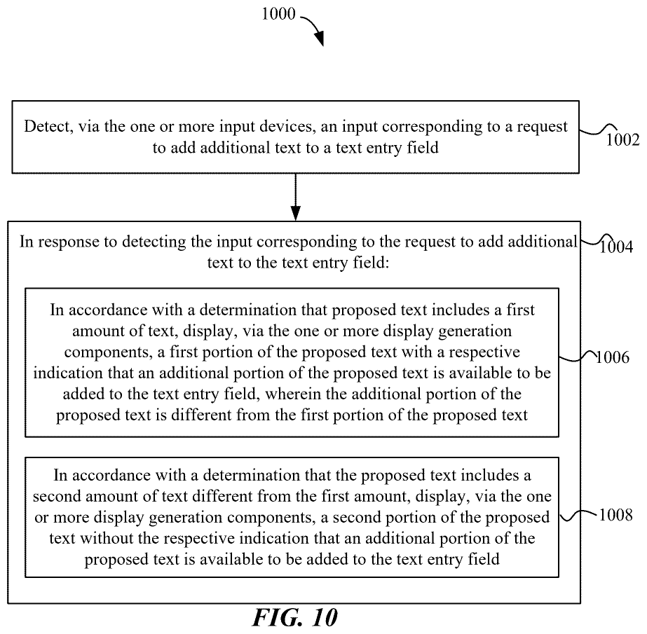

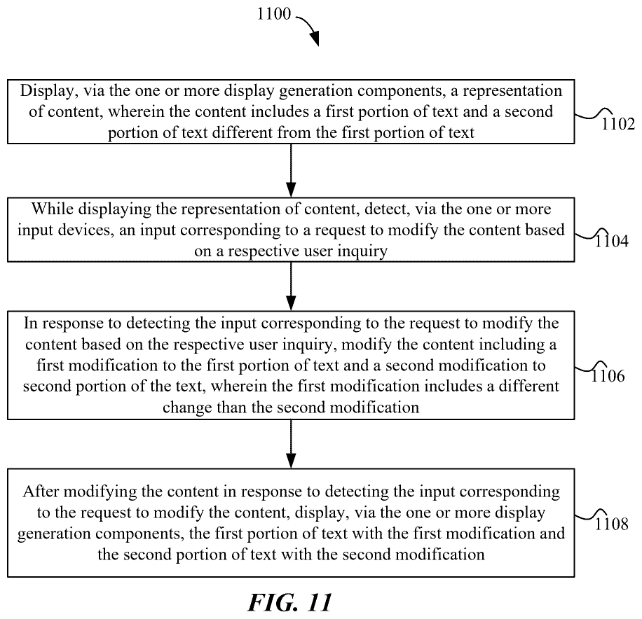

Below, FIGS. 1A-1B, 2, 3A-3G, 4A-4B, and 5A-5B provide a description of exemplary devices for performing the techniques for managing content. FIGS. 6A-6AN illustrate exemplary user interfaces for managing content in accordance with some embodiments. FIG. 7 is a flow diagram illustrating a process for providing responses based on a portion of content and a user inquiry in accordance with some embodiments. The user interfaces in FIGS. 6A-6AN are used to illustrate the processes described below, including the processes in FIG. 7. FIG. 8 is a flow diagram illustrating a process for displaying a visual indications of the result of running a section of code in accordance with some embodiments. The user interfaces in FIGS. 6A-6AN are used to illustrate the processes described below, including the processes in FIG. 8. FIGS. 9A-9AD illustrate exemplary user interfaces for completing content in accordance with some embodiments. FIG. 10 is a flow diagram illustrating a process for selectively displaying an indication of additional proposed text based on length of additional text in accordance with some embodiments. The user interfaces in FIGS. 9A-9AD are used to illustrate the processes described below, including the processes in FIG. 10. FIG. 11 is a flow diagram illustrating a process for modifying multiple portions of text as the result of an input to a request to modify the text in accordance with some embodiments. The user interfaces in FIGS. 9A-9AD are used to illustrate the processes described below, including the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an email application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

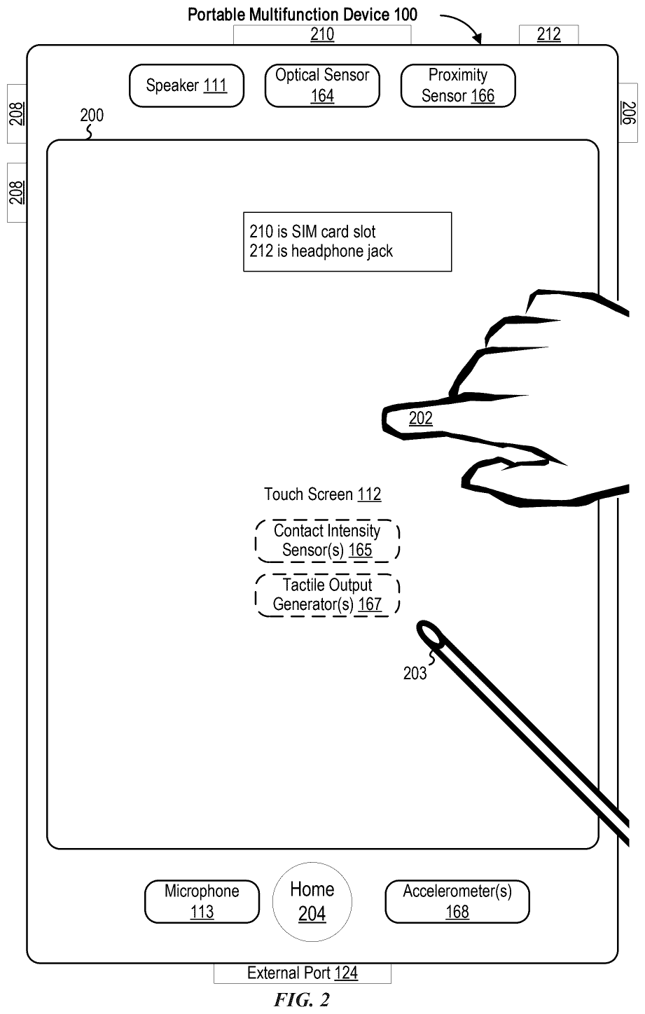

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

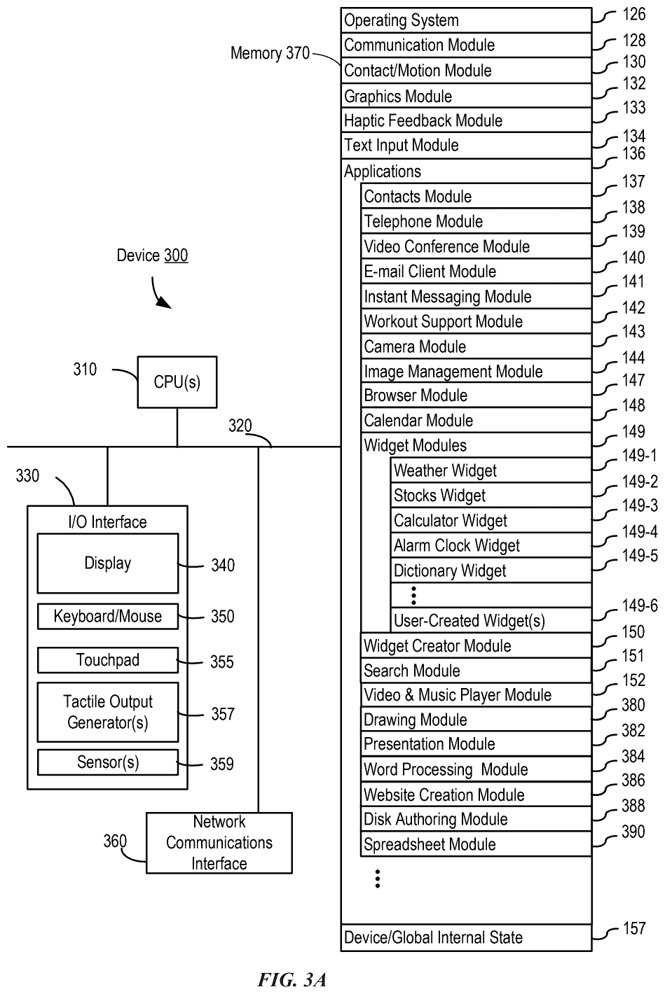

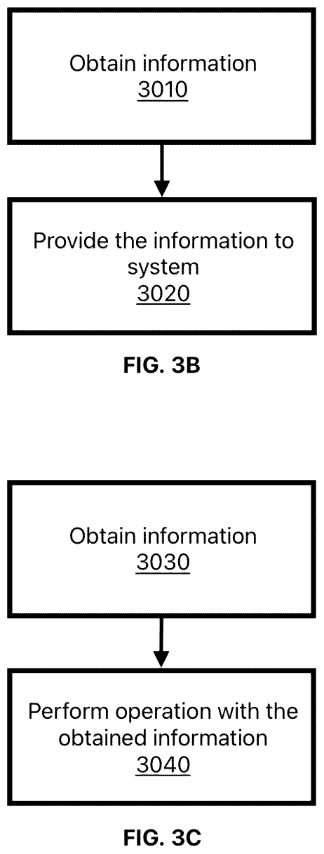

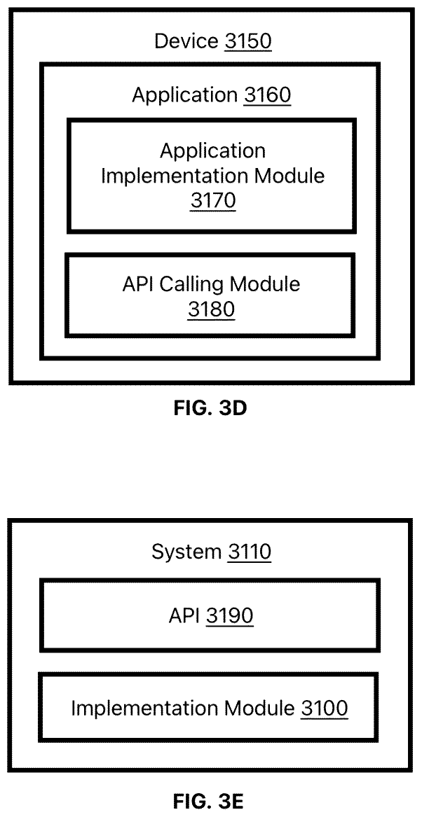

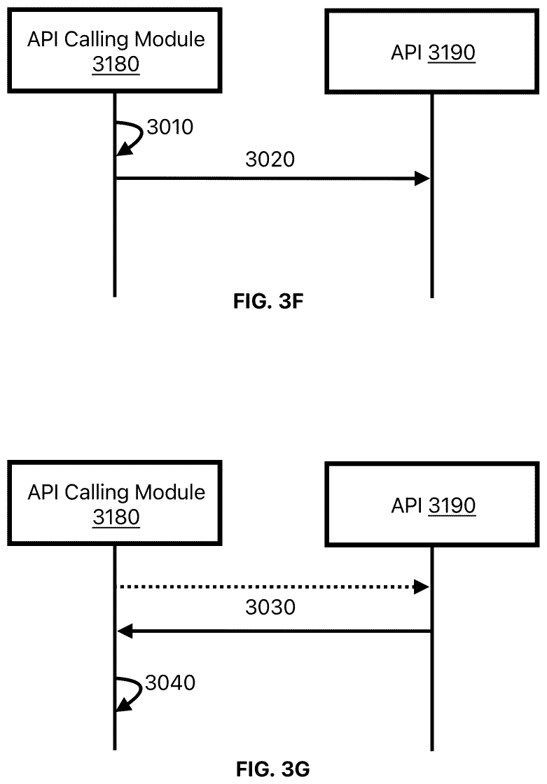

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, email 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to subevents of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or subevent, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700, 800, 1000, and 1100 (FIGS. 7, 8, 10, and 11) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

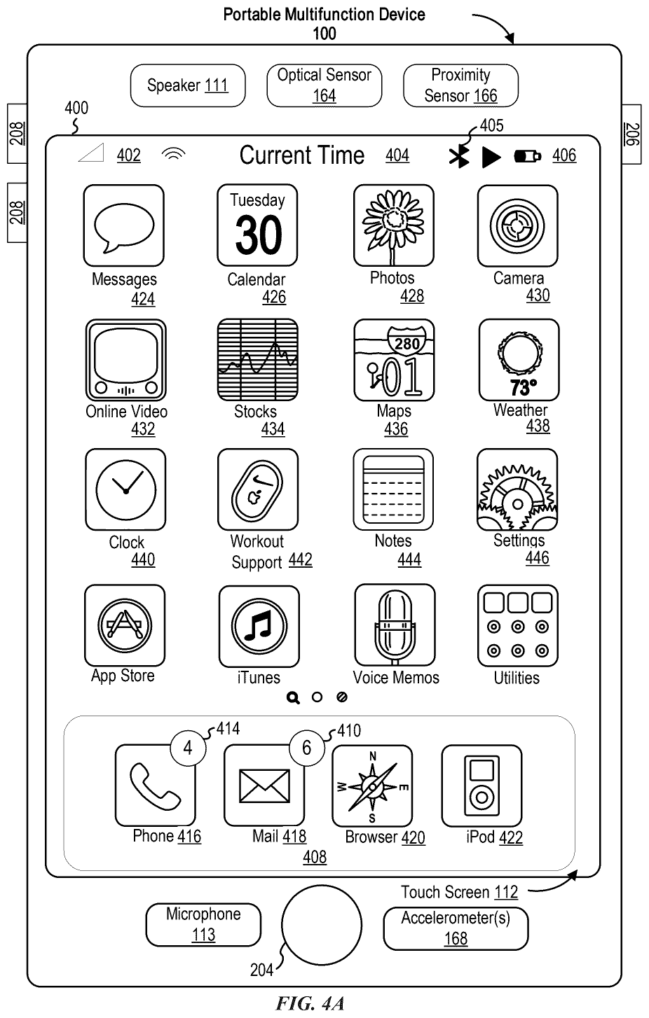

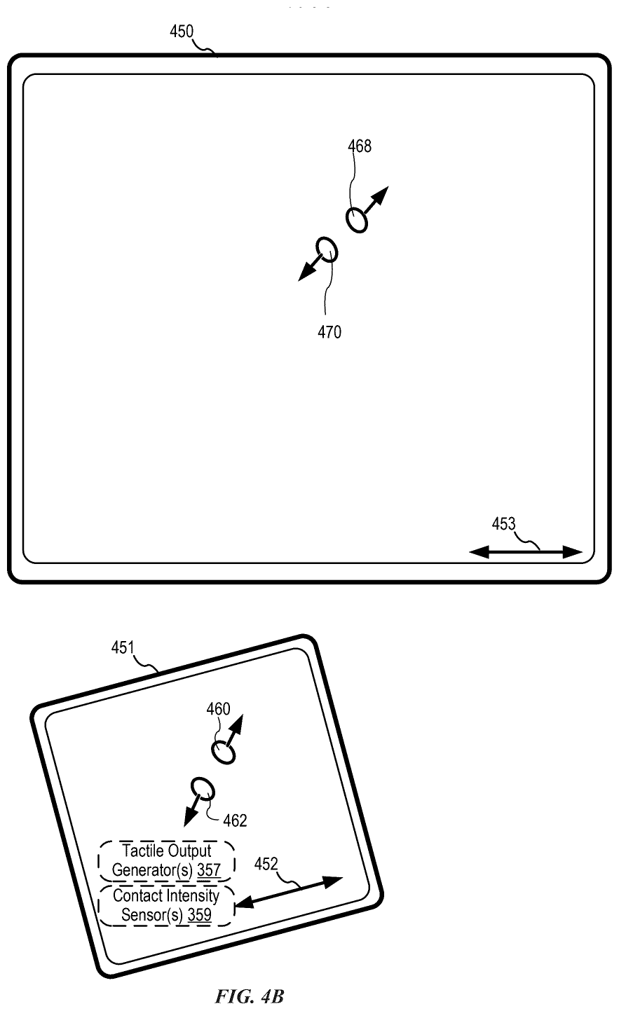

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

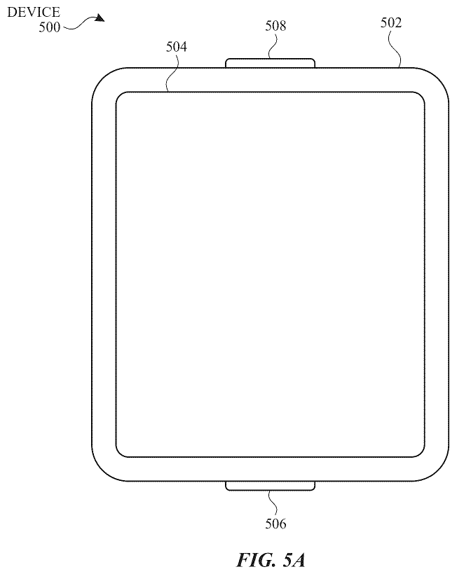

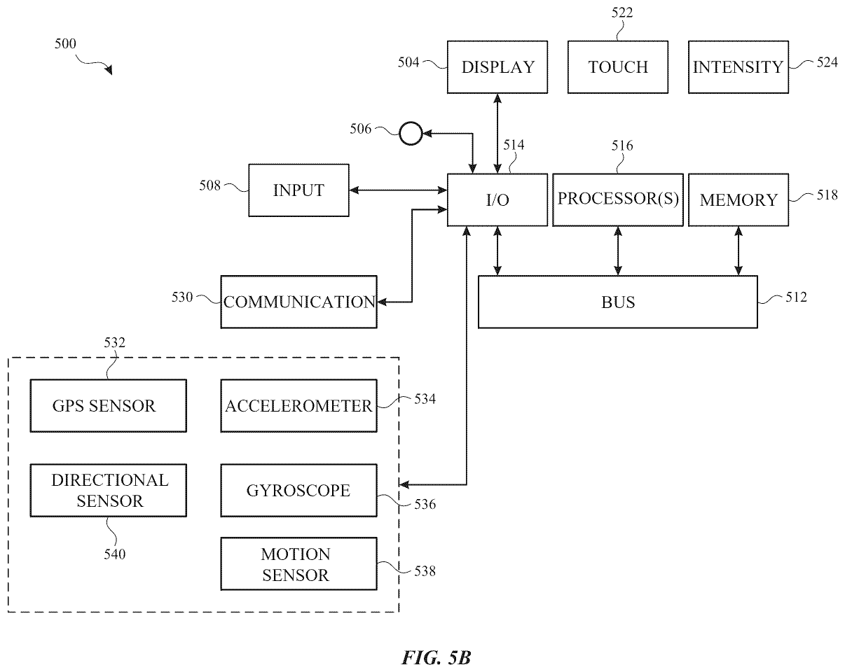

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800, 1000, and 1100 (FIGS. 7, 8, 10, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6AN illustrate exemplary user interfaces for managing content in accordance with some embodiments. The user interfaces in these figures are used to illustrate the processes described below, including the processes in FIGS. 7-8.

FIGS. 6A-6AN illustrate computer system 600 as a desktop computer. It should be recognized that computer system 600 can be other types of computer systems, such as a smart phone, a smart watch, a tablet, a laptop, a communal device, an accessory, a personal gaming system, a laptop computer, a fitness tracking device, and/or a head-mounted display (HMD) device. Additionally, FIGS. 6A-6AN illustrate keyboard 652, a physical keyboard that is connected to computer system 600. Keyboard 652 includes keys region 652a and touchpad 652f. Keys region 652a includes various typing keys corresponding to letters, numbers, symbols, and/or computer system commands. Computer system 600 displays typed content (e.g., for the purposes of this application, code) in response to detecting one or more inputs directed to the typing keys within keys region 652a. Keys region 652a also includes left arrow key 652b, up arrow key 652c, down arrow key 652d, and right arrow key 652e. In some embodiments, computer system 600 moves a text-insertion cursor (e.g., cursor indicator 654, described below) in response to detecting an input directed to left arrow key 652b, up arrow key 652c, down arrow key 652d, and/or right arrow key 652e. In some embodiments, computer system 600 moves a cursor and/or the text-insertion cursor and/or performs an operation in response to detecting an input directed to touchpad 652f. It should be recognized that, while the description below might refer to a particular type of input, other types of inputs can be used instead. For example, when the description refers to a mouse click, other types of inputs can be used instead such as an air gesture or a tap input.

In the examples described below with respect to FIGS. 6A-6AN, computer system 600 displays user interface 602 (e.g., a code editing user interface). As illustrated in FIG. 6A, user interface 602 includes code region 696, control region 656, preview region 692, status region 694, cursor indicator 654 (e.g., a cursor of computer system 600 that is moved based on input detected via touchpad 652f). As illustrated in FIG. 6A, computer system 600 displays cursor indicator 654 as a “mouse” cursor. In some embodiments, computer system 600 displays cursor indicator 654 in another form (e.g., a typing cursor and/or another shape).

Code region 696 is a region dedicated to displaying and/or editing code. Code region 696 includes code 640 (e.g., user-created code corresponding to a shopping application) and code overview indicator 642. Code 640 includes code corresponding to a current project. Code overview indicator 642 provides a minimized view of the code as indicated by code 640. In some embodiments, code overview indicator 642 displays only a portion of code (e.g., the code portion that computer system 600 is displaying) and does not show the totality of the code. In some embodiments, code overview indicator 642 displays the totality of the code.

Control region 656 is a region dedicated to navigating within user interface 602. Control region 656 includes exit control 604, minimize control 606, maximize control 608, hide control 610, run control 612, application control 614, tracking control 616, search control 618. approve control 620, intelligent coding control 622, and/or report navigator control 624. Computer system 600 exits (e.g., ceases to display) user interface 602 in response to detecting an input (e.g., a mouse click, an air gesture, and/or a tap input) directed to exit control 604. Computer system minimizes (e.g., shrinks the display) of user interface 602 in response to detecting an input (e.g., a mouse click, an air gesture, and/or a tap input) directed to minimize control 606. Computer system maximizes (e.g., expands the display and/or enters a Fullscreen state) of user interface 602 in response to detecting an input (e.g., a mouse click, an air gesture, and/or a tap input) directed to maximize control 608. Computer system 600 hides (e.g., ceases to display) control region 656 in response to detecting an input (e.g., a mouse click, an air gesture, and/or a tap input) directed to hide control 610. Computer system 600 builds and/or runs the code (e.g., the code corresponding to code 640) in response to detecting an input (e.g., a mouse click, an air gesture, and/or a tap input) directed to run control 612. Computer system 600 displays data related to the current project in response to detecting an input (e.g., a mouse click, an air gesture, and/or a tap input) directed to application control 614. Computer system 600 displays tracked changes to files related to the current project in response to detecting an input (e.g., a mouse click, an air gesture, and/or a tap input) directed to tracking control 616. Computer system 600 displays a search user interface in response to detecting an input (e.g., a mouse click, an air gesture, and/or a tap input) directed to search control 618. Computer system 600 displays an approval user interface in response to detecting an input (e.g., a mouse click, an air gesture, and/or a tap input) directed to approve control 620. Computer system 600 displays intelligent coding user interface elements in response to detecting an input (e.g., a mouse click, an air gesture, and/or a tap input) directed to intelligent coding control 622. Computer system 600 reports the navigator in response to detecting an input (e.g., a mouse click, an air gesture, and/or a tap input) directed to report navigator control 624. As will be discussed below, computer system 600 displays controls related to editing code within control region 656. In some embodiments, computer system 600 displays more, less, and/or different controls within control region 656. In some embodiments, computer system 600 displays controls in a different order within control region 656.

Preview region 692 is a region dedicated to displaying results of the code (e.g., code 640). Preview region 692 includes first project indicator 644, generate preview control 646, computer system indicator 648, and preview type control 650. First project indicator 644 indicates a first project (e.g., the project that code 640 corresponds to). Computer system indicator 648 indicates a type of computer system that allows a user to view how their project will appear on a specific type of computer system. As illustrated in FIG. 6A, computer system 600 displays computer system indicator 648 as a smart phone. Additionally, as illustrated in FIG. 6A, computer system 600 displays computer system indicator 648 with hatching to indicate that no preview is displayed on computer system indicator 648. In some embodiments, computer system 600 displays computer system indicator 648 as a different type of computer system (e.g., a smart watch, a tablet, a laptop computer and/or a desktop computer). Computer system 600 generates and displays a preview of the current project onto computer system indicator 648, as well as generating and displaying additional previews of other applications of the current project, in response to detecting an input (e.g., a mouse click, an air gesture, and/or a tap input) directed to generate preview control 646. Computer system 600 displays a drop-down menu that includes other preview options in response to detecting an input (e.g., a mouse click, an air gesture, and/or a tap input) directed to preview type control 650 (e.g., more specifically, in response to detecting an input directed to drop-down arrow 650d). Computer system 600 displays the drop-down menu in response to detecting an input (e.g., a mouse click, an air gesture, and/or a tap input) directed to preview type control 650 to allow a user to change the computer system type (e.g., via computer system indicator 648), allowing a user to view how their project will look appear on multiple types of computer systems. Additionally, computer system 600 displays computer system type indicator 650a (e.g., “Automatic-Smartphone”) as a part of preview type control 650 to indicate the current displayed computer system type to which computer system indicator 648 corresponds to. In some embodiments, computer system 600 displays more, less, and/or different controls within preview region 692. In some embodiments, computer system 600 displays controls in a different order within preview region 692.

Status region 694 is a region dedicated to interacting with user interface 602. Status region 694 includes graphic indicator 626, title indicator 628, navigation bar 630, project indicator 632, status indicator 634, add control 636, and hide control 638. Graphic indicator 626 indicates the current user interface (e.g., user interface 602). Title indicator 628 indicates the title of the current project. Navigation bar 630 includes project indicator 632 and status indicator 634. Project indicator 632 indicates the title of the project and the computer system type used in the project. As illustrated in FIG. 6A, the title of the current project is “TestProject” and the current computer system type is smartphone. Status indicator 632 indicates the status of user interface 602 in regard to an action (e.g., a test of the code, an approval of the code, and/or a save of the code). As illustrated in FIG. 6A, computer system 600 displays status indicator 634 as “Ready”, indicating that computer system 600 is ready for an action (e.g., a user-initiated input, process, and/or procedure corresponding to user interface 602). In some embodiments, computer system 600 adds a file to the current project in response to detecting an input (e.g., a mouse click, an air gesture, and/or a tap input) directed to add control 636. In some embodiments, computer system 600 hides (e.g., ceases to display) an inspector region in response to detecting an input (e.g., a mouse click, an air gesture, and/or a tap input) directed to hide control 638. In some embodiments, computer system 600 displays more, less, and/or different controls within status region 694. In some embodiments, computer system 600 displays controls in a different order within status region 694.

FIGS. 6A-6Z illustrate a process where computer system 600 displays suggestions to editing code. At FIG. 6A, computer system 600 detects, via touchpad 652f, selection input 605a directed to intelligent coding control 622. For example, selection input 605a can be a mouse click on intelligent coding control 622. It should be recognized that other types of inputs can be used instead of a mouse click, such as an air gesture or a tap input.

As illustrated in FIG. 6B, in response to detecting selection input 605a, computer system 600 displays code editing indicator 656a, navigation bar 656b, option control 656c, suggested question 656d, suggested question 656e, suggested question 656f, and option control 656g within control region 656.

Navigation bar 656b includes code editing indicator 656a. Code editing indicator 656a indicates that computer system 600, user interface 602, and/or an application corresponding to user interface 602 has entered into an editing state. While in an editing state, computer system 600 displays one or more suggested questions (e.g., prompts) to aid a user with editing their code. Computer system 600 displays one or more suggested questions based on code 640 (e.g., computer system 600 displays one or more suggested questions relevant specifically to the current project).

Computer system 600 displays one or more suggested questions (1) in response to initiating an editing state, (2) in response to typing and entering a first question into navigation bar 656b, (3) in response to selecting (e.g., highlighting) a first portion of code 640 (e.g., highlighting the totality of code 640), (4) in response to detecting that text-insertion cursor indicator 686 is at a first position within code 640, and/or (5) in response to detecting that cursor indicator 654 is hovering over a first portion of code (e.g., computer system 600 detects that cursor indicator 654 is hovering for a predetermined amount of time). Additionally, as illustrated in FIG. 6B, computer system 600 updates (e.g., changes) the displayed suggested questions (1) in response to detecting that a second question has been typed and entered into navigation bar 656b (e.g., a question different from the first question), (2) in response to detecting that a different portion of code 640 is selected (e.g., a portion of code different from the first portion of code), (3) in response to detecting that text-insertion cursor indicator 686 is at a different position within code 640 (e.g., a position different from the first position), and/or (4) in response to detecting that cursor indicator 654 is hovering over a different portion of code selected (e.g., a portion of code different from the first portion of code). In response to detecting an input (e.g., a mouse click, an air gesture, and/or a tap input) directed to a suggested question and/or an input (e.g., typing and/or speaking one or more words) corresponding to entering a typed question within navigation bar 656b, computer system 600 displays articles that include answers (e.g., as will be described in greater detail below) to the suggested question and/or typed question within navigation bar 656b.

In some embodiments, computer system 600 updates (e.g., changes) the displayed suggested questions in response to detecting that the contents of code 640 have been edited. In other embodiments, computer system 600 maintains (e.g., continues displaying) the displayed suggested questions in response to detecting that the contents of code 640 have been edited. In some embodiments, computer system 600 displays suggested questions based on the entire code (e.g., computer system 600 displays suggested questions relevant to the entire code not just what is being displayed and/or selected). In some embodiments, computer system 600 displays suggested questions based on external data (e.g., previous projects and/or internet data).

In response to detecting an input (e.g., a mouse click, an air gesture, and/or a tap input) directed to option control 656c, computer system 600 displays a menu (e.g., that includes controls) that allows a user to interact with displayed answers (as will be discussed in greater detail with respect to FIG. 6S). In response to detecting an input (e.g., a mouse click, an air gesture, and/or a tap input) directed to option control 656g, computer system 600 displays a menu (e.g., that includes controls) that allows a user to interact with threads (as will be discussed in greater detail with respect to FIG. 6T). At FIG. 6B, computer system 600 detects diagonal input 605b directed to touchpad 652f. For example, diagonal input 605b can be a drag input detected via touchpad 652f or mouse from one location to another. For another example, diagonal input 605b can be a tap input to place text-insertion cursor indicator 686 (described below) in the code. It should be recognized that other types of inputs can be used instead of diagonal input 605b, such as an air gesture moving from one location to another.

In between FIG. 6B and FIG. 6C, in response to detecting diagonal input 605b directed to touchpad 652f, computer system 600 moves cursor indicator 654 to hover over code portion 640a. Additionally, as illustrated in FIG. 6C, computer system 600 displays cursor indicator 654 in code portion 640a to indicate that cursor indicator 654 is hovering over an editable portion of code. As illustrated in FIG. 6C, computer system 600 changes the appearance of cursor indicator 654 to indicate that computer system 600 detected that cursor indicator 654 entered a typing field and/or computer system 600 detected that a user has initiated typing. Additionally, computer system 600 displays text-insertion cursor indicator 686 to indicate a next place where characters will be added from typing. At FIG. 6C, computer system 600 detects that cursor indicator 654 is hovering over code portion 640a. As illustrated in FIG. 6C, in response to detecting cursor indicator 654 hovering over code portion 640a, computer system 600 ceases to display suggested question 656e and suggested question 656f and displays suggested question 656h, suggested question 656i (e.g., computer system 600 displays new suggested questions that are relevant to code portion 640a), and suggested question 656d (e.g., computer system 600 continues to display suggested question 656d because it is relevant to code portion 640a and/or because it is relevant to the entirety of code 640) within control region 656. At FIG. 6C, computer system 600 detects key input 605c directed to down arrow key 652d. For example, key input 605c can be a key input on a physical keyboard or a tap input on a virtual keyboard. It should be recognized that other types of inputs can be used instead of key input 605c, such as a voice input.

In between FIG. 6C and FIG. 6D, in response to detecting key input 605c, computer system 600 moves text-insertion cursor indicator 686 to code portion 640b (e.g., a different portion of code). As illustrated in FIG. 6D, cursor indicator 654 did not move between FIG. 6C and FIG. 6D. At FIG. 6D, computer system 600 detects that text-insertion cursor indicator 686 is located at code portion 640b. As illustrated in FIG. 6D, in response to detecting text-insertion cursor indicator 686 is located at code portion 640b, computer system 600 ceases to display suggested question 656h and suggested question 656i and displays suggested question 656j, suggested question 656k (e.g., computer system 600 displays new suggested questions that are relevant to code portion 640b), and suggested question 656d (e.g., computer system 600 continues to display suggested question 656d because it is relevant to code portion 640b and/or because it is relevant to the entirety of code 640) within control region 656. At FIG. 6D, computer system 600 detects diagonal input 605d directed to touchpad 652f. For example, diagonal input 605d can be a drag input detected via touchpad 652f or a mouse from one location to another. It should be recognized that other types of inputs can be used instead of diagonal input 605b, such as an air gesture moving from one location to another or a tap input at a final location.

As illustrated in FIG. 6E, in response to detecting diagonal input 605d, computer system 600 moves cursor indicator 654 to code portion 640c (e.g., a portion different than code portion 640a and code portion 640b). At FIG. 6E, computer system 600 detects tap and diagonal input 605e directed to code portion 640c. For example, tap and diagonal input 605e can be a tap and drag input detected via touchpad 652f or a mouse from one location to another. For another example, tap and diagonal input 605e can include multiple tap inputs at different locations. It should be recognized that other types of inputs can be used instead of tap and diagonal input 605e, such as an air gesture moving from one location to another.

As illustrated in FIG. 6F, in response to detecting tap and diagonal input 605e, computer system 600 selects (e.g., highlights and/or designates) code portion 640c, as indicated by selection indicator 690. As illustrated in FIG. 6F, in response to selecting code portion 640c, computer system 600 ceases to display suggested question 656j and suggested question 656k and displays suggested question 656l, suggested question 656m (e.g., computer system 600 displays new suggested questions that are relevant to code portion 640c), and suggested question 656d (e.g., computer system 600 continues to display suggested question 656d because it is relevant to code portion 640c and/or because it is relevant to the entirety of code 640) within control region 656. In some embodiments, while code portion 640c is selected (e.g., highlighted and/or selected), computer system 600 displays a button corresponding to code portion 640c. For example, in response to detecting that code portion 640c is selected in the code, computer system 600 displays a button that allows a user to copy the selected text. In response to detecting an input (e.g., a mouse click, an air gesture, and/or a tap input) directed to the button, computer system 600 copies code portion 640c. Additionally, as illustrated in FIG. 6F, computer system 600 displays cursor indicator 654 as a mouse cursor (e.g., computer system 600 detects that cursor indicator 654 is not in a typing field and/or that a user does not want to type) rather than a typing cursor. At FIG. 6F, computer system 600 detects diagonal input 605f directed to touchpad 652f. For example, diagonal input 605f can be a drag input detected via touchpad 652f or a mouse from one location to another. It should be recognized that other types of inputs can be used instead of diagonal input 605f, such as an air gesture moving from one location to another or a tap input at a final location.

As illustrated in FIG. 6G, in response to detecting diagonal input 605f, computer system 600 moves cursor indicator 654 to code portion 640d (e.g., a portion different than code portion 640a, code portion 640b, and code portion 640c). As illustrated in FIG. 6G, computer system 600 changes the appearance of cursor indicator 654 to indicate that computer system 600 initiated typing (e.g., computer system 600 detected that cursor indicator 654 entered a typing field and/or computer system 600 detected that a user has initiated typing). At FIG. 6G, computer system 600 detects, via touchpad 652f, tap and diagonal input 605g directed to code portion 640d. For example, tap and diagonal input 605g can be a tap and drag input detected via touchpad 652f or a mouse from one location to another. For another example, tap and diagonal input 605g can include multiple tap inputs at different locations. It should be recognized that other types of inputs can be used instead of tap and diagonal input 605g, such as an air gesture moving from one location to another.

As illustrated in FIG. 6H, in response to detecting tap and diagonal input 605g, computer system 600 selects (e.g., highlights and/or designates) code portion 640d, as indicated by selection indicator 690. As illustrated in FIG. 6H, in response to selecting code portion 640d, computer system 600 ceases to display suggested question 656l and suggested question 656m and displays suggested question 656n, suggested question 6560 (e.g., computer system 600 displays new suggested questions that are relevant to code portion 640d), and suggested question 656d (e.g., computer system 600 continues to display suggested question 656d because it is relevant to code portion 640d and/or because it is relevant to the entirety of code 640) within control region 656. Additionally, as illustrated in FIG. 6H, computer system 600 displays cursor indicator 654 as a mouse cursor (e.g., computer system 600 detects that cursor indicator 654 is not in a typing field and/or that a user does not want to type) rather than a typing cursor. At FIG. 6H, computer system 600 detects diagonal input 605h directed to touchpad 652f. For example, diagonal input 605h can be a drag input detected via touchpad 652f or a mouse from one location to another. It should be recognized that other types of inputs can be used instead of diagonal input 605h, such as an air gesture moving from one location to another or a tap input at a final location.

As illustrated in FIG. 6I, in response to detecting diagonal input 605h, computer system 600 moves cursor indicator 654 over navigation bar 656b. At FIG. 6I, computer system 600 detects, via touchpad 652f, selection input 605i1 (e.g., a mouse click, an air gesture, and/or a tap input) directed to navigation bar 656b. At FIG. 6I, after detecting selection input 605i1, computer system 600 detects key input 605i3, key input 605i4, and key input 605i5 directed to keys within keys region 652a (e.g., multiple key inputs on a physical keyboard, multiple tap inputs on a virtual keyboard, or a voice input). In response to detecting selection input 605i1, key input 605i3, key input 605i4, and key input 605i5, computer system 600 begins filling navigation bar 656b with the entered typing. At FIG. 6I, computer system 600 detects a horizontal input to the right directed to touchpad 652f. For example, the horizontal input can be a horizontal input detected via touchpad 652f or a mouse from one location to another. It should be recognized that other types of inputs can be used instead of the horizontal input, such as an air gesture moving from one location to another or a tap input at a final location.

In between FIG. 6I and FIG. 6J, computer system 600 detects that the user finished typing. In response to detecting that the user finished typing, computer system 600 displays first user question indicator 656p (e.g., a first question related to the current project) within navigation bar 656b. In some embodiments, computer system 600 displays first user question indicator 656p in response to detecting an input corresponding to handwriting and/or a verbal input (e.g., as opposed to typing).

As illustrated in FIG. 6J, in response to detecting the horizontal input to the right, computer system 600 moves cursor indicator 654 over enter control 656q. As illustrated in FIG. 6J, computer system 600 displays enter control 656q within navigation bar 656b. Computer system 600 accepts (e.g., receives) a user question and displays a relevant answer corresponding to the user question in response to detecting an input (e.g., a mouse click, an air gesture, and/or a tap input) directed to enter control 656q. At FIG. 6J, computer system 600 detects, via touchpad 652f, selection input 605j (e.g., a mouse click, an air gesture, and/or a tap input) directed to enter control 656q.

As illustrated in FIG. 6K, in response to detecting selection input 605j, computer system 600 displays Article A indicator 656t, Article B indicator 656u, and Article C indicator 656v (e.g., computer system 600 displays relevant articles (e.g., answers) based on a first user question (e.g., first user question indicator 656p)) within control region 656. As illustrated in FIG. 6K, in response to detecting selection input 605j, computer system 600 ceases to display suggested question 656n, suggested question 6560 and suggested question 656d, and displays suggested question 656r and suggested question 656s (e.g., computer system 600 displays follow-up questions in response to displaying articles). Additionally, as illustrated in FIG. 6K, as computer system 600 displays Article A indicator 656t, Article B indicator 656u, and Article C indicator 656v, computer system 600 continues to display navigation bar 656b (e.g., computer system 600 continues to display navigation bar 656b in case a user wants to enter another question and/or a follow-up question). In some embodiments, computer system 600 displays articles based on a determination of relevance (e.g., computer system 600 displays a more relevant article higher within control region 656 and displays a less relevant article lower within control region 656.

Article A indicator 656t includes response indicator 656t1 and Add control 656t2. Response indicator 656t1 indicates a code sample able to be added to code 640 as an answer to first user question indicator 656p. Computer system 600 adds the code sample corresponding to response indicator 656t1 to code 640 in response to detecting an input (e.g., a mouse click, an air gesture, and/or a tap input) directed to Add control 656t2. In some embodiments, computer system 600 adds the code sample corresponding to response indicator 656t1 to a specific portion of code 640 in response to detecting user input directed to that specific portion of code. In some embodiments, computer system 600 adds the code sample corresponding to response indicator 656t1 to a specific portion of code 640 based on a determination of the code corresponding to response indicator 656t1 fits best with that portion of code to solve a user question (e.g., first user question indicator 656p).

Article B indicator 656u includes response indicator 656u1 and Insert control 656u2. Response indicator 656u1 indicates a code sample able to be inserted into code 640 as an answer to first user question indicator 656p. Computer system 600 inserts the code sample corresponding to response indicator 656u1 into code 640 in response to detecting an input (e.g., a mouse click, an air gesture, and/or a tap input) directed to Insert control 656u2. In some embodiments, computer system 600 inserts the code sample corresponding to response indicator 656u1 into a specific portion of code 640 in response to detecting an input (e.g., a mouse click, an air gesture, and/or a tap input) directed to that specific portion of code. In some embodiments, computer system 600 inserts the code sample corresponding to response indicator 656u1 into a specific portion of code 640 based on the user identifying the location to add the specific portion of code.

It should be recognized that Add control 656t2 of Article A indicator 656t and Insert control 656u2 of Article B indicator 656u are not the same, in some embodiments. In some embodiments, computer system 600 identifies the location to “add” the code sample to code 640 in response to an input (e.g., a mouse click, an air gesture, and/or a tap input) directed to Add control 656t2. For example, an input (e.g., a mouse click, an air gesture, and/or a tap input) directed to Add control 656t2 adds the code sample at a location corresponding to a different portion of code 640 than the location of text-insertion cursor indicator 686 and/or a different portion of code 640 than a selected (e.g., highlighted) portion of code 640. In some embodiments, a user identifies the location to “insert” the code sample to code 640 in response to an input (e.g., a mouse click, an air gesture, and/or a tap input) directed to Insert control 656u2. For example, an input (e.g., a mouse click, an air gesture, and/or a tap input) directed to Insert control 656u2 adds the code sample at a location corresponding to text-insertion cursor indicator 686 and/or at a location selected by the user after the input is detected directed to Insert control 656u2.

Article C indicator 656v includes response indicator 656v1. Response indicator 656v1 indicates a step-by-step process to show a user how to edit and/or modify code 640. In some embodiments, articles include specific controls that, in response to computer system 600 detecting an input (e.g., a mouse click, an air gesture, and/or a tap input) directed to the control, allow a user to edit and/or modify the existing code using the specific control. For example, the article includes an indication of a control not displayed on user interface 602 to stop checking for misspelled words in the code. In this example, in response to detecting an input (e.g., a mouse click, an air gesture, and/or a tap input) on the article, computer system 600 stops checking for misspelled words in the code, without the user needing to navigate additional menus to select a similar control. In some embodiments, articles include step-by-step guides on editing and/or modifying the existing code. For example, the code (and/or the portion of code) indicates a function that is incomplete. In this example, the article includes a step-by-step guide on how to complete the indicated function. In some embodiments, articles include links to external resources to help a user edit and/or modify the existing code. In some embodiments, the code (and/or the portion of code) indicates a common function, and the article includes a link to an external website describing the common function.

At FIG. 6K, computer system 600 detects, via touchpad 652f, selection input 605k1 (e.g., a mouse click, an air gesture, and/or a tap input) directed to navigation bar 656b. At FIG. 6K, after detecting selection input 605k1, computer system 600 detects key input 605k3, key input 605k4, and key input 605k5 directed to keys within keys region 652a (e.g., multiple key inputs on a physical keyboard, multiple tap inputs on a virtual keyboard, or a voice input). In response to detecting selection input 605k1, key input 605k3, key input 605k4, and key input 605k5, computer system 600 begins filling navigation bar 656b with the entered typing. At FIG. 6K, computer system 600 detects a horizontal input directed to touchpad 652f. For example, the horizontal input 605f can be a horizontal input detected via touchpad 652f or a mouse from one location to another. It should be recognized that other types of inputs can be used instead of the horizontal input, such as an air gesture moving from one location to another or a tap input at a final location.

In between FIG. 6K and FIG. 6L, computer system 600 detects that the user finished typing. In response to detecting that the user finished typing, computer system 600 displays second user question indicator 656w (e.g., a second question related to the current project) within navigation bar 656b. As illustrated in FIG. 6L, in response to detecting the horizontal input directed to touchpad 652f, computer system 600 moves cursor indicator 654 over enter control 656q. At FIG. 6L, computer system 600 detects, via touchpad 652f, selection input 605l (e.g., a mouse click, an air gesture, and/or a tap input) directed to enter control 656q.

As illustrated in FIG. 6M, in response to detecting selection input 605l, computer system 600 displays Article 1 indicator 656z, Article 2 indicator 656aa, Article 3 indicator 656ab, Article 4 indicator 656ac, and Article 5 indicator 656ad (e.g., computer system displays different relevant articles (answers) in response to receiving a second user question (e.g., second user question indicator 656w)). Additionally, as illustrated in FIG. 6M, in response to detecting selection input 605l, computer system 600 ceases to display suggested question 656s, and displays suggested question 656x and suggested question 656y.

Article 1 indicator 656z includes response indicator 656z1. Response indicator 656v1 indicates a step-by-step process to show a user how to edit and/or modify code 640. Article 2 indicator 656aa includes Create control 656aa1. Computer system 600 creates new code based on second user question indicator 656w in response to detecting an input (e.g., a mouse click, an air gesture, and/or a tap input) directed to Create control 656aa1. Article 3 indicator 656ab includes Add control 656ab1 and response indicator 656ab2. Response indicator 656ab2 indicates a code sample able to be added to code 640 as an answer to second user question indicator 656w. Computer system 600 adds the code sample corresponding to response indicator 656ab2 to code 640 in response to detecting an input (e.g., a mouse click, an air gesture, and/or a tap input) directed to Add control 656ab1. Article 4 indicator 656ac includes Insert control 656ac1 and response indicator 656ac2. Response indicator 656ac2 indicates a code sample able to be inserted into code 640 as an answer to second user question indicator 656w. Computer system 600 inserts the code sample corresponding to response indicator 656ac2 into code 640 in response to detecting an input (e.g., a mouse click, an air gesture, and/or a tap input) directed to Insert control 656ac1. Article 5 indicator 656ad includes Copy control 656ad1 and response indicator 656ad2. Response indicator 656ad2 indicates a code sample able to be copied and pasted into code 640 as an answer to second user question indicator 656w. Computer system 600 copies the code sample corresponding to response indicator 656ad2 into code 640 in response to detecting an input (e.g., a mouse click, an air gesture, and/or a tap input) directed to Copy control 656ad1.

It should be recognized that the following figures are presented as different scenarios in response to computer system 600 detecting different inputs. At FIG. 6M, computer system 600 detects, via touchpad 652f, selection input 605m1 (e.g., a mouse click, an air gesture, and/or a tap input) directed to option control 656c. At FIG. 6M, computer system 600 detects, via touchpad 652f, selection input 605m2 (e.g., a mouse click, an air gesture, and/or a tap input) directed to Create control 656aa1. At FIG. 6M, computer system 600 detects, via touchpad 652f, selection input 605m3 (e.g., a mouse click, an air gesture, and/or a tap input) directed to Add control 656ab1. At FIG. 6M, computer system 600 detects, via touchpad 652f, selection input 605m4 (e.g., a mouse click, an air gesture, and/or a tap input) directed to Insert control 656ac1. At FIG. 6M, computer system 600 detects, via touchpad 652f, selection input 605m5 (e.g., a mouse click, an air gesture, and/or a tap input) directed to Copy control 656ad1. At FIG. 6M, computer system 600 detects, via touchpad 652f, selection input 605m6 (e.g., a mouse click, an air gesture, and/or a tap input) directed to option control 656g. At FIG. 6M, computer system 600 detects, via touchpad 652f, selection input 605m7 (e.g., a mouse click, an air gesture, and/or a tap input) directed to generate preview control 646. Additionally, for the purposes of the following figures, touches are illustrated within user interface 602 rather than on touchpad 652f and cursor indicator 654 is omitted within FIG. 6M. This is to avoid confusion, due to multiple different inputs directed to multiple different controls, and it should be noted that computer system 600 does not stop displaying cursor indicator 654.

As illustrated in FIG. 6N, in response to detecting selection input 605m2, computer system 600 ceases to display code portion 640a and displays code 656aa2 (e.g., labelled “Article 2 response”) in place of code 640 within code region 696 as an answer to second user question indicator 656w. In some embodiments, computer system 600 creates and displays a new file for code 656aa2 and maintains code 640 within the current project.

As illustrated in FIG. 6O, in response to detecting selection input 605m3, computer system 600 adds code (e.g., as indicated by response indicator 656ab2) to code 640. In some embodiments, computer system 600 adds code corresponding to response indicator 656ab2 to a specific portion of code 640 in response to detecting an input (e.g., a mouse click, a tap and hold input, an air gesture, and/or a tap input) directed to that specific portion of code. In some embodiments, computer system 600 adds the code sample corresponding to response indicator 656ab2 to a specific portion of code 640 based on a determination of the code corresponding to response indicator 656ab2 fits best with that portion of code to solve a user question (e.g., second user question indicator 656w).

As illustrated in FIG. 6P, in response to detecting selection input 605m4, computer system 600 inserts code into code 640 (e.g., as indicated by response indicator 656ac2). In some embodiments, computer system 600 inserts the code sample corresponding to response indicator 656ac2 into a specific portion of code 640 in response to detecting an input (e.g., a mouse click, a tap and hold input, an air gesture, and/or a tap input) directed to that specific portion of code. In some embodiments, computer system 600 inserts the code sample corresponding to response indicator 656ac2 into a specific portion of code 640 based on the user identifying the location of the code 640 at the location corresponding to the bottom of code 640, as illustrated in FIG. 6P.

In between the scenario of FIG. 6M and FIG. 6Q, computer system 600 detects an input (e.g., a mouse click, movement of a mouse, an air gesture, and/or a tap input) directed to touchpad 652f. In response to touching the input directed to touchpad 652f, computer system 600 moves cursor indicator 654. At FIG. 6Q, computer system 600 detects, via touchpad 652f, set of one or more inputs 605q directed to code 640. In some embodiments, set of one or more inputs 605q includes a right click on a mouse, a tap input, and/or a press of one or more keys on keyboard 652.

As illustrated in FIG. 6R, in response to detecting set of one or more inputs 605q, computer system 600 pastes and displays the copied code (e.g., as indicated by response indicator 656ad2) as a part of code 640 (e.g., copied code is copied in response to selection input 605m5). In some embodiments, computer system 600 pastes the code sample corresponding to response indicator 656ad2 into a specific portion of code 640 based where an input (e.g., a mouse click, an air gesture, and/or a tap input) of set of one or more inputs 506q was located. In some embodiments, in response to detecting the one or more inputs 605q, computer system 600 displays a menu including a paste option. In some embodiments, in response to detecting an additional one or more inputs (e.g., a mouse click, an air gesture, and/or a tap input) on the paste option, computer system 600 pastes and displayed the copied code as part of code 640.

As illustrated in FIG. 6S, in response to detecting selection input 605m1 directed to option control 656c, computer system 600 displays menu 658. Menu 658 includes regenerate answer control 658a, delete answer control 658b, reveal in developer control 658c, and open in new window control. In some embodiments, computer system 600 regenerates an answer (e.g., answers) (e.g., computer system 600 displays new articles) in response to detecting an input (e.g., a mouse click, an air gesture, and/or a tap input) directed to regenerate answer control 658a. Computer system 600 deletes an answer (e.g., answers) in response to detecting an input (e.g., a mouse click, an air gesture, and/or a tap input) directed to delete answer control 658b. In some embodiments, computer system 600 displays the current project in a development mode in response to detecting an input (e.g., a mouse click, an air gesture, and/or a tap input) directed to reveal in developer control 658c. In some embodiments, computer system 600 opens a new window for the current project in response to detecting an input (e.g., a mouse click, an air gesture, and/or a tap input) directed to open in new window control 658d.

As illustrated in FIG. 6T, in response to detecting selection input 605m6, computer system 600 displays menu 660. Menu 660 includes clear thread control 660a, new thread control 660b, threads control 660c, more arrow 660c1, and show generated responses control 660d. In some embodiments, computer system 600 clears the thread (and/or threads) corresponding to the current project in response to detecting an input (e.g., a mouse click, an air gesture, and/or a tap input) directed to clear thread control 660a. Computer system 600 displays a new thread in response to detecting an input (e.g., a mouse click, an air gesture, and/or a tap input) directed to new thread control 660b. Computer system 600 displays data related to the thread corresponding to the current project in response to detecting an input (e.g., a mouse click, an air gesture, and/or a tap input) directed to threads control 660c. In some embodiments, computer system 600 displays additional data related to the thread corresponding to the current project in response to detecting an input (e.g., a mouse click, an air gesture, and/or a tap input) directed to more arrow 660c1. Computer system 600 displays generated responses in response to detecting an input (e.g., a mouse click, an air gesture, and/or a tap input) directed to show generated responses control 660d.

As illustrated in FIG. 6U, in response to detecting selection input 605m7, computer system 600 displays status indicator 634 as “Generating preview” to indicate that computer system 600 generates a preview in response to detecting selection input 605m7 and displays progress indicator 662 within navigation bar 630. Progress indicator 662 indicates the progress made until the completion of the generated preview. At FIG. 6U, computer system 600 detects vertical input 605u directed to touchpad 652f. For example, vertical input 605u can be a vertical input detected via touchpad 652f from one location to another. It should be recognized that other types of inputs can be used instead of vertical input 605u, such as movement of a mouse, an air gesture moving from one location to another, or a tap input at a final location.

In between FIG. 6U and FIG. 6V, computer system 600 completed the preview. As illustrated in FIG. 6V, in response to detecting vertical input 605u, computer system 600 moves cursor indicator 654 to hover over code 640. At FIG. 6V, computer system 600 makes a determination that the preview is complete. As illustrated in FIG. 6V, in response to making a determination that the preview is complete, computer system 600 displays status indicator 634 as “Ready” to indicate that computer system 600 has completed generating the preview and is ready for another action. As illustrated in FIG. 6V, computer system 600 ceases to display progress indicator 662. As illustrated in FIG. 6V, based on a determination that the code preview is complete, computer system 600 displays preview region 692 to include computer system indicator 648, preview type control 650, exit preview control 664, computer system indicator 666, left shift control 668, right shift control 670, add control 672, code preview region 674, and code preview indicator 676. As illustrated in FIG. 6V, computer system 600 displays computer system indicator 648 and computer system indicator 666 as smartphones (e.g., corresponding to the selected computer system type as indicated by preview type control 650).

As illustrated in FIG. 6V, based on a determination that the code preview has finished, computer system 600 displays computer system indicator 648 without hatching to display a full preview of how code 640 appears in its current state on a computer system. Computer system indicator 648 includes widget 648a (e.g., a widget created from code 640). Computer system 600 displays widget 648a as part of a shopping application that allows a user to purchase items and apply discounts to the items in their virtual shopping cart. Widget 648a includes graphic indicator 648a1 (e.g., a shopping cart), quantity indicator 648a2 and data indicator 648a3. Quantity indicator 648a2 indicates the quantity of items stored in a virtual shopping cart (e.g., as illustrated in FIG. 6V, the item is apples and the quantity is zero). Data indicator 648a3 indicates the data for the virtual shopping trip, including an item (e.g., apples) and a virtual coupon applied to the virtual shopping cart. As illustrated in FIG. 6V, the coupon is 15% off of apples. In some embodiments, computer system 600 exits (e.g., ceases to display) the preview in response to detecting an input (e.g., a mouse click, an air gesture, and/or a tap input) directed to exit preview control 664. At FIG. 6V, computer system 600 automatically sets parameters for computer system indicator 648, including widget 648a, graphic indicator 648a1, quantity indicator 648a2 and data indicator 648a3. Computer system 600 sets parameters for computer system indicator 648 to ensure the code is correctly applied and displayed. Such parameters can include text content, graphical content, and size. Additionally, computer system 600 automatically sets one or more parameter values based on contextual information from the code. For example, as illustrated in FIG. 6V, computer system 600 displays code preview indicator 676 with “apples” and the value “15”. Computer system 600 automatically sets the parameters of computer system indicator 648 (e.g., including widget 648a, graphic indicator 648a1, quantity indicator 648a2 and data indicator 648a3) in accordance with code preview indicator 676 (e.g., computer system 600 displays data indicator 648a3 as “Apples: 15% off”). In some embodiments, an automated process (e.g., a large language model and/or an artificial intelligence process) corresponding to computer system 600 automatically sets one or more parameters of computer system indicator 648.

Based on a determination that the code preview has finished, computer system 600 displays computer system indicator 666 as an indicator of another application of how code 640 appears in its current state on a computer system. As illustrated in FIG. 6V, computer system 600 displays computer system indicator 666 with hatching to indicate that computer system 600 has not finished fully generating the preview for computer system indicator 666. Computer system indicator 666 includes widget 666a (e.g., a widget created from code 640 showcasing another application of code 640). Computer system 600 displays widget 666a as part of a shopping application that allows a user to purchase items and apply discounts to the items in their virtual shopping cart. Widget 666a includes graphic indicator 666al (e.g., a shopping cart).

Computer system 600 shifts the position of computer system indicator 648 and computer system indicator 666 (e.g., as well as any other computer system indicators not displayed in FIG. 6V) to the left in response to detecting an input (e.g., a mouse click, an air gesture, and/or a tap input) directed to left shift control 668 to allow a user to view a different code preview. Computer system 600 shifts the position of computer system indicator 648 and computer system indicator 666 (e.g., as well as any other computer system indicators not displayed in FIG. 6V) to the right in response to detecting an input (e.g., a mouse click, an air gesture, and/or a tap input) directed to left shift control 668 to allow a user to view a different code preview.

Computer system 600 displays code preview region 674. Code preview region 674 includes code preview indicator 676 to indicate a portion of generated code that edits and/or modifies code 640. Computer system 600 adds the code corresponding to code preview indicator 676 to code 640 in response to detecting an input (e.g., a mouse click, an air gesture, and/or a tap input) directed to add control 672. At FIG. 6V, computer system 600 detects horizontal input 605v directed to touchpad 652f. For example, horizontal input 605v can be a horizontal input detected via touchpad 652f or a mouse from one location to another. It should be recognized that other types of inputs can be used instead of horizontal input 605v, such as an air gesture moving from one location to another or a tap input at a final location.

As illustrated in FIG. 6W, in response to detecting horizontal input 605v directed to touchpad 652f, computer system 600 displays cursor indicator 654 hovering over add control 672. As illustrated in FIG. 6W, based on a determination that the code preview has finished, computer system 600 displays computer system indicator 666 without hatching to display a full preview of how code 640 appears in its current state on a computer system. At FIG. 6W, computer system 600 detects, via touchpad 652f, selection input 605w (e.g., a mouse click, an air gesture, and/or a tap input) directed to add control 672. At FIG. 6W, computer system 600 detects a horizontal input (e.g., as described above) directed to touchpad 652f.

As illustrated in FIG. 6X, in response to detecting the horizontal input at FIG. 6W, computer system 600 displays cursor indicator 654 hover over computer system type indicator 650. As illustrated in FIG. 6X, in response to detecting selection input 605w, computer system 600 displays code preview indicator 676 as a part of code 640. As illustrated in FIG. 6X, in response to detecting selection input 605w, computer system 600 displays code preview indicator 676a in place of code preview indicator 676 (e.g., code preview indicator 676a corresponds to computer system indicator 666). Additionally, as illustrated in FIG. 6X, in response to detecting selection input 605w, computer system 600 displays project indicator 688. Project indicator 688 indicates a second project (e.g., the project that code 640 corresponds to with the addition of code preview indicator 676).

As illustrated in FIG. 6X, in response to detecting selection input 605w, computer system 600 ceases displaying computer system indicator 648 (e.g., including widget 648a, graphic indicator 648a1, quantity indicator 648a2 and data indicator 648a3) as computer system 600 integrates code preview indicator 676 into code 640. As illustrated in FIG. 6X, computer system 600 displays computer system indicator 666 in place of computer system indicator 648. Computer system indicator 666 includes widget 666a (e.g., a widget created from code 640). Computer system 600 displays widget 666a as part of a shopping application that allows a user to purchase items and apply discounts to the items in their virtual shopping cart. Widget 666a includes graphic indicator 666al (e.g., a shopping cart), quantity indicator 666a2 and data indicator 666a3. Quantity indicator 666a2 indicates the quantity of items stored in a virtual shopping cart (e.g., as illustrated in FIG. 6X, the item is oranges and the quantity is two). Data indicator 666a3 indicates the data for the virtual shopping trip, including an item (e.g., oranges) and a virtual coupon applied to the virtual shopping cart. As illustrated in FIG. 6X, the coupon is 15% off of oranges. Additionally, as illustrated in FIG. 6X, computer system 600 displays computer system indicator 678.

As illustrated in FIG. 6X, computer system 600 displays computer system indicator 678 with hatching to indicate that computer system 600 has not finished fully generating the preview for computer system indicator 678. Computer system indicator 678 includes widget 678a (e.g., a widget created from code 640 showcasing another application of code 640). Computer system 600 displays widget 678a as part of a shopping application that allows a user to purchase items and apply discounts to the items in their virtual shopping cart. Widget 678a includes graphic indicator 678al (e.g., a shopping cart) and data indicator 678a3. Data indicator 678a3 (though cut off in FIG. 6X) indicates the data for the virtual shopping trip, including an item (e.g., strawberries) and a virtual coupon applied to the virtual shopping cart.

As illustrated in FIG. 6X, in response to detecting the horizontal input at FIG. 6W, computer system 600 moves cursor indicator 654 to hover over drop-down arrow 650d. At FIG. 6X, computer system 600 detects, via touchpad 652f, selection input 605x (e.g., a mouse click, an air gesture, and/or a tap input) directed to drop-down arrow 650d.

As illustrated in FIG. 6Y, in response to detecting selection input 605x, computer system 600 expands preview type control 650. As illustrated in FIG. 6Y, preview type control 650 includes computer system type indicator 650a (e.g., “Automatic-Smartphone”), computer system type indicator 650b (e.g., “Tablet”), computer system type indicator 650c (e.g., “Computer”), and drop-down arrow 650d. At FIG. 6Y, computer system 600 detects, via touchpad 652f, selection input 605y (e.g., a mouse click, an air gesture, and/or a tap input) directed to computer system type indicator 650b.

As illustrated in FIG. 6Z, in response to detecting selection input 605y, computer system 600 displays computer system indicator 666 and computer system indicator 678 as tablets to allow a user to preview how code 640 appears in its current state on a tablet computer system. As illustrated in FIG. 6Z, computer system 600 changes the display of quantity indicator 666a2 666a3 to better fit the new computer system indicator type of tablet. As illustrated in FIG. 6Z, computer system 600 displays quantity indicator 666a2 as “2 in cart”. Additionally, as illustrated in FIG. 6Z, computer system 600 changes the display of project indicator 632 to indicate the new computer system indicator type of tablet. As illustrated in FIG. 6Z, in response to detecting selection input 605y, computer system 600 reduces the size of preview type control 650 and ceases displaying computer system type indicator 650a and computer system type indicator 650c. As illustrated in FIG. 6Z, preview type control includes computer system type indicator 650b (e.g., “Tablet”) and drop-down arrow 650d.

FIG. 6AA through FIG. 6AF illustrate an alternate scenario where computer system 600 edits code in accordance with some embodiments. In the examples described below with respect to FIGS. 6AA-6AF, computer system 600 displays user interface 602 (e.g., a code editing user interface). As illustrated in FIG. 6AA, user interface 602 includes code region 696 and preview region 692. In this iteration of user interface 602, code region 696 includes code 640 and intelligent coding control 698. As illustrated in FIG. 6AA, computer system 600 displays preview region 692 in the same manner as illustrated in FIG. 6V. In some embodiments, in response to detecting an input (e.g., a mouse click, an air gesture, and/or a tap input) directed to intelligent coding control 698, computer system 600 displays one or more intelligent coding user interface elements as discussed further below. In some embodiments, the one or more intelligent coding user interface elements relate to editing code within code region 696. In some embodiments, computer system 600 displays more, less, and/or different controls within code region 696. In some embodiments, computer system 600 displays controls in a different order within code region 696. At FIG. 6AA, computer system 600 detects selection input 605aa1 (e.g., a mouse click, an air gesture, and/or a tap input) directed to intelligent coding control 698. At FIG. 6AA, after detecting selection input 605aa1, computer system 600 detects diagonal input 605aa2 directed to touchpad 652f. For example, diagonal input 605aa2 can be a drag input detected via touchpad 652f or a mouse from one location to another. It should be recognized that other types of inputs can be used instead of diagonal input 605aa2, such as an air gesture moving from one location to another or a tap input at a final location.

As illustrated in FIG. 6AB, in response to detecting selection input 605aa1, computer system 600 displays navigation bar 698a (e.g., a text input field or prompt input field), and arrow 698b within code region 696. As illustrated in FIG. 6AB, arrow 698b is displayed as pointing downward indicating that there are one or more hidden user interface elements corresponding to intelligent coding control 698. In some embodiments, in response to detecting an input (e.g., a mouse click, an air gesture, and/or a tap input) on arrow 698b, computer system 600 displays the one or more hidden user interface elements. In some embodiments, the one or more hidden user interface elements includes one or more prompts to aid a user with editing their code. For example, the one or more hidden user interface elements can include one or more questions or suggested prompts generated based on code 640, such as a suggested question or a suggested prompt as described above with respect to FIGS. 6B-6I. As illustrated in FIG. 6AB, navigation bar 698a includes code editing indicator 698i. In some embodiments, code editing indicator 698i indicates that computer system 600, user interface 602, and/or an application corresponding to user interface 602 has entered into an editing state.

As illustrated in FIG. 6AB, computer system 600 displays cursor indicator 654 twice. This is to avoid confusion, due to multiple different inputs directed to multiple different controls, and it should be noted that computer system 600 does not display two iterations of cursor indicator 654.

As illustrated in FIG. 6AB, in response to detecting diagonal input 605aa2 directed to touchpad 652f, computer system 600 moves cursor indicator 654 to hover over arrow 698b. At FIG. 6AB, computer system 600 detects selection input 605ab1 (e.g., a mouse click, an air gesture, and/or a tap input) directed to arrow 698b.

As an alternative to the description in the last paragraph, as illustrated in FIG. 6AB, in response to detecting diagonal input 605ab6 directed to touchpad 652f, computer system 600 moves cursor indicator 654 to hover over navigation bar 698a. At FIG. 6AB, computer system 600 detects selection input 605ab2 (e.g., a mouse click, an air gesture, and/or a tap input) directed to navigation bar 698a. At FIG. 6AB, after detecting selection input 605ab2, computer system 600 detects key input 605ab3, key input 605ab4, and key input 605ab5 directed to keys within keys region 652a (e.g., multiple key inputs on a physical keyboard, multiple tap inputs on a virtual keyboard, or a voice input). In response to detecting key input 605ab3, key input 605ab4, and key input 605ab5, computer system 600 begins filling navigation bar 656b with the entered typing.

As illustrated in FIG. 6AC, in response to detecting selection input 605ab1 directed to arrow 698b, computer system 600 displays prompt 698c (e.g., labelled “Answer Prompt”), prompt 698d (e.g., labelled “Propose Prompt”), and prompt 698e (e.g., labelled “Insert Prompt”). In some embodiments, computer system 600 displays prompt 698c, prompt 698d, and prompt 698e in response to detecting selection input 605aa1, selection input 605ab2, detects key input 605ab3, key input 605ab4, and/or key input 605ab5. In some embodiments, in response to detecting selection input 605ab1 directed to arrow 698b (or expand affordance), computer system 600 displays arrow 698b as pointing upward, indicating that computer system 600 is no longer hiding user interface elements corresponding to intelligent coding control 698 (e.g., prompt 698c, prompt 698d, and prompt 698e).

In some embodiments, in response to detecting an input (e.g., a mouse click, an air gesture, and/or a tap input) directed to prompt 698c, computer system 600 displays an answer and/or helpful information relevant to the current project. In some embodiments, the answer includes tips and/or tricks, a step-by-step guide, and/or information from one or more external resources. In some embodiments, in response to detecting an input (e.g., a mouse click, an air gesture, and/or a tap input) directed to prompt 698d, computer system 600 displays one or more suggested revisions to the code as well as a control to implement and/or add the one or more suggested revisions to the code. In some embodiments, in response to detecting an input (e.g., a mouse click, an air gesture, and/or a tap input) directed to prompt 698e, computer system 600 inserts a code sample into the current project.

Also illustrated in FIG. 6AC, in response to detecting key input 605ab3, key input 605ab4, and key input 605ab5 directed to keys within keys region 652a, computer system 600 displays third user question indicator 698h (e.g., a third question related to the current project) within navigation bar 698a. In some embodiments, computer system 600 displays third user question indicator 698h in response to detecting an input corresponding to handwriting and/or a verbal input (e.g., as opposed to typing). In some embodiments, computer system 600 displays prompts based on third user question indicator 698h.

At FIG. 6AC, computer system 600 detects selection input 605ac1 (e.g., a mouse click, an air gesture, and/or a tap input) directed to prompt 698c. At FIG. 6AC, computer system 600 detects selection input 605ac2 (e.g., a mouse click, an air gesture, and/or a tap input) directed to prompt 698d. At FIG. 6AC, computer system 600 detects selection input 605ac3 (e.g., a mouse click, an air gesture, and/or a tap input) directed to prompt 698e. As illustrated in FIG. 6AC, computer system 600 displays cursor indicator 654 three times, one over prompt 698c, once over prompt 698d, ad once over prompt 698e. This is to avoid confusion, due to multiple different inputs directed to multiple different controls, and it should be noted that computer system 600 does not display three iterations of cursor indicator 654.

As illustrated in FIG. 6AD, in response to detecting selection input 605ac2 directed to prompt 698d, computer system 600 ceases display of prompt 698c, prompt 698d, and prompt 698e and displays revision indicator 698f. Revision indicator 698f includes description indicator 698f1, revision indicator 698f2, and apply control 698f3. Description indicator 698f1 indicates a description of the proposed revision to the current project. Revision indicator 698f2 indicates the proposed revision that computer system 600 adds to the current project in response to detecting an input (e.g., a mouse click, an air gesture, and/or a tap input) directed to apply control 698f3 (e.g., in response to detecting an input (e.g., a mouse click, an air gesture, and/or a tap input) directed to apply control 698f3, computer system 600 implements the proposed revision by adding the proposed revision into the current project). In some embodiments, the proposed revision is similar to response indicator 656ac2 as described above with respect to FIG. 6P or response indicator 656ad2 described above with respect to FIG. 6R. At FIG. 6AD, computer system 600 detects selection input 605ad1 (e.g., a mouse click, an air gesture, and/or a tap input) directed to apply control 698f3. At FIG. 6AD, computer system 600 detects diagonal input 605ad2 directed to touchpad 652f. For example, diagonal input 605ad2 can be a drag input detected via touchpad 652f from one location to another. It should be recognized that other types of inputs can be used instead of diagonal input 605ad2, such as movement of a mouse, an air gesture moving from one location to another, or a tap input at a final location.

As illustrated in FIG. 6AE, in response to detecting selection input 605ad1 (e.g., a mouse click, an air gesture, and/or a tap input) directed to apply control 698f3, computer system 600 adds the proposed code (e.g., as indicated by response indicator 698j, 698k, and 698l) to code 640. Please note that response indicator 698k and response indicator 698l can be alternative or additional code revisions that computer system 600 can display in response to detecting a selection input (e.g., a mouse click, an air gesture, and/or a tap input). For example, different proposed code revisions can be included in revision indicator 698f, causing different code revisions to be placed in different locations in response to detecting selection input 605ad1. For another example, revision indicator 698f can include a first proposed code revision with a first apply control and a second proposed code revision with a second apply control. In such an example, an input (e.g., a mouse click, an air gesture, and/or a tap input) corresponding to the first apply control can cause response indicator 698k to be added and an input (e.g., a mouse click, an air gesture, and/or a tap input) corresponding to the second apply control can cause response indicator 698l to be added. For another example, revision indicator 698f can correspond to multiple code revisions that are placed in different locations in response to detecting selection input 605ad1 (e.g., at least two of response indicator 698j, 698k, and 698l can be added).

In some embodiments, computer system 600 adds a proposed code revision (e.g., response indicators 698j, 698k, and/or 698l) to a specific portion of code 640 in response to detecting an input (e.g., a mouse click, an air gesture, and/or a tap input) directed to that specific portion of code. In some embodiments, computer system 600 adds a proposed code revision to a specific portion of code 640 based on a determination of the code corresponding to response indicator 698j fits best with that portion of code to solve a user question (e.g., third user question indicator 698h). Also illustrated in FIG. 6AE, in response to detecting selection input 605ad1, computer system 600 ceases display of revision indicator 698f and displays prompt 698c, prompt 698d, and prompt 698e. Additionally, computer system 600 displays prompt 698d differently (e.g., labelled as “Propose Prompt 2”) to indicate that the previous code revision proposal has been implemented and now computer system 600 displays a different proposal option.

As illustrated in FIG. 6AE, in response to detecting selection input 605ad1, computer system 600 displays preview region 692 in the same manner as illustrated in FIG. 6X (e.g., in response to applying and implementing a proposed code revision to code 640, computer system 600 displays preview region 692 to reflect the update to code 640). As illustrated in FIG. 6AE, in response to detecting diagonal input 605ad2 directed to touchpad 652f, computer system 600 moves cursor indicator 654 to hover over arrow 698b. At FIG. 6AE, computer system 600 detects selection input 605ae1 directed to arrow 698b. At FIG. 6AE, computer system 600 detects diagonal input 605ae2 directed to touchpad 652f. For example, diagonal input 605ae2 can be a drag input detected via touchpad 652f or a mouse from one location to another. It should be recognized that other types of inputs can be used instead of diagonal input 605ae2, such as an air gesture moving from one location to another or a tap input at a final location.

As illustrated in FIG. 6AF, in response to detecting selection input 605ae1, computer system 600 ceases displaying prompt 698c, prompt 698d, and prompt 698e. Additionally, computer system 600 displays arrow 698b as pointing downward. As illustrated in FIG. 6AF, in response to detecting diagonal input 605ad2 directed to touchpad 652f, computer system 600 moves cursor indicator 654 above arrow 698b.

FIG. 6AG through FIG. 6AN illustrate a process where computer system 600 generates and tests code (e.g., portions of code) within user interface 602. In between FIG. 6Z and FIG. 6AG, computer system 600 ceases to display preview region 692 (e.g., computer system 600 ceases to display all contents of preview region 692) and expands code region 696. Additionally, in between FIG. 6Z and FIG. 6AG, computer system 600 moved cursor indicator 654 to hover over code portion 640e. As illustrated in FIG. 6AG, computer system 600 changes the appearance of cursor indicator 654 to indicate that computer system 600 initiated typing (e.g., computer system 600 detected that cursor indicator 654 entered a typing field and/or computer system 600 detected that a user has initiated typing). At FIG. 6AG, computer system 600 detects tap and diagonal input 605am directed to touchpad 652f. For example, tap and diagonal input 605am can be a tap and drag input detected via touchpad 652f or a mouse from one location to another. For another example, tap and diagonal input 605am can include multiple tap inputs at different locations. It should be recognized that other types of inputs can be used instead of tap and diagonal input 605am, such as an air gesture moving from one location to another.

As illustrated in FIG. 6AH, in response to detecting tap and diagonal input 605am, computer system 600 selects (e.g., highlights and/or designates) code portion 640e, as indicated by selection indicator 690. At FIG. 6AH, computer system 600 detects selection input 605ah (e.g., a mouse click, an air gesture, and/or a tap input) directed to code portion 640e. In some embodiments, selection input 605an is a double tap on touchpad 652f.

As illustrated in FIG. 6AI, in response to detecting selection input 605ah, computer system 600 displays menu 680. Menu 680 includes jump to definition control 680a, show code actions control 680b, show quick help control 680c, generate test control 680d, generate preview control 680e, and suggest code 680f.

Computer system 600 jumps to a definition of a variable and/or function corresponding to code 640 in response to detecting an input (e.g., a mouse click, an air gesture, and/or a tap input) directed to jump to definition control 680a. In some embodiments, computer system 600 displays a code action menu in response to detecting an input (e.g., a mouse click, an air gesture, and/or a tap input) directed to show code actions control 680b. In some embodiments, computer system 600 displays a quick help menu (e.g., a menu that includes options to complete code via an automated process (e.g., a large language model and/or an artificial intelligence process)) in response to detecting an input (e.g., a mouse click, an air gesture, and/or a tap input) directed to show quick help control 680c. In some embodiments, computer system 600 tests a selected code portion in response to detecting an input (e.g., a mouse click, an air gesture, and/or a tap input) directed to generate test control 680d. In some embodiments, computer system 600 tests multiple portions of code. In some embodiments, computer system 600 tests the totality of the code. In some embodiments, computer system 600 tests code that is not selected.

At. FIG. 6AI, computer system 600 generates and displays a preview of the current project onto a computer system indicator in response to detecting an input (e.g., a mouse click, an air gesture, and/or a tap input) directed to generate preview control 680e. In some embodiments, computer system 600 suggests code based on a determination that the suggested code will improve code 640 in response to detecting an input (e.g., a mouse click, an air gesture, and/or a tap input) directed to suggest code 680f. At FIG. 6AI, computer system 600 detects, via touchpad 652f, selection input 605ai (e.g., a mouse click, an air gesture, and/or a tap input) directed to generate test control 680d.

As illustrated in FIG. 6AJ, in response to detecting selection input 605ai, computer system 600 ceases to display menu 680. Additionally, as illustrated in FIG. 6AJ, in response to detecting selection input 605ai, computer system 600 displays status indicator 634 as “Testing” to indicate that computer system 600 automatically tests code portion 640e (e.g., a selected code portion) and displays progress indicator 662 within navigation bar 630. In some embodiments, computer system 600 tests the whole of code 640 in response to detecting selection input 605ai. At FIG. 6AJ, computer system 600 detects diagonal input 605aj directed to touchpad 652f. For example, diagonal input 605aj can be a drag input detected via touchpad 652f or a mouse from one location to another. It should be recognized that other types of inputs can be used instead of diagonal input 605aj, such as an air gesture moving from one location to another or a tap input at a final location.

In between FIG. 6AJ and FIG. 6AK, computer system 600 makes a determination that the test corresponding to code portion 640e is complete. As illustrated in FIG. 6AK, in response to completing the test, computer system 600 displays status indicator 634 as “Test complete” to indicate that computer system 600 has completed testing code portion 640e and is ready for another action. As illustrated in FIG. 6AK, computer system 600 ceases to display progress indicator 662.

As illustrated in FIG. 6AK, based on a determination that the test is complete, computer system 600 displays test results region 682 and test details region 684. Test results region 682 includes first test indicator 682a, second test indicator 682b, and third test indicator 682c. First test indicator 682a indicates the results of a first test to a first portion of code. As illustrated in FIG. 6AK, first test indicator 682a corresponds to the first two lines of code within code 640. First test indicator 682a indicates the test results of “−0% 0/2 lines”, indicating that computer system 600 did not test the indicated code. Second test indicator 682b indicates the results of a second test to a second portion of code. As illustrated in FIG. 6AK, second test indicator 682b corresponds to the third line of code within code 640. Second test indicator 682b indicates the test results of “+100% 1/1 line”, indicating that computer system 600 tested all of the selected code (e.g., code portion 640e) and determined the code to be functional (e.g., in working order and/or correct). In some embodiments, computer system 600 displays a test indicator with data that indicates that tested code is not functional. For example, in a scenario where in response to determining that a portion of six lines of tested code is fully not functional, computer system displays “−0% 0/6 lines.” In another example, in a scenario where in response to determining that a portion of six lines of tested code is halfway functional, computer system displays “−50% 3/6 lines.” Third test indicator 682c indicates the results of a third test to a third portion of code. As illustrated in FIG. 6AK, third test indicator 682c corresponds to the remaining ten lines of code within code 640. Third test indicator 682c indicates the test results of “−0% 0/10 lines”, indicating that computer system 600 did not test the indicated code.

Test details region 684 includes generated tests indicator 684a, discard control 684b, save to control 684c, completion indicator 684d, and tested code indicator 684e. Generated tests indicator 684a indicates the title of test details region 684. In some embodiments, computer system 600 discards (e.g., removes, ceases to display, and/or deletes) tested code indicator 684e in response to detecting an input (e.g., a mouse click, an air gesture, and/or a tap input) directed to discard control 684b. Computer system 600 saves (e.g., stores, and/or implements) tested code indicator 684e to the current project in response to detecting an input (e.g., a mouse click, an air gesture, and/or a tap input) directed to save to control 684c. Completion indicator 684d indicates that the test corresponding to tested code indicator code 684e is complete and correct. Computer system 600 displays tested code indicator 684e to indicate the code tested (e.g., tested code indicator 684e corresponds to code portion 640e). As illustrated in FIG. 6AK, tested code indicator 684e is the same type of code as code 640. As illustrated in FIG. 6AK, in response to detecting diagonal input 605aj, computer system 600 moves cursor indicator 654 to third test indicator 682c. In some embodiments, computer system 600 displays test results region 682 and test details region 684 prior to a test. In some embodiments, an automated process (e.g., a large language model and/or an artificial intelligence process) corresponding to computer system 600 generates a test. In some embodiments, in response to making a determination that a test is complete, computer system 600 displays preview region 692 and a computer system indicator. Computer system 600 displays a preview of the tested code within the computer system indicator (e.g., in the same manner as seen in FIG. 6V through 6Z). At FIG. 6AK, computer system 600 detects, via touchpad 652f, selection input 605ak (e.g., a mouse click, an air gesture, and/or a tap input) directed to third test indicator 682c. At FIG. 6AK, computer system 600 detects a diagonal input directed to touchpad 652f. For example, the diagonal input can be a drag input detected via touchpad 652f or a mouse from one location to another. It should be recognized that other types of inputs can be used instead of the diagonal input, such as an air gesture moving from one location to another or a tap input at a final location.

As illustrated in FIG. 6AL, in response to detecting selection input 605ak, computer system 600 displays menu 680 (e.g., in the same manner as seen in FIG. 6AI). As illustrated in FIG. 6AL, in response to detecting the diagonal input at FIG. 6AK, computer system 600 moves cursor indicator 654 over generate test control 680d. At FIG. 6AL, computer system 600 detects, via touchpad 652f, selection input 605al (e.g., a mouse click, an air gesture, and/or a tap input) directed to generate test control 680d.

As illustrated in FIG. 6AM, in response to detecting selection input 605al, computer system 600 displays status indicator 634 as “Testing” to indicate that computer system 600 automatically tests the code corresponding to third test indicator 682c and displays progress indicator 662 within navigation bar 630.

In between FIG. 6AM and FIG. 6AN, computer system 600 completes the test on the code corresponding to third test indicator 682c. At FIG. 6AN, computer system 600 makes a determination that the test on the code corresponding to third test indicator 682c is complete.

As illustrated in FIG. 6AN, in response to making a determination that the test is complete, computer system 600 displays status indicator 634 as “Test complete” to indicate that computer system 600 has completed testing the code corresponding to third test indicator 682c and is ready for another action. As illustrated in FIG. 6AN, computer system 600 ceases to display progress indicator 662.

As illustrated in FIG. 6AN, in response to making a determination that the test is complete, computer system 600 ceases to display tested code indicator 684e (e.g., suggested code that corresponds to second test indicator 682b (e.g., the third line of code within code 640)) within test details region 684 and displays tested code indicator 684f within test details region 684. Computer system 600 displays tested code indicator 684f to indicate the code tested (e.g., tested code indicator 684f corresponds to the ten remaining lines of code within code 640).

As illustrated in FIG. 6AN, in response to computer system 600 making a determination that the test is complete, computer system 600 displays third test indicator 682c as “+100% 10/10 lines”, indicating that computer system 600 tested all of the selected code (e.g., code corresponding to third test indicator 682c) and determined the code to be functional (e.g., in working order and/or correct).

FIG. 7 is a flow diagram illustrating a process (e.g., process 700) for providing responses based on a portion of content and a user inquiry in accordance with some embodiments. Some operations in process 700 are, optionally, combined, the orders of some operations are, optionally, changed, and some operations are, optionally, omitted.

As described below, process 700 provides an intuitive way for providing responses based on a portion of content and a user inquiry. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication (e.g., wired communication and/or wireless communication) with one or more input devices (e.g., 652, 652a, 652b, 652c, 652d, 652e, and/or 652f) (e.g., a camera, a depth sensor, a microphone, a hardware input mechanism, a rotatable input mechanism, a heart monitor, a temperature sensor, and/or a touch-sensitive surface) and one or more output devices (e.g., an audio generation component, a speaker, a haptic output device) including one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device. In some embodiments, the audio generation component is a speaker, a smart speaker, a home theater system, a soundbar, a headphone, an earphone, an earbud, a speaker, a television speaker, an augmented reality headset speaker, an audio jack, an optical audio output, a Bluetooth audio output, and/or a HDMI audio output.

The computer system displays (702), via the one or more display generation components, an editing user interface (e.g., 602) including content (e.g., 640) (e.g., a set of one or more software instructions, code, and/or source script). In some embodiments, the content is included in a file of a project.

While displaying the editing user interface (e.g., 602), the computer system detects (704) (and/or receives), via the one or more input devices (e.g., 652, 652a, 652b, 652c, 652d, 652e, and/or 652f), an input (e.g., 605j and/or 605l) corresponding to (e.g., directed to, at a location of, related to and/or associated with) a respective user inquiry (e.g., 656p and/or 656w) (e.g., as described above with respect to FIGS. 6J-6L) (e.g., a prompt, an inquiry, a set of one or more characters, a set of one or more words, a statement, a request, question, and/or command). In some embodiments, the input corresponding to the respective user inquiry includes a selection of a button for submitting the respective user inquiry. In some embodiments, the input corresponding to the respective user inquiry includes a keyboard input to submit the respective user inquiry. In some embodiments, before detecting the input corresponding to the respective user inquiry, the computer system detects, via the one or more input devices, depression of a set of one or more keys of a keyboard (e.g., a virtual or a physical keyboard) (e.g., typing the respective user inquiry). In some embodiments, the input includes depression of a set of one or more keys of a keyboard (e.g., a virtual or a physical keyboard) (e.g., typing the respective user inquiry). In some embodiments, before detecting the input corresponding to the respective user inquiry, the computer system detects, via the one or more input devices, an audio input with the respective user inquiry. In some embodiments, the input includes an audio input with the respective user inquiry.

In response to detecting the input (e.g., 605j and/or 605l) corresponding to the respective user inquiry and in accordance with a determination that the respective user inquiry is a first user inquiry (e.g., 656p and/or 656w) (e.g., as described above with respect to FIGS. 6J-6L) and that the respective user inquiry corresponds to (e.g., is related to and/or associated with) a first portion of the content (e.g., 640a, 640b, 640c, and/or 640d) (e.g., the respective user inquiry corresponds to the first portion of the content when the first portion of the content is selected while detecting the input corresponding to the respective user inquiry), the computer system provides (706), via the one or more output devices, a first response (e.g., an answer and/or an automatically-generated response such as automatically-generated text content and or generative text content) that is generated (e.g., by an artificial intelligence (e.g., “AI”) process or a generative AI process) based on the first portion of the content and the first user inquiry. In some embodiments, providing the first response includes displaying, via the one or more display generation components, the first response and/or a representation of the first response. In some embodiments, providing the first response includes outputting, via an audio generation component of the one or more output devices, the first response and/or a representation of the first response. In some embodiments, the first response is based on the file and/or the project. In some embodiments, the first response that is generated based on the first portion of the content and the first user inquiry includes the first response that is generated based on the first portion of the content and the first user inquiry. In some embodiments, the first response that is generated based on the first portion of the content and the first user inquiry includes content corresponding to the first user inquiry and/or the first portion of the content. In some embodiments, the automatically-generated response is output without detecting, via the one or more input devices, (and/or after the user inquiry) an input corresponding to the response. In some embodiments, the input corresponding to the response includes a selection of a button for generating the first response. In some embodiments, the input corresponding to the response includes a keyboard for generating the first response. Providing a response based on a portion of content and a user inquiry in response to detecting an input corresponding to the user inquiry enables the computer system to respond to inquiries with responses tailored to specific portions and the inquiry as directed by the user, thereby performing an operation when a set of conditions has been met without requiring further user input, reducing the number of inputs needed to perform an operation, and/or providing improved visual feedback to the user.

In some embodiments, in response to detecting the input (e.g., 605j and/or 605l) corresponding to the respective user inquiry and in accordance with a determination that the respective user inquiry is a second user inquiry (e.g., 656p and/or 656w) (e.g., as described above with respect to FIGS. 6J-6L), different from the first user inquiry, and that the respective user inquiry corresponds to the first portion of the content (e.g., 640a, 640b, 640c, and/or 640d), the computer system provides, via the one or more output devices, a second response (e.g., an answer and/or an automatically-generated response such as automatically-generated text content and or generative text content) that is generated (e.g., by an artificial intelligence (e.g., “AI”) process or a generative AI process) based on the first portion of the content and the second user inquiry wherein the second response is different from the first response. In some embodiments, providing the second response includes displaying, via the one or more display generation components, the second response and/or a representation of the second response. In some embodiments, providing the second response includes outputting, via an audio generation component of the one or more output devices, the second response and/or a representation of the second response. In some embodiments, the second response includes a suggestion that does not include the second user inquiry. In some embodiments, the second response includes content corresponding to the second user inquiry and/or the first portion of the content.

In some embodiments, in response to detecting the input (e.g., 605j and/or 605l) corresponding to (e.g., directed to, at a location of, related to and/or associated with) the respective user inquiry and in accordance with a determination that the respective user inquiry is the first user inquiry (e.g., 656p and/or 656w) (e.g., as described above with respect to FIGS. 6J-6L) and that the respective user inquiry corresponds to a second portion of the content different from the first portion of the content (e.g., 640a, 640b, 640c, and/or 640d), the computer system provides, via the one or more output devices, a third response (e.g., an answer and/or an automatically-generated response such as automatically-generated text content and or generative text content) that is generated (e.g., by an artificial intelligence (e.g., “AI”) process or a generative AI process) based on the second portion of the content and the first user inquiry, wherein the third response is different from the first response (e.g., 656t, 656u, 656v, 656z, 656aa, 656ab, 656ac, 656ad, 698c, 698d, 698e and/or 698h). In some embodiments, providing the third response includes displaying, via the one or more display generation components, the third response and/or a representation of the third response. In some embodiments, providing the third response includes outputting, via an audio generation component of the one or more output devices, the third response and/or a representation of the third response. In some embodiments, the third response includes a suggestion that does not include the first user inquiry. In some embodiments, the third response includes content corresponding to the first user inquiry and/or the second portion of the content. In some embodiments, the third response is different from the first response and the second response. Providing different responses that are generated based on different user inquiries in response to detecting an input corresponding to the different user inquiries enables the computer system to respond to inquiries with responses tailored to specific portions and the particular inquiry as directed by the user, thereby performing an operation when a set of conditions has been met without requiring further user input, reducing the number of inputs needed to perform an operation, and/or providing improved visual feedback to the user.

In some embodiments, in response to detecting the input (e.g., 605j and/or 605l) corresponding to the respective user inquiry and in accordance with a determination that the respective user inquiry is a second user inquiry (e.g., 656p and/or 656w) (e.g., as described above with respect to FIGS. 6J-6L), different from the first user inquiry, and that the respective user inquiry corresponds to a second portion of the content different from the first portion of the content (e.g., 640a, 640b, 640c, and/or 640d), the computer system provides, via the one or more output devices, a fourth response (e.g., an answer and/or an automatically-generated response such as automatically-generated text content and or generative text content) that is generated (e.g., by an artificial intelligence (e.g., “AI”) process or a generative AI process) based on the second portion of the content and the second user inquiry, wherein the third response is different from the first response (and, optionally, is different from the second response and/or the third response). In some embodiments, providing the fourth response includes displaying, via the one or more display generation components, the fourth response and/or a representation of the fourth response. In some embodiments, providing the fourth response includes outputting, via an audio generation component of the one or more output devices, the fourth response and/or a representation of the fourth response. In some embodiments, the fourth response includes a suggestion that does not include the second user inquiry. In some embodiments, the fourth response includes content corresponding to the second user inquiry and/or the first portion of the content. Providing different responses that are generated based on different portions of content and different user inquiries in response to detecting an input corresponding to the different user inquiries enables the computer system to respond to different inquiries with responses tailored to specific portions and the particular inquiry as directed by the user, thereby performing an operation when a set of conditions has been met without requiring further user input, reducing the number of inputs needed to perform an operation, and/or providing improved visual feedback to the user.

In some embodiments, the editing user interface (e.g., 602) is (and/or includes) a code editing user interface (e.g., 602) (e.g., an integrated development environment (IDS), a code editor, and/or a text editor). In some embodiments, the content includes code (e.g., a set of one or more software instructions, and/or source script). In some embodiments, the code editing user interface includes a build control. In some embodiments, in response to detecting an input corresponding to (e.g., directed to, at a location of, related to and/or associated with) the build control, the computer system builds and/or compiles the content. In some embodiments, the input corresponding to the build control includes a click on a button corresponding to the build control. In some embodiments, the input corresponding to the build control includes one or more key presses of the keyboard. In some embodiments, the code editing user interface includes a run control. In some embodiments, in response to detecting an input corresponding to the run control, the computer system builds, compiles, runs, and/or executes code (e.g., compiled code) corresponding to the content. In some embodiments, the input corresponding to the run control includes a click on a button corresponding to the run control. In some embodiments, the input corresponding to the run control includes one or more key presses of the keyboard. In some embodiments, the code editing user interface includes a text editor with the content. In some embodiments, while displaying the text editor with the content, the computer system changes a visual appearance of one or more portions of the control, such as to indicate that the code editing user interface and/or the computer system recognizes special meaning to the one or more portions (e.g., specific to a programming language). In some embodiments, while displaying the text editor with the content, the computer system provides an indication of one or more errors with respect to the content. In some embodiments, the code editing user interface includes one or more controls that edit a segment of code, and/or including at least a segment of code.

In some embodiments, the computer system detects (and/or receives), via the one or more input devices (e.g., 652, 652a, 652b, 652c, 652d, 652e, and/or 652f), an input (e.g., 605b, 605c, 605e, and/or 605g) corresponding to (e.g., directed to, at a location of, related to and/or associated with) the first portion of the content (e.g., 640c) (e.g., before detecting the input corresponding to the respective user inquiry). In some embodiments, the input corresponding to the first portion of the content includes a selection input followed by movement input that moves over the first portion of the content. In some embodiments, the input corresponding to the first portion of the content includes one or more mouse clicks, a right mouse click, a left mouse click, and/or a double tap over at least a portion of the first portion of the content. In some embodiments, in response to detecting the input corresponding to the first portion of the content (e.g., 640a, 640b, 640c, and/or 640d), the computer system emphasizes (e.g., 690 and/or 698) (e.g., highlighting, displaying in bold text, and/or visually distinguishing) the first portion of the content relative to other portions of the content, wherein the determination that the respective user inquiry (e.g., 656p and/or 656w) (e.g., as described above with respect to FIGS. 6J-6L) corresponds to the first portion of the content includes a determination that the first portion of the content is emphasized while detecting the input corresponding to the respective user inquiry. In some embodiments, in response detecting the input corresponding to the first portion of the content (and/or while the first portion of the content is emphasized), the computer system does not emphasize (and/or deemphasizes) another portion of the content different from the first portion of the content. Emphasizing a portion of content in response to detecting an input corresponding to the portion of the content and using such emphasis for determining an response enables the computer system to select portions of content for the inquiry and distinguish the selected portions, thereby reducing the number of inputs needed to perform an operation and/or providing improved visual feedback to the user.

In some embodiments, in response to (and/or while) emphasizing the first portion of the content (e.g., 640c) (and/or in response to (and/or after) detecting the input corresponding to the first portion of the content), the computer system displays, via the one or more display generation components, a first user interface element (e.g., as described above with respect to FIG. 6F) (e.g., a selectable user interface element, an icon, a widget, a control, a button, a user interface, and/or a window). In some embodiments, the first user interface element does not correspond to and/or is not based on the first portion of the content. In some embodiments, in response to detecting an input corresponding to the first user interface element, the computer system displays, via the one or more display generation components, a user interface. In some embodiments, the input corresponding to the first user interface element includes a mouse click and/or a tap on a button corresponding to the first user interface element. In some embodiments, the input corresponding to the first user interface element includes one or more key presses of the keyboard. In some embodiments, the user interface is for providing an response based on the first portion of the content. In some embodiments, the user interface includes a text entry field (e.g., an input field for text, text entry box, and/or region for typing text). In some embodiments, the user interface corresponds to an agent and/or large language model. Displaying a user interface element in response to emphasizing a portion of content enables the computer system to provide additional information and/or control options as directed by the user, thereby reducing the number of inputs needed to perform an operation and/or providing improved visual feedback to the user.

In some embodiments, while emphasizing the first portion of the content (e.g., 640c) (and/or in response to (and/or after) detecting the input corresponding to the first portion of the content), the computer system displays, via the one or more display generation components, a set of one or more user interface elements (e.g., 680) (e.g., a selectable user interface element, an icon, a widget, a control, a button, a user interface, and/or a window) including a second user interface element (e.g., 680c) (e.g., a selectable user interface element, an icon, a widget, a control, a button, a user interface, and/or a window) corresponding to (e.g., directed to, at a location of, related to and/or associated with) the first portion of the content. In some embodiments, the set of one or more user interface elements correspond to (e.g., are associated with) the first portion of the content. In some embodiments, the set of one or more user interface elements includes a plurality of user interface elements. In some embodiments, in response to detecting an input corresponding to the second user interface element, the computer system performs an operation (e.g., copy, paste, and/or cut) with respect to the first portion of the content. In some embodiments, the input includes one or more mouse clicks, a right mouse click, a left mouse click, a double tap, a tap-hold-and-release input, and/or a tap-drag-and-release input. In some embodiments, the input corresponding to the second user interface element includes a mouse click and a movement of a mouse and/or a tap-hold-and-release input on the first portion of the content. In some embodiments, the input corresponding to the second user interface element includes one or more mouse clicks, a right mouse click, a left mouse click, and/or a double tap input on the first portion of the content. Displaying a set of one or more user interface elements including a user interface element corresponding to a portion of content while emphasizing the portion of the content enables the computer system to provide additional information and/or control options as directed by the user for the emphasized text, thereby reducing the number of inputs needed to perform an operation and/or providing improved visual feedback to the user.

In some embodiments, the first portion of the content (e.g., 640c) includes (and/or is) a first portion of code (e.g., existing code, highlighted code, selected code, user-generated code, script, currently-displayed code, and/or a set of one or more software instructions). In some embodiments, the portion of code includes a set of one or more software instructions, code, and/or source script. In some embodiments, while displaying the set of one or more user interface elements including the second user interface element, the computer system detects (and/or receives), via the one or more input devices (e.g., 652, 652a, 652b, 652c, 652d, 652e, and/or 652f), an input corresponding to (e.g., directed to, at a location of, related to and/or associated with) the second user interface element (680c). In some embodiments, the input corresponding to the second user interface element includes an input corresponding to a request to generate auxiliary code (e.g., test code, preview code, exemplary code, additional code, script, and/or a set of one or more software instruction) (e.g., different from the first portion of code) that corresponds to (e.g., related to, associated with, based on, and/or testing) the first portion of code. In some embodiments, the input corresponding to the second user interface element includes a selection of a button to generate the second portion of the code. In some embodiments, the input corresponding to the second user interface element includes a press and hold on the second user interface element to generate the second portion of the code. In some embodiments, in response to detecting the input corresponding to the second user interface element, the computer system displays, via the one or more display generation components, a second portion of code (e.g., auxiliary code, test code, preview code, exemplary code, additional code, script, and/or a set of one or more software instruction) that is different from the first portion of code and was generated (e.g., by an artificial intelligence (e.g., “AI”) process or a generative AI process) based on the first portion of code (e.g., as described above with respect to FIG. 6AC). In some embodiments, the editing user interface is for editing the portion of code. In some embodiments, the second portion of code is in the same coding language as the first portion of code. Displaying a portion of code that was generated based on another portion of code in response to detecting an input corresponding to a user interface element enables the computer system to automatically generate and/or complete code as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, while emphasizing the first portion of the content (e.g., 640c) (and/or in response to (and/or after) detecting the input corresponding to the first portion of the content) (and/or in response to detecting an input corresponding to the first user interface element), the computer system displays, via the one or more display generation components, a first text entry field (e.g., 656b) (e.g., an input field for text, text entry box, and/or region for typing text) for submitting a user inquiry (e.g., a textual user inquiry) respective user inquiry (e.g., 656p and/or 656w) (e.g., as described above with respect to FIGS. 6J-6L). In some embodiments, while displaying the first text entry field, the computer system detects, via the one or more input devices, a set of one or more inputs (e.g., a verbal input and/or a non-verbal input) (e.g., corresponding to a set of one or more characters). In some embodiments, in response to detecting the set of one or more inputs, the computer system displays, via the one or more display generation components, content (e.g., the set of one or more characters). In some embodiments, the content is the respective user inquiry. In some embodiments, the first text entry field is for submitting a user inquiry (e.g., a textual user inquiry). In some embodiments, a verbal input includes a verbal utterance, a sound, an audible request, an audible command, and/or an audible statement. In some embodiments, a non-verbal input includes a swipe input, a hold-and-drag input, a gaze input, an air gesture, mouse movement, and/or a mouse click. Displaying a text entry field for submitting a user inquiry while emphasizing a portion of content enables the computer system to accept text entry inquiries for the emphasized portion of content, thereby performing an operation when a set of conditions has been met without requiring further user input, reducing the number of inputs needed to perform an operation, and/or providing improved visual feedback to the user.

In some embodiments, the computer system detects (and/or receives), via the one or more input devices (e.g., 652, 652a, 652b, 652c, 652d, 652e, and/or 652f), an input corresponding to (e.g., directed to, at a location of, related to and/or associated with) the first portion of the content (e.g., 640a, 640b, 640c, and/or 640d) (e.g., before detecting the input corresponding to the respective user inquiry), wherein the input is directed to a first position of the content (e.g., as describe above with respect to FIGS. 6B-6C). In some embodiments, the input corresponding to the first portion of the content includes a movement input to move the text insertion element over the first position. In some embodiments, the input corresponding to the first portion of the content includes a mouse click and/or a tap input on the first position, moving the text insertion element to the first position. In some embodiments, in response to detecting the input corresponding to the first portion of the content (e.g., 640a, 640b, 640c, and/or 640d), the computer system displays, via the one or more display generation components, a text-insertion element (e.g., 698) (and/or a user interface element) (e.g., a cursor and/or a text-insertion cursor) at the first position, wherein the determination that the respective user inquiry corresponds to the first portion of the content includes a determination that text-insertion element is at the first position (e.g., as described above with respect to FIGS. 6B-6C). In some embodiments, while and/or before detecting the input corresponding to the first portion of the content, the computer system displays, via the one or more display generation components, the text-insertion element at a second position different from the first position. In some embodiments, the input corresponding to the first portion of the content includes an input corresponding to (e.g., directed to, at a location of, related to and/or associated with) a request to move the text-insertion element from the second position to the first position. Displaying a text-insertion element at a position in response to detecting an input corresponding to a portion of content enables the computer system to select portions of content based on the text-insertion element's position in the content as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, while displaying the editing user interface (e.g., 602) and before detecting the input (e.g., 605j and/or 605l) corresponding to the respective user inquiry, the computer system detects (and/or receives), via the one or more input devices (e.g., 652, 652a, 652b, 652c, 652d, 652e, and/or 652f), an input corresponding to (e.g., directed to, at a location of, related to and/or associated with) the first portion of the content (e.g., 640a, 640b, 640c, and/or 640d). In some embodiments, the input corresponding to the first portion of the content includes a mouse click and movement of a mouse and/or a tap and movement input on the first portion of the content. In some embodiments, the input corresponding to the first portion of the content is an air gesture corresponding to selecting the first portion of the content. In some embodiments, after (and/or in response to) detecting the input corresponding to the first portion of the content (e.g., 640a, 640b, 640c, and/or 640d) (and/or in response to detecting, via the one or more input devices, an input corresponding to a request to display one or more suggested user inquiries), the computer system displays, via the one or more display generation components, a first set of one or more suggested user inquiries (e.g., 656j, 656k, and/or 656d) (e.g., an inquiry, a set of one or more characters, a set of one or more words, a statement, a request, follow-up question, and/or command). In some embodiments, the first set of one or more suggested user inquiries includes the respective user inquiry. In some embodiments, the first set of one or more suggested user inquiries includes a plurality of suggested user inquiries. In some embodiments, the first set of one or more suggested user inquiries are generated (e.g., by an artificial intelligence (e.g., “AI”) process or a generative AI process) based on the content, other content different from the content, and/or the first portion of the content. Displaying a set of one or more suggested user inquiries after detecting an input corresponding to a portion of the content enables the computer system to provide suggested questions (e.g., for additional inquiries) for the selected content as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, while displaying the one or more suggested user inquiries (e.g., automatically-generated text content and/or generative text content), the computer system detects, via the one or more input devices (e.g., 652, 652a, 652b, 652c, 652d, 652e, and/or 652f), an input (e.g., 905e) corresponding to (e.g., directed to, at a location of, related to and/or associated with) a third portion of the content different from the first portion of the content (e.g., 640a, 640b, 640c, and/or 640d). In some embodiments, the input corresponding to the third portion of the content includes an input corresponding to a request to select the third portion of the content (e.g., instead of or in addition to the first portion of the content). In some embodiments, the input corresponding to the third portion of the content includes a mouse click and movement of a mouse and/or a tap and movement input on the third portion of the content. In some embodiments, the input corresponding to the third portion of the content includes a mouse click and/or a tap input to select the third portion of the content. In some embodiments, in response to detecting the input (e.g., 905e) corresponding to the third portion of the content, the computer system displays, via the one or more display generation components, a second set of one or more suggested user inquiries (e.g., 656l, 656m, and/or 656d) different from the first set of one or more suggested user inquiries (e.g., 656j, 656k, and/or 656d) (and/or ceases display of at least one suggested user inquiry of the first set of one or more suggested user inquiries). In some embodiments, displaying the second set of one or more suggested user inquiries includes updating display of the first set of one or more suggested user inquiries to the second set of one or more suggested user inquiries. In some embodiments, the second set of one or more suggested inquires does not include a suggested user inquiry included in the first set of one or more suggested inquires. In some embodiments, the second set of one or more suggested inquires includes a suggested user inquiry included in the first set of one or more suggested inquires. In some embodiments, the first set of one or more suggested inquires does not include a suggested user inquiry included in the second set of one or more suggested inquires. In some embodiments, the first set of one or more suggested inquires includes a suggested user inquiry included in the second set of one or more suggested inquires. Displaying a set of one or more suggested user inquiries in response to detecting an input corresponding to a portion of content enables the computer system to display different suggested questions as different portions of the content are selected, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, while displaying the first set of one or more suggested user inquiries (e.g., automatically-generated text content and/or generative text content), the computer system detects (and/or receives), via the one or more input devices (e.g., 652, 652a, 652b, 652c, 652d, 652e, and/or 652f), an input corresponding to (e.g., directed to, at a location of, related to and/or associated with) a request to edit a fourth portion of the content (e.g., 640a, 640b, and/or 640d) (e.g., a request to add and/or remove one or more characters to the content) (e.g., as described above with respect to FIG. 6B). In some embodiments, the fourth portion of the content is the first portion of the content. In some embodiments, the fourth portion of the content is different from the first portion of the content. In some embodiments, the input corresponding to the request to edit the fourth portion of the content includes a right click input to edit the fourth portion of the content. In some embodiments, the input corresponding to the request to edit the fourth portion of the content includes a gaze input corresponding to a request to edit the fourth portion of the content. In some embodiments, in response to detecting the input corresponding to the request to edit the fourth portion of the content, the computer system displays, via the one or more display generation components, a third set of one or more suggested user inquiries different from the first set of one or more suggested user inquiries (and/or ceases display of at least one suggested user inquiry of the first set of one or more suggested user inquiries) (e.g., as described above with respect to FIG. 6B). In some embodiments, displaying the third set of one or more suggested user inquiries includes updating display of the first set of one or more suggested user inquiries to the third set of one or more suggested user inquiries. In some embodiments, the third set of one or more suggested inquires does not include a suggested user inquiry included in the first set of one or more suggested inquires and/or the second set of one or more suggested inquiries. In some embodiments, the third set of one or more suggested inquires includes a suggested user inquiry included in the first set of one or more suggested inquires and/or the second set of one or more suggested inquiries. In some embodiments, the first set of one or more suggested inquires does not include a suggested user inquiry included in the second set of one or more suggested inquires and/or the third set of one or more suggested inquiries. In some embodiments, the first set of one or more suggested inquires includes a suggested user inquiry included in the second set of one or more suggested inquires and/or the third set of one or more suggested inquiries. Displaying a set of one or more suggested user inquiries different from another set of one or more suggested user inquiries in response to detecting an input corresponding to a request to edit a portion of content enables the computer system to display different user questions while portions of content are edited, thereby providing additional control options without cluttering the user interface with additional displayed control, reducing the number of inputs needed to perform an operation, and/or providing improved visual feedback to the user.

In some embodiments, the editing user interface (e.g., 602) includes a first text entry field (e.g., 656b) (e.g., an input field for text, text entry box, and/or region for typing text) (e.g., for submitting a user inquiry (e.g., a textual user inquiry). In some embodiments, while displaying the editing user interface (e.g., 602) and before detecting the input (e.g., 605j and/or 605l) corresponding to the respective user inquiry, the computer system detects (and/or receives), via the one or more input devices (e.g., 652, 652a, 652b, 652c, 652d, 652e, and/or 652f), an input (e.g., 605i3, 605i4, and/or 605i5) corresponding to (e.g., directed to, at a location of, related to and/or associated with) the first text entry field, wherein the input corresponding to the first text entry field includes (and/or defines) the respective user inquiry (e.g., 656p and/or 656w) (e.g., as described above with respect to FIGS. 6J-6L). In some embodiments, the input corresponding to the first text entry field includes a set of one or more inputs, each input corresponding to a different character that results in adding the respective user inquiry to the first text entry field. In some embodiments, the input corresponding to the first text entry field includes an audio input that includes the respective user inquiry, resulting in adding the respective user inquiry to the first text entry field. In some embodiments, the input corresponding to the first text entry field includes a handwritten input that includes the respective user inquiry, resulting in adding the respective user inquiry to the first text entry field. In some embodiments, in response to detecting the input (e.g., 605i3, 605i4, and/or 605i5) corresponding to the first text entry field (e.g., 656b), the computer system displays, via the one or more display generation components, text in the first text entry field, wherein the text corresponds to the respective user inquiry (e.g., 656p and/or 656w) (e.g., as described above with respect to FIGS. 6J-6L). Displaying text in a text entry field in response to detecting an input corresponding to the text entry field enables the computer system to accept text based inquiries and base responses on the text based inquiries, thereby providing additional control options without cluttering the user interface with additional displayed control, reducing the number of inputs needed to perform an operation, and/or providing improved visual feedback to the user.

In some embodiments, the content is displayed in a first user interface (e.g., 696) (e.g., a region, a panel, and/or user interface element of the editing user interface) of the editing user interface (e.g., 602). In some embodiments, providing the first response (e.g., automatically-generated response and/or generative text and/or audio content) (e.g., 656t, 656u, 656v, 656z, 656aa, 656ab, 656ac, 656ad, 698c, 698d, 698e and/or 698h) includes displaying, via the one or more display generation components, a first representation (e.g., text, images, and/or videos) of the first response in a second user interface (e.g., 656) (e.g., a region, a panel, and/or user interface element of the editing user interface) of the editing user interface (e.g., 602) separate (and/or different) from the first user interface of the editing user interface (and/or adjacent to the first user interface of the editing user interface). Displaying a representation of an response in a user interface of an editing user interface separate from a user interface of the editing user interface with content enables the computer system to separate responses from the content, thereby reducing the number of inputs needed to perform an operation and/or providing improved visual feedback to the user.

In some embodiments, the first response (e.g., automatically-generated response and/or generative text and/or audio content) (e.g., 656t, 656u, 656v, 656z, 656aa, 656ab, 656ac, 656ad, 698c, 698d, 698e and/or 698h) is generated (e.g., using an AI process or a generative AI process) based on a fifth portion of the content (e.g., the remainder of and/or another portion of the content not included in the first portion of the content) different from the first portion of the content (e.g., 640c). In some embodiments, the fifth portion of the content is displayed while detecting the input corresponding to the respective user inquiry. In some embodiments, the fifth portion of the content is not displayed while detecting the input corresponding to the respective user inquiry. Providing an response based on a portion of content and a user inquiry in response to detecting an input corresponding to the user inquiry for another portion of the content enables the computer system to respond to inquiries with responses tailored to specific portions, the inquiry, and the context of additional portions of the content (and/or the content itself) as directed by the user, thereby performing an operation when a set of conditions has been met without requiring further user input, reducing the number of inputs needed to perform an operation, and/or providing improved visual feedback to the user.

In some embodiments, the first response (e.g., automatically-generated response and/or generative text and/or audio content) (e.g., 656t, 656u, 656v, 656z, 656aa, 656ab, 656ac, 656ad, 698c, 698d, 698e and/or 698h) includes suggested content (e.g., 656ab2 and/or 656ac2) to add to a sixth portion of the content (e.g., 640a, 640b, and/or 640d) (and/or the content). In some embodiments, the sixth portion of the content is the first portion of the content. In some embodiments, the sixth portion of the content is different from the first portion of the content. Providing an response that includes suggested content to add to a portion of content based on the portion of the content and a user inquiry enables the computer system to respond to inquiries with tailored responses and suggested content to specific portions and the inquiry and the context of additional portions of the content as directed by the user, thereby performing an operation when a set of conditions has been met without requiring further user input, reducing the number of inputs needed to perform an operation, and/or providing improved visual feedback to the user.

In some embodiments, after (and/or while) providing the first response (e.g., automatically-generated response and/or generative text and/or audio content) (e.g., 656t, 656u, 656v, 656z, 656aa, 656ab, 656ac, 656ad, 698c, 698d, 698e and/or 698h), the computer system detects (and/or receives), via the one or more input devices (e.g., 652, 652a, 652b, 652c, 652d, 652e, and/or 652f), an input (e.g., 605m4) corresponding to (e.g., directed to, at a location of, related to and/or associated with) the suggested content (e.g., 656ac2) (e.g., a request to add the suggested content to the content and/or to the sixth portion of the content) (e.g., a set of one or more software instructions, code, and/or source script). In some embodiments, the input corresponding the suggested content includes an input corresponding a user interface element (e.g., a selectable user interface element, an icon, a widget, a control, a button, a user interface, and/or a window) corresponding to (e.g., directed to, at a location of, related to and/or associated with) the suggested content and/or the first response. In some embodiments, the input corresponding to the suggested content includes a mouse click and/or a tap on a button corresponding to adding the suggested content to the content. In some embodiments, the input corresponding to the suggested content includes a click and drag movement to a location to add the suggested content to the content. In some embodiments, in response to detecting the input (e.g., 605m4) corresponding to the suggested content (e.g., 656ac2), the computer system adds the suggested content to the content (e.g., 640) (e.g., as described above with respect to FIGS. 6P-6O) (e.g., adds the suggested content to the sixth portion of the content or another portion of the content different from the sixth portion of the content). Adding suggested content to other content in response to detecting an input corresponding to the suggested content enables the computer system to add the suggested content to the other content as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, displaying the first response (e.g., 656t, 656u, 656v, 656z, 656aa, 656ab, 656ac, 656ad, 698c, 698d, 698e and/or 698h) includes: in accordance with a determination that a set of one or more criteria is satisfied (e.g., a location within the content is able to be identified for placing content corresponding to the first response and/or content corresponding to the first response is able to be determined), displaying, via the one or more display generation components, a third user interface element (e.g., 656ab1) (e.g., a selectable user interface element, an option, an icon, a widget, a control, a button, a user interface, and/or a window) to add content (e.g., a set of one or more software instructions, code, and/or source script) corresponding to (e.g., directed to, at a location of, related to and/or associated with) the first response (e.g., 656t, 656u, 656v, 656z, 656aa, 656ab, 656ac, 656ad, 698c, 698d, 698e and/or 698h); and in accordance with a determination that the set of one or more criteria is not satisfied (e.g., a location within the content is not able to be identified for placing the content corresponding to the first response), displaying the first response (e.g., 656t, 656u, 656v, 656z, 656aa, 656ab, 656ac, 656ad, 698c, 698d, 698e and/or 698h) without displaying the third user interface element to add the content corresponding to (e.g., directed to, at a location of, related to and/or associated with) the first response. In some embodiments, while displaying the third user interface element to add the content corresponding to the first response, the computer system detects, via the one or more input devices, an input directed to the third user interface element. In some embodiments, in response to detecting the input directed to the third user interface element, the computer system adds the content corresponding to the first response to the content included in the editing user interface. In some embodiments, the input corresponding to the third user interface element includes a mouse click and/or a tap on a button for pasting the first response to the content. In some embodiments, the input corresponding to the third user interface element includes one or more key presses of the keyboard (e.g., control key and paste key). In some embodiments, in accordance with a determination that the set of one or more criteria is not satisfied (e.g., a location within the content is not able to be identified for placing the content corresponding to the first response), displaying the first response (e.g., 656t, 656u, 656v, 656z, 656aa, 656ab, 656ac, 656ad, 698c, 698d, 698e and/or 698h) without displaying the third user interface element to add the content corresponding to (e.g., directed to, at a location of, related to and/or associated with) the first response. Displaying a response either (1) with a user interface element to add content corresponding to the response or (2) without the user interface element to add content corresponding to the response enables the computer system to provide options to add content on behalf of users when the content can be identified and/or a location can be identified for the content, thereby performing an operation when a set of conditions has been met without requiring further user input, reducing the number of inputs needed to perform an operation, and/or providing improved visual feedback to the user.

In some embodiments, providing the first response (e.g., automatically-generated response and/or generative text and/or audio content) (e.g., 656t, 656u, 656v, 656z, 656aa, 656ab, 656ac, 656ad, 698c, 698d, 698e and/or 698h) includes displaying, via the one or more display generation components, a seventh portion of the content (e.g., 640) with a modification (e.g., 916, 918, 936, 938, 940) (e.g., as described below with respect to process 1100). In some embodiments, the seventh portion of the content is different from the first portion of the content. In some embodiments, the seventh portion of the content is the same as (and/or separate from) from the first portion of the content. Providing a response including displaying a portion of content with a modification enables the computer system to respond to inquiries with modified portions of the content as directed by the user, thereby performing an operation when a set of conditions has been met without requiring further user input, reducing the number of inputs needed to perform an operation, and/or providing improved visual feedback to the user.

In some embodiments, the content is first content. In some embodiments, the first response (e.g., automatically-generated response and/or generative text and/or audio content) (e.g., 656t, 656u, 656v, 656z, 656aa, 656ab, 656ac, 656ad, 698c, 698d, 698e and/or 698h) is generated (e.g., using an AI process or a generative AI process) based on second content different from the first content (e.g., as described above with respect to FIG. 6B). In some embodiments, the second content does not include the first content. In some embodiments, the second content is in a different line and/or function than the first content. In some embodiments, the second content is in a separate file than the first content. In some embodiments, the second content is in a file of various user interface elements and the first content is in a file of various functions. In some embodiments, the second content is related to the first content. In some embodiments, the second content is not displayed and/or being displayed. In some embodiments, the second content is in a region of the content that is not displayed. Providing a response that is generated based on additional (and/or different) content enables the computer system to respond to inquiries with responses tailored to specific portions of larger portions of content, thereby performing an operation when a set of conditions has been met without requiring further user input, reducing the number of inputs needed to perform an operation, and/or providing improved visual feedback to the user.

In some embodiments, in response to detecting the input (e.g., 605j and/or 605l) corresponding to (e.g., directed to, at a location of, related to and/or associated with) the respective user inquiry and in accordance with the determination that the respective user inquiry is the first user inquiry (e.g., 656p and/or 656w) (e.g., as described above with respect to FIGS. 6J-6L) and that the respective user inquiry corresponds to the first portion of the content (e.g., 640c) (and/or in addition to (and/or while) providing the first response), the computer system displays (and/or maintains display of), via the one or more display generation components, a first text entry field (e.g., 656b) (e.g., an input field for text, text entry box, and/or region for typing text) for submitting a user inquiry (e.g., 656p and/or 656w) (e.g., as described above with respect to FIGS. 6J-6L) (e.g., a textual user inquiry and/or a follow-up user inquiry). In some embodiments, a user inquiry added to the first text entry field and the respective user inquiry are both text. In some embodiments, a user inquiry added to the first text entry field and the respective user inquiry are different (e.g., both are not text). In some embodiments, the first text entry field is displayed in the user interface adjacent to the content. In some embodiments, after displaying the first text entry field, the computer system detects, via the one or more input devices, an input corresponding to (e.g., directed to, at a location of, related to and/or associated with) the first text entry field (e.g., a button to submit text within the first text entry field). In some embodiments, in response to detecting the input corresponding to the first text entry field and in accordance with a determination that text within the first text entry field corresponds to the first portion of the content, the computer system provides, via the one or more output devices, a sixth response that is generated (e.g., by an artificial intelligence (e.g., “AI”) process or a generative AI process) based on the text within the first text entry field (and/or the first portion of the content). In some embodiments, the sixth response is different from the first response. In some embodiments, the sixth response is the same as the first response. In some embodiments, the input corresponding to the first text entry field includes a mouse click and/or a tap on a portion of the content in the text entry field. In some embodiments, the input corresponding to the first text entry field includes a click-drag-and-release on a portion of the content in the text entry field. Displaying a text entry field for submitting a user inquiry in response to detecting an input corresponding to another user inquiry enables the computer system to provide a designated region for additional user inquiries for specific portions of content, thereby performing an operation when a set of conditions has been met without requiring further user input, reducing the number of inputs needed to perform an operation, and/or providing improved visual feedback to the user.

In some embodiments, the editing user interface (e.g., 602) includes a fourth user interface element (e.g., 680d) (e.g., a selectable user interface element, an option, an icon, a widget, a control, a button, a user interface, and/or a window) (e.g., to generate a test for selected content and/or code). In some embodiments, while displaying the fourth user interface element, the computer system detects (and/or receives), via the one or more input devices (e.g., 652, 652a, 652b, 652c, 652d, 652e, and/or 652f), an input (e.g., 605ac) corresponding to (e.g., directed to, at a location of, related to and/or associated with) the fourth user interface element (e.g., to generate a test for selected content and/or code) (e.g., a request to generate auxiliary content (e.g., test content, preview content, exemplary content, additional content) that corresponds to the first portion of content). In some embodiments, the input corresponding to the fourth user interface element includes a mouse click and/or a tap on a button corresponding to generating the test for a respective portion of the content. In some embodiments, the input corresponding to the fourth user interface element includes a gaze input on the fourth user interface element for longer than a threshold period of time (e.g., 10, 5, 3, 1, 0.5, 0.1, 0.05, or 0.01 seconds). In some embodiments, in response to detecting the input corresponding to the fourth user interface element, in accordance with a determination that an eighth portion of the content (e.g., 640e) is selected, the computer system displays (e.g., in response to and/or after generating the auxiliary content), via the one or more display generation components, a test for the eighth portion of the content (e.g., 640e). In some embodiments, in response to detecting the input corresponding to the fourth user interface element, the computer system displays, via the one or more display generation components, (e.g., concurrently with the first portion of the content) a visual indication of a result of executing (and/or running) the test for the eighth portion of the content. In some embodiments, testing the eighth portion of the content includes one or more features described below with respect to process 800. In some embodiments, the computer system generates the auxiliary content by an artificial intelligence (e.g., “AI”) process or a generative AI process. In some embodiments, in response to detecting the input corresponding to the fourth user interface element, in accordance with a determination that a ninth portion of the content (e.g., 640a, 640b, and/or 640d), different from the eighth portion of the content, is selected, the computer system displays (e.g., in response to and/or after generating the auxiliary content), via the one or more display generation components, a test for the ninth portion of the content (e.g., as described above with respect to FIG. 6AE) (e.g., without displaying the test for the tenth portion of the content). In some embodiments, in response to detecting the input corresponding to the fourth user interface element, the computer system displays (concurrently with the first portion of the content) a visual indication of a result of executing (and/or running) the test for the ninth portion of the content. In some embodiments, testing the ninth portion of the content includes one or more features described below with respect to process 800. In some embodiments, the test for the ninth portion of the content is different from the test for the eighth portion of the content. Displaying different tests based on which portion of content is selected enables the computer system to provide tests for specific portions of content as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the test for the eighth portion of the content (e.g., 684e) corresponds to (and/or tests) a plurality of functions (e.g., commands and/or instructions). In some embodiments, in response to detecting the input corresponding to (e.g., directed to, at a location of, related to and/or associated with) the fourth user interface element and while displaying the test for the eighth portion of the content (and/or while displaying the first portion of the content), the computer system displays, via the one or more display generation components, a visual indication of a result of executing (and/or running) the test for the eighth portion of the content. In some embodiments, in response to detecting the input corresponding to the fourth user interface element and while displaying the test for the ninth portion of the content (and/or while displaying the first portion of the content), the computer system displays, via the one or more display generation components, a visual indication of a result of executing (and/or running) the test for the ninth portion of the content. Displaying a visual indication of a result of executing a test that corresponds to a plurality of functions in response to detecting the input corresponding to the user interface element and while displaying the test for a portion of the content enables the computer system to test multiple functions at once, thereby performing an operation when a set of conditions has been met without requiring further user input, reducing the number of inputs needed to perform an operation, and/or providing improved visual feedback to the user.

In some embodiments, in response to detecting the input (e.g., 605j and/or 605l) corresponding to (e.g., directed to, at a location of, related to and/or associated with) the fourth user interface element (e.g., 680d) and while displaying the eighth portion of the content (e.g., e.g., 684e), the computer system displays (e.g., concurrently with the first portion of the content), via the one or more display generation components, a visual indication (e.g., 682b) of a result of executing (and/or running) the test for the eighth portion of the content (e.g., 684e), wherein the visual indication of the result of executing the test for the eighth portion of the content (e.g., 684e) is at a location adjacent to (e.g., corresponding to and/or nearby) the eighth portion of the content (e.g., and not adjacent to the ninth portion of the content). In some embodiments, in response to detecting the input corresponding to the user interface element and while displaying the test for the ninth portion of the content, the computer system displays (e.g., concurrently with the first portion of the content), via the one or more display generation components, a visual indication of a result of executing (and/or running) the test for the ninth portion of the content, wherein the visual indication of the result of executing the test for the ninth portion of the content is at a location adjacent to (e.g., corresponding to and/or nearby) the ninth portion of the content (e.g., and not adjacent to the eighth portion of the content). Displaying a visual indication of a result of executing a test for a portion of content in response to detecting an input corresponding to a user interface element enables the computer system to include a test, indicate the specific portion of content being tested, and provide a result of the test, thereby performing an operation when a set of conditions has been met without requiring further user input, reducing the number of inputs needed to perform an operation, and/or providing improved visual feedback to the user.

In some embodiments, in response to detecting the input (e.g., 605j and/or 605l) corresponding to the respective user inquiry and in accordance with the determination that the respective user inquiry is the first user inquiry (e.g., 656p and/or 656w) (e.g., as described above with respect to FIGS. 6J-6L) and that the respective user inquiry corresponds to the first portion of the content (e.g., 640a, 640b, 640c, and/or 640d) (and/or in addition to (and/or while) providing the first response), the computer system displays, via the one or more display generation components, a summary (e.g., 914a) (e.g., a user interface element corresponding to the first response and/or a representation of a list of changes corresponding to the first response) of modifications to the content. In some embodiments, the user interface element is a selectable user interface element, an option, an icon, a widget, a control, a button, a user interface, and/or a window. In some embodiments, the summary of the modifications to the content is displayed concurrently with providing the first response. In some embodiments, the summary of the modifications to the content is displayed before and/or after providing the first response. Displaying a summary of modifications to content in response to detecting an input corresponding to a respective user inquiry enables the computer system to summarize modifications after making them, thereby performing an operation when a set of conditions has been met without requiring further user input, reducing the number of inputs needed to perform an operation, and/or providing improved visual feedback to the user.

In some embodiments, providing the first response (e.g., automatically-generated response and/or generative text and/or audio content) (e.g., 656t, 656u, 656v, 656z, 656aa, 656ab, 656ac, 656ad, 698c, 698d, 698e and/or 698h) includes displaying, via the one or more display generation components, a user interface element (e.g., 922a and/or 922b) (e.g., a selectable user interface element, an icon, a widget, a control, a button, a user interface, and/or a window) corresponding (e.g., directed to, at a location of, related to and/or associated with) to navigating between a first modification (e.g., 916, 918, 936, 938, and/or 940) (e.g., as described below with respect to process 1100) of a tenth portion of the content and a second modification (e.g., 916, 918, 936, 938, and/or 940) of a eleventh portion of the content. In some embodiments, the second modification is different from the first modification (e.g., as described above with respect to FIGS. 9P-9T). In some embodiments, the computer system modifies (and/or automatically modifies) the tenth portion of the content with the first modification and the eleventh portion of the content with the second modification. In some embodiments, automatically modifying the tenth portion of the content and the eleventh portion of the content includes the computer system modifies the content without detecting, via the one or more input devices, (and/or after the user inquiry) an input corresponding to (e.g., directed to, at a location of, related to and/or associated with) the first response that is generated (e.g., by an artificial intelligence (e.g., “AI”) process or a generative AI process) based on the first portion of the content and the first user inquiry. In some embodiments, the input is a selection corresponding to the first response includes a mouse click and/or a tap on a button to modify the tenth portion of the content. In some embodiments, the input and/or a non-selection input corresponding to the first response includes one or more key presses of the keyboard corresponding to modifying the tenth portion of the content. In some embodiments, navigating between the first modification of the tenth portion of the content and the second modification of the eleventh portion of the content includes displaying a portion of the content (e.g., the first portion of the content, the tenth portion of the content, and/or the eleventh portion of the content) with a first emphasis (e.g., bold, highlight, and/or color change) and displaying the a modification of the portion of the content with a second emphasis different from the first emphasis. In some embodiments, the computer system detects (and/or receives), via the one or more input devices, an input corresponding to the user interface element corresponding to navigating between the first modification of the tenth portion of the content and the second modification of the eleventh portion of the content. In some embodiments, in response to detecting the input corresponding to the user interface element corresponding to navigating between the first modification of the tenth portion of the content and the second modification of the eleventh portion of the content, the computer system emphasizes and/or displays the first modification of the tenth portion of the content and/or the second modification of the eleventh portion of the content. In some embodiments, the input corresponding to the user interface element corresponding to navigating between the first modification of the tenth portion of the content and the second modification of the eleventh portion of the content includes a click on a button corresponding to the user interface element corresponding to navigating between the first modification of the tenth portion of the content and the second modification of the eleventh portion of the content. In some embodiments, the input corresponding to the user interface element corresponding to navigating between the first modification of the tenth portion of the content and the second modification of the eleventh portion of the content includes a voice input to navigate between the first modification of the tenth portion of the content and the second modification of the eleventh portion of the content (e.g., “next modification”). Providing a response including a user interface element corresponding to navigating between modifications enables the computer system to respond to inquiries with modified portions of the content and provide control options for navigation between those modified portions as directed by the user, thereby performing an operation when a set of conditions has been met without requiring further user input, reducing the number of inputs needed to perform an operation, and/or providing improved visual feedback to the user.

In some embodiments, after (and/or while) providing the first response (e.g., automatically-generated response and/or generative text and/or audio content) (e.g., 656t, 656u, 656v, 656z, 656aa, 656ab, 656ac, 656ad, 698c, 698d, 698e and/or 698h) (and/or while displaying at least a portion of the editing user interface), the computer system detects, via the one or more input devices (e.g., 652, 652a, 652b, 652c, 652d, 652e, and/or 652f), an input (and/or a set of one or more inputs) corresponding to (e.g., directed to, at a location of, related to and/or associated with) a request to display a history user interface (e.g., a set of previous user inquiries, inputs, and/or responses) different from the editing user interface (e.g., 602). In some embodiments, the input corresponding to the request to display the history user interface includes a mouse click and/or a tap on a button for displaying the history user interface. In some embodiments, the input corresponding to the request to display the history user interface includes a voice input corresponding to displaying the history user interface (e.g., “show me previous questions”). In some embodiments, in response to detecting the input corresponding to the request to display the history user interface, the computer system displays, via the one or more display generation components, the history user interface (e.g., 924) (and/or while displaying at least a portion of the editing user interface) including a set of one or more previous user inquiries (e.g., 912f and/or 926), wherein the set of one or more previous user inquiries includes the respective user inquiry (e.g., 656p and/or 656w) (e.g., as described above with respect to FIGS. 6J-6L). In some embodiments, the computer system overlays the history user interface on top of the editing user interface. In some embodiments, in conjunction with displaying the history user interface, the computer system ceases display of the editing user interface. Displaying a history user interface in response to detecting an input corresponding to a request to display the history user interface enables the computer system to respond to inquiries with a history of previous inquiries as directed by the user, thereby reducing the number of inputs needed to perform an operation and/or providing improved visual feedback to the user.

In some embodiments, after (and/or while) displaying the history user interface, the computer system detects, via the one or more input devices (e.g., 652, 652a, 652b, 652c, 652d, 652e, and/or 652f), an input (e.g., 905u1) (and/or a set of one or more inputs) corresponding to (e.g., directed to, at a location of, related to and/or associated with) a previous user inquiry (e.g., 912f) of the set of one or more previous user inquiries. In some embodiments, the input corresponding to the previous user inquiry includes a mouse click and/or a tap on a representation (e.g., text, images, and/or videos) of the previous user inquiry displayed in the history user interface. In some embodiments, the input corresponding to the previous user inquiry includes an air gesture corresponding to the previous user inquiry. In some embodiments, in response to detecting the input (e.g., 905u1) corresponding to the previous user inquiry of the set of one or more previous user inquiries, the computer system displays, via the one or more display generation components, a previous response (e.g., 914a) that was generated (e.g., by an artificial intelligence (e.g., “AI”) process or a generative AI process) based on the previous user inquiry (and/or based on a portion of the previous content) in the history user interface. In some embodiments, the previous user inquiry is the first user inquiry, and, in response to detecting the input corresponding to the first user inquiry of the set of previous user inquiries, the computer system displays the first response in the history user interface. Displaying a previous response in a history user interface in response to detecting an input corresponding to a previous user inquiry of a set of one or more previous user inquiries enables the computer system to respond to inputs to display previous responses to user inquiries as directed by the user and display additional information of the user inquiries, thereby reducing the number of inputs needed to perform an operation and/or providing improved visual feedback to the user.

In some embodiments, providing the first response (e.g., automatically-generated response and/or generative text and/or audio content) (e.g., 656t, 656u, 656v, 656z, 656aa, 656ab, 656ac, 656ad, 698c, 698d, 698e and/or 698h) includes displaying, via the one or more display generation components, a first set of one or more details (e.g., as described above with respect to FIG. 6AC) (e.g., a first set of features and/or a first content) corresponding to the first response. In some embodiments, the first content includes text, images, and/or data. In some embodiments, while displaying the first set of one or more details corresponding to the first response (e.g., 656t, 656u, 656v, 656z, 656aa, 656ab, 656ac, 656ad, 698c, 698d, 698e and/or 698h) (and/or while displaying at least a portion of the editing user interface), the computer system detects, via the one or more input devices (e.g., 652, 652a, 652b, 652c, 652d, 652e, and/or 652f), an input (e.g., 605ab1) (and/or a set of one or more inputs) corresponding to (e.g., directed to, at a location of, related to and/or associated with) the first response (e.g., 656t, 656u, 656v, 656z, 656aa, 656ab, 656ac, 656ad, 698c, 698d, 698e and/or 698h) (and/or the first set of one or more details). In some embodiments, the input corresponding to the first response includes a mouse click on the first set of one or more details. In some embodiments, the input corresponding to the first response includes a voice input corresponding to selecting the first response (e.g., “show me more details for the first response”). In some embodiments, in response to detecting the input corresponding to the first response (e.g., 656t, 656u, 656v, 656z, 656aa, 656ab, 656ac, 656ad, 698c, 698d, 698e and/or 698h), the computer system displays, via the one or more display generation components, a second set of one or more details (e.g., as described above with respect to FIG. 6C) (e.g., a second set of features and/or a second content), different from the first set of one or more details (e.g., without removing the first amount of detail and/or changing an appearance of content corresponding to the first amount of detail), corresponding to the first response (e.g., 656t, 656u, 656v, 656z, 656aa, 656ab, 656ac, 656ad, 698c, 698d, 698e and/or 698h). In some embodiments, the second set of details is displayed with the first set of one or more details. In some embodiments, the second set of one or more details is displayed separate from the first set of one or more details. In some embodiments, the second set of one or more details was not displayed before detecting the input corresponding to the first response. Displaying a set of one or more details in response to detecting an input corresponding to a response enables the computer system to respond to inputs on the response as directed by the user and display additional information of the response, thereby reducing the number of inputs needed to perform an operation and/or providing improved visual feedback to the user.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, providing the first response of method 700 can occur while displaying the visual indication of the result of running the code of method 800. For brevity, these details are not repeated herein.

FIG. 8 is a flow diagram illustrating a process (e.g., process 800) for displaying a visual indications of the result of running a section of code in accordance with some embodiments. Some operations in process 800 are, optionally, combined, the orders of some operations are, optionally, changed, and some operations are, optionally, omitted.

As described below, process 800 provides an intuitive way for displaying a visual indications of the result of running a section of code. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication (e.g., wired communication and/or wireless communication) with a display generation component (e.g., a display screen, a projector, and/or a touch-sensitive display) and one or more input devices (e.g., 652, 652a, 652b, 652c, 652d, 652e, and/or 652f) (e.g., a camera, a depth sensor, a microphone, a hardware input mechanism, a keyboard, a touchpad, a mouse, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device.

The computer system detects (802) (and/or receives), via the one or more input devices (e.g., 652, 652a, 652b, 652c, 652d, 652e, and/or 652f), an input (e.g., 605ac) corresponding to (e.g., directed to, at a location of, related to and/or associated with) a request to generate (e.g., by an artificial intelligence (e.g., “AI”) process or a generative AI process) auxiliary code (e.g., test code, preview code, exemplary code, additional code, script, and/or a set of one or more software instruction) (e.g., automatically-generated text content and or generative text content) that corresponds to (e.g., related to, associated with, based on, and/or testing) a first section of code (e.g., 640e) (e.g., existing code, highlighted code, selected code, user-generated code, script, currently-displayed code, and/or a set of one or more software instructions). In some embodiments, the computer system displays the first section of code while detecting the input corresponding to the request to generate auxiliary code that corresponds to the first section of code. In some embodiments, the input corresponding to the request to generate the auxiliary code includes a mouse click and mouse movement and/or a tap and movement input to select the first section of code. In some embodiments, the input corresponding to the request to generate the auxiliary code includes a mouse click and/or a tap on a button corresponding to a request to generate the auxiliary code. In some embodiments, the first section of code is different from the auxiliary code.

In response to (804) detecting the input corresponding to the request to generate the auxiliary code that corresponds to the first section of code, the computer system displays (806) (e.g., in response to and/or after generating the second section of code), via the display generation component, a second section of code (e.g., 684e) that is different from the first section of code and was generated (e.g., by an AI process or a generative AI process) based on the request to generate the auxiliary code. In some embodiments, the second section of code is displayed concurrently with the first section of code. In some embodiments, the second section of code is displayed in a different area of an editing user interface (e.g., as described above with respect to process 700) than the first section of code. In some embodiments, the second section of code is displayed in line with the first section of code. In some embodiments, the second section of code was not displayed before detecting the input corresponding to the request to generate auxiliary code that corresponds to the first section of code.

In response to (804) detecting the input corresponding to the request to generate the auxiliary code that corresponds to the first section of code, the computer system displays (808) (e.g., concurrently with the second section of code), via the display generation component, a visual indication (e.g., 682b) of a result of running (and/or executing) (e.g., in response to and/or after generating the second section of code) the second section of code. In some embodiments, the visual indication of the result of running the second section of code is based on the second section of code. In some embodiments, the visual indication of the result of running the second section of code is a result of running and/or executing the first section of code, the second section of code, and/or another section of code different from the first section of code and the second section of code. In some embodiments, the visual indication of the result of running the second section of code is a user interface element corresponding to (e.g., directed to, at a location of, related to and/or associated with) the success (e.g., a checkmark and/or color change) or failure (e.g., an x and/or a color change) of running the second section of code. In some embodiments, the visual indication of the result of running the second section of code is text corresponding to (e.g., directed to, at a location of, related to and/or associated with) running the test (e.g., “generating preview”), and/or completing the test (e.g., “ready”). In some embodiments, running the second section of code includes building the first section of code, the second section of code, and/or another section of code different from the first section of code and the second section of code. In some embodiments, running the second section of code includes running another section of code different from the second section of code. In some embodiments, in response to running the second section of code, the computer system generates and/or displays, via the display generation component, a result (e.g., displays a user interface element (e.g., indicating a success and/or failure) and/or outputs, via one or more output devices (e.g., an audio generation component (e.g., a speaker, smart speaker, home theater system, soundbar, headphone, earphone, earbud, speaker, television speaker, augmented reality headset speaker, audio jack, optical audio output, Bluetooth audio output, and/or HDMI audio output), a haptic generation component), content (e.g., audio and/or haptic feedback)) (and/or while displaying the first section of code and/or the second section of code). In some embodiments, in response to detecting the input corresponding to the request to generate the auxiliary code that corresponds to the first section of code, the computer system generates the second section of code (e.g., auxiliary code, test code, preview code, exemplary code, additional code, and/or a set of one or more software instruction). In some embodiments, the second section of code is generated based on the first section of code (e.g., different sections of code are generated when based on different sections of code). In some embodiments, in response to the computer system detects an input corresponding to (e.g., directed to, at a location of, related to and/or associated with) a request to generate auxiliary code that corresponds to another section of code different from the first section of code, the computer system generates a third set of code different from the first section of code and the second section of code. In some embodiments, in response to detecting the input corresponding to the request to generate auxiliary code that corresponds to another section of code, the computer system generates the second section of code before the computer system detects the input corresponding to the request to generate auxiliary code that corresponds to the first section of code. In some embodiments, the input corresponding to the request to generate auxiliary code that corresponds to another section of code includes mouse click and/or a tap on a button for generating the auxiliary code. In some embodiments, the input corresponding to the request to generate auxiliary code that corresponds to another section of code includes a voice input to add the auxiliary code (e.g., “generate additional code for this”). Displaying a section of code that is generated based on a request to generate auxiliary code and displaying a visual indication of running the section of code in response to detecting an input corresponding to a request to generate the auxiliary code that corresponds to a different section of code enables the computer system to display auxiliary code with results of running the auxiliary code as directed by the user for a specified portion of content, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, before detecting the input corresponding to (e.g., directed to, at a location of, related to and/or associated with) the request to generate the auxiliary code that corresponds to the first section of code (e.g., 640e), the computer system displays, via the display generation component, a third section of code that includes the first section of code, wherein the third section of code is different from the second section of code (e.g., 684e). In some embodiments, before detecting the input corresponding to the request to generate the auxiliary code that corresponds to the first section of code, while displaying at least a portion of the third section of code, the computer system detects (and/or receives), via the one or more input devices (e.g., 652, 652a, 652b, 652c, 652d, 652e, and/or 652f), an input (e.g., 605aa) corresponding to (e.g., directed to, at a location of, related to and/or associated with) the first section of code. In some embodiments, a mouse click includes a double click, a click and hold, and/or a click and drag. In some embodiments, the input is one or more mouse clicks, a right mouse click, a left mouse click, a mouse click with movement of a mouse, a double tap, a tap-hold-and-release input, and/or a tap-drag-and-release input. In some embodiments, the input corresponding to the first section of code includes a mouse clock and movement of a mouse and/or a tap and movement input of the first section of code from a third section of code that includes the first section of code. In some embodiments, the input corresponding to the first section of code includes a gaze input on at least a portion of the first section of code displayed on the display generation component. In some embodiments, in response to detecting the input corresponding to the first section of code, the computer system emphasizes (e.g., highlights, bolds, and/or visually distinguishes) the first section of code from another section of code (e.g., 640), different from the first section of code, of the third section of code, wherein the input, corresponding to the request to generate the auxiliary code that corresponds to the first section of code, is directed to a user interface element different from the first section of code, and wherein the request, to generate the auxiliary code that corresponds to the first section of code, corresponds to the first section of code as a result of (and/or based on and/or in response to) the first section of code being emphasized while detecting the input corresponding to the request to generate the auxiliary code that corresponds to the first section of code (e.g., as described above with respect to FIGS. 6AA-6AB). In some embodiments, the other section of code is not emphasized and/or deemphasized in response to detecting the input corresponding to the first section of code. In some embodiments, the other section of code is different from the second section of code. In some embodiments, the computer system displays the first section of code as emphasized from the other section of code in response to detecting the input corresponding to the request to generate the auxiliary code that corresponds to the first section of code. Emphasizing the section of code from another section of code in response to detecting the input corresponding to the section of code enables the computer system to distinguish the selected code from other code so as to inquire about the selected code as directed by the user, thereby performing an operation when a set of conditions has been met without requiring further user input, reducing the number of inputs needed to perform an operation, and/or providing improved visual feedback to the user.

In some embodiments, the visual indication of the result of running the second section of code (e.g., 684e) includes a user interface element (e.g., 648) (e.g., a preview, a user-interface preview, a representation, a visual representation, a selectable user interface element, an icon, a widget, a control, a button, a user interface, and/or a window) generated (e.g., by an artificial intelligence (e.g., “AI”) process or a generative AI process) by (and/or corresponding to) running the second section of code (and/or the first section of code). In some embodiments, the user interface element is based on the first section of code and/or the second section of code. In some embodiments, the user interface element is not based on the first section of code. Displaying a user interface element corresponding to running a section of code enables the computer system to visually indicate a result of the code, thereby performing an operation when a set of conditions has been met without requiring further user input, reducing the number of inputs needed to perform an operation, and/or providing improved visual feedback to the user.

In some embodiments, the user interface element includes one or more sub elements (e.g., a preview, a user-interface preview, a representation, a visual representation, a selectable user interface element, an icon, a widget, a control, and/or a button). In some embodiments, a sub element (e.g., 648a2 and/or 648a3) of the one or more sub elements is generated (e.g., by an artificial intelligence (e.g., “AI”) process or a generative AI process) based on one or more automatically selected parameter values (e.g., as described above with respect to FIG. 6V). In some embodiments, each sub element of the one or more sub elements includes a different portion of the user interface element. In some embodiments, the one or more automatically selected parameter values is not defined in the first section of code. In some embodiments, the one or more automatically selected parameter values is not defined in code associated with and/or corresponding to the first section of code. In some embodiments, the one or more automatically selected parameter values are code developed by the same developer as the first section of code. In some embodiments, the computer system and/or another computer system selects the one or more automatically selected parameter values based on the first section of code and/or another section of code. In some embodiments, the sub element of the one or more sub elements is generated (e.g., by an artificial intelligence (e.g., “AI”) process or a generative AI process) based on one or more parameter values defined in the first section of code and/or another section of code corresponding to (e.g., directed to, at a location of, related to and/or associated with) and/or associated with the first section of code. In some embodiments, a sub element of the one or more sub elements is generated (e.g., by an artificial intelligence (e.g., “AI”) process or a generative AI process) based on one or more parameter values defined in the first section of code and/or another section of code corresponding to (e.g., directed to, at a location of, related to and/or associated with) and/or associated with the first section of code. In some embodiments, the user interface element is based on one or more parameters generated (e.g., by an artificial intelligence (e.g., “AI”) process or a generative AI process) and/or determined after and/or in response to detecting the input corresponding to the request to generate the auxiliary code that corresponds to the first section of code. In some embodiments, displaying the visual indication includes displaying, via the display generation component, the sub element. Displaying a user interface element including one or more sub elements generated based on one or more automatically selected parameter values enables the computer system to provide a visual indication of specific parameters that are not explicitly defined in the code, thereby performing an operation when a set of conditions has been met without requiring further user input, reducing the number of inputs needed to perform an operation, and/or providing improved visual feedback to the user.

In some embodiments, the one or more automatically selected parameters includes text content (e.g., a text string, and/or text file). In some embodiments, the sub element (e.g., 648a2 and/or 648a3) includes a representation (e.g., text, images, and/or videos) of the text content (e.g., as described above with respect to FIG. 6V). In some embodiments, the sub element includes the text content. In some embodiments, displaying the visual indication includes displaying, via the display generation component, the text content and/or the representation of the text content.

In some embodiments, the one or more automatically selected parameters includes graphical content (e.g., color, pattern, and/or icon). In some embodiments, the sub element (e.g., 648a2 and/or 648a3) includes a representation (e.g., text, images, and/or videos) of the graphical content (e.g., as described above with respect to FIG. 6V). In some embodiments, the sub element includes the graphical content. In some embodiments, displaying the visual indication includes displaying, via the display generation component, the graphical content and/or the representation of the graphical content.

In some embodiments, the one or more automatically selected parameters includes a size (e.g., dimension and/or scale). In some embodiments, the sub element (e.g., 648a2 and/or 648a3) (and/or the user interface element) (and/or the visual indication) is displayed at the size (e.g., as described above with respect to FIG. 6V).

In some embodiments, a parameter of the one or more automatically selected parameters is selected (e.g., using an AI process or a generative AI process) based on contextual data (e.g., parameter name and/or defined parameter range) corresponding to (e.g., directed to, at a location of, related to and/or associated with) the first section of code (e.g., as described above with respect to FIG. 6V). Displaying a user interface element based on a parameter selected based on contextual data enables the computer system to automatically illustrate the effects of parameters with automatically specified parameters of the code based on context, thereby performing an operation when a set of conditions has been met without requiring further user input, reducing the number of inputs needed to perform an operation, and/or providing improved visual feedback to the user.

In some embodiments, a parameter of the one or more automatically selected parameters is selected by an artificial intelligence (e.g., “AI”) process (e.g., or a generative AI process). In some embodiments, the artificial intelligence process is without user input. In some embodiments, the artificial intelligence process is of the computer system and/or of another computer system different from the computer system. In some embodiments, the artificial intelligence process is an artificial intelligence process (e.g., large language model and/or generative artificial intelligence process). Displaying a user interface element based on a parameter selected by an artificial intelligence process enables the computer system to automatically illustrate the effects of parameters with automatically specified parameters using artificial intelligence processes, thereby performing an operation when a set of conditions has been met without requiring further user input, reducing the number of inputs needed to perform an operation, and/or providing improved visual feedback to the user.

In some embodiments, the visual indication of the result of running the second section of code (e.g., 684e) is a first visual indication (e.g., 682b). In some embodiments, the one or more automatically selected parameter values is a first set of one or more automatically selected parameter values. In some embodiments, in response to (and/or after) detecting the input (e.g., 605ab) corresponding to the request to generate the auxiliary code that corresponds to the first section of code (e.g., 640e), the computer system displays, via the display generation component, concurrently with the first visual indication, at least a portion of a second visual indication (e.g., a preview, a user-interface preview, a representation, a visual representation, a selectable user interface element, an icon, a widget, a control, a button, a user interface, and/or a window) of a result of running (and/or executing) a third section of code (e.g., automatically-generated code and/or generative code) (e.g., in response to and/or after generating the third section of code), wherein the third second of code was generated (e.g., using an AI process or a generative AI process) based on the request to generate the auxiliary code, wherein the second visual indication includes another sub element (e.g., a preview, a user-interface preview, a representation, a visual representation, a selectable user interface element, an icon, a widget, a control, and/or a button) different from the sub element, and wherein the other sub element is generated based on a second set of one or more automatically selected parameter values different from the first set of one or more automatically selected parameter values (e.g., as described above with respect to FIG. 6V). In some embodiments, the third section of code is generated based on the first section of code. In some embodiments, the third section of code is based on the third section of code. In some embodiments, the third section of code is a result of running and/or executing the first section of code, the second section of code, the third section of code, and/or another section of code different from the first section of code, the second section of code, and the third section of code. In some embodiments, the computer system displays concurrently with the first visual indication the at least the portion of the second visual indication of the result of running the third section of code and one or more other visual indications, each other visual indication being a result of running (and/or executing) a different section of code (e.g., generated based on the first section of code). In some embodiments, the another sub element is a portion of the second visual indication. In some embodiments, the second set of one or more automatically selected parameter values is not defined in the first section of code. In some embodiments, the second set of one or more automatically selected parameter values is not defined in code associated with and/or corresponding to the first section of code (e.g., code developed by the same developer as the first section of code). In some embodiments, the computer system and/or another computer system selects the second set of one or more automatically selected parameter values based on the first section of code and/or another section of code. Concurrently displaying a portion of a visual indication of a result of running a section of code in response to detecting an input corresponding to a request to generate auxiliary code that corresponds to another section of code enables the computer system to display different user interface elements for multiple different parameters, thereby performing an operation when a set of conditions has been met without requiring further user input, reducing the number of inputs needed to perform an operation, and/or providing improved visual feedback to the user.

In some embodiments, in response to detecting the input corresponding to the request to generate the auxiliary code that corresponds to the first section of code (e.g., 640e) and before displaying the user interface element (and/or the visual indication) (and/or while generating and/or loading the user interface element), the computer system displays, via the display generation component, an animation (e.g., 662) (e.g., movement of another user interface element, and/or a series of user interface elements) corresponding to (e.g., directed to, at a location of, related to and/or associated with) generating (e.g., using an AI process or a generative AI process) (and/or loading) the user interface element. In some embodiments, in response to detecting the input corresponding to the request to generate the auxiliary code that corresponds to the first section of code and in accordance with a determination that the user interface element has loaded, the computer system ceases display of the animation. In some embodiments, after, in response to, and/or in conjunction with displaying the user interface element, the computer system forgoes display of the animation. In some embodiments, another user interface element includes a selectable user interface element, an icon, a widget, a control, a button, a user interface, and/or a window. In some embodiments, the animation is a generation animation. Displaying an animation corresponding to generating a user interface element in response to detecting an input corresponding to a request to generate auxiliary code that corresponds to a section of code enables the computer system to display a representation of the status of running and generating the code as directed by the user, thereby reducing the number of inputs needed to perform an operation, and/or providing improved visual feedback to the user.

In some embodiments, the user interface element is a first user interface element. In some embodiments, while displaying the first user interface element, the computer system detects (and/or receives), via the one or more input devices (e.g., 652, 652a, 652b, 652c, 652d, 652e, and/or 652f), an input corresponding to (e.g., directed to, at a location of, related to and/or associated with) a request to navigate to another user interface element generated (e.g., by an artificial intelligence (e.g., “AI”) process or a generative AI process) based on the first section of code (e.g., 640e) (e.g., as described above with respect to FIG. 6V). In some embodiments, the input corresponding to the request to navigate to another user interface element includes a swipe input to the left on the display generation component. In some embodiments, the input corresponding to the request to navigate to another user interface element includes an air gesture swiping to the right on the display generation component. In some embodiments, in response to detecting the input corresponding to the request to navigate to another user interface element generated based on the first section of code, the computer system displays, via the display generation component, a second user interface element (e.g., a selectable user interface element, an icon, a widget, a control, a button, a user interface, and/or a window), different from the first user interface element, corresponding to (e.g., directed to, at a location of, resulting from, related to and/or associated with) running a fourth section of code that is different from the first section of code and the second section of code (e.g., 684e) and was generated (e.g., by an artificial intelligence (e.g., “AI”) process or a generative AI process) based on the first section of code, wherein the second user interface element was not previously displayed prior to detecting the input corresponding to the request to navigate to another user interface element generated based on the first section of code (e.g., as described above with respect to FIG. 6V). In some embodiments, the second user interface element includes at least a portion of the second user interface element. In some embodiments, a first portion of the second user interface element but not a second portion, different from the first portion, of the second user interface element was previously displayed prior to detecting the input corresponding the request to navigate to another user interface element generated based on the first section of code. Displaying a user interface element in response to detecting an input corresponding to a request to navigate to another user interface element generated based on a section of code enables the computer system to display different examples that were generated based on a specified section of code as directed by the user, thereby reducing the number of inputs needed to perform an operation and/or providing improved visual feedback to the user.

In some embodiments, while displaying the user interface element, the computer system displays, via the display generation component, a control (e.g., an affordance, a button, and/or an add user interface element) for adding the second section of code (e.g., 684e) to code including the first section of code (e.g., 640e). In some embodiments, while displaying the control for adding the second section of code to code including the first section of code, the computer system detects (and/or receives), via the one or more input devices (e.g., 652, 652a, 652b, 652c, 652d, 652e, and/or 652f), an input corresponding to (e.g., directed to, at a location of, related to and/or associated with) the control for adding the second section of code to code including the first section of code (e.g., as described above with respect to FIG. 6V). In some embodiments, the input corresponding to the control for adding the section of code to the code includes a mouse click and/or a tap input the control for adding the second section of code to the code. In some embodiments, input corresponding to the control for adding the section of code to the code includes a mouse click and movement of a mouse and/or a tap and movement input from the control to a position of the code where the second section of code is requested to be added. In some embodiments, in response to detecting the input corresponding to the control for adding the second section of code to code including the first section of code, the computer system adds the second section of code to the code including the first section of code (e.g., as described above with respect to FIG. 6V) (and/or displays, via the display generation component, the second section of code within the code including the first section of code). Adding a section of code to code in response to detecting an input corresponding to a control for adding the section of code enables the computer system to automatically add generated sections of code to the code as directed by the user, thereby reducing the number of inputs needed to perform an operation, providing additional control options without cluttering the user interface with additional displayed control, and/or providing improved visual feedback to the user.

In some embodiments, in response to (and/or after) detecting the input corresponding to the control for adding the second section of code (e.g., 684e) to code including the first section of code (e.g., 640e), the computer system ceases display of the user interface element (e.g., as described above with respect to FIG. 6X). Ceasing to display a user interface element in response to detecting an input corresponding to a control for adding a section of code to code enables the computer system to remove user interface elements corresponding to previous code, thereby reducing the number of inputs needed to perform an operation, providing additional control options without cluttering the user interface with additional displayed control, and/or providing improved visual feedback to the user.

In some embodiments, the user interface element is a first user interface element. In some embodiments, in response to (and/or after) detecting the input corresponding to the control for adding the second section of code (e.g., 684e) to code including the first section of code (e.g., 640e), the computer system displays, via the display generation component, a second user interface element, different from the first user interface element, in place of the first user interface element (e.g., as described above with respect to FIG. 6X) (and/or at a location where the first user interface element was displayed while detecting the input corresponding to the control for adding the second section of code to code including the first section of code). In some embodiments, the new user interface is a result of running (and/or executing) a fifth section of code that is different from the first section of code and the second section of code and was generated based on the first section of code. In some embodiments, in conjunction with displaying the second user interface element, the computer system ceases display of the first user interface element. Displaying a user interface element in response to detecting an input corresponding to a control for adding a section of code to code including another section of code enables the computer system to display different user interface elements for adding to the code as directed by the user (and/or without displaying user interface elements to code that were already added), thereby reducing the number of inputs needed to perform an operation, providing additional control options without cluttering the user interface with additional displayed control, and/or providing improved visual feedback to the user.

In some embodiments, in response to detecting the input corresponding to the request to generate the auxiliary code that corresponds to the first section of code (e.g., 640e), the user interface element has an appearance that is generated (e.g., by an artificial intelligence (e.g., “AI”) process or a generative AI process) based on a first target device (e.g., as described above with respect to FIGS. 6Y-6Z) (e.g., tablet, smart phone, computer, head-mounted display, and/or wearable device). In some embodiments, the first target device is a first selected target device, a currently selected target device, a first type of target device, a first selected type of target device, a currently selected type of target device. In some embodiments, the first target device changes the appearance that is generated, including changing the size, layout, and/or aspect ratio of the user interface element (and/or the user interface). Displaying a user interface element with an appearance that is generated based on a target device in response to detecting an input corresponding to a request to generate auxiliary code that corresponds to a section of code enables the computer system to display the results of running the second section of code in the context of intended devices as directed by the user, thereby reducing the number of inputs needed to perform an operation and/or providing improved visual feedback to the user.

In some embodiments, while displaying the user interface element with the appearance that is generated based on the first target device, the computer system detects (and/or receives), via the one or more input devices (e.g., 652, 652a, 652b, 652c, 652d, 652e, and/or 652f), a set of one or more inputs (e.g., 605y) corresponding to (e.g., directed to, at a location of, related to and/or associated with) a request to change a currently selected target device (e.g., for the user interface element). In some embodiments, in response to detecting the set of one or more inputs corresponding to the request to change the currently selected target device, the computer system displays, via the display generation component, the user interface element with an appearance that is generated based on a second target device different from the first target device (e.g., as described above with respect to FIGS. 6Y-6Z). In some embodiments, the user interface element with the appearance that is generated (e.g., by an artificial intelligence (e.g., “AI”) process or a generative AI process) based on the second target device is a result of running (and/or executing) a section of code that is different from the first section of code, the second section of code, the third section of code, and/or the fourth section of code and was generated based on the first section of code. In some embodiments, the second target device changes the appearance that is generated, including changing the size, layout, and/or aspect ratio of the user interface element (and/or the user interface). Displaying a user interface element with an appearance that is generated based on a target device different from a previous target device in response to detecting a set of one or more inputs corresponding to a request to change a currently selected target device enables the computer system to display different results of running the second section of code for different intended devices as directed by the user, thereby reducing the number of inputs needed to perform an operation, providing additional control options without cluttering the user interface with additional displayed control, and/or providing improved visual feedback to the user.

In some embodiments, the second section of code (e.g., 684e) is a test (e.g., test code, preview code, exemplary code, additional code, script, and/or a set of one or more software instructions) for the first section of code (e.g., 640e). In some embodiments, the test for the first section of code includes changing content (e.g., parameters, variables, and/or functions) of the first section of code. In some embodiments, the test for the first section of code includes testing portions of the first section of code (e.g., portions that are functions and/or portions that are variables).

In some embodiments, after (and/or in response to) running the second section of code (e.g., 684e) and while displaying (and/or continuing to display) the first section of code (e.g., 640e), the computer system displays, via the display generation component, an indicator (e.g., 682b) (e.g., a coverage indicator, a user interface element, a selectable user interface element, an icon, a control, and/or a button) to indicate that the test corresponds to the first section of code. In some embodiments, the indicator is displayed at a location corresponding to, associated with, and/or adjacent to the first section of code. In some embodiments, the indicator is not displayed at a location corresponding to, associated with, and/or adjacent to another section of code different from the first section of code. In some embodiments, displaying the indicator to indicate that the test corresponds to the first section of code includes updating display of an indicator corresponding to (e.g., directed to, at a location of, related to and/or associated with) the first section of code from a first state (e.g., a first numerical value) to a second state (e.g., a second numerical value greater than (e.g., by one or more than one, depending on a number of tests executed in response to detecting the input corresponding to the request to generate the auxiliary code that corresponds to the first section of code) the second numerical value) different from the first state. Displaying an indicator to indicate that a test corresponds to a section of code after running another section of code and while displaying the section of code enables the computer system display for the section of code the result of running the other section of code (and/or and therefore the likelihood the section of code is valid code), thereby reducing the number of inputs needed to perform an operation and/or providing improved visual feedback to the user.

In some embodiments, in response to detecting the input corresponding to the request to generate the auxiliary code that corresponds to the first section of code (e.g., 640e) and in accordance with a determination that a set of one or more coverage indicators (e.g., 682a and/or 628c) (e.g., a coverage bar) is disabled while detecting the input corresponding to the request to generate the auxiliary code that corresponds to the first section of code, the computer system displays, via the display generation component, (and/or enables) the set of one or more coverage indicators in conjunction with displaying the indicator (e.g., 628b) to indicate that the test corresponds to the first section of code (e.g., the set of one or more coverage indicators is not displayed while and/or before detecting the input corresponding to the request to generate the auxiliary code that corresponds to the first section of code). In some embodiments, in response to detecting the input corresponding to the request to generate the auxiliary code that corresponds to the first section of code and in accordance with a determination that the set of one or more coverage indicators is enabled while detecting the input corresponding to the request to generate the auxiliary code that corresponds to the first section of code, the computer system maintains display of, via the display generation component, the set of one or more coverage indicators in conjunction with displaying the indicator to indicate that the test corresponds to the first section of code. Maintaining display of a set of one or more coverage indicators in conjunction with displaying an indicator to indicate that a test corresponds to a section of code in accordance with a determination that the set of one or more coverage indicators is enabled while detecting an input corresponding to a request to generate auxiliary code that corresponds to the section of code enables the computer system to display an indication of the success and/or failure of testing the second section of code after testing the second section of code as directed by the user (e.g., when the user requests it), thereby reducing the number of inputs needed to perform an operation and/or providing improved visual feedback to the user.

In some embodiments, while displaying the set of one or more coverage indicators, the computer system detects (and/or receives), via the one or more input devices (e.g., 652, 652a, 652b, 652c, 652d, 652e, and/or 652f), a set of one or more user inputs (e.g., 605ac) corresponding to (e.g., directed to, at a location of, related to and/or associated with) a portion (e.g., 682c) (e.g., a coverage indicator) of the set of one or more coverage indicators, wherein the portion of the set of one or more coverage indicators corresponds to a third section of code (e.g., as described above with respect to FIGS. 6AE-6AF). In some embodiments, in response to detecting the set of one or more user inputs corresponding to the portion of the set of one or more coverage indicators, the computer system displays, via the display generation component, a fourth section of code (e.g., 684e) (e.g., a test for the third section of code) that is different from the third section of code and was generated (e.g., by an artificial intelligence (e.g., “AI”) process or a generative AI process) based on the third section of code (e.g., as described above with respect to FIGS. 6AE-6AF). In some embodiments, in response to detecting the set of one or more user inputs corresponding to the portion of the set of one or more coverage indicators, the computer system displays (e.g., concurrently with the third section of code), via the display generation component, a visual indication of a result of running (and/or executing) (e.g., in response to and/or after generating the fourth section of code) the third section of code. Displaying a section of code that is different from another section of code and was generated based on yet another section of code in response to detecting a set of one or more user inputs corresponding to a portion of a set of one or more coverage indicators enables the computer system to test additional sections of code as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the set of one or more coverage indicators is displayed concurrently with the fourth section of code (e.g., automatically-generated code and/or generative code) (e.g., 684e) and the third section of code (e.g., automatically-generated code and/or generative code) (e.g., as described above with respect to FIGS. 6AE-6AF) (e.g., after and/or in response to detecting the set of one or more user inputs corresponding to the portion of the set of one or more coverage indicators).

In some embodiments, the second section of code (e.g., automatically-generated code and/or generative code) (e.g., 684e) is displayed in a first region (e.g., 684) (e.g., a user interface, an area, and/or a user interface element) adjacent to a third section of code (e.g., automatically-generated code and/or generative code) (e.g., project code and/or a larger section of code) that includes the first section of code (e.g., 640). In some embodiments, the third section of code is displayed in a second region (e.g., a user interface, an area, and/or a user interface element) (e.g., of an editing user interface) different from the first region. In some embodiments, the first region is of an editing user interface.

In some embodiments, the second section of code (e.g., automatically-generated code and/or generative code) (e.g., 684e) is generated (e.g., by an artificial intelligence (e.g., “AI”) process or a generative AI process) by an artificial intelligence (e.g., “AI”) process (e.g., or a generative AI process). In some embodiments, the artificial intelligence process is without user input. In some embodiments, the artificial intelligence process is of the computer system and/or of another computer system different from the computer system. In some embodiments, the artificial intelligence process is an artificial intelligence process (e.g., large language model and/or generative artificial intelligence process). Generating a section of code by an artificial intelligence process enables the computer system to automatically determine the section of code based on the section of code (and/or without additional user direction) as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the first section of code (e.g., 640e) is in the same programming language (e.g., scripting language, coding syntax, and/or code language) as the second section of code (e.g., 684e) (e.g., as described above with respect to FIG. 6AE).

Note that details of the processes described above with respect to process 800 (e.g., FIG. 8) are also applicable in an analogous manner to other processes described herein. For example, process 1000 optionally includes one or more of the characteristics of the various processes described above with reference to process 800. For example, displaying the second section of code generated based on a request to generate auxiliary code of method 800 can be the text to be added to with additional text of method 1000. For brevity, these details are not repeated herein.

FIGS. 9A-9X illustrate exemplary user interfaces for completing text using multiple electronic computer systems in accordance with some embodiments. The user interfaces in these figures are used to illustrate the processes described below, including the processes in FIGS. 10 and 11.

FIGS. 9A-9X illustrate computer system 600 as a desktop computer. It should be recognized that computer system 600 can be other types of computer systems, such as a smart phone, a smart watch, a tablet, a laptop, a communal device, an accessory, a personal gaming system, a laptop computer, a fitness tracking device, and/or a head-mounted display (HMD) device. Additionally, FIGS. 9A-9X illustrate keyboard 652, a physical keyboard that is connected to computer system 600. Keyboard 652 includes keys region 652a and touchpad 652f. Keys region 652a includes various typing keys corresponding to letters, numbers, symbols, and/or computer system commands. Computer system 600 displays typed content (e.g., for the purposes of this application, code) in response to detecting one or more inputs directed to the typing keys within keys region 652a. Keys region 652a also includes left arrow key 652b, up arrow key 652c, down arrow key 652d, and right arrow key 652e. In some embodiments, computer system 600 moves a text-insertion cursor (e.g., cursor indicator 654, described below) in response to detecting an input directed to left arrow key 652b, up arrow key 652c, down arrow key 652d, and/or right arrow key 652e. In some embodiments, computer system 600 moves a touchpad cursor and/or the text-insertion cursor and/or performs an operation in response to detecting an input directed to touchpad 652f.

In the examples described below with respect to FIGS. 9A-9X, computer system 600 displays user interface 602 (e.g., a code editing user interface). As illustrated in FIG. 9A, user interface 602 includes code region 696, and cursor indicator 654 (e.g., a cursor of computer system 600 that is moved based on input detected via touchpad 652f or a mouse).

Code region 696 is a region dedicated to displaying and/or editing code. Code region 696 includes code 640 (e.g., user-created code corresponding to a shopping application), text-insertion cursor indicator 686, intelligent coding control 622, and history control 900. Code 640 includes code corresponding to a current line. In some embodiments, text-insertion cursor indicator 686 is displayed to indicate a next place where characters will be added from typing. As illustrated in FIG. 9A, computer system 600 displays text-insertion cursor indicator 686 at the end of code 640 (e.g., more specifically, next to “fu”) to indicate that a user is in the middle of typing. In some embodiments, computer system 600 displays intelligent coding user interface elements in response to detecting an input (e.g., a mouse click, an air gesture, and/or a tap input) directed to intelligent coding control 622. In some embodiments, history user interface elements corresponding to the current line are displayed in response to detecting an input (e.g., a mouse click, an air gesture, and/or a tap input) directed to history control 900.

As illustrated in FIG. 9A, computer system 600 displays cursor indicator 654 as a “mouse” cursor. In some embodiments, computer system 600 displays cursor indicator 654 in another form (e.g., a typing cursor and/or another shape). Code region 696 is a region dedicated to displaying and/or editing code. Code region 696 includes code 640 (e.g., user-created code corresponding to a shopping application). It should be recognized that more, fewer, and/or different elements can be included in user interface 602.

FIGS. 9A-9L illustrate a process where computer system 600 offers proposed text and/or autocompleted text for incomplete code. Proposed text is generated text added to code 640 by an automated process, such as a large language model or generative artificial intelligence. In some embodiments, proposed text takes into account other text and/or comments in code 640 and/or other files. For example, proposed text can include function calls with variables from code 640 inserted intelligently into the function calls. Autocompleted text, on the other hand, is recommended text, often referred to as “suggestions” to be added to code 640. Unlike proposed text, autocompleted text is not necessarily created by an automated process. Instead, it is based on existing code samples and/or data available to the computer system. For example, predictive typing provides suggestions based on the user's input, while advanced AI systems generate complete phrases or sentences. In some embodiments, autocompleted text takes into a current line and/or what a user is currently typing and provides suggestions that match. For example, variable names and/or function calls that match a first few types characters can be suggested in autocompleted text.

At FIG. 9A, computer system 600 detects key input 905a1, key input 905a2, and key input 905a3 directed to keys within keys region 652a (e.g., multiple key inputs on a physical keyboard, multiple tap inputs on a virtual keyboard, or a voice input). In response to detecting key input 905a1, key input 905a2, and key input 905a3, computer system 600 begins filling code 640 with the entered typing. In some embodiments, key input 905a1, key input 905a2, and key input 905a3 are voice commands (e.g., the user vocally instructs computer system 600 on what code they want entered into the). At FIG. 9A, computer system 600 detects horizontal rightward input 905a4 directed to touchpad 652f. It should be recognized that other types of inputs can be used instead of rightward input 905a4, such as movement of a mouse or an air gesture.

In between FIGS. 9A and 9B, computer system 600 detects that the user finished typing. In response to detecting that the user finished typing, computer system 600 displays additional code within code 640 (e.g., “func apply”). As part of detecting that the user finished typing, text-insertion cursor indicator 686 is displayed at the end of the entered code. At FIG. 9B, computer system 600 displays autocompleted text (e.g., computer system 600 displays code suggestions based on the current line) and proposed text. Autocompleted text is recommended text (e.g., “suggestions”) to be added to code 640. In some embodiments, it should be recognized that the one or more options of autocompleted text can be generated based on text in the text entry field. Additionally, the one or more options of autocompleted text can be generated based on different files and/or different text than that in the text entry field. Furthermore, the one or more options of autocompleted text can be generated without the computer system detecting, via the one or more input devices, an input (e.g., a mouse click, an air gesture, and/or a tap input) corresponding to the text in the text entry field (and/or after the input corresponding to the request to add additional text to the text entry field).

Additionally, as illustrated in FIG. 9B, computer system 600 displays proposed text within code 640 (e.g., computer system 600 displays “(_coupon:)” in the same line of code as “func apply”). As illustrated in FIG. 9B, the proposed text is displayed as greyed text adjacent to cursor indicator 686 to indicate that the proposed text has not been accepted into code 640. In some embodiments, the proposed text is generated based on code recognition, which predicts a specific outcome based on the entered code. In other embodiments, the proposed text is generated based on historical data, comments within the current line, and/or external sources such as information from the internet.

As illustrated in FIG. 9B, computer system 600 displays autocompletion region 902 while displaying the preview of the proposed code in code 640. Computer system 600 displays autocompletion region 902 to indicate autocompleted text based on the entered code within code 640. Autocompleted text includes suggestions for additional code. However, the autocompleted text does not include specific variables for features as generated by proposed text and illustrated in FIG. 9B. As illustrated in FIG. 9B, autocompletion region 902 includes suggestion 902a (e.g., “func apply(_coupon:)”), suggestion 902b (e.g., “func apply(_img:)”), and suggestion 902c (e.g., “func apply(_color:)”). In some embodiments, in response to an input (e.g., movement of a mouse or movement detected via touchpad 652f) to move cursor indicator 654 over a different suggestion than suggestion 902a (e.g., suggestion 902b and/or 902c) computer system 600 ceases display the proposed text “(_coupon:)” without adding the proposed text to code 640. In some embodiments, in response to an input (e.g., movement of a mouse or movement detected via touchpad 652f) to move cursor indicator 654 over the different suggestion, computer system 600 displays the autocompleted text in code 640. In some embodiments, in response to detecting a selection input (e.g., a mouse click, an air gesture, and/or a tap input) on suggestion 902a, suggestion 902b, or suggestion 902c, computer system 600 adds the corresponding suggestion of autocompleted text to code 640. In some embodiments, in response to detecting an input (e.g., a mouse click, an air gesture, and/or a tap input) on suggestion 902a, computer system 600 ceases displaying proposed text “_coupon:” and displays code corresponding to suggestion 902a. In some embodiments, the variable added by the autocompleted text is substituted for proposed text.

In some embodiments, where the selection input is on suggestion 902b or suggestion 902c, computer system 600 adds the function of the respective suggestion to code 640. For example, in response to detecting an input (e.g., a mouse click, an air gesture, and/or a tap input) on suggestion, computer system 600 completes the entire function (e.g., more than one line of code) with proposed text to complete the suggested autocompleted text illustrated at FIG. 9B. In some embodiments, autocompleted text are ordered based off of relevance to the entered code (e.g., at FIG. 9B, computer system 600 makes a determination that suggestion 902a is the most relevant to the current line, and, in response, displays suggestion 902a at the top of autocompletion region 902). In some embodiments, computer system 600 displays autocompletion region 902 in response to a determination that the entered code satisfies the set of criteria (e.g., described above) that makes it eligible for autocompleted text.

As illustrated in FIG. 9B, in response to detecting horizontal rightward input 905a4, computer system 600 moves cursor indicator 654 over suggestion 902a. At FIG. 9B, computer system 600 detects, via touchpad 652f, selection input 905b1 (e.g., a mouse click, an air gesture, and/or a tap input) directed to suggestion 902a. At FIG. 9B, computer system 600 detects vertical leftward input 905b2 directed to touchpad 652f. It should be recognized that other types of inputs can be used instead of vertical leftward input 905b2, such as movement of a mouse or an air gesture. At FIG. 9B, computer system 600 detects key input 905b3 directed to “tab” key 652h within keys region 652a.

As illustrated in FIG. 9C, in response to detecting selection input 905b1, computer system 600 adds the autocompleted text to suggestion 902a to code 640 (e.g., “func apply(_coupon:)”). As part of adding the code corresponding to suggestion 902a to code 640, computer system 600 displays the added code with a black coloration (e.g., computer system 600 ceases displaying the proposed code with a grey coloration). Additionally, computer system 600 moves text-insertion cursor indicator 686 to the next line in the code. As illustrated in FIG. 9C, in response to adding the code corresponding to suggestion 902a to code 640, computer system 600 ceases display of autocompletion region 902. In an alternate embodiment, in response to detecting key input 905b3 directed to “tab” key 652h, computer system 600 adds the proposed code that was gray in code 640 in FIG. 9B. In some embodiments, key input 905b3 is a voice command (e.g., “Add that.”). As illustrated in FIG. 9C, in response to detecting vertical leftward input 905b2, computer system 600 moves cursor indicator 654 to the side of code 640.

At FIG. 9C, computer system 600 detects key input 905c1, key input 905c2, and key input 905c3 directed to keys within keys region 652a (e.g., multiple key inputs on a physical keyboard, multiple tap inputs on a virtual keyboard, or a voice input). In response to detecting key input 905c1, key input 905c2, and key input 905c3, computer system 600 begins filling code 640 with the entered typing. In some embodiments, key input 905c1, key input 905c2, and key input 905c3 are voice commands (e.g., the user vocally instructs computer system 600 on what code they want entered into the current line).

In between FIGS. 9C and 9D, computer system 600 detects that the user finished typing. In response to detecting that the user finished typing, computer system 600 displays additional code within code 640 (e.g., “func start”). As part of detecting that the user finished typing, text-insertion cursor indicator 686 is displayed at the end of the entered code. At FIG. 9D, computer system 600 makes a determination that the entered code satisfies a set of criteria that makes it eligible for proposed text but not autocompleted text. It should be recognized that autocompleted text could be included in FIG. 9D in some embodiments.

As illustrated in FIG. 9D, computer system 600 displays a preview of proposed text within code 640 (e.g., computer system 600 displays “Checkout ( )->Int {” in the same line of code as “func start”) that generates a completion of the line of code. As illustrated in FIG. 9D, the preview of the proposed text is displayed as greyed text to indicate that the proposed text has not been accepted into code 640. In some embodiments, the proposed text is generated by an automated process (e.g., large language model and/or generative artificial intelligence process). It should be recognized that the proposed text can be based off of code recognition (e.g., the entered code is predicted to result in a specific typed outcome), history (e.g., computer system 600 determines that the entered code has been entered before within the current line and generates the proposed text based on previously entered code), comments within the current line (e.g., including code 640), and/or external sources (e.g., the internet). In some embodiments, computer system 600 generates the proposed text through an automated process. In some embodiments, computer system 600 displays the proposed text in response to a determination that the entered code satisfies a set of criteria that makes it eligible for proposed text. In some embodiments, the set of criteria includes criteria that are satisfied based on code recognition, history, comments within the current line, and/or external sources (e.g., as described above). In some embodiments, computer system 600 determines the criteria are satisfied. In some other embodiments, computer system 600 receives an indication that the criteria are satisfied.

As illustrated in FIG. 9D, computer system 600 displays more control 904 at the end of the code preview. In some embodiments, computer system 600 displays more control 904 when additional lines of the proposed text are available and/or generated to complete the function of the code. In some embodiments, in response to detecting an input (e.g., a mouse click, an air gesture, and/or a tap input) directed to more control 904, computer system 600 displays multiple hidden lines of additional code corresponding to the proposed text (e.g., in some embodiments, the proposed text is one line of code (e.g., as illustrated in FIG. 9C) and in some embodiments, the proposed text is multiple lines of code). In some embodiments, in response to detecting an input (e.g., a mouse click, an air gesture, and/or a tap input) to the option key within keys region 652a, computer system 600 ceases display of more control 904 and displays a preview of multiple lines of code corresponding to the proposed text. At FIG. 9D, computer system 600 detects key input 905d directed to “tab” key 652h within keys region 652a. In some embodiments, key input 905d is a voice command (e.g., “Add that.”).

As illustrated in FIG. 9E, in response to detecting key input 905d, computer system 600 adds the code corresponding to the preview to code 640 (e.g., “func start Checkout ( )->Int {”). As part of adding the code corresponding to the preview to code 640, computer system 600 displays the added code with a black coloration (e.g., computer system 600 ceases displaying the added code with a grey coloration as it is added into code 640). Additionally, computer system 600 moves text-insertion cursor indicator 686 to the next line in the code (e.g., before the code preview). As illustrated in FIG. 9E, in response to adding the code corresponding to the preview to code 640 (e.g., “func start Checkout ( )->Int {”), computer system 600 displays another line of preview code corresponding to proposed text (e.g., “let finalPrice”) following text-insertion cursor indicator 686. In some embodiments, an additional key input (e.g., similar to and/or the same as 905d) is detected and computer system 600 adds the preview code to code 640. As part of displaying another line of preview code, computer system 600 displays more control 904 at the end of the code preview. At FIG. 9E, computer system 600 detects key input 905e directed to “option” key 652g within keys region 652a. In some embodiments, key input 905e directed to “option” key 652g is a hold input (e.g., the user holds the option key down). In some embodiments, key input 905e is a selection input directed to more control 904.

As illustrated in FIG. 9F, in response to detecting key input 905e, computer system 600 displays an expanded preview (e.g., multiple lines) of proposed text including additional lines of generated code. As illustrated in FIG. 9F, the expanded preview of the proposed text is displayed as greyed text to indicate that the proposed text has not been accepted into code 640. At FIG. 9F, computer system 600 detects key input 905f directed to “tab” key 652h within keys region 652a. In some embodiments, key input 905f is a voice command (e.g., “Add the next line of code.”).

As illustrated in FIG. 9G, in response to detecting key input 905f, computer system 600 adds the code corresponding to the first line of the expanded preview of the proposed text in code 640 (e.g., “let finalPrice”). As part of adding the code corresponding to the preview of the proposed text in code to code 640, computer system 600 displays the added code with a black coloration (e.g., computer system 600 ceases displaying the added code with a grey coloration as it is added into code 640). Additionally, computer system 600 moves text-insertion cursor indicator 686 to the next line in the expanded preview. At FIG. 9G, computer system 600 detects key input 905g directed to “tab” key 652h within keys region 652a. In some embodiments, key input 905g is a voice command (e.g., “Add the next line of code.”).

As illustrated in FIG. 9H, in response to detecting key input 905g, computer system 600 adds the code corresponding to the second line of the expanded preview of proposed text to code 640 (e.g., “=products.reduce (0) {price, product in”). As part of adding the code corresponding to the preview of proposed text to code 640, computer system 600 displays the added code with a black coloration (e.g., computer system 600 ceases displaying the added code with a grey coloration as it is added into code 640). Additionally, computer system 600 moves text-insertion cursor indicator 686 to the next line in the expanded preview. At FIG. 9H, computer system 600 detects key input 905h1 directed to “tab” key 652h within keys region 652a. At FIG. 9H, computer system 600 detects key input 905h2 directed to “Option” key 652g within keys region 652a. In some embodiments, key input 90h1 and key input 905h2 are detected at the same time. In some embodiments, key input 90h1 and key input 905h2 are a voice command (e.g., “Add all lines of code.”).

As illustrated in FIG. 9I, in response to detecting key input 905h1 and key input 605h2, computer system 600 adds the remaining lines of code corresponding to the expanded preview of proposed text to code 640. As part of adding the remaining lines of code corresponding to the preview of proposed text to code 640, computer system 600 displays the remaining lines of code with a black coloration (e.g., computer system 600 ceases displaying the remaining lines of code with a grey coloration as they are added into code 640). Additionally, as part of adding the remaining lines of code corresponding to the preview of proposed text to code 640, computer system 600 ceases to display the top line of code 640 to make room in the display for the added lines of code. As illustrated in FIG. 9I, computer system 600 moves text-insertion cursor indicator 686 to the next line in code 640.

At FIG. 9I, computer system 600 detects key input 905i1, key input 905i2, and key input 905i3 directed to keys within keys region 652a (e.g., computer system 600 detects that the user is typing). In response to detecting key input 905i1 (e.g., a key press input, and/or a keyboard input), key input 905i2 (e.g., a key press input, and/or a keyboard input), and key input 905i3 (e.g., a key press input, and/or a keyboard input), computer system 600 begins filling code 640 with the entered typing. In some embodiments, key input 905i1, key input 905i2, and key input 905i3 are voice commands (e.g., the user vocally instructs computer system 600 on what code they want entered into the). At FIG. 9I, computer system 600 detects vertical input 905i4 directed to touchpad 652f.

In between FIGS. 9I and 9J, computer system 600 detects that the user finished typing. In response to detecting that the user finished typing, computer system 600 displays additional code within code 640 (e.g., “=Double (finalPrice)”). As part of detecting that the user finished typing, text-insertion cursor indicator 686 is displayed at the end of the entered code. At FIG. 9J, computer system 600 makes a determination that the entered code satisfies a set of criteria that makes it eligible for proposed text and autocompleted text.

As illustrated in FIG. 9J, in response to making a determination that the entered code satisfies a set of criteria that makes it eligible for proposed text and autocompleted text, computer system 600 displays suggestion region 946. Computer system 600 displays suggestion region 946 to indicate autocompleted text suggestions based off of the entered code within code 640 (e.g., because the entered code is different than the entered code seen in FIG. 9J, computer system 600 displays new suggestions). As illustrated in FIG. 9J, suggestion region 946 includes suggestion 946a (e.g., “=Double (finalPrice)*Double (multiplier)”), suggestion 946b (e.g., “=Double (finalPrice)−Double (discountAmount)”), and suggestion 946c (e.g., ““=Double (finalPrice)+Double (taxAmount)”).

Additionally, as illustrated in FIG. 9J, computer system 600 displays proposed text within code 640 (e.g., computer system 600 displays “*Double (multiplier)” in the same line of code as “=Double (finalPrice)”) to propose a completion of the line of code. As illustrated in FIG. 9J, the proposed text is displayed as greyed text to indicate that the proposed text has not been accepted into code 640.

As illustrated in FIG. 9J, in response to detecting vertical input 905i4, computer system 600 moves cursor indicator 654 over suggestion 946a. At FIG. 9J, computer system 600 detects, via touchpad 652f, selection input 905j1 (e.g., a mouse click, an air gesture, and/or a tap input) directed to suggestion 946a. At FIG. 9J, computer system 600 detects key input 905j2 directed to “tab” key 652h within keys region 652a. At FIG. 9J, computer system 600 detects vertical input 905j3 directed to touchpad 652f. For example, vertical input 605u can be a vertical input detected via touchpad 652f from one location to another. It should be recognized that other types of inputs can be used instead of vertical input 605u, such as movement of a mouse, an air gesture moving from one location to another, or a tap input at a final location.

As illustrated in FIG. 9K, in response to detecting selection input 905j1, computer system 600 adds the code corresponding to suggestion 946a to code 640 (e.g., “=Double (finalPrice)*Double (multiplier)”). In some embodiments, computer system 600 adds the code corresponding to suggestion 946a to code 640 in response to detecting key input 905j2. As illustrated in FIG. 9, in response to detecting vertical input 905i4, computer system 600 moves cursor indicator 654 to the right of code 640.

As part of adding the code corresponding to suggestion 946a to code 640, computer system 600 displays the added code with a black coloration (e.g., computer system 600 ceases displaying the proposed code with a grey coloration). Additionally, computer system 600 moves text-insertion cursor indicator 686 to the next line in the code (e.g., before the expanded code preview). As illustrated in FIG. 9K, in response to adding the code corresponding to suggestion 946a to code 640, computer system 600 displays another line of preview code corresponding to proposed text (e.g., “return finalPrice-”) following text-insertion cursor indicator 686. As illustrated in FIG. 9K, the proposed text is displayed after the autocompleted text added from FIG. 9J. As part of displaying another line of preview code, computer system 600 displays more control 904 at the end of the code preview to indicate that there are multiple other lines of code in the code preview to complete the function.

At FIG. 9K, computer system 600 detects key input 905k1 directed to “tab” key 652h within keys region 652a. At FIG. 9K, computer system 600 detects key input 905k2 directed to “Option” key 652g within keys region 652a. In some embodiments, key input 90k1 and key input 905k2 are detected at the same time. In some embodiments, key input 90k1 and key input 905k2 are a voice command (e.g., “Add all lines of code.”). At FIG. 9K, computer system 600 detects downward vertical input 905k3 directed to touchpad 652f. For example, downward vertical input 905k3 can be a vertical input detected via touchpad 652f from one location to another. It should be recognized that other types of inputs can be used instead of downward vertical input 905k3, such as movement of a mouse, an air gesture moving from one location to another, or a tap input at a final location.

At FIG. 9L, in response to detecting key input 905k1 and key input 605k2, computer system 600 adds the remaining lines of code corresponding to the expanded preview to code 640 (e.g., though not illustrated in FIG. 9L because the length of the code is greater than the display can show, computer system 600 added multiple lines of code (e.g., as indicated by more control 904) into code 640). As illustrated in FIG. 9L, computer system 600 displays code 640 from the beginning of the code. At FIG. 9L, computer system 600 detects selection input 905l1 (e.g., a mouse click, an air gesture, and/or a tap input) directed to intelligent coding control 622.

At FIG. 9L, computer system 600 detects key input 905l2, key input 905l3, and key input 905l4 directed to keys within keys region 652a (e.g., multiple key inputs on a physical keyboard, multiple tap inputs on a virtual keyboard, or a voice input). In response to detecting key input 905l2, key input 905l3, and key input 905l4, computer system 600 begins filling a navigation bar corresponding to intelligent coding control 622. In some embodiments, key input 905l2, key input 905l3, and key input 905l4 are voice commands (e.g., the user vocally instructs computer system 600 on what prompt they want entered into the navigation bar corresponding to intelligent coding control 622). At FIG. 9L, computer system 600 detects horizontal rightward input 905l5 directed to touchpad 652f.

FIGS. 9M-9X illustrate a process where computer system 600 modifies code for a current line. As illustrated in FIG. 9M, in response to detecting selection input 905l1 directed to intelligent coding control 622, computer system 600 displays navigation bar 912. Navigation bar 912 includes code editing indicator 912a, pop-up control 912b, report control 912c, enter control 912d, and user entry 912e. Code editing indicator 912aa indicates that computer system 600, user interface 602, and/or an application corresponding to user interface 602 has entered into an editing state. While in an editing state, computer system 600 displays one or more prompts (e.g., prompt 906, prompt 908, and prompt 910) to aid a user with editing their code. In some embodiments, computer system 600 displays one or more prompts based on code 640 (e.g., computer system 600 displays one or more suggested questions relevant specifically to the current line).

In some embodiments, in response to detecting an input (e.g., a mouse click, an air gesture, and/or a tap input) directed to pop-up control 912b, computer system 600 displays a pop-up user interface element. In some embodiments, the pop-up user interface element includes information corresponding to the current line. In some embodiments, the pop-up user interface element includes a guide for progressing in the current line. In some embodiments, the pop-up user interface element includes a history of the edits made to the current line. In some embodiments, in response to detecting an input (e.g., a mouse click, an air gesture, and/or a tap input) directed to report control 912c, computer system 600 displays a user interface that allows the user to report an issue with the current line. In some embodiments, in response to detecting an input (e.g., a mouse click, an air gesture, and/or a tap input) directed to enter control 912d, computer system 600 generates a response to a user entry within navigation bar 912.

As illustrated in FIG. 9M, in response to detecting key input 905l2, key input 905l3, and key input 905l4, computer system 600 displays user entry 912e (e.g., “Please make Price color change based on price drop”) (e.g., a command directed to computer system 600 to modify code 640) within navigation bar 912. As illustrated in FIG. 9M, in response to detecting horizontal rightward input 905l5, computer system 600 moves cursor indicator 654 over enter control 912d. At FIG. 9M, computer system 600 detects, via touchpad 652f, selection input 905m (e.g., a mouse click, an air gesture, and/or a tap input) directed to enter control 912d. In some embodiments, selection input 905m is a voice command (e.g., “Make that change.”).

FIG. 9N illustrates a separate embodiment following FIG. 9L. As illustrated in FIG. 9N, in response to detecting key input 905l2, key input 905l3, and key input 905l4, computer system 600 displays user entry 912f (e.g., “How do I make Price color change based on price drop?”) (e.g., an inquiry directed to computer system 600 to on how to modify code 640) within navigation bar 912. As illustrated in FIG. 9N, in response to detecting horizontal rightward input 905l5, computer system 600 moves cursor indicator 654 over enter control 912d. At FIG. 9N, computer system 600 detects, via touchpad 652f, selection input 905n1 (e.g., a mouse click, an air gesture, and/or a tap input) directed to enter control 912d. In some embodiments, selection input 905n1 is a voice command (e.g., “Show me how.”). At FIG. 9N, computer system 600 detects vertical leftward input 905n2 directed to touchpad 652f.

FIG. 9O illustrates a scenario following FIG. 9N. As illustrated in FIG. 9O, in response to detecting selection input 905n1, computer system 600 displays modification region 914. Modification region 914 is displayed to provide information on how to modify the current line based on an inquiry (e.g., user entry 912f). Modification region 914 includes proposed code description 914a, code changes indicator 914b, caret 914b1, caret 914b2, proposed code sample indicator 914c, and apply control 914d.

In some embodiments, proposed code description 914a includes a description of the proposed code modifications detailed within modification region 914. In some embodiments, proposed code description 914a summarizes the modifications. For example, the proposed code description 914a describes the changes that were made without showing proposed code and/or includes bullet points of the proposed text. In some embodiments, code changes indicator 914b indicates the changes to the code below (e.g., as illustrated by proposed code sample indicator 914c). In some embodiments, in response to detecting an input (e.g., a mouse click, an air gesture, and/or a tap input) directed to caret 914b1, computer system 600 ceases display of the changes to the code. In some embodiments, proposed code sample indicator 914c indicates the modified code that can be added to the current line. In some embodiments, in response to detecting an input (e.g., a mouse click, an air gesture, and/or a tap input) directed to apply control 914d, computer system 600 implements the proposed code modifications detailed within modification region 914 (e.g., computer system 600 adds the code corresponding to proposed code sample indicator 914c to the current line).

As illustrated in FIG. 9O, in response to detecting vertical leftward input 905n2, computer system 600 moves cursor indicator 654 over apply control 914d. At FIG. 9O, computer system 600 detects, via touchpad 652f, selection input 905o1 (e.g., a mouse click, an air gesture, and/or a tap input) directed to apply control 914d. In some embodiments, selection input 905o1 is a voice command (e.g., “Apply the changes.”). At FIG. 9O, computer system 600 detects vertical rightward input 905o2 directed to touchpad 652f. For example, vertical rightward input 905o2 can be a drag input detected via touchpad 652f from one location to another. It should be recognized that other types of inputs can be used instead of vertical rightward input 905o2, such as movement of a mouse, an air gesture moving from one location to another, or a tap input at a final location.

As illustrated in FIG. 9P, in response to detecting selection input 905o1, computer system 600 adds code modifications to the current line based on the suggestions included in modification region 914. The code modifications include response indicator 916, response indicator 918, and response indicator 936. Though not illustrated in FIG. 9P, computer system 600 adds other code modifications to the current line (e.g., the code modifications are implemented in sections of code 640 not displayed in FIG. 9P). In some embodiments, the current line is modified based on a selected portion of code 640. For example, if the first three lines of code 640 are selected (e.g., highlighted), computer system 600 modifies the current line based off of the three selected lines. In some embodiments, in response to detecting selection input 905o1, computer system 600 only modifies a single portion of the current line. For example, in a scenario with a different user entry, in response to detecting an input (e.g., a mouse click, an air gesture, and/or a tap input) directed to apply control 914d, computer system 600 only modifies a single portion of code 640 (e.g., a line, a word, and/or a phrase).

In an alternative embodiment, at FIG. 9P computer system 600 adds code modifications to the current line in response to detecting selection input 905m, without displaying modification region 914 as described above with respect to FIG. 9O. User entry 912f requests the same change as user entry 912e for changing the price color based on price drops, resulting in the same responses indicated in code 640. However, user entry 912f differs from user entry 912e; user entry 912e is a command “Please make . . . ”, while user entry 912f is an educational request “How do I . . . ”. In some embodiments, computer system 600 displays FIG. 9P in response to detecting selection input 905m specifically because user entry 912e is a command. In contrast, user entry 912f asks how to perform an action, leading to different handling. For example, if the request is about converting payments to local currency, the generated responses would differ based on the nature of the user entry.

As part of adding code modifications to the current line, computer system 600 ceases display of modification region 914 and displays modification history region 920 above navigation bar 912. Modification history region 920 includes user entry 912f (e.g., “How do I make Price color change based on price drop?”), changes indicator 922, caret 922a, and caret 922b. In some embodiments, changes indicator 922 indicates the amount of changes made to the code in response to applying a suggested code modification (e.g., a code modification corresponding to user entry 912f). As illustrated in FIG. 9P, computer system 600 displays changes indicator 922 as “5 changes” to indicate that five total modifications to the current line were made in response to user entry 912f. In some embodiments, in response to detecting an input (e.g., a mouse click, an air gesture, and/or a tap input) directed to caret 922a, computer system 600 highlights a code modification (e.g., highlights a previous response indicator in the order) corresponding to user entry 912f. As an example, in response to detecting an input (e.g., a mouse click, an air gesture, and/or a tap input) directed to caret 922a, while highlighting response indicator 918, computer system 600 highlights response indicator 916.

In some embodiments, in response to detecting an input (e.g., a mouse click, an air gesture, and/or a tap input) directed to caret 922b, computer system 600 highlights a code modification (e.g., highlights the next response indicator in the order) corresponding to user entry 912f. As an example, in response to detecting an input (e.g., a mouse click, an air gesture, and/or a tap input) directed to caret 922b, computer system 600 highlights response indicator 916. In response to detecting another input (e.g., a mouse click, an air gesture, and/or a tap input) directed to caret 922a, computer system 600 highlights response indicator 918.

In some embodiments, computer system 600 cycles through code modification responses in response to detecting an input (e.g., a mouse click, an air gesture, and/or a tap input) directed to left arrow key 652b and/or right arrow key 652e as opposed to caret 922a and caret 922b. In some embodiments, computer system 600 cycles through code modification responses in response to detecting an air gesture as opposed to detecting an input (e.g., a mouse click, an air gesture, and/or a tap input) directed to caret 922a and/or caret 922b. In some embodiments, computer system 600 cycles through code modification responses in response to detecting a voice command as opposed to detecting an input (e.g., a mouse click, an air gesture, and/or a tap input) directed to caret 922a and/or caret 922b (e.g., “Show me the next change.” and/or “Show me the previous change.”). As illustrated in FIG. 9P, in response to detecting vertical rightward input 905o2, computer system 600 moves cursor indicator 654 over caret 922b. At FIG. 9P, computer system 600 detects selection input 905p (e.g., a mouse click, an air gesture, and/or a tap input) directed to caret 922b. In some embodiments, selection input 905p is a voice command (e.g., “Show me the first change.”).

As illustrated in FIG. 9Q, in response to detecting selection input 905p, computer system 600 highlights response indicator 916. At FIG. 9Q, computer system 600 detects selection input 905q (e.g., a mouse click, an air gesture, and/or a tap input) directed to caret 922b. In some embodiments, selection input 905p is a voice command (e.g., “Show me the second change.”).

As illustrated in FIG. 9R, in response to detecting selection input 905q, computer system 600 highlights response indicator 918. At FIG. 9R, computer system 600 detects selection input 905r (e.g., a mouse click, an air gesture, and/or a tap input) directed to caret 922b. In some embodiments, selection input 905r is a voice command (e.g., “Show me the third change.”).

As illustrated in FIG. 9S, in response to detecting selection input 905r, computer system 600 highlights response indicator 936. At FIG. 9S, computer system 600 detects selection input 905s1 (e.g., a mouse click, an air gesture, and/or a tap input) directed to caret 922b. In some embodiments, selection input 905s1 is a voice command (e.g., “Show me the fourth change.”). At FIG. 9S, computer system 600 detects vertical input 905s2 directed to touchpad 652f.

As illustrated in FIG. 9T, in response to detecting selection input 905s1, computer system 600 highlights response indicator 938. As part of highlighting response indicator 938, computer system 600 scrolls down the display of the current line until response indicator 938 is visible (e.g., computer system 600 ceases displaying a top portion of the current line and displays a portion previously hidden). Additionally, as illustrated in FIG. 9T, computer system 600 displays response indicator 940 within code 640. As illustrated in FIG. 9T, in response to detecting vertical input 905s2, computer system 600 moves cursor indicator 654 over to history control 900.

At FIG. 9T, computer system 600 detects selection input 905t (e.g., a mouse click, an air gesture, and/or a tap input) directed to history control 900. In some embodiments, selection input 905r is a voice command (e.g., “Show me the history of edits made to my code.”). At FIG. 9T, computer system 600 detects horizontal rightward input 905t2 directed to touchpad 652f. For example, rightward input 905t2 can be a drag input detected via touchpad 652f from one location to another. It should be recognized that other types of inputs can be used instead of rightward input 905t2, such as movement of a mouse, an air gesture moving from one location to another, or a tap input at a final location.

As illustrated in FIG. 9U, in response to detecting selection input 905t, computer system 600 displays history region 924. History region 924 includes user entry 912f and user entry 926. In some embodiments, computer system 600 displays user-created entries that resulted in a modification of the current). In some embodiments, computer system 600 does not display user-created entries that did not result in a modification of the current line. For example, computer system 600 does not display user-created entries such as a request to research a given function because such a user-created entry would not modify the current line. In another example, computer system 600 does not display user-created entries such as a request to modify text that was later undone and/or deleted. In some embodiments, in response to detecting an input (e.g., a mouse click, an air gesture, and/or a tap input) directed to user entry 912f, computer system 600 displays user interface elements that include a description of the proposed code modifications as well as the added code sample. In some embodiments, in response to detecting an input (e.g., a mouse click, an air gesture, and/or a tap input) directed to user entry 926, computer system 600 displays user interface elements that include a description of the proposed code modifications as well as the added code sample.

In addition to displaying user entry 912f, computer system 600 displays time indicator 930, changes indicator 922, caret 922a, and caret 922b. In some embodiments, time indicator 930 indicates the time the user entry was entered (e.g., via input (e.g., a mouse click, an air gesture, and/or a tap input) directed to enter control 912d). As illustrated in FIG. 9U, time indicator 930 is displayed as “Today: 9:41 AM”.

In addition to displaying user entry 926, computer system 600 displays time indicator 932, changes indicator 928, caret 928a, and caret 928b. As illustrated in FIG. 9U, user entry 926 is displayed as “How do I add a discount?”. In some embodiments, changes indicator 928 indicates the amount of changes made to the code in response to applying a suggested code modification (e.g., a code modification corresponding to user entry 926). As illustrated in FIG. 9U, computer system 600 displays changes indicator 928 as “3 changes” to indicate that three total modifications to the current line were made in response to user entry 926. In some embodiments, in response to detecting an input (e.g., a mouse click, an air gesture, and/or a tap input) directed to caret 928a, computer system 600 highlights a code modification corresponding to user entry 926 (e.g., highlights a previous response indicator in the order). In some embodiments, in response to detecting an input (e.g., a mouse click, an air gesture, and/or a tap input) directed to caret 928b, computer system 600 highlights a code modification (e.g., highlights the next response indicator in the order) corresponding to user entry 926. In some embodiments, time indicator 932 indicates the time the user entry was entered (e.g., via input (e.g., a mouse click, an air gesture, and/or a tap input) directed to enter control 912d). As illustrated in FIG. 9U, time indicator 930 is displayed as “Today: 8:03 AM”. It should be recognized that computer system 600 displays user entries in chronological order of most recent as illustrated by user entry 912f displayed over user entry 926 (e.g., time indicator 930 indicates that user entry 912f occurred after user entry 926). At FIG. 9U, computer system 600 detects selection input 905u1 (e.g., a mouse click, an air gesture, and/or a tap input) directed to user entry 912f. At FIG. 9U, computer system 600 detects horizontal leftward input 905u2 directed to touchpad 652f. For example, horizontal leftward input 905u2 can be a drag input detected via touchpad 652f from one location to another. It should be recognized that other types of inputs can be used instead of horizontal leftward input 905u2, such as movement of a mouse, an air gesture moving from one location to another, or a tap input at a final location.

As illustrated in FIG. 9V, in response to detecting selection input 905u, computer system 600 displays code description 914a and proposed code sample indicator 914c (e.g., computer system 600 displays additional details about user entry 912f). In some embodiments, proposed code description 914a includes a description of the proposed code modifications corresponding to user entry 912f including why the proposed code was displayed. In some embodiments, proposed code sample indicator 914c indicates the modified code sample that was added to the current line corresponding to user entry 912f. As illustrated in FIG. 9V, in response to detecting horizontal leftward input 905u2, computer system 600 moves cursor indicator 654 outside of history region 924. At FIG. 9V, computer system 600 detects selection input 905v1 (e.g., a mouse click, an air gesture, and/or a tap input) directed to code 640. At FIG. 9V, computer system 600 detects horizontal leftward input 905v2 directed to touchpad 652f.

As illustrated in FIG. 9W, in response to detecting selection input 905v1, computer system 600 ceases display of history region 924. Additionally, in response to detecting horizontal leftward input 905v2, computer system 600 moves cursor indicator 654 over pop-up control 912b. At FIG. 9W, computer system 600 detects selection input 905w1 (e.g., a mouse click, an air gesture, and/or a tap input) directed to pop-up control 912b. At FIG. 9W, computer system 600 detects horizontal rightward input 905w2 directed to touchpad 652f. For example, horizontal rightward input 905w2 can be a drag input detected via touchpad 652f from one location to another. It should be recognized that other types of inputs can be used instead of horizontal rightward input 905w2, such as movement of a mouse, an air gesture moving from one location to another, or a tap input at a final location.

As illustrated in FIG. 9X, in response to detecting selection input 905w1, computer system 600 displays pop-up region 934. Pop-up region 934 includes additional information indicator 942, guide indicator 944, user entry 912f, time indicator 930, changes indicator 922, caret 922a, caret 922b, user entry 926, time indicator 932, changes indicator 928, caret 928a, and caret 922b (e.g., pop-up region 934 includes a variety of relevant information to the current line, such as additional information, guides, and edit history). In some embodiments, additional information indicator 942 indicates additional information for the current line, such details of coding and/or other examples of similar line. In some embodiments, guide indicator 944 includes a guide on adding relevant code to the current line. As illustrated in FIG. 9X, in response to detecting horizontal rightward input 905w2, computer system 600 moves cursor indicator 654 over navigation bar 912.

FIGS. 9X-9AD illustrate a process where computer system 600 modifies code for multiple files. At FIG. 9X, computer system 600 detects selection input 905x1 (e.g., a mouse click, an air gesture, and/or a tap input) directed to navigation bar 912 and, after, key inputs 905x2, 905x3, and 905x4 directed to keys within keys region 652a (e.g., multiple key inputs on a physical keyboard, multiple tap inputs on a virtual keyboard, or a voice input). It should be recognized that key inputs 905x2, 905x3, and 905x4 are example of an input mechanism to add to navigation bar 912 and that other input mechanisms can be used, such as voice commands (e.g., the user vocally instructs computer system 600 on what prompt they want entered into navigation bar 912). Additionally, at FIG. 9X, computer system 600 detects horizontal rightward input 905x5 directed to touchpad 652f. In some embodiments, horizontal rightward input 905x5 can be a drag input detected via touchpad 652f from one location to another. It should be recognized that other types of inputs can be used instead of horizontal rightward input 905x5, such as movement of a mouse, an air gesture moving from one location to another, or a tap input at a final location.

As illustrated in FIG. 9Y, in response to detecting selection input 905x1, computer system 600 ceases display of pop-up region 934. Additionally, in response to detecting key inputs 905x2, 905x3, and 905x4, computer system 600 displays user entry 912g (e.g., “Add a notification when a new coupon is available”) within navigation bar 912. In some embodiments, user entry 912g is a command directed to computer system 600 to modify code 640 and/or other code related to code 640. In such embodiments, the other code can be code that is in the same project as code 640, such as code in a different file than a file including code 640.

As illustrated in FIG. 9Y, in response to detecting horizontal rightward input 905x5, computer system 600 moves cursor indicator 654 over enter control 912d. At FIG. 9Y, computer system 600 detects selection input 905y1 (e.g., a mouse click, an air gesture, and/or a tap input) directed to enter control 912d. It should be recognized that selection input 905y1 is an example of a selection input and can be other inputs, such as a tap input, an air gesture input, and/or a verbal input. Additionally, at FIG. 9Y, computer system 600 detects vertical input 905y2 directed to touchpad 652f. In some embodiments, vertical input 905y2 can be a drag input detected via touchpad 652f from one location to another. It should be recognized that other types of inputs can be used instead of vertical input 905y2, such as movement of a mouse, an air gesture moving from one location to another, or a tap input at a final location.

At FIG. 9Z, in response to detecting selection input 905y1, computer system 600 modifies multiple files based on user entry 912g. In some embodiments, as part of modifying multiple files, computer system 600 ceases display of code 640 and displays files region 948. In other embodiments, files region 948 is displayed over code 640 (e.g., at least a portion of code 640 is covered by files region 948). In other embodiments, code 640 is shrunk with an animation to become file 950. As illustrated in FIG. 9Z, files region 948 includes a window for each of the multiple files changed, including file 950, file 956, file 964, and file 972. In some embodiments, file 950, file 956, file 964, and file 972 are interrelated. In such embodiments, each of the files (e.g., file 950, file 956, file 964, and file 972) can correspond to and/or be included in the same project and/or folder. For example, file 950 can be a file corresponding to the user interface of a current project. File 956 can be a file corresponding to notifications and status updates of the current project. File 964 can be a file corresponding to implementing push notifications of the current project. File 972 can be a file corresponding to implementing background push notifications of the current project. In other embodiments, each of the files (e.g., file 950, file 956, file 964, and file 972) can correspond to and/or be included in separate projects.

In some embodiments, as part of modifying the multiple files, computer system 600 displays code modifications in the multiple files. As illustrated in FIG. 9Z, the code modifications include response indicator 954 corresponding to file 950, response indicator 962 corresponding to file 956, response indicator 970 corresponding to file 964, and response indicator 978 corresponding to file 972. Though not illustrated in FIG. 9Z, computer system 600 can add other code modifications to file 950 and file 956 in response to detecting selection input 905y1 as described further below with respect to FIGS. 9AB and 9AD.

As illustrated in FIG. 9Z, file 950 includes title indicator 952 (e.g., “File 1”), code 640, response indicator 916, and response indicator 954. It should be recognized that file 950 is the same file as illustrated in FIGS. 9A-9Y within code region 696 (e.g., the file including code 640). As illustrated in FIG. 9Z, response indicator 916 is displayed with hatching to indicate that response indicator 916 is a response to a previous input to modify code (e.g., selection input 905o1) as illustrated in FIGS. 9O-9P and is not a response to the most recent input to modify multiple current files (e.g., selection input 905y1). As illustrated in FIG. 9Z, file 956 includes title indicator 958 (e.g., “File 2”), code 960, and response indicator 962. As illustrated in FIG. 9Z, file 964 includes title indicator 966 (e.g., “File 3”), code 968, and response indicator 970. As illustrated in FIG. 9Z, file 972 includes title indicator 974 (e.g., “File 4”), code 976, and response indicator 978.

In some embodiments, as part of modifying the multiple files, computer system 600 ceases display of user entry 912f and displays user entry 912g within modification history region 920. As illustrated in FIG. 9Z, computer system 600 displays changes indicator 922 as “6 changes” to indicate that six total modifications to multiple current files were made based on user entry 912g. As illustrated in FIG. 9Z, in response to detecting vertical input 905y2, computer system 600 moves cursor indicator 654 over caret 622b. At FIG. 9Z, computer system 600 detects selection input 905z (e.g., a mouse click, an air gesture, and/or a tap input) directed to caret 622b. It should be recognized that selection input 905z is an example of a selection input and can be other inputs, such as a tap input, an air gesture input, and/or a verbal input.

As illustrated in FIG. 9AA, in response to detecting selection input 905z, computer system 600 highlights response indicator 954 within file 950. At FIG. 9AA, computer system 600 detects selection input 905aa (e.g., a mouse click, an air gesture, and/or a tap input) directed to caret 922b. It should be recognized that selection input 905aa is an example of a selection input and can be other inputs, such as a tap input, an air gesture input, and/or a verbal input.

As illustrated in FIG. 9AB, in response to detecting selection input 905aa, computer system 600 displays another portion of code 640 after scrolling downwards in code 640. As part of displaying the other portion of code 640, computer system 600 highlights response indicator 936 and response indicator 980 and ceases display of response indicator 954 and response indicator 916. As illustrated in FIG. 9AB, response indicator 936 is highlighted with hatching to indicate that response indicator 936 is a response to a previous input to modify code (e.g., selection input 905o1) as illustrated in FIGS. 9O-9P and is not a response to the most recent input to modify multiple current files (e.g., selection input 905y1). It should be recognized that, in response to detecting selection input 905aa, computer system 600 scrolls code 640 and does not scroll other code corresponding to other documents and/or files.

At FIG. 9AB, in response to detecting selection input 905aa, computer system 600 skips over response indicator 916 and response indicator 936 because each of response indicator 916 and response indicator 936 correspond to a less recent request and selection input 905aa corresponds to a most recent request (e.g., selection input 905y1). At FIG. 9AB, computer system 600 detects selection input 905ab (e.g., a mouse click, an air gesture, and/or a tap input) directed to caret 922b. It should be recognized that selection input 905ab is an example of a selection input and can be other inputs, such as a tap input, an air gesture input, and/or a verbal input.

As illustrated in FIG. 9AC, in response to detecting selection input 905ab, computer system 600 highlights response indicator 962 within file 956. It should be recognized that neither code 640 nor code 960 is scrolled in response to detecting selection input 905ab. Such can be a result of not needing to scroll to highlight a next modification. At FIG. 9AC, computer system 600 detects selection input 905ac (e.g., a mouse click, an air gesture, and/or a tap input) directed to caret 922b. It should be recognized that selection input 905ac is an example of a selection input and can be other inputs, such as a tap input, an air gesture input, and/or a verbal input.

As illustrated in FIG. 9AD, in response to detecting selection input 905ac, computer system 600 displays another portion of code 960 after scrolling downwards in code 960. As part of displaying the other portion of code 960, computer system 600 highlights response indicator 982 and ceases display of response indicator 962. It should be recognized that, in response to detecting selection input 905ac, computer system 600 scrolls the other portion of code 960 and does not scroll other code corresponding to other files and/or documents.

FIG. 10 is a flow diagram illustrating a process (e.g., process 1000) for selectively displaying an indication of additional proposed text based on length of additional text in accordance with some embodiments. Some operations in process 1000 are, optionally, combined, the orders of some operations are, optionally, changed, and some operations are, optionally, omitted.

As described below, process 1000 provides an intuitive way for selectively displaying an indication of additional proposed text based on length of additional text. Process 1000 reduces the cognitive burden on a user, thereby creating a more efficient human-machine interface. For battery-operated computing devices, enabling a user to interact with such devices faster and more efficiently conserves power and increases the time between battery charges.

In some embodiments, process 1000 is performed at a computer system (e.g., 600) that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system detects (1002), via the one or more input devices (e.g., 652, 652a, 652b, 652c, 652d, 652e, and/or 652f), an input (e.g., 905a1, 905a2, 905a3, 905b1, 905b2, 905b3, 905c1, 905c2, 905c3, 905d, 905f, 905g, 905h1, 905i1, 905i2, 905i3, 905j2, 905kl, and/or 905k2) corresponding to (and/or associated with) a request to add additional text (e.g., auto-generated text and/or recommended text) to a text entry field (e.g., 640) (e.g., an input field for text, a text entry box, and/or a region for typing text). In some embodiments, the input corresponding to the request to add additional text to the text entry field includes selection of a button to add text. In some embodiments, the input corresponding to the request to add additional text to the text entry field includes a press of a tab key on a keyboard. In some embodiments, the input corresponding to the request to add additional text to the text entry field includes one or more key presses of the keyboard.

In response to (1004) (and/or while) detecting the input (e.g., 905a1, 905a2, 905a3, 905b1, 905b2, 905b3, 905c1, 905c2, 905c3, 905d, 905f, 905g, 905h1, 905i1, 905i2, 905i3, 905j2, 905k1, and/or 905k2) corresponding to the request to add additional text to the text entry field (e.g., 640), in accordance with a determination that proposed text includes a first amount (e.g., a quantity of words, characters, and/or lines) of text, the computer system displays (1006), via the one or more display generation components, a first portion of the proposed text (e.g., automatically-generated text content and or generative text content) (e.g., to be added to the text entry field) with a respective indication (e.g., 904) (e.g., a preview, a user-interface preview, a representation, a visual representation, a selectable user interface element, an icon, a widget, a control, a button, a user interface, and/or a window) that an additional portion of the proposed text (and/or that additional proposed text) is available to be added to the text entry field (e.g., 640), wherein the additional portion of the proposed text is different from the first portion of the proposed text (e.g., as described above with respect to FIGS. 9D, 9E, and/or 9K). In some embodiments, the first portion is proposed to be added to the text entry field. In some embodiments, while displaying the first portion of the proposed text, the computer detects, via the one or more input devices, an input corresponding to a confirmation of the first portion of the proposed text. In some embodiments, in response to detecting the input corresponding to the confirmation of the first portion of the proposed text, the computer system adds the first portion of the proposed text to the text entry field. In some embodiments, the input corresponding to a confirmation of the first portion of the proposed text includes a mouse click and/or a tap on a button corresponding to corresponding to a confirmation of the first portion of the proposed text. In some embodiments, the input corresponding to a confirmation of the first portion of the proposed text includes one or more key presses of the keyboard (e.g., the enter key) to confirm the first portion of the proposed text.

In response to (1004) detecting the input corresponding to the request to add additional text to the text entry field, in accordance with a determination that the proposed text includes a second amount of text different from (e.g., more or less than) the first amount, the computer system displays (1008), via the one or more display generation components, a second portion (e.g., the first portion or another portion different from the first portion) of the proposed text (e.g., automatically-generated text content and or generative text content) without the respective indication (e.g., 640) that an additional portion of the proposed text (and/or that additional proposed text) is available to be added to the text entry field (e.g., 640) (e.g., as described above with respect to FIGS. 9B, and/or 9J). In some embodiments, the second portion is proposed to be added to the text entry field. In some embodiments, while displaying the second portion of the proposed text, the computer detects, via the one or more input devices, an input corresponding to a confirmation of the second portion of the proposed text. In some embodiments, in response to detecting the input corresponding to the confirmation of the second portion of the proposed text, the computer system adds the second portion of the proposed text to the text entry field. In some embodiments, the input corresponding to a confirmation of the second portion of the proposed text includes a mouse click and/or a tap on a button corresponding to corresponding to a confirmation of the second portion of the proposed text. In some embodiments, the input corresponding to a confirmation of the second portion of the proposed text includes one or more key presses of the keyboard (e.g., the enter key) to confirm the second portion of the proposed text. Displaying a portion of proposed text with a respective indication that an additional portion of the proposed text is available to be added to the text entry field when the proposed text includes a particular amount of text and displaying the portion of the proposed text without the respective indication when the proposed text includes another amount of text enables the computer system to respond to requests with proposed text as indicated by the user and selectively indicate the availability of additional text, thereby performing an operation when a set of conditions has been met without requiring further user input, reducing the number of inputs needed to perform an operation, and/or providing improved visual feedback to the user.

In some embodiments, the input corresponding to the request to add the additional text to the text entry field (e.g., 640) includes a typing input (e.g., physical keyboard presses, and/or touch inputs on a virtual keyboard) (e.g., 905a1, 905a2, 905a3, 905b1, 905b2, 905b3, 905c1, 905c2, 905c3, 905i1, 905i2, and/or 905i3). Displaying a portion of proposed text with a respective indication that an additional portion of the proposed text is available to be added to a text entry field in response to detecting an input including a typing input enables the computer system to respond to typed requests with proposed text as indicated by the user and selectively indicate the availability of additional text, thereby performing an operation when a set of conditions has been met without requiring further user input, reducing the number of inputs needed to perform an operation, and/or providing improved visual feedback to the user.

In some embodiments, the input corresponding to the request to add the additional text to the text entry field (e.g., 640) includes a dictation input (e.g., as described above with respect to FIGS. 9D and/or 9L) (e.g., voice input, gestures, and/or audio request). Displaying a portion of proposed text with a respective indication that an additional portion of the proposed text is available to be added to a text entry field in response to detecting an input including a dictation input enables the computer system to respond to dictated requests with proposed text as indicated by the user and selectively indicate the availability of additional text, thereby performing an operation when a set of conditions has been met without requiring further user input, reducing the number of inputs needed to perform an operation, and/or providing improved visual feedback to the user.

In some embodiments, before detecting the input corresponding to the request to add additional text to the text entry field (e.g., 640), the computer system displays, via the one or more display generation components, one or more options for adding autocompleted text (e.g., automatically-generated text content and or generative text content) (e.g., 902a, 902b, 902c, 946a, 946b, and/or 946c) (e.g., in the text entry field), wherein the input corresponding to the request to add the additional text to the text entry field includes a selection (e.g., 905b1 and/or 905j1) of a respective option of the one or more options for adding autocompleted text. In some embodiments, the one or more options for adding autocompleted text is recommended text. In some embodiments, the one or more options for adding autocompleted text is generated (e.g., by an artificial intelligence (e.g., “AI”) process or a generative AI process) based on text in the text entry field. In some embodiments, the one or more options for adding autocompleted text is generated (e.g., by an artificial intelligence (e.g., “AI”) process or a generative AI process) based on different files and/or different text than in the text entry field. In some embodiments, the one or more options for adding autocompleted text is generated (e.g., by an artificial intelligence (e.g., “AI”) process or a generative AI process) without the computer system detecting, via the one or more input devices, (and/or after the input corresponding to the request to add additional text to the text entry field) an input corresponding to the text in the text entry field. In some embodiments, the input corresponding to the text in the text entry field includes a mouse click and/or a tap on a button corresponding to text in the text entry field. In some embodiments, the input corresponding to the text in the text entry field includes one or more key presses of the keyboard corresponding to the text in the text entry field. Displaying one or more portions of autocompleted text while detecting an input corresponding to a request to add additional text to a text entry field enables the computer system to provide autocompleted text automatically for the user that is controllable by the user, thereby performing an operation when a set of conditions has been met without requiring further user input, reducing the number of inputs needed to perform an operation, and/or providing improved visual feedback to the user.

In some embodiments, the one or more options for adding autocompleted text (e.g., generated using an AI process or a generative AI process) (e.g., 902a, 902b, 902c, 946a, 946b, and/or 946c) includes a first option of autocompleted text (e.g., automatically-generated text content and or generative text content (e.g., in the text entry field) (e.g., automatically-generated text content and or generative text content) (e.g., 902a, 902b, 902c, 946a, 946b, and/or 946c) and a second option of autocompleted text (e.g., automatically-generated text content and or generative text content) (e.g., 902a, 902b, 902c, 946a, 946b, and/or 946c) different from the first option of autocompleted text. In some embodiments, in response to detecting the input corresponding to the request to add additional text to the text entry field (e.g., 640) (and/or while displaying the one or more options for adding autocompleted text), in accordance with a determination that the input corresponding to the request to add additional text to the text entry field (e.g., 640) corresponds to (e.g., is related to and/or associated with) a selection of the first option (e.g., 902a, 902b, 902c, 946a, 946b, and/or 946c) of the autocompleted text, the computer system displays, via the one or more display generation components, content (e.g., automatically-generated text content and or generative text content) corresponding to the first option of the autocompleted text in the text entry field (e.g., as described above with respect to FIGS. 9C and/or 9J) (e.g., and/or forgoes display of the second option of the autocompleted text). In some embodiments, the input corresponding to the request to add additional text to the text entry field corresponding to the selection of the first option of the autocompleted text includes a selection of an indication (e.g., a preview, a user-interface preview, a representation, a visual representation, a selectable user interface element, an icon, a widget, a control, a button, a user interface, and/or a window) corresponding to the first option of the autocompleted text. In some embodiments, in response to detecting the input corresponding to the request to add additional text to the text entry field, in accordance with a determination that the input corresponding to the request to add additional text to the text entry field (e.g., 640) corresponds to (e.g., is related to and/or associated with) a selection of the second option (e.g., 902a, 902b, 902c, 946a, 946b, and/or 946c) of the autocompleted text, the computer system displays, via the one or more display generation components, content corresponding to the second option of the autocompleted text in the text entry field (e.g., as described above with respect to FIGS. 9C and/or 9J) (e.g., and/or forgoes display of the first option of the autocompleted text). In some embodiments, the input corresponding to the request to add additional text to the text entry field corresponding to the selection of the second option of the autocompleted text includes a selection of an indication (e.g., a preview, a user-interface preview, a representation, a visual representation, a selectable user interface element, an icon, a widget, a control, a button, a user interface, and/or a window) corresponding to the second option of the autocompleted text. Displaying content corresponding to an option of the autocompleted text in a text entry when an input corresponding to a request to add additional text to the text entry field corresponds to a selection of a respective option of the autocompleted text enables the computer system to provide selected options of text as directed by the user, thereby performing an operation when a set of conditions has been met without requiring further user input, reducing the number of inputs needed to perform an operation, and/or providing improved visual feedback to the user.

In some embodiments, the first portion of the proposed text (e.g., automatically-generated text content and or generative text content) is displayed at a first location in the text entry field (e.g., 640). In some embodiments, the content corresponding to the first option of the autocompleted text is displayed at a second location in the text entry field (e.g., 640). In some embodiments, the first location is after (e.g., at a location further in the text, and/or closer to the bottom of the text entry field) the first location (e.g., as described above with respect to FIG. 9K). In some embodiments, the second portion of the proposed text is displayed is displayed at a third location of the text entry field. In some embodiments, the second option of the autocompleted text is displayed at a fourth location of the text entry field. In some embodiments, the third location is after the fourth location and/or the second location. Displaying an option of proposed text at a location after an option of autocompleted text is displayed enables the computer system to provide and arrange text for a user, thereby performing an operation when a set of conditions has been met without requiring further user input and/or providing improved visual feedback to the user.

In some embodiments, the input (e.g., 905a1, 905a2, 905a3, 905b1, 905b2, 905b3, 905c1, 905c2, 905c3, 905d, 905f, 905g, 905h1, 905i1, 905i2, 905i3, 905j2, 905k1, and/or 905k2) corresponding to the request to add additional text to the text entry field (e.g., 640) corresponds to (e.g., is related to and/or associated with) a request to preview (e.g., display and/or output) the one or more options for adding autocompleted text (e.g., automatically-generated text content and or generative text content) (e.g., 905e, and/or 905k2). In some embodiments, in response to detecting the request to preview the one or more options of autocompleted content, the computer system displays, via the one or more display generation components, the one or more options for adding autocompleted text for a threshold period of time (e.g., 0.1 to 500 seconds), indefinitely, until an additional input is detected, and/or until the input corresponding to the request to add additional text to the text entry field (e.g., a press and hold input) is no longer received. Requesting to preview one or more options for adding autocompleted text enables the computer system to provide autocompleted text before committing the autocompleted text to the content of the file and/or the text entry field, thereby performing an operation when a set of conditions has been met without requiring further user input, reducing the number of inputs needed to perform an operation, and/or providing improved visual feedback to the user.

In some embodiments, the input (e.g., 905a1, 905a2, 905a3, 905b1, 905b2, 905b3, 905c1, 905c2, 905c3, 905d, 905f, 905g, 905h1, 905i1, 905i2, 905i3, 905j2, 905k1, and/or 905k2) corresponding to the request to add the additional text to the text entry field (e.g., 640) corresponds to (e.g., is, is related to and/or associated with) a request to insert (e.g., add and/or display) content (e.g., 905b1 and/or 905j1) corresponding to an option of the one or more options for adding autocompleted text (e.g., automatically-generated text content and/or generative text content) in the text entry field. In some embodiments, in response to detecting the input corresponding to the request to add additional text to the text entry field, the computer system displays, via the one or more display generation components, the one or more options for adding autocompleted text in the text entry field. Displaying one or more options for adding autocompleted text while detecting an input corresponding to a request to insert content corresponding to an option of one or more options for adding autocompleted text in a text entry field enables the computer system to add autocompleted text to content as directed by the user, thereby reducing the number of inputs needed to perform an operation and/or providing improved visual feedback to the user.

In some embodiments, while displaying the first portion of the proposed text (e.g., automatically-generated text content and/or generative text content) with the respective indication that the additional portion of the proposed text is available to be added to the text entry field (e.g., 640), the computer system detects, via the one or more input devices (e.g., 652, 652a, 652b, 652c, 652d, 652e, and/or 652f), an input (e.g., 905b3, 905d, 905f, 905g, 905h1, 905j2, and/or 905k1) corresponding to a request to add the first portion of the proposed text. In some embodiments, the input corresponding to the request to add the first portion of the proposed text includes selection of a button to add the first portion of the proposed text. In some embodiments, the input corresponding to the request to add the first portion of the proposed text includes selection of a button to add the proposed text. In some embodiments, the input corresponding to the request to add the first portion of the proposed text includes a press of a key (e.g., a tab key, an enter key, and/or a control key and a tab key) on a keyboard. In some embodiments, the input includes one or more key presses of the keyboard. In some embodiments, in response to detecting the input (e.g., 905b3, 905d, 905f, 905g, 905h1, 905j2, and/or 905k1) corresponding to the request to add the first portion of the proposed text and in accordance with a determination that the input is a first type (e.g., keyboard input, particular key press input, tap input, and/or mouse click input) of input, the computer system inserts (e.g., displaying and/or adding) the first portion of the proposed text in the text entry field (e.g., 640) (e.g., as described above with respect to FIGS. 9B, 9D, 9G, 9H, 9I, and/or 9L) (e.g., without inserting another portion of the proposed text in the text entry field). In some embodiments, the input corresponding to the request to add the first portion of the proposed text is the same type of input as the input corresponding to the request to add additional text to the text entry field. In some embodiments, the input corresponding to the request to add the first portion of the proposed text is a different type of input than the input corresponding to the request to add the additional text to the text entry field. In some embodiments, while displaying the second portion of the proposed text, the computer system detects, via the one or more input devices, an input corresponding to a request to add the second portion of the proposed text. In some embodiments, in response to detecting the input corresponding to the request to add the second portion of the proposed text and in accordance with a determination that the input is the first type of input, the computer system inserts the second portion of the proposed text in the text entry field. In some embodiments, the input corresponding to the request to add the second portion of the proposed text includes a button to insert the proposed text. In some embodiments, the input corresponding to the request to add the second portion of the proposed text includes a press of a key (e.g., a tab key, an enter key, and/or a control key and a tab key) on a keyboard to insert the proposed text. Inserting a portion of proposed text in a text entry field in response to detecting an input corresponding to a request to add the portion of the proposed text enables the computer system to add proposed text as directed by the user, thereby providing improved visual feedback to the user.

In some embodiments, the proposed text (e.g., automatically-generated text content and/or generative text content) is first proposed text. In some embodiments, after (and/or in response to) inserting the first portion of the first proposed text (e.g., as described above with respect to FIG. 9E), in accordance with a determination that second proposed text (e.g., automatically-generated text content and or generative text content) (e.g., a remaining portion of the first proposed text not including the first portion of the proposed text) includes a third amount (e.g., a quantity of words, characters, and/or lines) of text (e.g., the first amount of text or another amount of text different from the first amount of text), the computer system displays, via the one or more display generation components, a first portion of the second proposed text (e.g., to be added to the text entry field) with a respective indication (e.g., 904) (e.g., a preview, a user-interface preview, a representation, a visual representation, a selectable user interface element, an icon, a widget, a control, a button, a user interface, and/or a window) that an additional portion of the second proposed text (and/or that additional proposed text) is available to be added to the text entry field (e.g., 640), wherein the additional portion of the second proposed text is different from the first portion of the second proposed text (e.g., as described above at FIG. 9E). In some embodiments, the first portion of the second proposed text is proposed to be added to the text entry field. In some embodiments, while displaying the first portion of the second proposed text, the computer system detects, via the one or more input devices, an input corresponding to a confirmation of the first portion of the second proposed text. In some embodiments, in response to detecting the input corresponding to the confirmation of the first portion of the second proposed text, the computer system adds the first portion of the second proposed text to the text entry field. In some embodiments, the third amount is different from the first amount and/or second amount. In some embodiments, the third amount is the same as the first amount and/or the second amount. In some embodiments, the second proposed text is different from the first proposed text. In some embodiments, the input corresponding to the confirmation of the first portion of the second proposed text includes a mouse click and/or a tap on a button to add the second proposed text. In some embodiments, the input corresponding to the confirmation of the first portion of the second proposed text includes one or more key presses of the keyboard to add the second proposed text. In some embodiments, after inserting the first portion of the first proposed text, in accordance with a determination that the second proposed text includes a fourth amount of text different from (e.g., more or less than) the third amount of text, the computer system displays, via the one or more display generation components, a second portion (e.g., the third portion or another portion different from the third portion) of the second proposed text without the respective indication (e.g., 904) that the additional portion of the second proposed text (and/or that additional proposed text) is available to be added to the text entry field (e.g., 640) (e.g., as described above at FIG. 9E). In some embodiments, while displaying the second portion of the second proposed text, the computer system detects, via the one or more input devices, an input corresponding to a confirmation of the second proposed text. In some embodiments, in response to detecting the input corresponding to the confirmation of the second proposed text, the computer system adds the additional portion of the proposed text to the text entry field. In some embodiments, the second portion of the second proposed text is different from the first portion of the second proposed text. In some embodiments, the input corresponding to the confirmation of the second proposed text includes a mouse click and/or a tap on a button for adding the second proposed text. In some embodiments, the input corresponding to the confirmation of the second proposed text includes one or more key presses of the keyboard to add the second proposed text. Displaying a respective portion of proposed text is available to be added to a text entry field in accordance with a determination that an additional portion of the proposed text includes a respective amount of text enables the computer system to respond to requests with proposed text as indicated by the user and selectively indicate the availability of additional text, thereby performing an operation when a set of conditions has been met without requiring further user input, reducing the number of inputs needed to perform an operation, and/or providing improved visual feedback to the user.

In some embodiments, the proposed text (e.g., automatically-generated text content and/or generative text content) is first proposed text. In some embodiments, after (and/or in response to) inserting the first portion of the first proposed text (e.g., as described above with respect to FIG. 9E), the computer system displays, via the one or more display generation components, a respective indication (e.g., 904) (e.g., a preview, a user-interface preview, a representation, a visual representation, a selectable user interface element, an icon, a widget, a control, a button, a user interface, and/or a window) that an additional portion of the second proposed text is available to be added to the text entry field (e.g., 640) (e.g., as described above with respect to FIG. 9E). In some embodiments, while displaying the respective indication that the additional portion of the second proposed text is available to be added to the text entry field (e.g., 640), the computer system detects, via the one or more input devices (e.g., 652, 652a, 652b, 652c, 652d, 652e, and/or 652f), an input (e.g., 905d, 905f, 905h1, 905j2, and/or 905k1) corresponding to (and/or associated with) a request to add the first portion of the second proposed text to the text entry field (e.g., as described above with respect to FIG. 9E). In some embodiments, the input corresponding to the request to add the first portion of the second proposed text includes selection of a button to add the first portion of the second proposed text. In some embodiments, the input corresponding to the request to add the first portion of the second proposed text includes a press of a tab key on a keyboard. In some embodiments, the input corresponding to the request to add the first portion of the second proposed text includes one or more key presses of the keyboard. In some embodiments, in response to (and/or while) detecting the input (e.g., 905d, 905f, 905h1, 905j2, and/or 905k1) corresponding to the request to add the first portion of the second proposed text to the text entry field (e.g., 640) and in accordance with a determination that the input corresponding to the request to add the first portion of the second proposed text is the same type (e.g., keyboard input, particular key press input, tap input, and/or mouse click input) of input as the input corresponding to the request to add the first portion of the first proposed text, the computer system inserts (e.g., displaying and/or adding) the first portion of the second proposed text to the text entry field (e.g., as described above with respect to FIG. 9E). Inserting a portion of proposed text in response to detecting an input corresponding to a request to add a portion of the proposed text to a text entry field when an input corresponding to a request to add an additional portion of the proposed text to the text entry field is the same type of input as the input corresponding to the request to add the portion of the proposed text enables the computer system to respond to repeated requests with proposed text as indicated by the user, thereby performing an operation when a set of conditions has been met without requiring further user input, reducing the number of inputs needed to perform an operation, and/or providing improved visual feedback to the user.

In some embodiments, after (and/or in response to) inserting the first portion of the second proposed text (e.g., automatically-generated text content and/or generative text content) (e.g., as described above with respect to FIG. 9E), the computer system displays, via the one or more display generation components, a respective indication (e.g., 904) (e.g., a preview, a user-interface preview, a representation, a visual representation, a selectable user interface element, an icon, a widget, a control, a button, a user interface, and/or a window) that an additional portion of a third proposed text (e.g., automatically-generated text content and/or generative text content) is available to be added to the text entry field (e.g., 640). In some embodiments, while displaying the respective indication that the additional portion of the third proposed text is available to be added to the text entry field (e.g., 640), the computer system detects, via the one or more input devices (e.g., 652, 652a, 652b, 652c, 652d, 652e, and/or 652f), an input corresponding to (and/or associated with) a request to add the first portion of the third proposed text to the text entry field (e.g., as described above with respect to FIG. 9E). In some embodiments, the input corresponding to the request to add the first portion of the third proposed text includes selection of a button to add the first portion of the third proposed text. In some embodiments, the input corresponding to the request to add the first portion of the third proposed text includes a press of a tab key on a keyboard. In some embodiments, the input corresponding to the request to add the first portion of the third proposed text includes one or more key presses of the keyboard. In some embodiments, in response to (and/or while) detecting the input corresponding to the request to add the first portion of the third proposed text to the text entry field (e.g., 640) and in accordance with a determination that the input corresponding to the request to add the request to add the first portion of the third proposed text is the same type (e.g., keyboard input, particular key press input, tap input, and/or mouse click input) of input as the input corresponding to the request to add the first portion of the second proposed text, the computer system inserts (e.g., displaying and/or adding) the first portion of the third proposed text to the text entry field (e.g., as described above with respect to FIG. 9E). Inserting a portion of proposed text to a text entry field in response to detecting an input corresponding to a request to add the portion of the proposed text to the text entry field when the input corresponding to a request to add an additional portion of the proposed text to the text entry field is the same type of input as the input corresponding to the request to add the portion of the proposed text enables the computer system to respond to repeated requests with proposed text as indicated by the user, thereby performing an operation when a set of conditions has been met without requiring further user input, reducing the number of inputs needed to perform an operation, and/or providing improved visual feedback to the user.

In some embodiments, after (and/or in response to) inserting the first portion of the second proposed text (e.g., automatically-generated text content and/or generative text content) to the text entry field (e.g., 640) (e.g., as described above with respect to FIG. 9E), the computer system detects, via the one or more input devices (e.g., 652, 652a, 652b, 652c, 652d, 652e, and/or 652f), an input (e.g., 905k1 and/or 905k2) corresponding to (and/or associated with) a request to add an additional portion of a fourth proposed text (e.g., automatically-generated text content and/or generative text content) to the text entry field (e.g., 640) (e.g., as described above with respect to FIG. 9K). In some embodiments, the input corresponding to the request to add the additional portion of the of the fourth proposed text to the text entry field includes selection of a button to add text. In some embodiments, the input corresponding to the request to add the additional portion of the of the fourth proposed text to the text entry field includes a press of an option and tab key on a keyboard. In some embodiments, the input corresponding to the request to add the additional portion of the of the fourth proposed text to the text entry field one or more key presses of the keyboard. In some embodiments, the additional portion of the fourth proposed text is different from the additional portion of the first proposed text. In some embodiments, the additional portion of the fourth proposed text is the same as the additional portion of the first proposed text. In some embodiments, in response to (and/or while) detecting the input (e.g., 905k1 and/or 905k2) corresponding to the request to add the additional portion of the fourth proposed text to the text entry field (e.g., 640) and in accordance with a determination that the input corresponding to the request to add the additional portion of the fourth proposed text to the text entry field is a different type (e.g., keyboard input, particular key press input, tap input, and/or mouse click input) of input than the input corresponding to the request to add the additional portion of the first proposed text to the text entry field, the computer system inserts (e.g., displaying and/or adding) the additional portion of the fourth proposed text in the text entry field (e.g., as described above with respect to FIG. 9K). Inserting an additional portion of proposed text in a text entry field in response to detecting an input corresponding to a request to add the additional portion of the proposed text to the text entry field when the input corresponding to the request to add the additional portion of the proposed text to the text entry field is a different type of input than an input corresponding to a request to add an additional portion of other proposed text to the text entry field enables the computer system to insert proposed text as directed by the user with different actions for different types of assigned inputs, thereby performing an operation when a set of conditions has been met without requiring further user input, reducing the number of inputs needed to perform an operation, and/or providing improved visual feedback to the user.

In some embodiments, before inserting the additional portion of the fourth proposed text (e.g., automatically-generated text content and/or generative text content) in the text entry field (e.g., 640), the computer system displays, via the one or more display generation components, the additional portion of the fourth proposed text with a first appearance (e.g., as described above with respect to FIG. 9D) (e.g., color, opacity, saturation, brightness, highlight, and/or bold), wherein inserting the additional portion of the fourth proposed text in the text entry field includes displaying, via the one or more display generation components, the additional portion of the fourth proposed text with a second appearance (e.g., as described above with respect to FIG. 9E) different from the first appearance (and/or ceasing display of the additional portion of the fourth proposed text with the first appearance). In some embodiments, inserting the additional portion of the fourth proposed text in the text entry field includes changing the additional portion of the fourth proposed text in the text entry field from the first appearance to the second appearance. Displaying an additional portion of proposed text with a different appearance after inserting the additional portion in a text entry field enables the computer system to distinguish proposed text and text that is inserted, thereby performing an operation when a set of conditions has been met without requiring further user input, reducing the number of inputs needed to perform an operation, and/or providing improved visual feedback to the user.

In some embodiments, while displaying the first portion of the proposed text (e.g., automatically-generated text content and/or generative text content) (e.g., as described above with respect to FIG. 9E) with the respective indication that the additional portion (e.g., 904) of the proposed text is available to be added to the text entry field (e.g., 640), the computer system detects, via the one or more input devices (e.g., 652, 652a, 652b, 652c, 652d, 652e, and/or 652f), an input (e.g., 905e) corresponding to (and/or associated with) a request to display the additional portion of the proposed text. In some embodiments, the input corresponding to the request to display the additional portion of the proposed text includes a press of an option key on a keyboard. In some embodiments, the input corresponding to the request to display the additional portion of the proposed text includes one or more key presses of the keyboard. In some embodiments, in response to (and/or while) detecting the input (e.g., 905e) corresponding to the request to display the additional portion of the proposed text, the computer system displays, via the one or more display generation components, the additional portion of the proposed text (e.g., as described above with respect to FIG. 9F) (and/or without inserting the additional portion of the proposed text). In some embodiments, the computer system displays the additional portion of the proposed text regardless of the amount of text (e.g., the first amount or the second amount). Displaying an additional portion of proposed text in response to detecting an input corresponding to a request to display the additional portion of the proposed text enables the computer system to display the additional text as directed the user, thereby performing an operation when a set of conditions has been met without requiring further user input, reducing the number of inputs needed to perform an operation, and/or providing improved visual feedback to the user.

In some embodiments, the additional portion of the proposed text (e.g., automatically-generated text content and/or generative text content) is an additional portion of a first proposed text. In some embodiments, while displaying the additional portion of the first proposed text with the respective indication that the additional portion of the first proposed text is available to be added to the text entry field (e.g., 640), the computer system detects, via the one or more input devices (e.g., 652, 652a, 652b, 652c, 652d, 652e, and/or 652f), an input (e.g., 905b1, 905b2, 905b3, 905c1, 905c2, 905c3, 905i1, 905i2, and/or 905i3) corresponding to (and/or associated with) a request to add text to the text entry field. In some embodiments, the input corresponding to the request to add the text to the text entry field includes selection of a button to add the text. In some embodiments, the input corresponding to the request to add the text to the text entry field includes a press of a tab key on a keyboard. In some embodiments, the input corresponding to the request to add the text to the text entry field includes one or more key presses of the keyboard. In some embodiments, the input corresponding to the request to add the text to the text entry field is different from the input corresponding to the request to add additional text to the text entry field. In some embodiments, in response to (and/or while) detecting the input (e.g., 905b1, 905b2, 905b3, 905c1, 905c2, 905c3, 905i1, 905i2, and/or 905i3) corresponding to the request to add the text to the text entry field (e.g., 640), the computer system ceases display of the additional portion of the first proposed text and the respective indication that the additional portion of the first proposed text is available to be added to the text entry field (e.g., 640) (e.g., as described above with respect to FIGS. 9C, and/or 9I). In some embodiments, in response to detecting the input corresponding to the request to add the text to the text entry field, in accordance with a determination that a fifth proposed text includes a fifth amount (e.g., a quantity of words, characters, and/or lines) of text, the computer system displays, via the one or more display generation components, a first portion of the fifth proposed text in the text entry field (e.g., 640) with a respective indication (e.g., 904) (e.g., a preview, a user-interface preview, a representation, a visual representation, a selectable user interface element, an icon, a widget, a control, a button, a user interface, and/or a window) that an additional portion of the fifth proposed text (and/or that additional proposed text) is available to be added to the text entry field, wherein the additional portion of the fifth proposed text is different from the additional portion of the first proposed text (e.g., as described above with respect to FIGS. 9C, and/or 9I). In some embodiments, the additional portion of the first proposed text is proposed to be added to the text entry field. In some embodiments, while displaying the additional portion of the fifth proposed text, the computer detects, via the one or more input devices, an input corresponding to a confirmation of the first portion of the fifth proposed text. In some embodiments, in response to detecting the input corresponding to the confirmation of the first portion of the fifth proposed text, the computer system adds the first portion of the fifth proposed text to the text entry field. In some embodiments, the fifth amount of text is the same amount of text as the first amount of text. In some embodiments, the fifth amount of text is a different amount of text than the first amount. In some embodiments, the input corresponding to the confirmation of the first portion of the fifth proposed text includes a click on a button corresponding to the confirmation of the first portion of the fifth proposed text. In some embodiments, the input corresponding to the confirmation of the first portion of the fifth proposed text includes one or more key presses of the keyboard to add the first portion of the fifth proposed text to the text entry field. In some embodiments, in response to detecting the input corresponding to the request to add the text to the text entry field, in accordance with a determination that the fifth proposed text includes a sixth amount of text different from (e.g., more or less than) the fifth amount of text, the computer system displays, via the one or more display generation components, a second portion (e.g., the first portion or another portion different from the first portion) of the fifth proposed text without the respective indication (e.g., 904) that the additional portion of the fifth proposed text (and/or that additional proposed text) is available to be added to the text entry field (e.g., 640) (e.g., as described above with respect to FIGS. 9C, and/or 9I). In some embodiments, the sixth amount is different from the fifth amount and/or the first amount. In some embodiments, the sixth amount is the same as the fifth amount and/or the first amount. Updating proposed text in a text entry field after adding text enables the computer system to change the proposed text as the user provides additional inputs, thereby performing an operation when a set of conditions has been met without requiring further user input, reducing the number of inputs needed to perform an operation, and/or providing improved visual feedback to the user.

In some embodiments, while displaying the first portion of the fifth proposed text in the text entry field (e.g., 640) with the respective indication that the additional portion of the fifth proposed text is available to be added to the text entry field, the computer system detects, via the one or more input devices (e.g., 652, 652a, 652b, 652c, 652d, 652e, and/or 652f), an input (e.g., 905d, 905f, 905h1, 905j2, and/or 905k1) corresponding to a confirmation (e.g., acceptance) of the additional portion of the fifth proposed text. In some embodiments, the input corresponding to the confirmation of the additional portion of the fifth proposed text includes selection of a button to add the additional portion of the fifth proposed text. In some embodiments, the input corresponding to the confirmation of the additional portion of the fifth proposed text includes a press of a tab key on a keyboard. In some embodiments, t the input corresponding to the confirmation of the additional portion of the fifth proposed text includes one or more key presses of the keyboard. In some embodiments, in response to detecting the input (e.g., 905d, 905f, 905h1, 905j2, and/or 905k1) corresponding to the confirmation of the additional portion of the fifth proposed text, the computer system displays (and/or inserting, as described above), via the one or more display generation components, the additional portion of the sixth proposed text in the text entry field (e.g., 640). In some embodiments, after (and/or in response to) the additional portion of the sixth proposed text in the text entry field (e.g., 640), in accordance with a determination that seventh proposed text (e.g., a remaining portion of the first proposed text not including the first portion of the proposed text) includes a sixth amount (e.g., a quantity of words, characters, and/or lines) of text (e.g., the first amount of text or another amount of text different from the first amount of text), the computer system displays, via the one or more display generation components, a first portion of the seventh proposed text (e.g., to be added to the text entry field) with a respective indication (e.g., 904) (e.g., a preview, a user-interface preview, a representation, a visual representation, a selectable user interface element, an icon, a widget, a control, a button, a user interface, and/or a window) that an additional portion of the seventh proposed text (and/or that additional proposed text) is available to be added to the text entry field (e.g., 640), wherein the additional portion of the seventh proposed text is different from the first portion of the seventh proposed text (e.g., as described above with respect to FIGS. 9E, 9G, 9I, 9K, and/or 9I). In some embodiments, the first portion of the seventh proposed text is proposed to be added to the text entry field. In some embodiments, while displaying the first portion of the seventh proposed text, the computer system detects, via the one or more input devices, an input corresponding to a confirmation of the first portion of the seventh proposed text. In some embodiments, in response to detecting the input corresponding to the confirmation of the first portion of the seventh proposed text, the computer system adds the first portion of the seventh proposed text to the text entry field. In some embodiments, the sixth amount is different from the first amount and/or second amount. In some embodiments, the sixth amount is the same as the first amount and/or the second amount. In some embodiments, the input corresponding to the confirmation of the first portion of the seventh proposed text includes a mouse click and/or a tap on a button corresponding to the confirmation of the first portion of the seventh proposed text. In some embodiments, the input corresponding to the confirmation of the first portion of the seventh proposed text includes a voice input for adding the first portion of the seventh proposed text (e.g., “add that”). In some embodiments, the seventh proposed text is different from the first proposed text. In some embodiments, after the additional portion of the sixth proposed text in the text entry field, in accordance with a determination that the seventh proposed text includes a seventh amount of text different from (e.g., more or less than) the sixth amount of text, the computer system displays, via the one or more display generation components, a second portion (e.g., the third portion or another portion different from the third portion) of the seventh proposed text, without the respective indication that the additional portion of the seventh proposed text (and/or that additional proposed text) is available to be added to the text entry field (e.g., 640) (e.g., as described above with respect to FIGS. 9E, 9G, 9I, 9K, and/or 9I). In some embodiments, while displaying the second portion of the seventh proposed text, the computer detects, via the one or more input devices, an input corresponding to a confirmation of the seventh proposed text. In some embodiments, in response to detecting the input corresponding to the confirmation of the seventh proposed text, the computer system adds the additional portion of the proposed text to the text entry field. In some embodiments, the second portion of the seventh proposed text is different from the first portion of the second proposed text. In some embodiments, the input corresponding to the confirmation of the seventh proposed text includes a mouse click and/or a tap on a button corresponding to the confirmation of the seventh proposed text. In some embodiments, the input corresponding to the confirmation of the seventh proposed text includes one or more key presses of the keyboard for adding the additional portion of the proposed text. Displaying a respective portion of proposed text is available to be added to the text entry field when an additional portion of the proposed text includes a respective amount of text enables the computer system to respond to requests with proposed text as indicated by the user and selectively indicate the availability of additional text, thereby performing an operation when a set of conditions has been met without requiring further user input, reducing the number of inputs needed to perform an operation, and/or providing improved visual feedback to the user.

In some embodiments, the proposed text (e.g., automatically-generated text content and/or generative text content) includes (and/or is) proposed code (e.g., autogenerated code and/or recommended code). In some embodiments, code is a set of one or more software instructions, and/or source script.

In some embodiments, the text entry field (e.g., 640) corresponds to a file. In some embodiments, the file includes the text entry field. In some embodiments, the file includes code previously added via one or more inputs. In some embodiments, in accordance with a determination that the file includes first code, the proposed code includes second code different from the first code. In some embodiments, in accordance with a determination that the file includes third code different from the first code, the proposed code includes third code different from the first code and the second code (e.g., without including the second code) (e.g., as described above with respect to FIG. 9D). Displaying different proposed code based on other code in a file enables the computer system to display code as directed by the user and provide the code based on code in the file, thereby performing an operation when a set of conditions has been met without requiring further user input and/or providing improved visual feedback to the user.

In some embodiments, the text entry field (e.g., 640) corresponds to a file. In some embodiments, the file includes the text entry field. In some embodiments, the file includes code previously added via one or more inputs. In some embodiments, in accordance with a determination that the file includes a first comment (e.g., feedback and/or appended language), the proposed code includes a first portion of code. In some embodiments, in accordance with a determination that the file includes a second comment (e.g., feedback and/or appended language) different from the first comment, the proposed code (e.g., automatically-generated text content and/or generative text content) includes a second portion of code different from the first portion of code (e.g., without including the first portion of code) (e.g., as described above with respect to FIG. 9D). Displaying different proposed code based on comments in a file enables the computer system to display code as directed by the user and provide the code based on comments in the file, thereby performing an operation when a set of conditions has been met without requiring further user input and/or providing improved visual feedback to the user.

In some embodiments, the additional portion of the proposed text (e.g., automatically-generated text content and/or generative text content) is generated by an artificial intelligence (e.g., “AI”) process (e.g., as described above with respect to FIGS. 9A-9L (e.g., or a generative AI process). In some embodiments, the artificial intelligence process is without user input. In some embodiments, the artificial intelligence process is of the computer system and/or of another computer system different from the computer system. In some embodiments, the artificial intelligence process is an artificial intelligence process (e.g., large language model and/or generative artificial intelligence process). Generating proposed code by an artificial intelligence process enables the computer system to automatically determine the proposed code (and/or without additional user direction) as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

Note that details of the processes described above with respect to process 1000 (e.g., FIG. 10) are also applicable in an analogous manner to other processes described herein. For example, process 1100 optionally includes one or more of the characteristics of the various processes described above with reference to process 1000. For example, displaying an indication of additional proposed text of method 1000 can occur while modifying multiple portions of text (e.g., proposed text) of method 1100. For brevity, these details are not repeated herein.

FIG. 11 is a flow diagram illustrating a process (e.g., process 1100) for modifying multiple portions of text as the result of an input to a request to modify the text in accordance with some embodiments. Some operations in process 1100 are, optionally, combined, the orders of some operations are, optionally, changed, and some operations are, optionally, omitted.

As described below, process 1100 provides an intuitive way for modifying multiple portions of text as the result of an input to a request to modify the text. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a computer system (e.g., 600) that is in communication (e.g., wired communication and/or wireless communication) with one or more input devices (e.g., 652, 652a, 652b, 652c, 652d, 652e, and/or 652f) (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system displays (1102), via the one or more display generation components, text (e.g., 640) including a first portion of the text and a second portion of the text (and/or a third portion of the text different from the first portion of the text and the second portion of the text) different from the first portion of the text. In some embodiments, the third portion of the text is between the first portion of the text and the second portion of the text.

While displaying the text (e.g., 640) (e.g., the first portion of the text, the second portion of the text, and/or another portion of the text different from the first portion of the text and the second portion of the text), the computer system detects (1104), via the one or more input devices (e.g., 652, 652a, 652b, 652c, 652d, 652e, and/or 652f), an input (e.g., 905m and/or 905n1) corresponding to a request to modify the text based on a respective user inquiry (e.g., a user-selected prompt, a selected prompt, an inquiry, a user-selected inquiry, a selected inquiry, prompt, a set of one or more characters, a set of one or more words, a statement, a request, question, and/or command). In some embodiments, the input corresponding to the request to modify the text based on a respective user inquiry includes selection of a button to modify the text. In some embodiments, the input corresponding to the request to modify the text based on a respective user inquiry includes a press of a tab key on a keyboard. In some embodiments, the input corresponding to the request to modify the text based on a respective user inquiry includes one or more key presses of the keyboard corresponding to the respective user inquiry, and/or a press of the enter key.

In response to (and/or while) detecting the input (e.g., 905m and/or 905n1) corresponding to the request to modify the text (e.g., 640) based on the respective user inquiry (e.g., 912e and/or 912f), the computer system modifies (1106) the text (e.g., the first portion of the text, the second portion of the text, and/or another portion of the text different from the first portion of the text and the second portion of the text) (e.g., using an artificial intelligence (e.g., “AI”) process or a generative AI process) including a first modification (e.g., using an artificial intelligence (e.g., “AI”) process or a generative AI process) (e.g., 916, 918, 936, 938, 940) to the first portion of the text and a second modification (e.g., using an artificial intelligence (e.g., “AI”) process or a generative AI process) (e.g., 916, 918, 936, 938, 940) to the second portion of the text, wherein the first modification includes a different change than the second modification (e.g., without a modification to the third portion of the text). In some embodiments, modifying the text includes the computer system displays, via the one or more display generation components, the text with a first modification.

After modifying the text (e.g., using an artificial intelligence (e.g., “AI”) process or a generative AI process) (e.g., 640) in response to detecting the input corresponding to the request to modify the text, the computer system displays (1108), via the one or more display generation components, the first portion of the text with the first modification (e.g., 916, 918, 936, 938, 940) and the second portion of the text with the second modification (e.g., 916, 918, 936, 938, 940). In some embodiments, in response to detecting the input corresponding to the request to modify the text based on the respective user inquiry, the computer system maintains display of, via the one or more display generation components, the text (e.g., the first portion of the text, the second portion of the text, and/or another portion of the text different from the first portion of the text and the second portion of the text). In some embodiments, in response to detecting the input corresponding to the request to modify the text based on the user inquiry, the computer system modifies the first portion of the text and the second portion of the text. In some embodiments, the text is displayed in response to detecting the input corresponding to the request to modify the text based on the respective user inquiry without displaying the first modification to the first portion of the text and/or the second modification to the second portion of the text (e.g., another portion of the text is displayed). Displaying a portion of text with a modification after modifying the text in response to detecting an input corresponding to a request to modify the text enables the computer system to modify multiple different portions of text as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the respective user inquiry (e.g., 912e and/or 912f) is a first respective user inquiry. In some embodiments, the text (e.g., 640) includes a third portion of the text, a fourth portion of the text different from the third portion of the text, a fifth portion of the text different from the third portion of the text and the fourth portion of the text, and a sixth portion of the text different from the third portion of the text, the fourth portion of the text, and the fifth portion of the text. In some embodiments, the third portion of the text is different from the first portion of the text and/or the second portion of the text. In some embodiments, the fourth portion of the text is different from the first portion of the text and the second portion of the text. In some embodiments, the fifth portion of the text is different from the first portion of the text and the second portion of the text. In some embodiments, the sixth portion of the text is different from the first portion of the text and the second portion of the text. In some embodiments, after (and/or while) displaying the first portion of the text (e.g., 640) with the first modification (e.g., 916, 918, 936, 938, 940) and the second portion of the text with the second modification (e.g., 916, 918, 936, 938, 940), the computer system detects, via the one or more input devices (e.g., 652, 652a, 652b, 652c, 652d, 652e, and/or 652f), an input (e.g., 905m1, 905n1, and/or 905o1) corresponding to a request to modify the text based on a second respective user inquiry (e.g., 905m1, 905n1, and/or 905o1) (e.g., a user-selected prompt, a selected prompt, an inquiry, a user-selected inquiry, a selected inquiry, prompt, a set of one or more characters, a set of one or more words, a statement, a request, question, and/or command), wherein the second respective user inquiry is different from the first respective user inquiry. In some embodiments, the input corresponding to the request to modify the text based on a second respective user inquiry includes selection of a button to modify the text. In some embodiments, the input corresponding to the request to modify the text based on the second respective user inquiry includes a press of a tab key on a keyboard. In some embodiments, the input corresponding to the request to modify the text based on the second respective user inquiry includes one or more key presses of the keyboard corresponding to the second respective user inquiry, and/or a press of the enter key. In some embodiments, in response to (and/or while) detecting the input (e.g., 905m1, 905n1, and/or 905o1) corresponding to the request to modify the text (e.g., 640) based on the second respective user inquiry (e.g., 905m1, 905n1, and/or 905o1), in accordance with a determination that the second respective user inquiry (e.g., 912e and/or 912f) is a first user inquiry, the computer system modifies the text (e.g., 640) (e.g., the first portion of the text, the second portion of the text, and/or another portion of the text different from the first portion of the text and the second portion of the text) including a third modification (e.g., 916, 918, 936, 938, 940) to the third portion of the text and a fourth modification (e.g., 916, 918, 936, 938, 940) to the fourth portion of the text, wherein the third modification includes a different change than the fourth modification (e.g., as described above with respect to FIG. 9P). In some embodiments, modifying the text includes displaying, via the one or more display generation components, the third portion of the text with the third modification and the fourth portion of the text with the fourth modification. In some embodiments, the third modification is different from the first modification and/or the second modification. In some embodiments, the third modification is the same as the first modification and/or the second modification. In some embodiments, the fourth modification is different from the first modification and/or the second modification. In some embodiments, the fourth modification is the same as the first modification and/or the second modification. In some embodiments, in response to detecting the input corresponding to the request to modify the text based on the second respective user inquiry, in accordance with a determination that the second respective user inquiry (e.g., 912e and/or 912f) is a second user inquiry different from the first user inquiry, the computer system modifies the text (e.g., 640) (e.g., the first portion of the text, the second portion of the text, and/or another portion of the text different from the first portion of the text and the second portion of the text) including a fifth modification (e.g., 916, 918, 936, 938, 940) to the fifth portion of the text and a sixth modification (e.g., 916, 918, 936, 938, 940) to the sixth portion of the text (e.g., as described above with respect to FIG. 9P), wherein the fifth modification includes a different change than the sixth modification. In some embodiments, modifying the text includes displaying, via the one or more display generation components, the fifth portion of the text with the fifth modification and the sixth portion of the text with the sixth modification. In some embodiments, the fifth modification is different from the first modification and/or the second modification. In some embodiments, the sixth modification is the same as the first modification and/or the second modification. In some embodiments, the fifth modification is different from the first modification and/or the second modification. In some embodiments, the sixth modification is the same as the first modification and/or the second modification. Modifying different portions of text when different user inquiries are detected enables the computer system to perform different modifications for different inquiries as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the respective user inquiry (e.g., 912e and/or 912f) is a first respective user inquiry. In some embodiments, the text (e.g., 640) includes a seventh portion of the text and an eighth portion of the text different from the seventh portion of the text. In some embodiments, after (and/or while) displaying the first portion of the text with the first modification (e.g., 916, 918, 936, 938, 940) and the second portion of the text with the second modification (e.g., 916, 918, 936, 938, 940), the computer system detects, via the one or more input devices (e.g., 652, 652a, 652b, 652c, 652d, 652e, and/or 652f), an input (e.g., 905m1, 905n1, and/or 905o1) corresponding to a request to modify the text (e.g., 640) based on a third respective user inquiry (e.g., 912e and/or 912f) (e.g., a user-selected prompt, a selected prompt, an inquiry, a user-selected inquiry, a selected inquiry, prompt, a set of one or more characters, a set of one or more words, a statement, a request, question, and/or command), wherein the third respective user inquiry is different from the first respective user inquiry. In some embodiments, the input corresponding to the request to modify the text based on the third respective user inquiry includes selection of a button to modify the text. In some embodiments, the input corresponding to the request to modify the text based on the third respective user inquiry includes a press of a tab key on a keyboard. In some embodiments, the input corresponding to the request to modify the text based on the third respective user inquiry includes one or more key presses of the keyboard corresponding to the third respective user inquiry and/or a press of the enter key. In some embodiments, in response to (and/or while) detecting the input (e.g., 905m1, 905n1, and/or 905o1) corresponding to the request to modify the text (e.g., 640) based on the third respective user inquiry (e.g., 912e and/or 912f), in accordance with a determination that the third respective user inquiry (e.g., 912e and/or 912f) is a third user inquiry, the computer system modifies (e.g., using an artificial intelligence (e.g., “AI”) process or a generative AI process) the text (e.g., 640) including a seventh modification (e.g., using an artificial intelligence (e.g., “AI”) process or a generative AI process) (e.g., 916, 918, 936, 938, 940) to the seventh portion of the text and an eighth modification (e.g., using an artificial intelligence (e.g., “AI”) process or a generative AI process) (e.g., 916, 918, 936, 938, 940) to the eighth portion of the text, wherein the seventh modification includes a different change than the eighth modification (e.g., as described above with respect to FIG. 9P). In some embodiments, modifying the text includes displaying, via the one or more display generation components, the seventh portion of the text with the seventh modification and the eighth portion of the text with the eighth modification. In some embodiments, the seventh modification is different from the first modification and/or the second modification. In some embodiments, the seventh modification is the same as the first modification and/or the second modification. In some embodiments, the eighth modification is different from the first modification and/or the second modification. In some embodiments, the eighth modification is the same as the first modification and/or the second modification. In some embodiments, in response to detecting the input corresponding to the request to modify the text based on the third respective user inquiry, in accordance with a determination that the third respective user inquiry (e.g., 912e and/or 912f) is a fourth user inquiry different from the third user inquiry, the computer system modifies (e.g., using an artificial intelligence (e.g., “AI”) process or a generative AI process) the text (e.g., 640) including a ninth modification (e.g., using an artificial intelligence (e.g., “AI”) process or a generative AI process) (e.g., 916, 918, 936, 938, 940) to the seventh portion of the text and a tenth modification (e.g., using an artificial intelligence (e.g., “AI”) process or a generative AI process) (e.g., 916, 918, 936, 938, 940) to the eighth portion of the text, wherein the ninth modification includes a different change than the seventh modification and the tenth modification, and wherein the tenth modification includes a different change than the eighth modification (e.g., as described above with respect to FIG. 9P). In some embodiments, modifying the text includes displaying, via the one or more display generation components, the seventh portion of the text with the ninth modification and the eighth portion of the text with the tenth modification. In some embodiments, the ninth modification is different from the first modification and/or the second modification. In some embodiments, the ninth modification is the same as the first modification and/or the second modification. In some embodiments, the tenth modification is different from the first modification and/or the second modification. In some embodiments, the tenth modification is the same as the first modification and/or the second modification. Modifying the same portion of text differently when different user inquiries are detected enables the computer system to modify multiple portions of text with different inquiries as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the first portion of the text with the first modification (e.g., 916, 918, 936, 938, 940) and the second portion of the text with the second modification (e.g., 916, 918, 936, 938, 940) are displayed concurrently (e.g., as described above with respect to FIGS. 9P-9T). In some embodiments, before concurrently displaying the first portion of the text with the first modification (e.g., 916, 918, 936, 938, 940) and the second portion of the text with the second modification (e.g., 916, 918, 936, 938, 940), the computer system displays, via the one or more display generation components, the first portion of the text with the first modification without displaying the second portion of the text with the second modification (e.g., as described above with respect to FIGS. 9P-9T). In some embodiments, displaying the first portion of the text with the first modification and the second portion of the text with the second modification includes displaying the first portion of the text with the first modification sequentially (and/or one and then another, and/or based on location of the portion of the text) with the second portion of the text with the second modification. In some embodiments, before concurrently displaying the first portion of the text with the first modification and the second portion of the text with the second modification, the computer system displays, via the one or more display generation components, the second portion of the text with the second modification without displaying the first portion of the text with the first modification. In some embodiments, displaying the first portion of the text with the first modification and the second portion of the text with the second modification includes displaying the first portion of the text with the first modification sequentially as they are generated (e.g., using an artificial intelligence (e.g., “AI”) process or a generative AI process) (e.g., by the computer system and/or a different computer system) in response to detecting the input corresponding to the request to modify the text based on the respective user inquiry. Displaying a portion of text with a modification before concurrently displaying the portion of the text with a different portion of the text with another modification enables the computer system to display each modification sequentially, thereby performing an operation when a set of conditions has been met without requiring further user input, reducing the number of inputs needed to perform an operation, and/or providing improved visual feedback to the user.

In some embodiments, displaying the first portion of the text with the first modification (e.g., 916, 918, 936, 938, 940) and the second portion of the text with the second modification (e.g., 916, 918, 936, 938, 940) includes concurrently displaying, via the one or more display generation components, the first portion of the text with the first modification and the second portion of the text with the second modification (e.g., as described above with respect to FIGS. 9P-9T). In some embodiments, after modifying the text in response to detecting the input corresponding to the request to modify the text based on the respective user inquiry, the computer system displays, via the one or more display generation components, the first portion of the text with the first modification and the second portion of the text with the second modification after receiving (and/or generating) the first portion of the text with the first modification (e.g., a first code generation prompt) and the second portion of the text with the second modification (e.g., a second code generation prompt). Concurrently displaying a portion of text with a modification and another portion of the text with a different modification enables the computer system to show modifications to a user, thereby performing an operation when a set of conditions has been met without requiring further user input, reducing the number of inputs needed to perform an operation, and/or providing improved visual feedback to the user.

In some embodiments, detecting the input (e.g., 905i1, 905i2, and/or 905i3) corresponding to the request to modify the text (e.g., 640) based on the respective user inquiry (e.g., 912e and/or 912f) includes detecting, via the one or more input devices (e.g., 652, 652a, 652b, 652c, 652d, 652e, and/or 652f), a prompt being entered. In some embodiments, the prompt is a set of one or more characters. In some embodiments, the set of one or more characters is typed on a keyboard and/or input by voice input. In some embodiments, the prompt is a question and/or request corresponding to the text. In some embodiments, the prompt optionally includes text (e.g., code). In some embodiments, the text was previously entered and/or in additional portions of the text different from the first portion of the text and/or the second portion of the text (e.g., in a file including the text, and/or not displayed by the one or more display generation components).

In some embodiments, before detecting the input (e.g., 905m and/or 905n1) corresponding to the request to modify the text (e.g., 640) based on the respective user inquiry (e.g., 912e and/or 912f) (and/or in conjunction with displaying the text including the first portion of the text and the second portion of the text), the computer system detects, via the one or more input devices (e.g., 652, 652a, 652b, 652c, 652d, 652e, and/or 652f), an input (e.g., 905o1) corresponding to the respective user inquiry. In some embodiments, the input corresponding to the respective user inquiry includes a mouse click and/or a tap on a button for submitting the respective user inquiry. In some embodiments, the input corresponding to the respective user inquiry includes a voice input of the respective user inquiry (e.g., “how do I make price color change based on price drop?”). In some embodiments, in response to detecting the input (e.g., 905o1) corresponding to the respective user inquiry (e.g., 912e and/or 912f), the computer system displays, via the one or more display generation components, a user interface element (e.g., an affordance, a selectable user interface element, an icon, a widget, a control, a button, a user interface, and/or a window) to modify the text (e.g., 640) (e.g., to modify the first portion of the text and/or the second portion of the text) based on the respective user inquiry, wherein detecting the input corresponding to the request to modify the text based on the respective user inquiry includes detecting an input corresponding to the user interface element to modify the text based on the respective user inquiry. In some embodiments, the user interface element to modify the text is a proposed response to (e.g., the first portion of the text with the first modification and/or the second portion of the text with the second modification) the respective user inquiry. Displaying a user interface element to modify text in response to detecting an input corresponding to a respective user inquiry enables the computer system to display modifications before applying them to the text as directed by the user, thereby reducing the number of inputs needed to perform an operation and/or providing improved visual feedback to the user.

In some embodiments, after modifying the text (e.g., 640) in response to detecting the input (e.g., 905m and/or 905n1) corresponding to the request to modify the text (e.g., 640) (and/or while displaying the first portion of the text with the first modification and the second portion of the text with the second modification), the computer system displays, via the one or more display generation components, an indication (e.g., a description, summary, a user-interface preview, a representation, a visual representation, a selectable user interface element, an icon, a widget, a control, a button, a user interface, and/or a window) of the first modification (e.g., 916, 918, 936, 938, 940) and the second modification (e.g., 916, 918, 936, 938, 940), wherein the indication is separate from (and/or different from) the first portion of the text with the first modification and the second portion of the text with the second modification. Displaying an indication of a portion of text with a modification and a different indication of a different portion of the text with a different modification enables the computer system to provide additional explanation of the first modification and the second modification as directed by the user, thereby reducing the number of inputs needed to perform an operation and/or providing improved visual feedback to the user.

In some embodiments, a first user interface includes the text (e.g., 640) (and/or the first portion of the text and/or the second portion of the text). In some embodiments, after modifying the text (e.g., 640) in response to detecting the input corresponding to the request to modify the text (and/or while displaying the first portion of the text with the first modification and the second portion of the text with the second modification), the computer system displays, via the one or more display generation components, an option (e.g., 912b) (e.g., a user interface element, a selectable user interface element, a control, and/or a button) to display information corresponding (and/or related) to the first modification (e.g., 916, 918, 936, 938, 940) and the second modification (e.g., 916, 918, 936, 938, 940) in the second user interface. In some embodiments, while displaying the option to display information corresponding to the first modification and the second modification in the second user interface, the computer system detects, via the one or more input devices, an input (e.g., 912b) corresponding to the option to display information corresponding to the first modification and the second modification in the second user interface. In some embodiments, the input corresponding to the option to display information corresponding to the first modification and the second modification in the second user interface includes a click on a button for displaying information corresponding to the first modification and the second modification. In some embodiments, the input corresponding to the option to display information corresponding to the first modification and the second modification in the second user interface includes a voice input corresponding to displaying information corresponding to the first modification and the second modification (e.g., “tell me more”). In some embodiments, in response to detecting the input corresponding to the option to display information corresponding to the first modification and the second modification in the second user interface, the computer system displays, via the one or more display generation components, the second user interface (e.g., 934) including the information corresponding to the first modification and the second modification. In some embodiments, the second user interface is navigated (e.g., changed view of content and/or moved a portion of the text in the second user interface) separately from the first user interface. In some embodiments, the information includes data not previously displayed. In some embodiments, the information includes data corresponding to the request to modify the text. In some embodiments, the information includes data corresponding to the text. Displaying a user interface element to display related information in a different user interface in response to an input corresponding to an option to display information corresponding to the related information enables the computer system to display additional information as directed by the user in a separate user interface and distinguishing the related information from the text, thereby reducing the number of inputs needed to perform an operation and/or providing improved visual feedback to the user.

In some embodiments, after modifying the text (e.g., 640) in response to detecting the input corresponding to the request to modify the text and while displaying the first portion of the text with the first modification (e.g., 916, 918, 936, 938, 940) (and/or while displaying the second portion of the text with the second modification), the computer system detects, via the one or more input devices (e.g., 652, 652a, 652b, 652c, 652d, 652e, and/or 652f), an input (e.g., 905p, 905q, 905r, and/or 905s) corresponding to a request to view (e.g., display, navigate through, and/or change to) a subsequent modification (e.g., 916, 918, 936, 938, 940) to the text (e.g., as described above with respect to FIGS. 9P-9T). In some embodiments, the input corresponding to the request to view the subsequent modification to the text includes selection of a button to navigate the text. In some embodiments, the input corresponding to the request to view the subsequent modification to the text includes a press of an arrow key on a keyboard. In some embodiments, the input corresponding to the request to view the subsequent modification to the text includes one or more key presses of the keyboard. In some embodiments, in response to detecting the input (e.g., 905p, 905q, 905r, and/or 905s) corresponding to the request to view the subsequent modification (e.g., 916, 918, 936, 938, 940) to the text (e.g., 640), the computer system displays, via the one or more display generation components, a third portion of the text with a third modification (e.g., automatically-generated text content and or generative text content) (e.g., 916, 918, 936, 938, 940) different from the first portion of the text with the first modification (e.g., 916, 918, 936, 938, 940) (e.g., as described above with respect to FIGS. 9P-9T). In some embodiments, the third portion of the text is different from the first portion of the text and/or the second portion of the text. In some embodiments, the third portion of the text is the same as and separate from the first portion of the text and/or the second portion of the text. In some embodiments, modifying the text includes the third modification to the third portion of the text. In some embodiments, the third modification includes a different modification than the first modification and/or the second modification. In some embodiments, the third modification includes the same modification as the first modification and/or the second modification. Navigating to another portion of text with another modification in response to detecting an input corresponding to a request to navigate enables the computer system to display different modifications as directed by the user and/or display additional modifications that would not otherwise fit in a displayable area, thereby reducing the number of inputs needed to perform an operation and/or providing improved visual feedback to the user.

In some embodiments, the input (e.g., 905p, 905q, 905r, and/or 905s) corresponding to the request to view the subsequent modification (e.g., 916, 918, 936, 938, 940) to the text (e.g., 640) includes a user input. In some embodiments, the user input is a mouse click and/or a tap input on a button for viewing subsequent modifications to the text. In some embodiments, the user input is an air gesture corresponding to viewing subsequent modifications to the text (e.g., a swipe). In some embodiments, the user input includes a gesture shortcut corresponding to viewing subsequent modifications to the text (e.g., an input corresponding to one or more different inputs to perform an operation) (e.g., tab key and m key).

In some embodiments, the input (e.g., 905p, 905q, 905r, and/or 905s) corresponding to the request to view the subsequent modification (e.g., 916, 918, 936, 938, 940) to the text (e.g., 640) includes a selection of a user interface element (e.g., 922a and/or 922b) (e.g., an option, a selectable user interface element, an icon, a widget, a control, a button, a user interface, and/or a window) to navigate through one or more subsequent modifications. In some embodiments, the computer system displays the third interface element to navigate through the one or more subsequent modifications after modifying the text in response to detecting the input corresponding to the request to modify the text, and while displaying the first portion of the text with the first modification (and/or while displaying the second portion of the text with the second modification), and before detecting the input corresponding to the request to view the subsequent modification to the text. Navigating through one or more subsequent modifications by selecting a user interface element enables the computer system to display controls that navigate modifications when directed by the user, thereby reducing the number of inputs needed to perform an operation and/or providing improved visual feedback to the user.

In some embodiments, before (and/or while) detecting the input (e.g., 905p, 905q, 905r, and/or 905s) corresponding to the request to view (e.g., display, navigate through, and/or change to) a subsequent modification to the text (e.g., 640), the computer system displays, via the one or more display generation components, (1) the user interface element (e.g., 922a and/or 922b) to navigate through the one or more subsequent modifications and (2) a user interface element (e.g., 922a and/or 922b) to navigate through one or more prior modifications, wherein the user interface element to navigate through the one or more subsequent modifications is different from the user interface element to navigate through the one or more prior modifications. In some embodiments, while displaying the user interface element (e.g., 922a and/or 922b) to navigate through the one or more subsequent modifications and the user interface element to navigate through the one or more prior modifications, the computer system detects, via the one or more input devices (e.g., 652, 652a, 652b, 652c, 652d, 652e, and/or 652f), an input (e.g., 905p, 905q, 905r, and/or 905s) corresponding to a respective user interface element. In some embodiments, the input on the respective user interface element includes selection of the user interface element to navigate through the one or more subsequent modifications or the user interface element to navigate through the one or more prior modifications. In some embodiments, the input on the respective user interface element includes a press of an arrow key on a keyboard. In some embodiments, in response to detecting the input (e.g., 905p, 905q, 905r, and/or 905s) on the respective user interface element, in accordance with a determination that the respective user interface element (e.g., 922a and/or 922b) is the user interface element to navigate through the one or more subsequent modifications, the computer system displays a fifth portion of the text in a first direction (e.g., up and/or down in the text) from the first portion of the text with the first modification (e.g., 916, 918, 936, 938, 940) (and/or the second portion of the text with the second modification). In some embodiments, the fifth portion of the text is a subsequent portion of the text that was modified from the first portion of the text and/or the second portion of the text. In some embodiments, in response to detecting the input on the respective user interface element, in accordance with a determination that the respective user interface element (e.g., 922a and/or 922b) is the user interface element to navigate through the one or more prior modifications, the computer system displays a sixth portion of the text in a second direction from the first portion of the text with the first modification (e.g., 916, 918, 936, 938, 940) (and/or the second portion of the text with the second modification), wherein the second direction is different from the first direction. In some embodiments, the sixth portion of the text is a prior portion of the text that was modified from the first portion of the text and/or the second portion of the text. Displaying a portion of text in a first direction from another portion of the text when a user interface element to navigate through one or more subsequent modifications is selected and in a second direction from the other portion of the text when a user interface element to navigate through one or more prior modifications enables the computer system to provide controls for navigation in different direction when selected and directed by the user, thereby reducing the number of inputs needed to perform an operation and/or providing improved visual feedback to the user.

In some embodiments, the input corresponding to the request to view the subsequent modification (e.g., 916, 918, 936, 938, 940) to the text (e.g., 640) is a first input (e.g., 905p, 905q, 905r, and/or 905s) corresponding to the request to view the subsequent modification to the text. In some embodiments, after (and/or while) displaying the third portion of the text with the third modification (e.g., 916, 918, 936, 938, 940), the computer system detects, via the one or more input devices (e.g., 652, 652a, 652b, 652c, 652d, 652e, and/or 652f), a second input (e.g., 905p, 905q, 905r, and/or 905s) corresponding to a request to view (e.g., display, navigate through, and/or change to) a subsequent modification (e.g., 916, 918, 936, 938, 940) to the text (e.g., 640), wherein the second input corresponding to the request to view the subsequent modification to the text is the same as (e.g., same type and/or same gesture) and separate from the first input (e.g., 905p, 905q, 905r, and/or 905s) corresponding to the request to view the subsequent modification to the text. In some embodiments, the second input corresponding to the request to view the subsequent modification to the text includes selection of a button to navigate the text. In some embodiments, the second input corresponding to the request to view the subsequent modification to the text includes a press of an arrow key on a keyboard. In some embodiments, the second input corresponding to the request to view the subsequent modification to the text includes one or more key presses of the keyboard. In some embodiments, in response to detecting the second input (e.g., 905p, 905q, 905r, and/or 905s) corresponding to the request to view the subsequent modification (e.g., 916, 918, 936, 938, 940) to the text (e.g., 640), the computer system displays, via the one or more display generation components, a seventh portion of the text with a seventh modification (e.g., automatically-generated text content and or generative text content) (e.g., 916, 918, 936, 938, 940) different from first modification (e.g., 916, 918, 936, 938, 940) and the second modification (e.g., 916, 918, 936, 938, 940). In some embodiments, the seventh portion of the text is different from the first portion of the text and/or the second portion of the text. In some embodiments, the seventh portion of the text is the same as and separate from the first portion of the text and/or the second portion of the text. Displaying a portion of text with a modification in response to detecting another input corresponding to a request to view a subsequent modification to the text enables the computer system to navigate multiple times to different modifications as directed by the user, thereby reducing the number of inputs needed to perform an operation and/or providing improved visual feedback to the user.

In some embodiments, in response to (and/or while) detecting the input (e.g., 905m and/or 905n1) corresponding to the request to modify the text (e.g., 640) based on the second respective user inquiry (e.g., 912e and/or 912f) (and/or after modifying the text in response to detecting the input corresponding to the request to modify the text and while displaying the first portion of the text with the first modification and/or while displaying the second portion of the text with the second modification), the computer system displays, via the one or more display generation components, an indication (e.g., 922) (e.g., a preview, a user-interface preview, a representation, a visual representation, a selectable user interface element, an icon, a widget, a control, a button, a user interface, and/or a window) of a number (e.g., quantity and/or total) of different modifications (e.g., changes, amendments, and/or differences). Displaying an indication of a number of different modifications after modifying text enables the computer system to indicate to a user how many changes were made when modifying the text as directed by the user, thereby reducing the number of inputs needed to perform an operation and/or providing improved visual feedback to the user.

In some embodiments, before detecting the input (e.g., 905m and/or 905n1) corresponding to the request to modify the text (e.g., 640) based on the respective user inquiry (e.g., 912e and/or 912f), the computer system detects, via the one or more input devices (e.g., 652, 652a, 652b, 652c, 652d, 652e, and/or 652f), an input (e.g., 905e) corresponding to (e.g., directed to, at a location of, related to and/or associated with) a request to select (e.g., as described above in relation to process 700) an eighth portion of the text, wherein the respective user inquiry is based on the eighth portion of the text (e.g., in response to the eighth portion of the text being selected while detecting the input corresponding to the request to modify the text based on the respective user inquiry), and wherein the input corresponding to the request to modify the text based on the respective user inquiry is detected while the eighth portion of the text is selected (e.g., as described above in relation to process 700). In some embodiments, the input corresponding to the request to select the eighth portion of the text includes a selection input followed by movement input that moves over the eighth portion of the text. In some embodiments, the input corresponding to the request to select the eighth portion of the text includes one or more mouse clicks, a right mouse click, a left mouse click, and/or a double tap over at least a portion of the eighth portion of the content. In some embodiments, the eighth portion of the text is the same as the first portion of the text and/or the second portion of the text. In some embodiments, the eighth portion of the text is different from as the first portion of the text and/or the second portion of the text. Detecting an input corresponding to a request to select a portion of text before detecting an input corresponding to a request to modify the text based on a respective user inquiry enables the computer system to modify the text based on selected portions as directed by the user (e.g., focus on the selected portion), thereby reducing the number of inputs needed to perform an operation, performing an operation when a set of conditions has been met without requiring further user input, and/or providing improved visual feedback to the user.

In some embodiments, the request to modify the text (e.g., 640) based on the respective user inquiry (e.g., 912e and/or 912f) is a request to modify the text based on a first respective user inquiry. In some embodiments, after detecting multiple requests to modify the text (e.g., 640) (e.g., based on the respective user inquiry and/or a user inquiry different from the respective user inquiry), the computer system includes the request to modify the text based on the first respective user inquiry (e.g., 912e and/or 912f) and a request to modify the text based on a sixth respective user inquiry, displaying, via the one or more display generation components, a representation (e.g., 924) (e.g., text, images, and/or videos) of the request to modify the text based on the first respective user inquiry and a representation of the request to modify the text based on the sixth respective user inquiry. In some embodiments, the representation of the request to modify the text based on the first respective user inquiry and the representation of the request to modify the text based on the sixth respective user inquiry are displayed in a list of additional representation of requests to modify the text based on respective user inquiries. Displaying a representation of a request to modify text based on a first respective user inquiry and a representation of a request to modify the text based on a second respective user inquiry enables the computer system to provide a history of requests entered by user(s), thereby reducing the number of inputs needed to perform an operation and/or providing improved visual feedback to the user.

In some embodiments, the representation (e.g., 924) of the request to modify the text (e.g., 640) based on the first respective user inquiry (e.g., 912e and/or 912f) corresponds to a first set of one or more modifications to the text (e.g., that have not been undone, reversed, and/or deleted). In some embodiments, the representation of the request to modify the text based on the sixth respective user inquiry corresponds to a second set one or more modifications (e.g., that have not been undone, reversed, and/or deleted) different from the first set of one or more modifications. Displaying representations of requests to modify text that were not undone enables the computer system to display relevant information to a user of modifications to the text, thereby reducing the number of inputs needed to perform an operation and/or providing improved visual feedback to the user.

In some embodiments, the representation (e.g., 924) of the request to modify the text (e.g., 640) based on the first respective user inquiry (e.g., 912e and/or 912f) includes a portion of the request to modify the text based on the first respective user inquiry. In some embodiments, the first respective user inquiry is a prompt (e.g., as described above). In some embodiments, the portion of the request to modify the text based on the first respective user inquiry includes a summary of the first respective user inquiry to modify the text. Displaying a portion of a request to modify text enables the computer system to display which prompts were performed, thereby reducing the number of inputs needed to perform an operation and/or providing improved visual feedback to the user.

In some embodiments, the representation (e.g., 924) of the request to modify the text (e.g., 640) based on the first respective user inquiry (e.g., 912e and/or 912f) includes a first set of one or more of details (e.g., a first set of features and/or a first content). In some embodiments, after (and/or while) displaying the representation (e.g., 924) of the request to modify the text (e.g., 640) based on the first respective user inquiry (e.g., 912e and/or 912f) (and/or the representation of the request to modify the text based on the sixth respective user inquiry), the computer system detects, via the one or more input devices (e.g., 652, 652a, 652b, 652c, 652d, 652e, and/or 652f), an input (e.g., 905u1) corresponding to selection of the representation of the request to modify the text based on the first respective user inquiry. In some embodiments, the input corresponding to the selection of the representation of the request to modify the text based on the first respective user inquiry includes a mouse click and/or a tap on the representation of the request to modify the text based on the first respective user inquiry. In some embodiments, the input corresponding to the selection of the representation of the request to modify the text based on the first respective user inquiry includes a press of an enter key on a keyboard. In some embodiments, in response to detecting the input (e.g., 905u1) corresponding to the selection of the representation of the request to modify the text (e.g., 640) based on the first respective user inquiry (e.g., 912e and/or 912f), the computer system displays, via the one or more display generation components, a second set of one or more details (e.g., a second set of features and/or a second content), different from the first set of one or more details, corresponding to the request to modify the text based on the first respective user inquiry (e.g., without removing the first set of one or more details and/or changing an appearance of content corresponding to the first set of one or more details) (e.g., as described above with respect to FIG. 9V). In some embodiments, the second set of one or more details include additional features and/or content not included in the first set of one or more details. Displaying additional details with respect to a request to modify text in response to detecting an input corresponding to a selection of a representation of the request enables the computer system to provide additional details as directed by the user, thereby reducing the number of inputs needed to perform an operation and/or providing improved visual feedback to the user.

In some embodiments, displaying the second set of one or more details includes displaying, via the one or more display generation components, the first portion of the text with the first modification (e.g., 916, 918, 936, 938, 940) (and/or the second portion of the text with the second modification) (e.g., as described above with respect to FIG. 9V).

In some embodiments, displaying the second set of one or more details includes displaying, via the one or more display generation components, a representation (e.g., 914a) (e.g., text, images, and/or videos) of a reason that the first modification (e.g., 916, 918, 936, 938, 940) (and/or the second modification) was made (e.g., as described above with respect to FIG. 9V).

In some embodiments, the representation of the request to modify the text (e.g., 640) based on the first respective user inquiry (e.g., 912e and/or 912f) and the representation of the request to modify the text based on the sixth respective user inquiry are displayed in chronological order (e.g., as described above with respect to FIG. 9U) (e.g., from most recent request to modify the text to least recent request to modify the text).

In some embodiments, displaying the first portion of the text (e.g., 640) with the first modification (e.g., 916, 918, 936, 938, 940) includes emphasizing (e.g., highlighting, coloring, displaying in bold text, with a border and/or visually distinguishing) the first portion of the text (and/or the second portion of the text) relative to one or more other portions of the text (e.g., as described above with respect to FIGS. 9P-9T). In some embodiments, emphasizing the first portion of the text includes maintaining emphasis of the first portion of the text for a threshold period of time. In some embodiments, the computer system fades emphasis of the first portion of the text over a threshold period of time. In some embodiments, after modifying the text in response to detecting the input corresponding to the request to modify the text, the computer system does not emphasize (and/or deemphasizes) the one or more other portions of the text. Emphasizing a portion of text relative to one or more portions of the text enables the computer system to indicate which portions were modified as directed by the user, thereby reducing the number of inputs needed to perform an operation and/or providing improved visual feedback to the user.

In some embodiments, the respective user inquiry (e.g., 912e and/or 912f) is a first respective user inquiry. In some embodiments, after (and/or while) displaying the first portion of the text with the first modification (e.g., 916, 918, 936, 938, 940) (and/or the second portion of the text with the second modification), the computer system detects, via the one or more input devices (e.g., 652, 652a, 652b, 652c, 652d, 652e, and/or 652f), an input (e.g., 905m1, 905n1, and/or 905o1) corresponding to a request to modify the text (e.g., 640) based on an eighth respective user inquiry (e.g., 912e and/or 912f) different from the first user inquiry (e.g., a user-selected prompt, a selected prompt, a prompt, a user-selected inquiry, a selected inquiry, a set of one or more characters, a set of one or more words, a statement, a request, question, and/or command). In some embodiments, the input corresponding to the request to modify the text based on the eighth respective user inquiry includes selection of a button to modify the text. In some embodiments, the input corresponding to the request to modify the text based on the eighth respective user inquiry includes a press of a tab key on a keyboard. In some embodiments, the input corresponding to the request to modify the text based on the eighth respective user inquiry includes one or more key presses of the keyboard corresponding to the sixth respective user inquiry, and/or a press of the enter key. In some embodiments, the input corresponding to the request to modify the text based on the eighth respective user inquiry is different from the input corresponding to the request to modify the text based on the first respective user inquiry. In some embodiments, the input corresponding to the request to modify the text based on the eighth respective user inquiry is the same as and separate from the input corresponding to the request to modify the text based on the first respective user inquiry. In some embodiments, in response to (and/or while) detecting the input (e.g., 905m1, 905n1, and/or 905o1) corresponding to the request to modify the text (e.g., 640) based on the eighth respective user inquiry (e.g., 912e and/or 912f), the computer system modifies (e.g., using an artificial intelligence (e.g., “AI”) process or a generative AI process) the text (e.g., the first portion of the text, the second portion of the text, and/or another portion of the text different from the first portion of the text and the second portion of the text) including (and/or consisting of) an eighth modification (e.g., using an artificial intelligence (e.g., “AI”) process or a generative AI process) (e.g., 916, 918, 936, 938, 940) to a ninth portion of the text (and/or no additional portion of the text different from the ninth portion of the text). In some embodiments, the ninth portion of the text is different from the first portion of the text and/or the second portion of the text. In some embodiments, the ninth portion of the text is the same as and separate from the first portion of the text and the second portion of the text. In some embodiments, the eighth modification is different from the first modification and/or the second modification. In some embodiments, the eighth modification is the same as the first modification and/or the second modification. In some embodiments, modifying the text includes displaying, via the one or more display generation components, the ninth portion of the text with the eighth modification. In some embodiments, after modifying the text (e.g., 640) in response to detecting the input corresponding to the request to modify the text based on the eighth respective user inquiry (e.g., 912e and/or 912f), the computer system displays, via the one or more display generation components, the ninth portion of the text with the eighth modification (e.g., 916, 918, 936, 938, 940). In some embodiments, in response to detecting the input corresponding to the request to modify the text based on the eighth respective user inquiry, the computer system maintains display of, via the one or more display generation components, the text (e.g., the ninth portion of the text and/or another portion of the text). Displaying a portion of text with a modification after modifying the text in response to detecting an input corresponding to a request to modify the text based on a respective user inquiry enables the computer system to modify single portions of text based on the inquiry of the user (e.g., not always multiple portions), thereby reducing the number of inputs needed to perform an operation and/or providing improved visual feedback to the user.

Note that details of the processes described above with respect to process 1100 (e.g., FIG. 11) are also applicable in an analogous manner to the processes described herein. For example, process 700 optionally includes one or more of the characteristics of the various processes described herein with reference to process 1100. For example, modifying the multiple portions of text of method 1100 can occur based on the respective user inquiry of the method 800. For brevity, these details are not repeated herein.

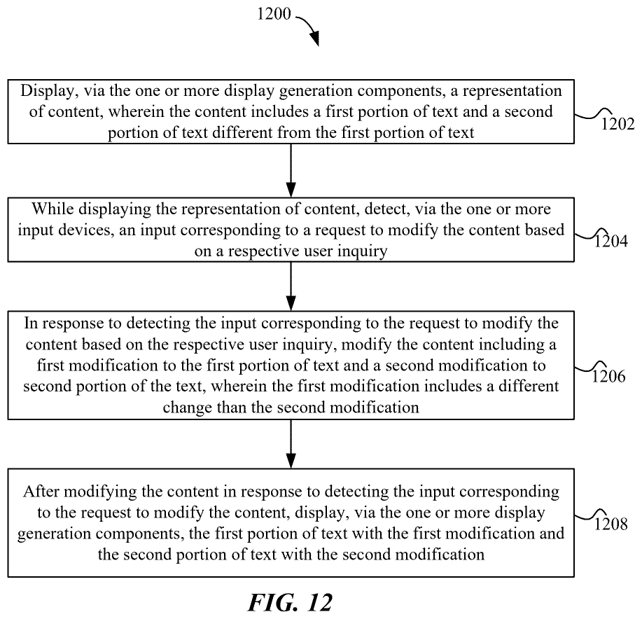

FIG. 12 is a flow diagram illustrating a process (e.g., process 1200) for modifying multiple portions of text as the result of an input to a request to modify content in accordance with some embodiments. Some operations in process 1200 are, optionally, combined, the orders of some operations are, optionally, changed, and some operations are, optionally, omitted.

As described below, process 1200 provides an intuitive way for modifying multiple portions of text as the result of an input to a request to modify content. Process 1200 reduces the cognitive burden on a user, thereby creating a more efficient human-machine interface. For battery-operated computing devices, enabling a user to interact with such devices faster and more efficiently conserves power and increases the time between battery charges.

In some embodiments, process 1200 is performed at a computer system (e.g., 600) that is in communication (e.g., wired communication and/or wireless communication) with one or more input devices (e.g., 652, 652a, 652b, 652c, 652d, 652e, and/or 652f) (e.g., a camera, a depth sensor, a microphone, a hardware input mechanism, a rotatable input mechanism, a heart monitor, a temperature sensor, and/or a touch-sensitive surface) and one or more display generation components (e.g., a display screen, a projector, and/or a touch-sensitive display). In some embodiments, the computer system is a phone, a watch, a tablet, a fitness tracking device, a wearable device, an accessory, a speaker, a light, a head-mounted display (HMD), and/or a personal computing device.

The computer system displays (1202), via the one or more display generation components, a representation of content (e.g., 640) (e.g., a representation of a file, a representation of a portion of a file, a representation of a project that includes multiple files, or a representation of a portion of a project that includes multiple files), wherein the content includes a first portion of text and a second portion of text (and/or a third portion of text different from the first portion of text and the second portion of text) different from the first portion of text. In some embodiments, the third portion of text is between the first portion of text and the second portion of text. In some embodiments, the first portion of text and the second portion of text are in a single file. In some embodiments, the first portion of text and the second portion of text are in different files.

While displaying the representation of content (e.g., the first portion of text, the second portion of text, and/or another portion of text different from the first portion of text and the second portion of text), the computer system detects (1204), via the one or more input devices (e.g., 652, 652a, 652b, 652c, 652d, 652e, and/or 652f), an input (e.g., 905m, 905n1, and/or 905y1) corresponding to a request to modify the content based on a respective user inquiry (e.g., a user-selected prompt, a selected prompt, an inquiry, a user-selected inquiry, a selected inquiry, prompt, a set of one or more characters, a set of one or more words, a statement, a request, question, and/or command). In some embodiments, the input, corresponding to the request to modify the content based on the respective user inquiry, includes selection of a button to modify the content. In some embodiments, the input, corresponding to the request to modify the content based on the respective user inquiry, includes a press of a tab key on a keyboard. In some embodiments, the input, corresponding to the request to modify the content based on the respective user inquiry, includes one or more key presses of the keyboard corresponding to the respective user inquiry, and/or a press of the enter key. In some embodiments, the input, corresponding to the request to modify the content based on the respective user inquiry, corresponds to a request to modify content in one or more files and/or documents based on the respective user inquiry. In some embodiments, the one or more files and/or documents are a collection of interrelated elements (e.g., files, documents, a project, an executable, a software program, a code repository, a folder, a group, and/or set of data).

In response to (and/or while) detecting the input (e.g., 905m, 905n1, and/or 905y1) corresponding to the request to modify the content (e.g., 640) based on the respective user inquiry (e.g., 912e, 912f, and/or 912g), the computer system modifies (1206) the content (e.g., the first portion of text, the second portion of text, and/or another portion of text different from the first portion of text and the second portion of text) (e.g., using an artificial intelligence (e.g., “AI”) process or a generative AI process) including a first modification (e.g., 916, 918, 936, 938, 940, 954, 962, 970, 978, 980, and/or 982) (e.g., automatically-generated text content and or generative text content) to the first portion of text and a second modification (e.g., 916, 918, 936, 938, 940, 954, 962, 970, 978, 980, and/or 982) (e.g., automatically-generated content and or generative content) to the second portion of text, wherein the first modification includes a different change than the second modification (e.g., without a modification to the third portion of text). In some embodiments, modifying the content includes displaying, via the one or more display generation components, the content with a first modification.

After modifying the content (e.g., 640) (e.g., using an artificial intelligence (e.g., “AI”) process or a generative AI process) in response to detecting the input corresponding to the request to modify the content, the computer system displays (1208), via the one or more display generation components, the first portion of text with the first modification (e.g., 916, 918, 936, 938, 940, 954, 962, 970, 978, 980, and/or 982) and the second portion of text with the second modification (e.g., 916, 918, 936, 938, 940, 954, 962, 970, 978, 980, and/or 982). In some embodiments, in response to detecting the input corresponding to the request to modify the content based on the respective user inquiry, the computer system maintains display of, via the one or more display generation components, the representation of the content. In some embodiments, the representation of the content is a first representation of content. In some embodiments, in response to detecting the input corresponding to the request to modify the content based on the respective user inquiry, the computer system displays, via the one or more display generation components, a second representation of the content without displaying the first modification to the first portion of text and/or the second modification to the second portion of text (e.g., a representation of another portion of text is displayed). In some embodiments, the first portion of text is included in a first file, and the second portion of text is included in the first file. In some embodiments, the first portion of text is included in a first file, and the second portion of text is included in a second file different from the first file. Displaying a portion of text with a modification after modifying the content in response to detecting an input corresponding to a request to modify the content enables the computer system to modify multiple different portions of text as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the respective user inquiry (e.g., 912e, 912f, and/or 912g) is a first respective user inquiry. In some embodiments, the content (e.g., 640) includes a third portion of text, a fourth portion of text different from the third portion of text, a fifth portion of text different from the third portion of text and the fourth portion of text, and a sixth portion of text different from the third portion of text, the fourth portion of text, and the fifth portion of text. In some embodiments, the third portion of text is different from the first portion of text and/or the second portion of text. In some embodiments, the fourth portion of text is different from the first portion of text and the second portion of text. In some embodiments, the fifth portion of text is different from the first portion of text and the second portion of text. In some embodiments, the sixth portion of text is different from the first portion of text and the second portion of text. In some embodiments, after (and/or while) displaying the first portion of text with the first modification (e.g., 916, 918, 936, 938, 940, 954, 962, 970, 978, 980, and/or 982) and the second portion of text with the second modification (e.g., 916, 918, 936, 938, 940, 954, 962, 970, 978, 980, and/or 982), the computer system detects, via the one or more input devices (e.g., 652, 652a, 652b, 652c, 652d, 652e, and/or 652f), an input (e.g., 905m1, 905n1, 905o1, and/or 905y1) corresponding to a request to modify the content based on a second respective user inquiry (e.g., 905m1, 905n1, 905o1, and/or 905y1) (e.g., a user-selected prompt, a selected prompt, an inquiry, a user-selected inquiry, a selected inquiry, prompt, a set of one or more characters, a set of one or more words, a statement, a request, question, and/or command), wherein the second respective user inquiry is different from the first respective user inquiry. In some embodiments, the input, corresponding to the request to modify the content based on the second respective user inquiry, includes selection of a button to modify the content. In some embodiments, the input, corresponding to the request to modify the content based on the second respective user inquiry, includes a press of a tab key on a keyboard. In some embodiments, the input, corresponding to the request to modify the content based on the second respective user inquiry, includes one or more key presses of the keyboard corresponding to the second respective user inquiry, and/or a press of the enter key. In some embodiments, in response to (and/or while) detecting the input (e.g., 905m1, 905n1, 905o1, and/or 905y1) corresponding to the request to modify the content (e.g., 640) based on the second respective user inquiry (e.g., 905m1, 905n1, 905o1, and/or 905y1), in accordance with a determination that the second respective user inquiry is a first user inquiry, the computer system modifies the content (e.g., 640) (e.g., the first portion of text, the second portion of text, and/or another portion of text different from the first portion of text and the second portion of text) (e.g., using an artificial intelligence (e.g., “AI”) process or a generative AI process) including a third modification (e.g., 916, 918, 936, 938, 940, 954, 962, 970, 978, 980, and/or 982) (e.g., automatically-generated text content and or generative text content) to the third portion of text and a fourth modification (e.g., 916, 918, 936, 938, 940, 954, 962, 970, 978, 980, and/or 982) (e.g., automatically-generated text content and or generative text content) to the fourth portion of text, wherein the third modification includes a different change than the fourth modification (e.g., as described above with respect to FIG. 9P). In some embodiments, modifying the content includes displaying, via the one or more display generation components, the third portion of text with the third modification and/or the fourth portion of text with the fourth modification. In some embodiments, the third modification is different from the first modification and/or the second modification. In some embodiments, the third modification is the same as the first modification and/or the second modification. In some embodiments, the fourth modification is different from the first modification and/or the second modification. In some embodiments, the fourth modification is the same as the first modification and/or the second modification. In some embodiments, in response to detecting the input corresponding to the request to modify the content based on the second respective user inquiry, in accordance with a determination that the second respective user inquiry (e.g., 912e, 912f, and/or 912g) is a second user inquiry different from the first user inquiry, the computer system modifies the content (e.g., 640) (e.g., the first portion of text, the second portion of text, and/or another portion of text different from the first portion of text and the second portion of text) (e.g., using an AI process or a generative AI process) including a fifth modification (e.g., 916, 918, 936, 938, 940, 954, 962, 970, 978, 980, and/or 982) (e.g., automatically-generated text content and or generative text content) to the fifth portion of text and a sixth modification (e.g., 916, 918, 936, 938, 940, 954, 962, 970, 978, 980, and/or 982) (e.g., automatically-generated text content and or generative text content) to the sixth portion of (e.g., as described above with respect to FIG. 9P) text, wherein the fifth modification includes a different change than the sixth modification. In some embodiments, modifying the content includes displaying, via the one or more display generation components, the fifth portion of text with the fifth modification and the sixth portion of text with the sixth modification. In some embodiments, the fifth modification is different from the first modification and/or the second modification. In some embodiments, the sixth modification is the same as the first modification and/or the second modification. In some embodiments, the fifth modification is different from the first modification and/or the second modification. In some embodiments, the sixth modification is the same as the first modification and/or the second modification. Modifying different portions of text when different user inquiries are detected enables the computer system to perform different modifications for different inquiries as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the respective user inquiry (e.g., 912e, 912f, and/or 912g) is a first respective user inquiry. In some embodiments, the content (e.g., 640) includes a seventh portion of text and an eighth portion of text different from the seventh portion of text. In some embodiments, after (and/or while) displaying the first portion of text with the first modification (e.g., 916, 918, 936, 938, 940, 954, 962, 970, 978, 980, and/or 982) and the second portion of text with the second modification (e.g., 916, 918, 936, 938, 940, 954, 962, 970, 978, 980, and/or 982), the computer system detects, via the one or more input devices (e.g., 652, 652a, 652b, 652c, 652d, 652e, and/or 652f), an input (e.g., 905m1, 905n1, 905o1, and/or 905y1) (e.g., a selection input and/or a non-selection input) corresponding to a request to modify the content (e.g., 640) based on a third respective user inquiry (e.g., 912e, 912f, and/or 912g) (e.g., a user-selected prompt, a selected prompt, an inquiry, a user-selected inquiry, a selected inquiry, prompt, a set of one or more characters, a set of one or more words, a statement, a request, question, and/or command), wherein the third respective user inquiry is different from the first respective user inquiry. In some embodiments, the input, corresponding to the request to modify the content based on the third respective user inquiry, includes selection of a button to modify the content. In some embodiments, the input, corresponding to the request to modify the content based on the third respective user inquiry, includes a press of a tab key on a keyboard. In some embodiments, the input, corresponding to the request to modify the content based on the third respective user inquiry, includes one or more key presses of the keyboard corresponding to the third respective user inquiry and/or a press of the enter key. In some embodiments, in response to (and/or while) detecting the input (e.g., 905m1, 905n1, 905o1, and/or 905y1) corresponding to the request to modify the content (e.g., 640) based on the third respective user inquiry (e.g., 912e, 912f, and/or 912g), in accordance with a determination that the third respective user inquiry (e.g., 912e, 912f, and/or 912g) is a third user inquiry, the computer system modifies (e.g., using an artificial intelligence (e.g., “AI”) process or a generative AI process) the content (e.g., 640) including a seventh modification (e.g., 916, 918, 936, 938, 940, 954, 962, 970, 978, 980, and/or 982) (e.g., automatically-generated text content and or generative text content) to the seventh portion of text and an eighth modification (e.g., 916, 918, 936, 938, 940, 954, 962, 970, 978, 980, and/or 982) (e.g., automatically-generated text content and or generative text content) to the eighth portion of text, wherein the seventh modification includes a different change than the eighth modification (e.g., as described above with respect to FIG. 9P). In some embodiments, modifying the content includes displaying, via the one or more display generation components, the seventh portion of text with the seventh modification and the eighth portion of text with the eighth modification. In some embodiments, the seventh modification is different from the first modification and/or the second modification. In some embodiments, the seventh modification is the same as the first modification and/or the second modification. In some embodiments, the eighth modification is different from the first modification and/or the second modification. In some embodiments, the eighth modification is the same as the first modification and/or the second modification. In some embodiments, in response to detecting the input corresponding to the request to modify the content based on the third respective user inquiry, in accordance with a determination that the third respective user inquiry (e.g., 912e, 912f, and/or 912g) is a fourth user inquiry different from the third user inquiry, the computer system modifies (e.g., using an AI process or a generative AI process) the content including a ninth modification (e.g., 916, 918, 936, 938, 940, 954, 962, 970, 978, 980, and/or 982) (e.g., automatically-generated text content and or generative text content) to the seventh portion of text and a tenth modification (e.g., automatically-generated text content and or generative text content) to the eighth portion of text, wherein the ninth modification includes a different change than the seventh modification and the tenth modification, and wherein the tenth modification includes a different change than the eighth modification (e.g., as described above with respect to FIG. 9P). In some embodiments, modifying the content includes displaying, via the one or more display generation components, the seventh portion of text with the ninth modification and the eighth portion of text with the tenth modification. In some embodiments, the ninth modification is different from the first modification and/or the second modification. In some embodiments, the ninth modification is the same as the first modification and/or the second modification. In some embodiments, the tenth modification is different from the first modification and/or the second modification. In some embodiments, the tenth modification is the same as the first modification and/or the second modification. Modifying the same portion of text differently when different user inquiries are detected enables the computer system to modify multiple portions of text with different inquiries as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, the first portion of text with the first modification (e.g., 916, 918, 936, 938, 940, 954, 962, 970, 978, 980, and/or 982) and the second portion of text with the second modification (e.g., 916, 918, 936, 938, 940, 954, 962, 970, 978, 980, and/or 982) are displayed concurrently (e.g., as described above with respect to FIGS. 9P-9T). In some embodiments, before concurrently displaying the first portion of text with the first modification (e.g., 916, 918, 936, 938, 940, 954, 962, 970, 978, 980, and/or 982) and the second portion of text with the second modification (e.g., 916, 918, 936, 938, 940, 954, 962, 970, 978, 980, and/or 982), the computer system displays, via the one or more display generation components, the first portion of text with the first modification without displaying the second portion of text with the second modification (e.g., as described above with respect to FIGS. 9P-9T). In some embodiments, displaying the first portion of text with the first modification and the second portion of text with the second modification includes displaying the first portion of text with the first modification sequentially (and/or one and then another, and/or based on location of the portion of text) with the second portion of text with the second modification. In some embodiments, before concurrently displaying the first portion of text with the first modification and the second portion of text with the second modification, the computer system displays, via the one or more display generation components, the second portion of text with the second modification without displaying the first portion of text with the first modification. In some embodiments, displaying the first portion of text with the first modification and the second portion of text with the second modification includes displaying the first portion of text with the first modification sequentially as they are generated (e.g., by an artificial intelligence (e.g., “AI”) process or a generative AI process) (e.g., by the computer system and/or a different computer system) in response to detecting the input corresponding to the request to modify the content based on the respective user inquiry. Displaying a portion of text with a modification before concurrently displaying the portion of text with a different portion of text with another modification enables the computer system to display each modification sequentially, thereby performing an operation when a set of conditions has been met without requiring further user input, reducing the number of inputs needed to perform an operation, and/or providing improved visual feedback to the user.

In some embodiments, displaying the first portion of text with the first modification (e.g., 916, 918, 936, 938, 940, 954, 962, 970, 978, 980, and/or 982) and the second portion of text with the second modification (e.g., 916, 918, 936, 938, 940, 954, 962, 970, 978, 980, and/or 982) includes concurrently displaying, via the one or more display generation components, the first portion of text with the first modification and the second portion of text with the second modification (e.g., as described above with respect to FIGS. 9P-9T). In some embodiments, after modifying the content in response to detecting the input corresponding to the request to modify the content based on the respective user inquiry, the computer system displays, via the one or more display generation components, the first portion of text with the first modification and the second portion of text with the second modification after receiving (and/or generating) the first portion of text with the first modification (e.g., a first code generation prompt) and the second portion of text with the second modification (e.g., a second code generation prompt). Concurrently displaying a portion of text with a modification and another portion of text with a different modification enables the computer system to show modifications to a user, thereby performing an operation when a set of conditions has been met without requiring further user input, reducing the number of inputs needed to perform an operation, and/or providing improved visual feedback to the user.

In some embodiments, detecting the input (e.g., 905i1, 905i2, and/or 905i3) corresponding to the request to modify the content (e.g., 640) based on the respective user inquiry (e.g., 912e, 912f, and/or 912g) includes detecting, via the one or more input devices (e.g., 652, 652a, 652b, 652c, 652d, 652e, and/or 652f), a prompt being entered. In some embodiments, the prompt is a set of one or more characters. In some embodiments, the set of one or more characters is typed on a keyboard and/or input by voice input. In some embodiments, the prompt is a question and/or request corresponding to the content. In some embodiments, the prompt optionally includes text (e.g., code). In some embodiments, the content was previously entered and/or in additional portions of the content different from the first portion of text and/or the second portion of text (e.g., in a file including the content, and/or not displayed by the one or more display generation components).

In some embodiments, before detecting the input (e.g., 905m and/or 905n1) corresponding to the request to modify the content (e.g., 640) based on the respective user inquiry (e.g., 912e, 912f, and/or 912g) (and/or in conjunction with displaying the representation of the content including the first portion of text and the second portion of text), the computer system detects, via the one or more input devices (e.g., 652, 652a, 652b, 652c, 652d, 652e, and/or 652f), an input (e.g., 905o1) (e.g., a selection input and/or a non-selection input) corresponding to the respective user inquiry. In some embodiments, the input corresponding to the respective user inquiry includes a tap input on a button for submitting the respective user inquiry. In some embodiments, the input corresponding to the respective user inquiry includes a voice input of the respective user inquiry (e.g., “how do I make price color change based on price drop?”). In some embodiments, in response to detecting the input (e.g., 905o1) corresponding to the respective user inquiry (e.g., 912e, 912f, and/or 912g), the computer system displays, via the one or more display generation components, a user interface element (e.g., an affordance, a selectable user interface element, an icon, a widget, a control, a button, a user interface, and/or a window) to modify the content (e.g., 640) (e.g., to modify the first portion of text and/or the second portion of text) based on the respective user inquiry, wherein detecting the input corresponding to the request to modify the content based on the respective user inquiry includes detecting an input corresponding to the user interface element to modify the content based on the respective user inquiry. In some embodiments, the user interface element to modify the content is a proposed response to (e.g., the first portion of text with the first modification and/or the second portion of text with the second modification) the respective user inquiry. Displaying a user interface element to modify text in response to detecting an input corresponding to a respective user inquiry enables the computer system to display modifications before applying them to the content as directed by the user, thereby reducing the number of inputs needed to perform an operation and/or providing improved visual feedback to the user.

In some embodiments, after modifying the content in response to detecting the input (e.g., 905m and/or 905n1) corresponding to the request to modify the content (e.g., 640) (and/or while displaying the first portion of text with the first modification and the second portion of text with the second modification), the computer system displays, via the one or more display generation components, an indication (e.g., a description, summary, a user-interface preview, a representation, a visual representation, a selectable user interface element, an icon, a widget, a control, a button, a user interface, and/or a window) of the first modification (e.g., 916, 918, 936, 938, 940, 954, 962, 970, 978, 980, and/or 982) and the second modification (e.g., 916, 918, 936, 938, 940, 954, 962, 970, 978, 980, and/or 982), wherein the indication is separate from (and/or different from) the first portion of text with the first modification and the second portion of text with the second modification. Displaying an indication of a portion of text with a modification and a different indication of a different portion of text with a different modification enables the computer system to provide additional explanation of the first modification and the second modification as directed by the user, thereby reducing the number of inputs needed to perform an operation and/or providing improved visual feedback to the user.

In some embodiments, a first user interface includes the content (e.g., 640) (and/or the first portion of text and/or the second portion of text). In some embodiments, after modifying the content in response to detecting the input corresponding to the request to modify the content (and/or while displaying the first portion of text with the first modification and the second portion of text with the second modification), the computer system displays, via the one or more display generation components, an option (e.g., 912b) (e.g., a user interface element, a selectable user interface element, a control, and/or a button) to display information corresponding (and/or related) to the first modification (e.g., 916, 918, 936, 938, 940, 954, 962, 970, 978, 980, and/or 982) and the second modification (e.g., 916, 918, 936, 938, 940, 954, 962, 970, 978, 980, and/or 982) in a second user interface (e.g., 924). In some embodiments, while displaying the option (e.g., 912b) to display information corresponding to the first modification (e.g., 916, 918, 936, 938, 940, 954, 962, 970, 978, 980, and/or 982) and the second modification (e.g., 916, 918, 936, 938, 940, 954, 962, 970, 978, 980, and/or 982) in the second user interface (e.g., 924), the computer system detects, via the one or more input devices, an input (e.g., 905t1) corresponding to the option to display information corresponding to the first modification and the second modification in the second user interface. In some embodiments, the input corresponding to the option to display information corresponding to the first modification and the second modification in the second user interface includes a click on a button for displaying information corresponding to the first modification and the second modification. In some embodiments, the input corresponding to the option to display information corresponding to the first modification and the second modification in the second user interface includes a voice input corresponding to displaying information corresponding to the first modification and the second modification (e.g., “tell me more”). In some embodiments, in response to detecting the input (e.g., 905t1) corresponding to the option to display information corresponding to the first modification (e.g., 916, 918, 936, 938, 940, 954, 962, 970, 978, 980, and/or 982) and the second modification (e.g., 916, 918, 936, 938, 940, 954, 962, 970, 978, 980, and/or 982) in the second user interface (e.g., 924), the computer system displays, via the one or more display generation components, the second user interface including the information corresponding to the first modification and the second modification. In some embodiments, the second user interface is navigated (e.g., changed view of content and/or moved a portion of text in the second user interface) separately from the first user interface. In some embodiments, the information includes data not previously displayed. In some embodiments, the information includes data corresponding to the request to modify the content. In some embodiments, the information includes data corresponding to the content. Displaying a user interface element to display related information in a different user interface in response to an input corresponding to an option to display information corresponding to the related information enables the computer system to display additional information as directed by the user in a separate user interface and distinguishing the related information from the content, thereby reducing the number of inputs needed to perform an operation and/or providing improved visual feedback to the user.

In some embodiments, after modifying the content (e.g., 640) in response to detecting the input corresponding to the request to modify the content and while displaying the first portion of text with the first modification (e.g., 916, 918, 936, 938, 940, 954, 962, 970, 978, 980, and/or 982) (and/or while displaying the second portion of text with the second modification), the computer system detects, via the one or more input devices (e.g., 652, 652a, 652b, 652c, 652d, 652e, and/or 652f), an input (e.g., 905p, 905q, 905r, and/or 905s) (e.g., a selection input and/or a non-selection input) corresponding to a request to view (e.g., display, navigate through, and/or change to) a subsequent modification to the content (e.g., 916, 918, 936, 938, 940, 954, 962, 970, 978, 980, and/or 982) (e.g., in the same file as the modification to the content and/or a different interrelated element to the modification to the content). In some embodiments, the input corresponding to the request to view the subsequent modification to the content includes selection of a button to navigate the content. In some embodiments, the input corresponding to the request to view the subsequent modification to the content includes a press of an arrow key on a keyboard. In some embodiments, the input corresponding to the request to view the subsequent modification to the content includes one or more key presses of the keyboard. In some embodiments, in response to detecting the input (e.g., 905p, 905q, 905r, and/or 905s) corresponding to the request to view the subsequent modification (e.g., 916, 918, 936, 938, 940, 954, 962, 970, 978, 980, and/or 982) to the content, the computer system displays, via the one or more display generation components, a third portion of text with a third modification (e.g., 916, 918, 936, 938, 940, 954, 962, 970, 978, 980, and/or 982) (e.g., automatically-generated text content and or generative text content) different from the first portion of text with the first modification (e.g., 916, 918, 936, 938, 940, 954, 962, 970, 978, 980, and/or 982) (e.g., as described above with respect to FIGS. 9P-9T). In some embodiments, the third portion of text is different from the first portion of text and/or the second portion of text. In some embodiments, the third portion of text is the same as and separate from the first portion of text and/or the second portion of text. In some embodiments, modifying the content includes the third modification to the third portion of text. In some embodiments, the third modification includes a different modification than the first modification and/or the second modification. In some embodiments, the third modification includes the same modification as the first modification and/or the second modification. Navigating to another portion of text with another modification in response to detecting an input corresponding to a request to navigate enables the computer system to display different modifications as directed by the user and/or display additional modifications that would not otherwise fit in a displayable area, thereby reducing the number of inputs needed to perform an operation and/or providing improved visual feedback to the user.

In some embodiments, the input (e.g., 905p, 905q, 905r, and/or 905s) corresponding to the request to view the subsequent modification (e.g., 916, 918, 936, 938, 940, 954, 962, 970, 978, 980, and/or 982) to the content (e.g., 640) includes a user input (e.g., a selection input and/or a non-selection input). In some embodiments, the user input is a tap input on a button for viewing subsequent modifications to the content. In some embodiments, the user input is an air gesture corresponding to viewing subsequent modifications to the content (e.g., a swipe). In some embodiments, the user input includes a gesture shortcut corresponding to viewing subsequent modifications to the content (e.g., an input corresponding to one or more different inputs to perform an operation) (e.g., tab key and m key).

In some embodiments, the input (e.g., 905p, 905q, 905r, and/or 905s) corresponding to the request to view the subsequent modification (e.g., 916, 918, 936, 938, 940, 954, 962, 970, 978, 980, and/or 982) to the content (e.g., 640) includes a selection of a user interface element (e.g., an option, a selectable user interface element, an icon, a widget, a control, a button, a user interface, and/or a window) to navigate through one or more subsequent modifications. In some embodiments, the computer system displays the third interface element to navigate through the one or more subsequent modifications after modifying the content in response to detecting the input corresponding to the request to modify the content, and while displaying the first portion of text with the first modification (and/or while displaying the second portion of text with the second modification), and before detecting the input corresponding to the request to view the subsequent modification to the content. Navigating through one or more subsequent modifications by selecting a user interface element enables the computer system to display controls that navigate modifications when directed by the user, thereby reducing the number of inputs needed to perform an operation and/or providing improved visual feedback to the user.

In some embodiments, before (and/or while) detecting the input (e.g., 905p, 905q, 905r, and/or 905s) corresponding to the request to view (e.g., display, navigate through, and/or change to) a subsequent modification to the content (e.g., 640), the computer system displays, via the one or more display generation components, the user interface element (e.g., 922a and/or 922b) to navigate through the one or more subsequent modifications and a user interface element to navigate through one or more prior modifications, wherein the user interface element to navigate through the one or more subsequent modifications is different from the user interface element to navigate through the one or more prior modifications. In some embodiments, while displaying the user interface element (e.g., 922a and/or 922b) to navigate through the one or more subsequent modifications and the user interface element to navigate through the one or more prior modifications, the computer system detects, via the one or more input devices (e.g., 652, 652a, 652b, 652c, 652d, 652e, and/or 652f), an input (e.g., 905p, 905q, 905r, and/or 905s) corresponding to a respective user interface element. In some embodiments, the input on the respective user interface element includes selection of the user interface element to navigate through the one or more subsequent modifications or the user interface element to navigate through the one or more prior modifications. In some embodiments, the input on the respective user interface element includes a press of an arrow key on a keyboard. In some embodiments, in response to detecting the input (e.g., 905p, 905q, 905r, and/or 905s) on the respective user interface element, in accordance with a determination that the respective user interface element (e.g., 922a and/or 922b) is the user interface element to navigate through the one or more subsequent modifications, the computer system displays a fifth portion of text in a first direction (e.g., up and/or down in the content) from the first portion of text with the first modification (and/or the second portion of text with the second modification). In some embodiments, the fifth portion of text is a subsequent portion of text that was modified from the first portion of text and/or the second portion of text. In some embodiments, in response to detecting the input on the respective user interface element, in accordance with a determination that the respective user interface element is the user interface element to navigate through the one or more prior modifications, the computer system displays a sixth portion of text in a second direction from the first portion of text with the first modification (e.g., 916, 918, 936, 938, 940, 954, 962, 970, 978, 980, and/or 982) (and/or the second portion of text with the second modification), wherein the second direction is different from the first direction. In some embodiments, the sixth portion of text is a prior portion of text that was modified from the first portion of text and/or the second portion of text. Displaying a portion of text in a first direction from another portion of text when a user interface element to navigate through one or more subsequent modifications is selected and in a second direction from the other portion of text when a user interface element to navigate through one or more prior modifications enables the computer system to provide controls for navigation in different direction when selected and directed by the user, thereby reducing the number of inputs needed to perform an operation and/or providing improved visual feedback to the user.

In some embodiments, the input corresponding to the request to view the subsequent modification (e.g., 916, 918, 936, 938, 940, 954, 962, 970, 978, 980, and/or 982) to the content (e.g., 640) is a first input (e.g., 905p, 905q, 905r, and/or 905s) corresponding to the request to view the subsequent modification to the content. In some embodiments, after (and/or while) displaying the third portion of text with the third modification (e.g., 916, 918, 936, 938, 940, 954, 962, 970, 978, 980, and/or 982), the computer system detects, via the one or more input devices (e.g., 652, 652a, 652b, 652c, 652d, 652e, and/or 652f), a second input (e.g., 905p, 905q, 905r, and/or 905s) (e.g., a selection input and/or a non-selection input) corresponding to a request to view (e.g., display, navigate through, and/or change to) a subsequent modification to the content (e.g., 916, 918, 936, 938, 940, 954, 962, 970, 978, 980, and/or 982) (e.g., in the same file as the modification to the content and/or a different interrelated file to the modification to the content), wherein the second input corresponding to the request to view the subsequent modification to the content is the same as (e.g., same type and/or same gesture) and separate from the first input corresponding to the request to view the subsequent modification to the content. In some embodiments, the second input corresponding to the request to view the subsequent modification to the content includes selection of a button to navigate the content. In some embodiments, the second input corresponding to the request to view the subsequent modification to the content includes a press of an arrow key on a keyboard. In some embodiments, the second input corresponding to the request to view the subsequent modification to the content includes one or more key presses of the keyboard. In some embodiments, in response to detecting the second input (e.g., 905p, 905q, 905r, and/or 905s) corresponding to the request to view the subsequent modification (e.g., 916, 918, 936, 938, 940, 954, 962, 970, 978, 980, and/or 982) to the content (e.g., 640), the computer system displays, via the one or more display generation components, a seventh portion of text with a seventh modification (e.g., 916, 918, 936, 938, 940, 954, 962, 970, 978, 980, and/or 982) (e.g., automatically-generated text content and or generative text content) different from first modification (e.g., 916, 918, 936, 938, 940, 954, 962, 970, 978, 980, and/or 982) and the second modification (e.g., 916, 918, 936, 938, 940, 954, 962, 970, 978, 980, and/or 982). In some embodiments, the seventh portion of text is different from the first portion of text and/or the second portion of text. In some embodiments, the seventh portion of text is the same as and separate from the first portion of text and/or the second portion of text. Displaying a portion of text with a modification in response to detecting another input corresponding to a request to view a subsequent modification to the content enables the computer system to navigate multiple times to different modifications as directed by the user, thereby reducing the number of inputs needed to perform an operation and/or providing improved visual feedback to the user.

In some embodiments, in response to (and/or while) detecting the input (e.g., 905m and/or 905n1) corresponding to the request to modify the content based on the second respective user inquiry (e.g., 912e, 912f, and/or 912g) (and/or after modifying the content in response to detecting the input corresponding to the request to modify the content and while displaying the first portion of text with the first modification and/or while displaying the second portion of text with the second modification), the computer system displays, via the one or more display generation components, an indication (e.g., 922) (e.g., a preview, a user-interface preview, a representation, a visual representation, a selectable user interface element, an icon, a widget, a control, a button, a user interface, and/or a window) of a number (e.g., quantity and/or total) of different modifications (e.g., changes, amendments, and/or differences). Displaying an indication of a number of different modifications after modifying text enables the computer system to indicate to a user how many changes were made when modifying the content as directed by the user, thereby reducing the number of inputs needed to perform an operation and/or providing improved visual feedback to the user.

In some embodiments, before detecting the input (e.g., 905m and/or 905n1) corresponding to the request to modify the content (e.g., 640) based on the respective user inquiry (e.g., 912e, 912f, and/or 912g), the computer system detects, via the one or more input devices (e.g., 652, 652a, 652b, 652c, 652d, 652e, and/or 652f), an input (e.g., 905e) (e.g., a tap input and/or a non-tap input) corresponding to (e.g., directed to, at a location of, related to and/or associated with) a request to select (e.g., as described above in relation to process 1200) an eighth portion of text, wherein the respective user inquiry is based on the eighth portion of text (e.g., in response to the eighth portion of text being selected while detecting the input corresponding to the request to modify the content based on the respective user inquiry), and wherein the input corresponding to the request to modify the content based on the respective user inquiry is detected while the eighth portion of text is selected (e.g., as described above in relation to process 1200). In some embodiments, the input corresponding to the request to select the eighth portion of text includes a selection input followed by movement input that moves over the eighth portion of text. In some embodiments, the input corresponding to the request to select the eighth portion of text includes a double tap over at least a portion of the eighth portion of the content. In some embodiments, the eighth portion of text is the same as the first portion of text and/or the second portion of text. In some embodiments, the eighth portion of text is different from as the first portion of text and/or the second portion of text. Detecting an input corresponding to a request to select a portion of text before detecting an input corresponding to a request to modify the content based on a respective user inquiry enables the computer system to modify the content based on selected portions as directed by the user (e.g., focus on the selected portion), thereby reducing the number of inputs needed to perform an operation, performing an operation when a set of conditions has been met without requiring further user input, and/or providing improved visual feedback to the user.

In some embodiments, the request to modify the content (e.g., 640) based on the respective user inquiry (e.g., 912e, 912f, and/or 912g) is a request to modify the content based on a first respective user inquiry. In some embodiments, after detecting multiple requests to modify the content (e.g., based on the respective user inquiry and/or a user inquiry different from the respective user inquiry), the computer system includes the request to modify the content based on the first respective user inquiry (e.g., 912e, 912f, and/or 912g) and a request to modify the content based on a sixth respective user inquiry, displaying, via the one or more display generation components, a representation (e.g., 924) (e.g., text, images, and/or videos) of the request to modify the content based on the first respective user inquiry and a representation of the request to modify the content based on the sixth respective user inquiry. In some embodiments, the representation of the request to modify the content based on the first respective user inquiry and the representation of the request to modify the content based on the sixth respective user inquiry are displayed in a list of additional representation of requests to modify the content based on respective user inquiries. Displaying a representation of a request to modify text based on a first respective user inquiry and a representation of a request to modify the content based on a second respective user inquiry enables the computer system to provide a history of requests entered by user(s), thereby reducing the number of inputs needed to perform an operation and/or providing improved visual feedback to the user.

In some embodiments, the representation (e.g., 924) of the request to modify the content (e.g., 640) based on the first respective user inquiry (e.g., 912e, 912f, and/or 912g) corresponds to a first set of one or more modifications to the content (e.g., that have not been undone, reversed, and/or deleted). In some embodiments, the representation of the request to modify the content based on the sixth respective user inquiry corresponds to a second set one or more modifications (e.g., that have not been undone, reversed, and/or deleted) different from the first set of one or more modifications. Displaying representations of requests to modify text that were not undone enables the computer system to display relevant information to a user of modifications to the content, thereby reducing the number of inputs needed to perform an operation and/or providing improved visual feedback to the user.

In some embodiments, the representation (e.g., 924) of the request to modify the content (e.g., 640) based on the first respective user inquiry (e.g., 912e, 912f, and/or 912g) includes a portion of the request to modify the content based on the first respective user inquiry. In some embodiments, the first respective user inquiry is a prompt (e.g., as described above). In some embodiments, the portion of the request to modify the content based on the first respective user inquiry includes a summary of the first respective user inquiry to modify the content. Displaying a portion of a request to modify text enables the computer system to display which prompts were performed, thereby reducing the number of inputs needed to perform an operation and/or providing improved visual feedback to the user.

In some embodiments, the representation (e.g., 924) of the request to modify the content (e.g., 640) based on the first respective user inquiry includes a first set of one or more of details (e.g., a first set of features and/or a first content). In some embodiments, after (and/or while) displaying the representation (e.g., 924) of the request to modify the content (e.g., 640) based on the first respective user inquiry (e.g., 912e, 912f, and/or 912g) (and/or the representation of the request to modify the content based on the sixth respective user inquiry), the computer system detects, via the one or more input devices (e.g., 652, 652a, 652b, 652c, 652d, 652e, and/or 652f), an input (e.g., 905u1) (e.g., a selection input and/or a non-selection input) corresponding to selection of the representation of the request to modify the content based on the first respective user inquiry. In some embodiments, the input corresponding to the selection of the representation of the request to modify the content based on the first respective user inquiry includes a tap on the representation of the request to modify the content based on the first respective user inquiry. In some embodiments, the input corresponding to the selection of the representation of the request to modify the content based on the first respective user inquiry includes a press of an enter key on a keyboard. In some embodiments, in response to detecting the input (e.g., 905u1) corresponding to the selection of the representation of the request to modify the content (e.g., 640) based on the first respective user inquiry (e.g., 912e, 912f, and/or 912g), the computer system displays, via the one or more display generation components, a second set of one or more details (e.g., a second set of features and/or a second content), different from the first set of one or more details, corresponding to the request to modify the content based on the first respective user inquiry (e.g., without removing the first set of one or more details and/or changing an appearance of content corresponding to the first set of one or more details) (e.g., as described above with respect to FIG. 9V). In some embodiments, the second set of one or more details include additional features and/or content not included in the first set of one or more details. Displaying additional details with respect to a request to modify text in response to detecting an input corresponding to a selection of a representation of the request enables the computer system to provide additional details as directed by the user, thereby reducing the number of inputs needed to perform an operation and/or providing improved visual feedback to the user.

In some embodiments, displaying the second set of one or more details includes displaying, via the one or more display generation components, the first portion of text with the first modification (e.g., 916, 918, 936, 938, 940, 954, 962, 970, 978, 980, and/or 982) (and/or the second portion of text with the second modification) (e.g., as described above with respect to FIG. 9V).

In some embodiments, displaying the second set of one or more details includes displaying, via the one or more display generation components, a representation (e.g., 914a) (e.g., text, images, and/or videos) of a reason that the first modification (e.g., 916, 918, 936, 938, 940, 954, 962, 970, 978, 980, and/or 982) (and/or the second modification) was made (e.g., as described above with respect to FIG. 9V).

In some embodiments, the representation of the request to modify the content (e.g., 640) based on the first respective user inquiry (e.g., 912e, 912f, and/or 912g) and the representation of the request to modify the content based on the sixth respective user inquiry are displayed in chronological order (e.g., from most recent request to modify the content to least recent request to modify the content).

In some embodiments, displaying the first portion of text with the first modification (e.g., 916, 918, 936, 938, 940, 954, 962, 970, 978, 980, and/or 982) includes emphasizing (e.g., highlighting, coloring, displaying in bold text, with a border and/or visually distinguishing) the first portion of text (and/or the second portion of text) relative to one or more other portions of the content (e.g., as described above with respect to FIGS. 9P-9T). In some embodiments, emphasizing the first portion of text includes maintaining emphasis of the first portion of text for a threshold period of time. In some embodiments, the computer system fades emphasis of the first portion of text over a threshold period of time. In some embodiments, after modifying the content in response to detecting the input corresponding to the request to modify the content, the computer system does not emphasize (and/or deemphasizes) the one or more other portions of the content. Emphasizing a portion of text relative to one or more portions of the content enables the computer system to indicate which portions were modified as directed by the user, thereby reducing the number of inputs needed to perform an operation and/or providing improved visual feedback to the user.

In some embodiments, the respective user inquiry is a first respective user inquiry. In some embodiments, after (and/or while) displaying the first portion of text with the first modification (e.g., 916, 918, 936, 938, 940, 954, 962, 970, 978, 980, 982, 954, 962, 970, 978, 980, and/or 982) (and/or the second portion of text with the second modification), the computer system detects, via the one or more input devices (e.g., 652, 652a, 652b, 652c, 652d, 652e, and/or 652f), an input (e.g., 905m1, 905n1, and/or 905o1, and/or 905y1) (e.g., a selection input and/or a non-selection input) corresponding to a request to modify the content (e.g., 640) based on an eighth respective user inquiry (e.g., 912e, 912f, and/or 912g) different from the first respective user inquiry (e.g., a user-selected prompt, a selected prompt, a prompt, a user-selected inquiry, a selected inquiry, a set of one or more characters, a set of one or more words, a statement, a request, question, and/or command). In some embodiments, the input corresponding to the request to modify the content based on the eighth respective user inquiry includes selection of a button to modify the content. In some embodiments, the input corresponding to the request to modify the content based on the eighth respective user inquiry includes a press of a tab key on a keyboard. In some embodiments, the input corresponding to the request to modify the content based on the eighth respective user inquiry includes one or more key presses of the keyboard corresponding to the eighth respective user inquiry, and/or a press of the enter key. In some embodiments, the input corresponding to the request to modify the content based on the eighth respective user inquiry is different from the input corresponding to the request to modify the content based on the first respective user inquiry. In some embodiments, the input corresponding to the request to modify the content based on the eighth respective user inquiry is the same as and separate from the input corresponding to the request to modify the content based on the first respective user inquiry. In some embodiments, in response to (and/or while) detecting the input (e.g., 905m1, 905n1, 905o1, and/or 905y1) corresponding to the request to modify the content (e.g., 640) based on the eighth respective user inquiry (e.g., 912e, 912f, and/or 912g), the computer system modifies (e.g., using an artificial intelligence (e.g., “AI”) process or a generative AI process) the content (e.g., the first portion of text, the second portion of text, and/or another portion of text different from the first portion of text and the second portion of text) including (and/or consisting of) an eighth modification (e.g., automatically-generated text content and or generative text content) to a ninth portion of text (and/or no additional portion of text different from the ninth portion of text). In some embodiments, the ninth portion of text is different from the first portion of text and/or the second portion of text. In some embodiments, the ninth portion of text is the same as and separate from the first portion of text and the second portion of text. In some embodiments, the eighth modification is different from the first modification and/or the second modification. In some embodiments, the eighth modification is the same as the first modification and/or the second modification. In some embodiments, modifying the content includes displaying, via the one or more display generation components, the ninth portion of text with the eighth modification. In some embodiments, after modifying the content (e.g., 640) in response to detecting the input corresponding to the request to modify the content based on the eighth respective user inquiry (e.g., 912e, 912f, and/or 912g), the computer system displays, via the one or more display generation components, the ninth portion of text with the eighth modification (e.g., 916, 918, 936, 938, 940, 954, 962, 970, 978, 980, and/or 982). In some embodiments, in response to detecting the input corresponding to the request to modify the content based on the eighth respective user inquiry, the computer system maintains display of, via the one or more display generation components, the content (e.g., the ninth portion of text and/or another portion of text). Displaying a portion of text with a modification after modifying the content in response to detecting an input corresponding to a request to modify the content based on a respective user inquiry enables the computer system to modify single portions of text based on the inquiry of the user (e.g., not always multiple portions), thereby reducing the number of inputs needed to perform an operation and/or providing improved visual feedback to the user.

In some embodiments, the first modification (e.g., 916, 918, 936, 938, 940, 954, 962, 970, 978, 980, and/or 982) of the first portion of text and the second modification of the second portion of text are included in a single file (e.g., 950, 956, 964, or 972) (and/or document). Displaying a portion of text with a modification after modifying multiple portions of text from a single file enables the computer system to modify multiple different portions of the same text with a single request, thereby performing an operation when a set of conditions has been met without requiring further user input, providing additional control options without cluttering the user interface with additional displayed control, and/or providing improved visual feedback to the user.

In some embodiments, the content (e.g., 640) includes a collection of multiple interrelated files (e.g., a software program or code repository). In some embodiments, the collection of multiple interrelated files includes a first file (e.g., 950, 956, 964, or 972) and a second file (e.g., 950, 956, 964, or 972) different from the first file. In some embodiments, the first file (e.g., 950, 956, 964, or 972) includes the first portion of text and the second portion of text. In some embodiments, the second file (e.g., 950, 956, 964, or 972) includes a respective portion of text from the second file. In some embodiments, the respective portion of text is different from the first portion of text and/or the second portion of text. In some embodiments, the respective portion of text is the same as and separate from the first portion of text and the second portion of text. In some embodiments, modifying the content (e.g., 640) includes a modification (e.g., 962 and/or 982) (e.g., automatically-generated text content and or generative text content) to the respective portion of text from the second file. In some embodiments, the modification to the respective portion of text from the second file is different from the first modification and/or the second modification. In some embodiments, the modification to the respective portion of text from the second file is the same as the first modification and/or the second modification. In some embodiments, after modifying the content in response to detecting the input corresponding to the request to modify the content based on the respective user inquiry, the computer system displays, via the one or more display generation components, the modification to the respective portion of text from the second file (e.g., while displaying and/or while not displaying the first portion of text with the first modification of text and/or the second portion of text with the second modification of text). Displaying a portion of text with a modification after modifying multiple different files enables the computer system to modify multiple different portions of files with one request as directed by the user, thereby performing an operation when a set of conditions has been met without requiring further user input, providing additional control options without cluttering the user interface with additional displayed control, reducing the number of inputs needed to perform an operation, and/or providing improved visual feedback to the user.

In some embodiments, in response to detecting the input (e.g., 905m, 905n1, and/or 905y1) corresponding to the request to modify the content (e.g., 640), the computer system concurrently displays via the one or more display generation components, a portion of the first file (e.g., 950, 956, 964, or 972) (e.g., the first portion of text with the first modification, the second portion of text with the second modification, and/or another portion of text different from the first portion of text and the second portion of text) and a portion of the second file (e.g., 950, 956, 964, or 972) (e.g., the respective portion of text from the second file with the modification and/or another portion of text from the second file different from the respective portion of text from the second file). In some embodiments, before and/or while detecting the input corresponding to the request to modify the content, the computer system does not display the portion of the first file and/or the portion of the second file. Displaying a portion of each of multiple files that were modified in response to detecting a request to modify content enables the computer system to indicate the multiple files that were edited as directed by the user, thereby performing an operation when a set of conditions has been met without requiring further user input, reducing the number of inputs needed to perform an operation, and/or providing improved visual feedback to the user.

In some embodiments, the portion of the first file (e.g., 950, 956, 964, or 972) includes the first portion of text with the first modification. In some embodiments, the portion of the second file includes the respective portion of text from the second file with the modification to the respective portion of text from the second file.

In some embodiments, the portion of the first file is a first portion of the first file. In some embodiments, while concurrently displaying the first portion of the first file (e.g., 950, 956, 964, or 972) and the respective portion of text from the second file (e.g., 950, 956, 964, or 972) (and/or while displaying the first portion of text with the first modification, the second portion of text with the second modification, and/or the respective portion of text with the modification to the respective portion of text from the second file), the computer system detects, via the one or more input devices, an input (e.g., 905z, 905aa, 905ab, and/or 905ac) corresponding to a request to navigate (e.g., scroll and/or navigate, such as navigate to a different, adjacent portion of content or to a previous or next portion of text with a modification) the content (e.g., 640) (e.g., in a first direction, such as previous or backward direction, or a second direction, such as a next or forward direction). In some embodiments, in response to detecting the input (e.g., 905z, 905aa, 905ab, and/or 905ac) corresponding to the request to navigate the content (e.g., 640), the computer system ceases display of the first portion of the first file (e.g., 950, 956, 964, or 972) (e.g., as described above at FIGS. 9AB-9AD). In some embodiments, in response to detecting the input corresponding to the request to navigate the content, the computer system displays, via the one or more display generation components, a second portion of the first file (e.g., 950, 956, 964, or 972), wherein the second portion of the first file is different from the first portion of the first file (e.g., as described above at FIGS. 9AB-9AD). In some embodiments, the computer system animates ceasing display of the first portion of the first file and displaying the second portion of the first file as a scroll and/or navigation the content. In some embodiments, in response to detecting the input corresponding to the request to navigate the content, the computer system maintains display of the respective portion of text from the second file (e.g., 950, 956, 964, or 972) (e.g., without scrolling the second file and/or ceasing display of any portion of the second file). Navigating content of a file in response to a request while maintaining a place in content in a second file enables the computer system to selectively navigate particular files as directed by the user, thereby providing additional control options without cluttering the user interface with additional displayed control, and/or providing improved visual feedback to the user.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve managing content. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing content, such as user preferences for additional code, modifying code, and/or controls for the code. Accordingly, use of such personal information data enables users to have a computer system perform operations for managing content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

1. A method, comprising:
at a computer system that is in communication with one or more input devices and one or more output devices including one or more display generation components:
displaying, via the one or more display generation components, an editing user interface including content;
while displaying the editing user interface, detecting, via the one or more input devices, an input corresponding to a respective user inquiry; and
in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

2. The method of claim 1, further comprising:
in response to detecting the input corresponding to the respective user inquiry and in accordance with a determination that the respective user inquiry is a second user inquiry, different from the first user inquiry, and that the respective user inquiry corresponds to the first portion of the content, providing, via the one or more output devices, a second response that is generated based on the first portion of the content and the second user inquiry wherein the second response is different from the first response.

3. The method of claim 1, further comprising:
in response to detecting the input corresponding to the respective user inquiry and in accordance with a determination that the respective user inquiry is the first user inquiry and that the respective user inquiry corresponds to a second portion of the content different from the first portion of the content, providing, via the one or more output devices, a third response that is generated based on the second portion of the content and the first user inquiry, wherein the third response is different from the first response.

4. The method of claim 1, further comprising:
in response to detecting the input corresponding to the respective user inquiry and in accordance with a determination that the respective user inquiry is a second user inquiry, different from the first user inquiry, and that the respective user inquiry corresponds to a second portion of the content different from the first portion of the content, providing, via the one or more output devices, a fourth response that is generated based on the second portion of the content and the second user inquiry, wherein the third response is different from the first response.

5. The method of claim 1, wherein the editing user interface is a code editing user interface.

6. The method of claim 1, further comprising:
detecting, via the one or more input devices, an input corresponding to the first portion of the content; and
in response to detecting the input corresponding to the first portion of the content, emphasizing the first portion of the content relative to other portions of the content, wherein the determination that the respective user inquiry corresponds to the first portion of the content includes a determination that the first portion of the content is emphasized while detecting the input corresponding to the respective user inquiry.

7. The method of claim 6, further comprising:
in response to emphasizing the first portion of the content, displaying, via the one or more display generation components, a first user interface element.

8. The method of claim 6, further comprising:
while emphasizing the first portion of the content, displaying, via the one or more display generation components, a set of one or more user interface elements including a second user interface element corresponding to the first portion of the content.

9. The method of claim 8, wherein the first portion of the content includes a first portion of code, the method further comprising:
while displaying the set of one or more user interface elements including the second user interface element, detecting, via the one or more input devices, an input corresponding to the second user interface element; and
in response to detecting the input corresponding to the second user interface element, displaying, via the one or more display generation components, a second portion of code that is different from the first portion of code and was generated based on the first portion of code.

10. The method of claim 6, further comprising:
while emphasizing the first portion of the content, displaying, via the one or more display generation components, a first text entry field for submitting a user inquiry.

11. The method of claim 1, further comprising:
detecting, via the one or more input devices, an input corresponding to the first portion of the content, wherein the input is directed to a first position of the content; and
in response to detecting the input corresponding to the first portion of the content, displaying, via the one or more display generation components, a text-insertion element at the first position, wherein the determination that the respective user inquiry corresponds to the first portion of the content includes a determination that text-insertion element is at the first position.

12. The method of claim 1, further comprising:
while displaying the editing user interface and before detecting the input corresponding to the respective user inquiry, detecting, via the one or more input devices, an input corresponding to the first portion of the content; and
after detecting the input corresponding to the first portion of the content, displaying, via the one or more display generation components, a first set of one or more suggested user inquiries.

13. The method of claim 12, further comprising:
while displaying the one or more suggested user inquiries, detecting, via the one or more input devices, an input corresponding to a third portion of the content different from the first portion of the content; and
in response to detecting the input corresponding to the third portion of the content, displaying, via the one or more display generation components, a second set of one or more suggested user inquiries different from the first set of one or more suggested user inquiries.

14. The method of claim 12, further comprising:
while displaying the first set of one or more suggested user inquiries, detecting, via the one or more input devices, an input corresponding to a request to edit a fourth portion of the content; and
in response to detecting the input corresponding to the request to edit the fourth portion of the content, displaying, via the one or more display generation components, a third set of one or more suggested user inquiries different from the first set of one or more suggested user inquiries.

15. The method of claim 1, wherein the editing user interface includes a first text entry field, the method further comprising:
while displaying the editing user interface and before detecting the input corresponding to the respective user inquiry, detecting, via the one or more input devices, an input corresponding to the first text entry field, wherein the input corresponding to the first text entry field includes the respective user inquiry; and
in response to detecting the input corresponding to the first text entry field, displaying, via the one or more display generation components, text in the first text entry field, wherein the text corresponds to the respective user inquiry.

16. The method of claim 1, wherein the content is displayed in a first user interface of the editing user interface, and wherein providing the first response includes displaying, via the one or more display generation components, a first representation of the first response in a second user interface of the editing user interface separate from the first user interface of the editing user interface.

17. The method of claim 1, wherein the first response is generated based on a fifth portion of the content different from the first portion of the content.

18. The method of claim 1, wherein the first response includes suggested content to add to a sixth portion of the content.

19. The method of claim 18, further comprising:
after providing the first response, detecting, via the one or more input devices, an input corresponding to the suggested content; and
in response to detecting the input corresponding to the suggested content, adding the suggested content to the content.

20. The method of claim 1, wherein displaying the first response includes:
in accordance with a determination that a set of one or more criteria is satisfied, displaying, via the one or more display generation components, a third user interface element to add content corresponding to the first response; and
in accordance with a determination that the set of one or more criteria is not satisfied, displaying the first response without displaying the third user interface element to add the content corresponding to the first response.

21. The method of claim 1, wherein providing the first response includes displaying, via the one or more display generation components, a seventh portion of the content with a modification.

22. The method of claim 1, wherein the content is first content, and wherein the first response is generated based on second content different from the first content.

23. The method of claim 1, further comprising:
in response to detecting the input corresponding to the respective user inquiry and in accordance with the determination that the respective user inquiry is the first user inquiry and that the respective user inquiry corresponds to the first portion of the content, displaying, via the one or more display generation components, a first text entry field for submitting a user inquiry.

24. The method of claim 1, wherein the editing user interface includes a fourth user interface element, the method further comprising:
while displaying the fourth user interface element, detecting, via the one or more input devices, an input corresponding to the fourth user interface element; and
in response to detecting the input corresponding to the fourth user interface element:
in accordance with a determination that an eighth portion of the content is selected, displaying, via the one or more display generation components, a test for the eighth portion of the content; and
in accordance with a determination that a ninth portion of the content, different from the eighth portion of the content, is selected, displaying, via the one or more display generation components, a test for the ninth portion of the content.

25. The method of claim 24, wherein the test for the eighth portion of the content corresponds to a plurality of functions.

26. The method of claim 24, further comprising:
in response to detecting the input corresponding to the fourth user interface element and while displaying the eighth portion of the content, displaying, via the one or more display generation components, a visual indication of a result of executing the test for the eighth portion of the content, wherein the visual indication of the result of executing the test for the eighth portion of the content is at a location adjacent to the eighth portion of the content.

27. The method of claim 1, further comprising:
in response to detecting the input corresponding to the respective user inquiry and in accordance with the determination that the respective user inquiry is the first user inquiry and that the respective user inquiry corresponds to the first portion of the content, displaying, via the one or more display generation components, a summary of modifications to the content.

28. The method of claim 1, wherein providing the first response includes displaying, via the one or more display generation components, a user interface element corresponding to navigating between a first modification of a tenth portion of the content and a second modification of a eleventh portion of the content, wherein the second modification is different from the first modification.

29. The method of claim 1, further comprising:
after providing the first response, detecting, via the one or more input devices, an input corresponding to a request to display a history user interface different from the editing user interface; and
in response to detecting the input corresponding to the request to display the history user interface, displaying, via the one or more display generation components, the history user interface including a set of one or more previous user inquiries, wherein the set of one or more previous user inquiries includes the respective user inquiry.

30. The method of claim 29, further comprising:
after displaying the history user interface, detecting, via the one or more input devices, an input corresponding to a previous user inquiry of the set of one or more previous user inquiries; and
in response to detecting the input corresponding to the previous user inquiry of the set of one or more previous user inquiries, displaying, via the one or more display generation components, a previous response that was generated based on the previous user inquiry in the history user interface.

31. The method of claim 1, wherein providing the first response includes displaying, via the one or more display generation components, a first set of one or more details corresponding to the first response, the method further comprising:
while displaying the first set of one or more details corresponding to the first response, detecting, via the one or more input devices, an input corresponding to the first response; and
in response to detecting the input corresponding to the first response, displaying, via the one or more display generation components, a second set of one or more details, different from the first set of one or more details, corresponding to the first response.

32.-35. (canceled)

36. A non-transitory computer-readable storage medium storing one or more programs configured to be executed by one or more processors of a computer system that is in communication with one or more input devices and one or more output devices including one or more display generation components, the one or more programs including instructions for:
displaying, via the one or more display generation components, an editing user interface including content;
while displaying the editing user interface, detecting, via the one or more input devices, an input corresponding to a respective user inquiry; and
in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

37. A computer system configured to communicate with one or more input devices and one or more output devices including one or more display generation components, comprising:
one or more processors; and
memory storing one or more programs configured to be executed by the one or more processors, the one or more programs including instructions for:
displaying, via the one or more display generation components, an editing user interface including content;
while displaying the editing user interface, detecting, via the one or more input devices, an input corresponding to a respective user inquiry; and
in response to detecting the input corresponding to the respective user inquiry and in accordance with a determination that the respective user inquiry is a first user inquiry and that the respective user inquiry corresponds to a first portion of the content, providing, via the one or more output devices, a first response that is generated based on the first portion of the content and the first user inquiry.

38.-172. (canceled)
